(19) United States
(12) Patent Application Publication
(10) Pub. No.: US 2025/0322838 A1
(43) Pub. Date: Oct. 16, 2025

(54) IN-CANAL AND OTHER MICROPHONE SOUND CAPTURE AND SOUND OUTPUT, AND ASSOCIATED SYSTEMS, METHODS, DEVICES, AND NON-TRANSITORY COMPUTER-READABLE MEDIA

(71) Applicant: Iyo Inc., Redwood City, CA (US)

(72) Inventors: Neil David Treat, Los Gatos, CA (US); Kyle Steven Hoefer, Santa Clara, CA (US); Jason Steven Rugolo, Gilbert, AZ (US)

(73) Assignee: Iyo Inc., Redwood City, CA (US)

(21) Appl. No.: 19/178,754

(22) Filed: Apr. 14, 2025

Related U.S. Application Data
(63) Continuation-in-part of application No. 19/097,807, filed on Apr. 1, 2025.
(60) Provisional application No. 63/633,611, filed on Apr. 12, 2024.

(51) Int. Cl. G10L 21/0216; H04R 1/10

(52) U.S. Cl. CPC G10L 21/0216; H04R 1/1016; H04R 1/1083; G10L 2021/02166; H04R 2410/01; H04R 2420/07; H04R 2460/01; H04R 2460/13

(57) ABSTRACT

Utilizing in-canal microphones and other microphones in wearable devices is described. One embodiment is an ear-worn device that includes an in-canal microphone configured to capture sounds in an ear canal and an array of microphones configured to capture external sounds. The ear-worn device may utilize the in-canal microphone to determine if the user is actively speaking. Upon such a determination, the ear-worn device may turn on the array of microphones to capture the user's voice and perform beamforming to focus the array of microphones on the user's mouth. Such speech can then be processed and provided to an artificial intelligence agent. The ear-worn device may switch between using the in-canal microphone and the array of microphones to capture the user's voice depending on environmental noise, the context of the user, and the voice content. The ear-worn device may also blend captures from the in-canal microphone and the array of microphones.

### CROSS-REFERENCE TO RELATED APPLICATIONS

This application is a continuation-in-part of U.S. patent application Ser. No. 19/097,807, filed Apr. 1, 2025, and entitled “IN-CANAL AND OTHER MICROPHONE SOUND CAPTURE AND SOUND OUTPUT, AND ASSOCIATED SYSTEMS, METHODS, DEVICES, AND NON-TRANSITORY COMPUTER-READABLE MEDIA,” which claims priority to U.S. Provisional Patent Application No. 63/633,611, filed on Apr. 12, 2024, and entitled “Auditory User Interfaces.” This application is related to U.S. patent application Ser. No. 18/621,974, filed on Mar. 29, 2024, and entitled “VIRTUAL AUDITORY DISPLAY FILTERS AND ASSOCIATED SYSTEMS, METHODS, AND NON-TRANSITORY COMPUTER-READABLE MEDIA,” to U.S. patent application Ser. No. 18/622,540, filed Mar. 29, 2024, and entitled “VIRTUAL AUDITORY DISPLAY DEVICES AND ASSOCIATED SYSTEMS, METHODS, AND DEVICES,” to U.S. patent application Ser. No. 19/177,479, filed Apr. 11, 2025, and entitled “AUDITORY USER INTERFACES AND ASSOCIATED SYSTEMS, METHODS, DEVICES, AND NON-TRANSITORY COMPUTER-READABLE MEDIA,” and to U.S. patent application Ser. No. ______, filed on the same day herewith, and entitled “AUDIO MIXED REALITY AND ASSOCIATED SYSTEMS, METHODS, DEVICES, AND NON-TRANSITORY COMPUTER-READABLE MEDIA.” Each of the foregoing applications is incorporated by reference herein in its entirety.

### TECHNICAL FIELD

The present disclosure relates in general to wearable device audio capture and playback systems, and in particular to ear-worn audio capture and playback systems that utilize in-canal microphones and other microphones to facilitate or enhance speech detection, privacy, noise cancellation, and interactions with artificial intelligence agents or other signal-processing modules or with other users, such as through telephony.

### BACKGROUND

Existing ear-worn devices, such as earbuds, may have either two external microphones or an in-ear canal microphone. An external microphone may capture speech from the user's mouth, but may also pick up ambient sound from other speakers or unwanted acoustic interference, and may not fully address confidentiality; if a user speaks at normal volume, there may still be a risk that bystanders can overhear, and the microphone may also pick up extraneous chatter. An in-ear canal microphone may suffer from limited fidelity or have difficulty capturing a robust full-spectrum speech signal for advanced processing, such as voice recognition.

Conventional voice recognition systems are primarily trained on normal-volume speech. When users whisper or when bone-conducted speech is utilized, significant high-frequency and amplitude content may be lost, degrading recognition accuracy. Moreover, privacy-conscious individuals often avoid speaking aloud in shared or public spaces, but existing systems are not tuned to capture quiet, breathy vocalizations, mumbled speech, or sub-audible or sub-vocalized speech. In sub-vocalized speech, vocal cords vibrate minimally, and many speech formants lie below typical detection thresholds. Traditional voice activity detection (VAD) and standard machine learning-based speech to text models often fail to accurately identify phonemes when speech amplitude is so low. Additionally, in-canal microphones introduce unique acoustic profiles-particularly an emphasis on bone-conducted components in sub-1 kHz frequencies-which standard STT pipelines do not fully accommodate. Accordingly, existing systems do not adequately handle whispered or near-silent speech.

In closed-back or fully occluded in-canal devices, users benefit from noise isolation and the ability to capture voice with minimal external interference. However, these advantages come at the cost of internal body noise amplification. Vibrations from speaking, chewing, or movement can resonate within the sealed ear canal, causing discomfort, distorted self-perception of voice volume (leading users to speak louder), and distracting drumming or pulsating sounds (for example, footsteps, heartbeat). Current attempts at tackling occlusion rely on partial venting or equalization, which can degrade noise cancellation quality or fail to address dynamic scenarios (for example, transitioning from stillness to activity).

No admission is necessarily intended, nor should it be construed, that any of the preceding information constitutes prior art.

### SUMMARY

This disclosure describes technology for utilizing in-canal microphones and other microphones in wearable devices. One embodiment of an aspect of the technology is an ear-worn device that includes an in-canal microphone configured to capture sounds in an ear canal and an array of microphones configured to capture external sounds. The ear-worn device may utilize the in-canal microphone to determine if the user is actively speaking. Upon such a determination, the ear-worn device may turn on the array of microphones to capture the user's voice and perform beamforming to focus the array of microphones on the user's mouth. Such speech can then be processed and provided to an artificial intelligence agent. The ear-worn device may switch between using the in-canal microphone and the array of microphones to capture the user's voice depending on environmental noise, the context of the user, and the voice content. The ear-worn device may also blend captures from the in-canal microphone and the array of microphones.

The ear-worn device may utilize the in-canal microphone for other purposes. One other purpose is to detect sub-vocalized or whispered speech through the use of signal processing techniques or customized speech to text recognition models configured to recognize sub-vocalized or whispered speech.

Another purpose the ear-worn device may utilize the in-canal microphone for is to compensate for internal body noises that may resonate within the sealed ear canal. The ear-worn device may utilize noise cancellation and adaptive equalization techniques to remove or reduce such internal sounds as well as to mitigate the sensation of the user's voice being muffled or overly loud when the user is speaking.

### BRIEF DESCRIPTION OF THE DRAWINGS

The particular arrangements shown in the Figures should not be viewed as limiting. It should be understood that the illustrated elements, including the shape, size and scale, may not necessarily be drawn in actual proportion to each other.

FIG. 1A is a front bottom perspective view of a virtual auditory display device according to an embodiment.

FIG. 1B is a front elevational view of the virtual auditory display device of FIG. 1A.

FIG. 2 is a front perspective view and a rear view of an ear-worn device of the virtual auditory display device of FIG. 1A.

FIG. 3 is an exploded view of the ear-worn device of FIG. 2

FIG. 4 is an exploded view of an electronics package of the ear-worn device of FIG. 2.

FIG. 5A is a front perspective view and a rear perspective view of an acoustics package of the ear-worn device of FIG. 2.

FIG. 5B is a front perspective view and a rear perspective view of another acoustics package of another ear-worn device of the virtual auditory display device of FIG. 1A.

FIG. 5C depicts multiple views of the acoustics package of FIG. 5A.

FIG. 5D depicts multiple views of the acoustics package of FIG. 5B.

FIG. 6 is an exploded view of the acoustics package of FIG. 5A and an ear interface of the virtual auditory display device of FIG. 1A.

FIG. 7A is a rear bottom perspective view and FIG. 7B is a front top perspective view of a collar for an ear-worn device in some embodiments.

FIG. 8A is a graph depicting frequency responses of multiple audio signals for acoustic packages according to various embodiments.

FIG. 8B is another graph depicting frequency responses of multiple audio signals for acoustic packages according to various embodiments.

FIG. 9A is a rear perspective view of an ear-worn device having the collar of FIGS. 7A and 7B and a pressure-equalization vent in some embodiments.

FIG. 9B is a cross-sectional view of an ear-worn device having another pressure-equalization vent in some embodiments.

FIG. 10A is a logic block diagram of components of an electronics package of the virtual auditory display system of FIG. 1A.

FIG. 10B is another logic block diagram of components of another electronics package of the virtual auditory display system of FIG. 1A.

FIG. 11 is a front perspective view and a rear perspective view of an ear-worn device of a virtual auditory display device according to another embodiment.

FIG. 12 is an exploded view of the ear-worn device of FIG. 11.

FIG. 13 is an exploded view of the electronics package of the ear-worn device of FIG. 11.

FIG. 14 is a logic block diagram of components of the electronics package of FIG. 13.

FIGS. 15A and 15B depict multiple views of a virtual auditory display device according to another embodiment.

FIGS. 16A and 16B depict multiple views of a virtual auditory display device according to another embodiment.

FIG. 17A is a front perspective view and FIG. 17B is a rear perspective view of a virtual auditory display device according to another embodiment.

FIGS. 17C through 17G depict multiple views of an ear-worn device of the virtual auditory display device of FIGS. 17A and 17B.

FIGS. 18A and 18B depict multiple views of a controller for the virtual auditory display device of FIGS. 17A through 17G according to some embodiments.

FIG. 19 depicts a cable that may be utilized with the virtual auditory display device of FIGS. 17A through 17G and the controller of FIGS. 18A and 18B according to some embodiments.

FIG. 20 depicts a battery assembly that may be utilized with the virtual auditory display device of FIGS. 17A through 17G and the controller of FIGS. 18A and 18B according to some embodiments.

FIG. 21 depicts a wireless communications device in some embodiments.

FIGS. 22A and 22B depict multiple views of a virtual auditory display device according to another embodiment.

FIG. 23 is a diagram of an environment in which a virtual auditory display system and virtual auditory display devices may operate in some embodiments.

FIG. 24A is a block diagram depicting components of the virtual auditory display system in some embodiments.

FIG. 24B is a block diagram depicting components of an ear-worn device in some embodiments.

FIG. 24C is a block diagram depicting a process for generating acoustic environment digital filters in some embodiments.

FIG. 24D is a block diagram depicting operations of a spatialization engine of the virtual auditory display system in some embodiments.

FIG. 25A is a block diagram of a method of generating and applying digital filters in some embodiments.

FIG. 25B is a block depicting components of a filter generation system in some embodiments

FIGS. 26A through 26C are graphs of frequency responses of digital audio signals in some embodiments.

FIG. 27A depicts a distribution of center frequencies as a function of azimuth (x-axis) and elevation (y-axis) for the left ear.

FIG. 27B depicts a distribution of center frequencies as a function of azimuth (x-axis) and elevation (y-axis) for the right ear.

FIG. 28A is a graph of the center frequency of a digital filter as a function of elevation angle relative to a head orientation according to some embodiments.

FIG. 28B is a graph of user experience data of multiple trials with five different digital filters, which vary as a function of notch center frequency, in some embodiments.

FIGS. 29A through 29X depict gain modifier masks that may be applied to modify gains of digital filters in some embodiments.

FIGS. 30A and 30B depict head shadow gains produced by digital filters in some embodiments.

FIG. 30C depicts an output of the application of digital filters to a digital audio signal according to some embodiments.

FIG. 30D depicts user experience data for a transfer function based on digital filters according to some embodiments and user experience data for a prior art transfer function.

FIG. 30E depicts an example head-related transfer function (HRTF).

FIGS. 31A and 31B depict methods of generating digital filters according to some embodiments.

FIGS. 32A and 32B depict methods of applying digital filters according to some embodiments.

FIG. 32C depicts a method of generating and applying virtual auditory display filters in some embodiments.

FIGS. 33A and 33B depict an example user interface for displaying a representation of a virtual audio display in some embodiments.

FIG. 33C depicts an example user interface for adjusting settings for a virtual audio display in some embodiments.

FIG. 34 is multiple images depicting example use cases of display filter technology in some embodiments.

FIGS. 35A and 35B are diagrams of a method of personalizing digital filters in some embodiments.

FIGS. 36A and 36B depict methods of personalizing digital filters in some embodiments.

FIGS. 37A through 37C depict an example user interface for calibrating a virtual auditory display device in some embodiments.

FIGS. 37D through 37F depict an example user interface for personalizing a virtual auditory display of a virtual auditory display device in some embodiments.

FIGS. 37G through 37J depict an example user interface for providing information on calibration of a virtual auditory display device and personalization of a virtual auditory display of the virtual auditory display device in some embodiments.

FIG. 38A is an exploded view of an ear-worn device that may embody aspects of the described technology.

FIG. 38B is an exploded view of a portion of the ear-worn device of FIG. 38A.

FIG. 39 depicts an example environment in which aspects of the described technology may operate in some embodiments.

FIGS. 40-48 are flow diagrams illustrating example methods that some embodiments of aspects of the described technology may perform.

FIG. 49 depicts a block diagram of an example digital device in some embodiments.

Throughout the drawings, like reference numerals will be understood to refer to like parts, components, and structures.

### DETAILED DESCRIPTION

Described herein are virtual auditory display devices. A virtual auditory display device may include a first ear-worn device and a second ear-worn device that a person wears on the person's ears. The virtual auditory display device may receive audio signals from another device and generate virtual auditory display sound based on the audio signals. Virtual auditory display sound may refer to sounds that are capable of being perceived by the wearer of the virtual auditory display device as coming from any point in space surrounding the wearer. The virtual auditory display device may thus provide an immersive sound experience for the wearer.

Virtual auditory display devices may have a wide range of uses. For example, a music creator may use a virtual auditory display device to listen to music the music creator has produced. The music creator may then remix or modify the music based on their hearing the music rendered as virtual auditory display sound. For example, the music creator may move the location of certain sounds, emphasize certain sounds, de-emphasize certain sounds, and the like. In this fashion, the music creator may utilize the virtual auditory display device as part of an iterative process of creating music until the music creator achieves the desired effect for the music.

Another use may be by music afficionados who may utilize a virtual auditory display device to provide a listening experience that reinvigorates the music that they love. Another use may be for users who play video games. The virtual auditory display devices may allow the users to hear sounds emanating from locations that are not shown on their displays, thereby improving the users' awareness.

Another group of example use cases relate to military, non-military (for example, first responders such as police and firefighters) and/or other organizational applications. Virtual auditory display devices may be used to provide hyper-realistic virtual audio environments that facilitate virtual training for military and/or non-military personnel. For military personnel, virtual auditory display devices and associated devices may provide enhanced hearing, communications and hyper-situational awareness in combat and training. Other uses are described herein, and still other uses will be apparent.

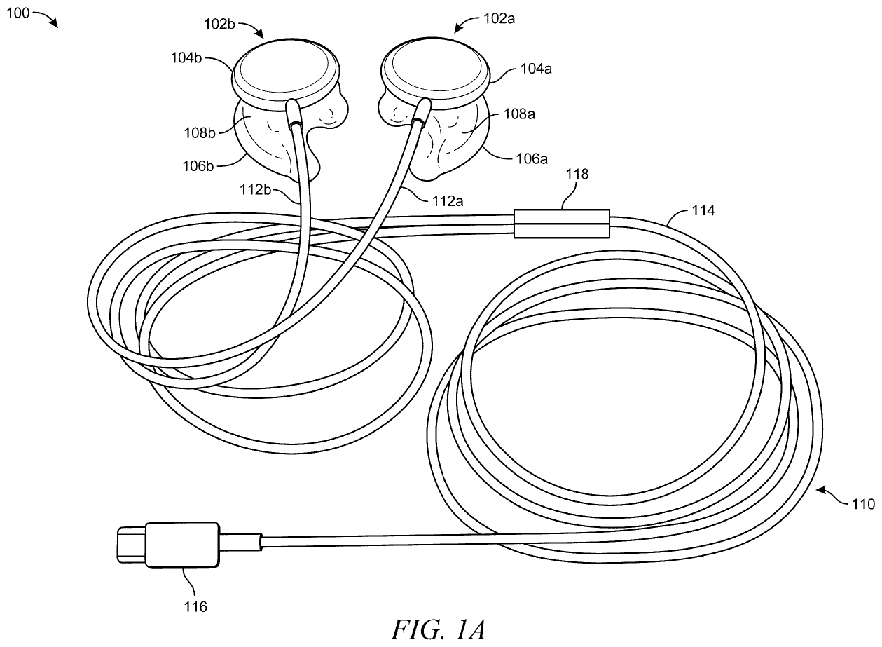

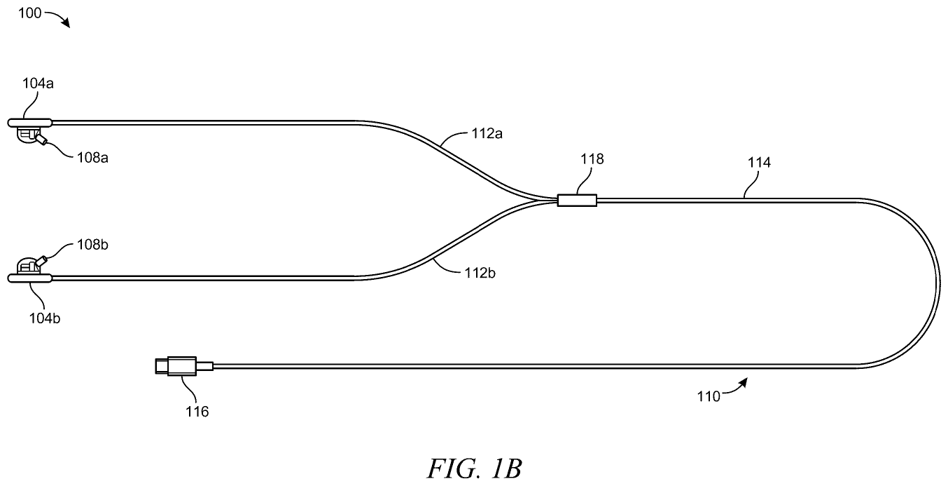

FIG. 1A is a front bottom view of a virtual auditory display device 100 according to an embodiment. The virtual auditory display device 100 includes a first ear-worn device 102a, a second ear-worn device 102b, and a cable 110. The first ear-worn device 102a includes a first electronics package 104a, a first ear interface 106a, and a first acoustic package 108a positioned within the first ear interface 106a and attached to the first electronics package 104a.

The second ear-worn device 102b includes a second electronics package 104b, a second ear interface 106b, and a second acoustic package 108b positioned within the second ear interface 106b and attached to the second electronics package 104b. The cable 110 includes a connector 116, a cable connector portion 114, a junction 118, a first cable portion 112a connected to the junction 118 and the first electronics package 104a, and a second cable portion 112b connected to the junction 118 and the second electronics package 104b.

As described in more detail herein, the first ear interface 106a is structured to be placed in a left ear of a wearer of the virtual auditory display device 100 and the second ear interface 106b is structured to be placed in a right ear of the wearer. The first ear interface 106a and the second ear interface 106b may be custom made for the wearer's ears so as to provide a generally acoustically sealed fit for the wearer's ears.

Each of the first electronics package 104a and the second electronics package 104b includes electronics components for generating audio signals based on digital audio signals received via the cable 110 from an external device, such as a phone or a computer, to which the virtual auditory display device 100 is connected. Each of the first acoustic package 108a and the second acoustic package 108b includes one or more analog components, such as one or more speakers, that are configured to emit sound based on the audio signals received from the first electronics package 104a and the second electronics package 104b respectively. The sound travels through the first ear interface 106a and the second ear interface 106b and into the ear canals of the wearers.

FIG. 1A depicts the first electronics package 104a and the second electronics package 104b as attached to the first acoustic package 108a and the second acoustic package 108b, respectively. However, as described in more detail herein, the first electronics package 104a and the second electronics package 104b may be removed from the first acoustic package 108a and the second acoustic package 108b, respectively.

The wearer may remove the first electronics package 104a and the second electronics package 104b from the first acoustic package 108a and the second acoustic package 108b and insert the first ear interface 106a into the wearer's left ear and the second ear interface 106b into the wearer's right ear. The wearer may then connect the first electronics package 104a to the first acoustic package 108a and the second electronics package 104b to the second acoustic package 108b.

Although the first ear interface 106a and the first acoustic package 108a are for the left ear of the wearer and the second ear interface 106b and the second acoustic package 108b are for the right ear of the wearer, the first electronics package 104a may be connected to either the first acoustic package 108a or the second acoustic package 108b. Similarly, the second electronics package 104b may be connected to either the first acoustic package 108a or the second acoustic package.

The user may connect the virtual auditory display device 100 to an external device such as a phone or laptop or desktop computer (not illustrated in FIG. 1A) via the connector 116 of the cable 110. The external device may stream two-channel digital audio to the first ear-worn device 102a and the second ear-worn device 102b via the cable 110. The two-channel digital audio may have been generated using virtual auditory display filters that produce audio signals that the first ear-worn device 102a and the second ear-worn device 102b use to generate virtual auditory display sound for the wearer. Virtual auditory display sound may refer to sounds that are capable of being perceived by the wearer of the virtual auditory display device 100 as coming from any point in space surrounding the wearer. The virtual auditory display device 100 may thus provide an immersive sound experience for the wearer using the sound output by the first ear-worn device 102a and the sound output by the second ear-worn device 102b. The generation of virtual auditory display filters and application of virtual auditory display filters so that the first ear-worn device 102a and the second ear-worn device 102b may output virtual auditory display sound is described in more detail herein.

FIG. 1B is a front elevational view of the virtual auditory display device 100. The first ear-worn device 102a and the second ear-worn device 102b are shown without the first acoustic package 108a and the second acoustic package 108b positioned within the first ear interface 106a and the second ear interface 106b, respectively.

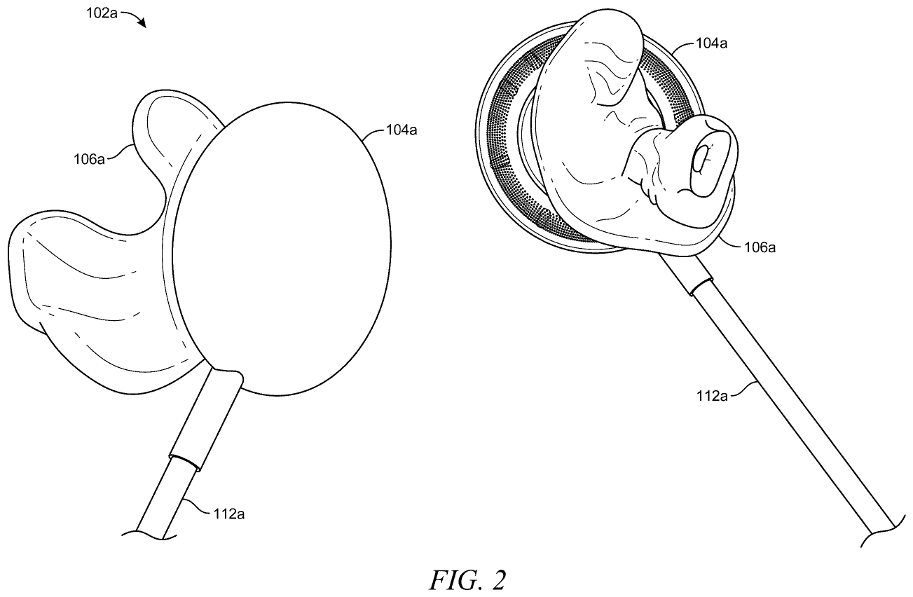

FIG. 2 depicts a front perspective view and a rear view of the first ear-worn device 102a. As described in more detail herein, the first electronics package 104a is removably magnetically coupleable to the first acoustic package 108a (not illustrated in FIG. 2), and the first acoustic package 108a is removably coupleable to the first ear interface 106a. Similarly, for the second ear-worn device 102b (not illustrated in FIG. 2), the second electronics package 104b is removably coupleable to the second acoustic package 108b and the second acoustic package 108b is removably coupleable to the second ear interface 106b.

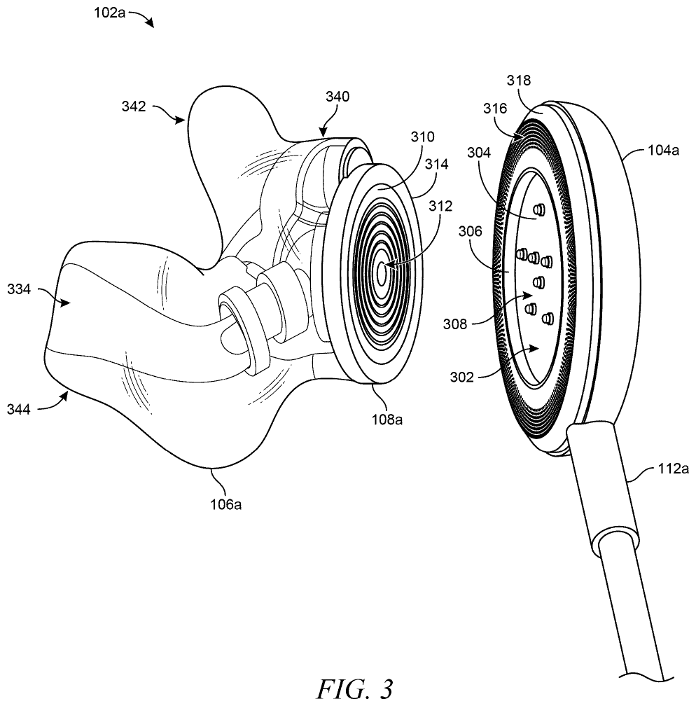

FIG. 3 is an exploded view of the first ear-worn device 102a. The first ear-worn device 102a includes the first electronics package 104a, the first acoustic package 108a, and the first ear interface 106a. The first acoustic package 108a includes a connector 310 having a generally planar surface. The connector 310 includes a first set of electrical contacts 312 on the generally planar surface. In some embodiments, the first set of electrical contacts 312 includes a set of annular electrical contacts. In some embodiments, there are seven annular electrical contacts in the set. The first acoustic package 108a also includes a magnet 314 having a generally hollow cylindrical shape.

The first electronics package 104a includes a microphone cover 318 including multiple perforations 316. The first electronics package 104a further includes a magnet 306 positioned inward relative to the microphone cover 318. The microphone cover 318 and the magnet 306 form a generally cylindrical recess 302 having a generally planar surface 304. A second set of electrical contacts 308 extend outwards from the generally planar surface 304. Each electrical contact of the second set of electrical contacts 308 is configured to connect with a separate electrical contact of the first set of electrical contacts 312 so that power and/or data may pass between the electronics package 104a and the acoustics package 108a. In some embodiments, the second set of electrical contacts 308 includes a set of pogo pins. In some embodiments, there are seven pogo pins in the set, and each pogo pin is arranged on the generally planar surface 304 such that the pogo pin contacts a separate annular electrical contact.

The generally cylindrical recess 302 has the same general shape as the magnet 314 and the connector 310 of the second acoustic package 108b. The first electronics package 104a may thus removably magnetically couple to the first acoustic package 108a. The first electronics package 104a is removably magnetically coupleable to the first acoustic package 108a due to attractive magnetic forces between the magnet 314 and the magnet 306. Similarly, the second electronics package 104b of the second ear-worn device 102b is also removably magnetically coupleable to the second acoustic package 108b due to magnetic attractive forces between corresponding magnets.

The first ear interface 106a includes a proximal portion 340, an upper portion 342, and a distal portion 344. When first ear-worn device 102a is worn by a wearer, the distal portion 344 is positioned in the left ear canal of the wearer and the upper portion 342 is positioned generally proximate to the left ear concha and generally between the left ear antihelix and helical crus of the wearer. The proximal portion 340 is positioned generally proximate to the left ear antihelix, antitragus, and tragus of the wearer.

The first ear interface 106a also includes a first opening and multiple cavities (not illustrated in FIG. 3) that allow the first acoustic package 108a to be placed into and positioned within the first ear interface 106a. The first ear interface 106a also includes a second opening (not illustrated in FIG. 3) and a passage 334 from the second opening to the first acoustic package 108a. The second ear interface 106b is structured similarly to the first ear interface 106a but for the right ear of the wearer.

The first ear interface 106a and the second ear interface 106b (not illustrated in FIG. 3) may be custom-made for a left ear and a right ear of a wearer. The first ear interface 106a and the second ear interface 106b may thus provide a generally acoustically sealed fit for the left ear and the right ear, respectively, of the wearer. The first ear interface 106a and the second ear interface 106b may be made of any suitable material, such as silicone, thermoplastic elastomers (TPE), and/or other biocompatible options, and may be transparent, translucent, or opaque.

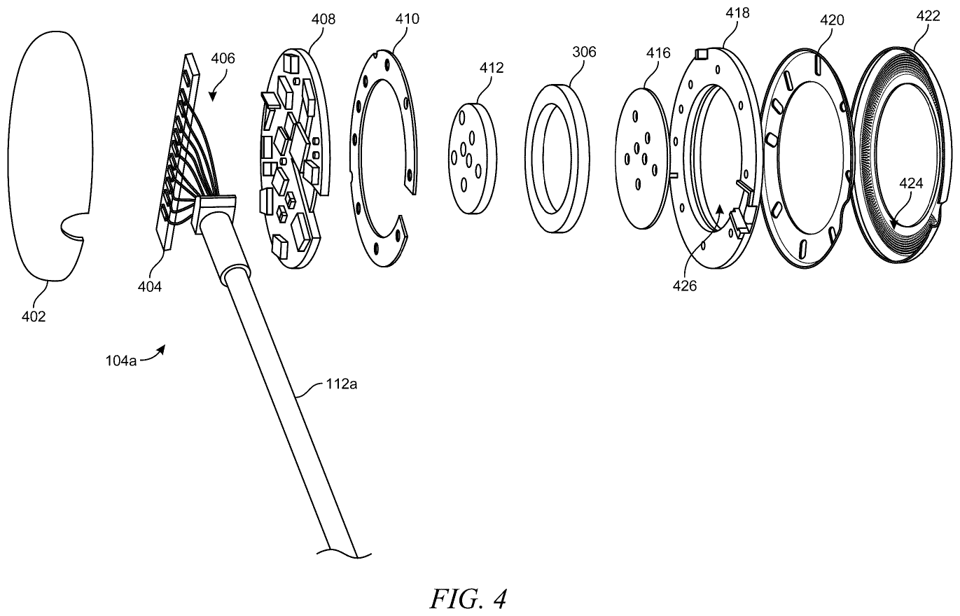

FIG. 4 is an exploded view of the first electronics package 104a. From left to right, the first electronics package 104a includes a cap 402. The cap 402 may be made from titanium or other suitable material. In some embodiments, the cap 402 is machined from a solid block of material (for example, titanium). In some embodiments, the cap 402 has a curvature continuous surface. In some embodiments, at least a portion of the cap 402 has a curvature continuous surface.

The first electronics package 104a further includes a cable printed circuit board 404. The first cable portion 112a includes multiple wires 406 that are attached to the cable printed circuit board 404. In some embodiments, the first cable portion 112a includes eleven wires. Several of the multiple wires 406 may be for carrying power and/or data from an external device to which the connector 116 is connected to, such as a phone or a desktop or laptop computer. Several of the multiple wires 406 may be for carrying data to and from the first electronics package 104a.

The first electronics package 104a further includes a printed circuit board 408. The printed circuit board 408 includes multiple electronics components such as a microcontroller, memory, an inertial measurement unit (IMU)-based sensor system (which may be referred to as an IMU), a magnetometer, codecs with audio digital signal processors (DSPs), multiple microphones, and the second set of electrical contacts 308.

In some embodiments, the printed circuit board 408 includes nine microphones. The nine microphones on the printed circuit board 408 may be utilized for different purposes. In some embodiments, eight of the nine microphones are digital and may be utilized to create a transparency mode by capturing external noises that are processed by the first electronics package 104a and output by first acoustic package 108a. In some embodiments, one microphone is a high signal-to-noise ratio analog microphone that may be utilized for feedforward active noise cancellation.

The first electronics package 104a also includes a first pressure-sensitive adhesive layer 410, an electrical connector spacer 412, the magnet 306, and a first pressure-sensitive adhesive layer 416.

The first electronics package 104a also includes a microphone manifold 418 having an opening 426 with a continuously increasing radius that may reduce or eliminate a Helmholtz resonance. The first electronics package 104a further includes a microphone cover adhesive layer 420 and a microphone cover 422. The microphone cover 422 includes numerous perforations 424 to allow sounds to pass through and be captured by the multiple microphones on the printed circuit board 408. The microphone cover 422 may be made of any suitable material, such as stainless steel, and the numerous perforations 424 may be created by chemical etching. In some embodiments a perforation has a diameter of approximately 150 microns.

The components of the first electronics package 104a may be attached or coupled using any suitable means, such as adhesives, mechanical fasteners, ultrasonic welding, and the like. Although not depicted in FIG. 4, the second electronics package 104b may include generally similar components as the first electronics package 104a.

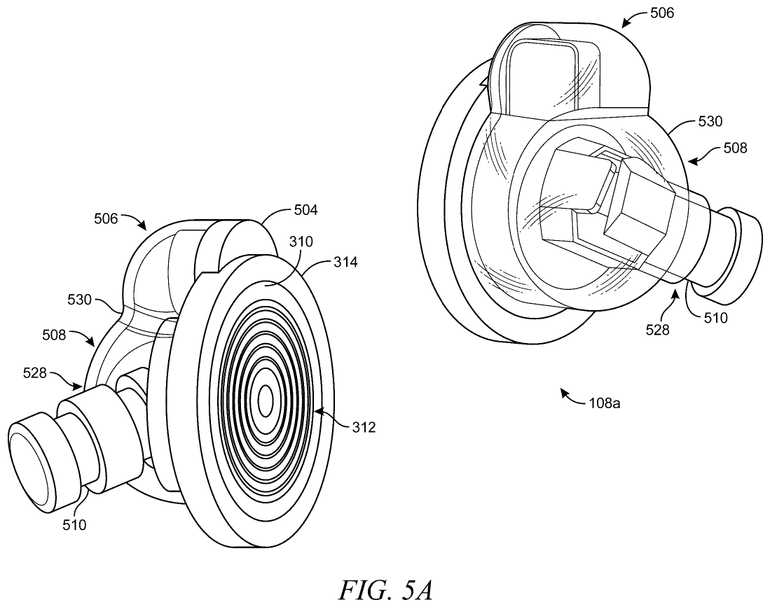

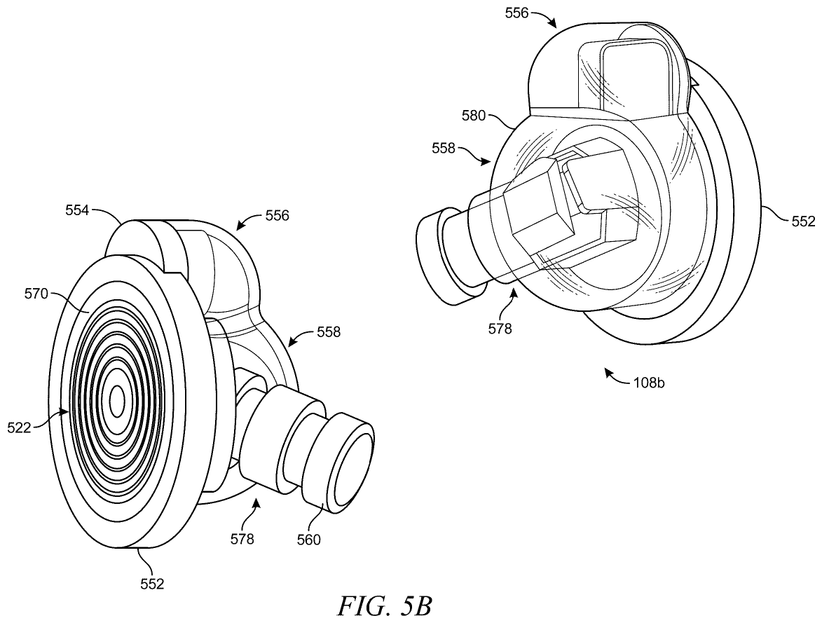

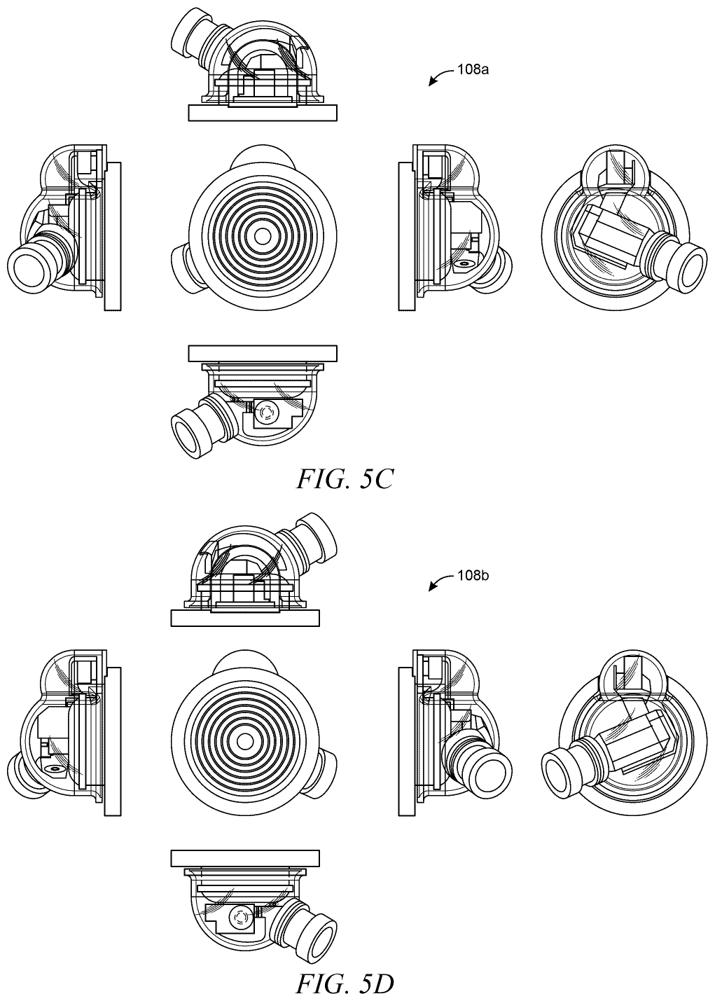

FIG. 5A depicts a front perspective view and a rear perspective view of the first acoustic package 108a. The first acoustic package 108a is for a left ear of a wearer. The first acoustic package 108a includes a housing 530 that includes a first housing portion 508 having a first partial generally capsule shape and a second housing portion 506 having a second partial generally capsule shape. The first partial generally capsule shape of the first housing portion 508 may include a first partial generally cylindrical portion and a first partial generally hemispherical portion. Similarly, the second partial generally capsule shape of the second housing portion 506 may include a second partial generally cylindrical portion and a second partial generally hemispherical portion.

The housing 530 also includes a third housing portion 528 having a generally cylindrical shape. Positioned within the housing 530 are various components including one or more speakers, such as a driver and a balanced armature. The housing 530 may be made of any suitable material, such as polycarbonate, and may be transparent, translucent, or opaque.

The first acoustic package 108a further includes the magnet 314, the connector 310, the first set of electrical contacts 312, and a cap 504. The first acoustic package 108a further includes a snout 510, a portion of which is positioned in the third housing portion 528.

FIG. 5B depicts a front perspective view and a rear perspective view of the second acoustic package 108b. The second acoustic package 108b is for a right ear of a wearer. The second acoustic package 108b includes a housing 580 that includes a first housing portion 558 having a first partial generally capsule shape and a second housing portion 556 having a second partial generally capsule shape. The first partial generally capsule shape of the first housing portion 558 may include a first partial generally cylindrical portion and a first partial generally hemispherical portion. Similarly, the second partial generally capsule shape of the second housing portion 556 may include a second partial generally cylindrical portion and a second partial generally hemispherical portion.

The housing 580 also includes a third housing portion 578 having a generally cylindrical shape. Positioned within the housing 580 are various components including one or more speakers, such as a driver and a balanced armature. The housing 580 may be made of any suitable material, such as polycarbonate, and may be transparent, translucent, or opaque.

The second acoustic package 108b further includes a magnet 552, a connector 570, a set of annular electrical contacts 522 on the connector 570, and a cap 554. The second acoustic package 108b further includes a snout 560, a portion of which is positioned in the third housing portion 578. The components of the first acoustic package 108a and the second acoustic package 108b may be attached or coupled using any suitable means, such as adhesives, mechanical fasteners, ultrasonic welding, and the like.

FIG. 5C depicts multiple views of the first acoustic package 108a, including a front elevational view, a rear elevational view, a left-side elevational view, a right-side elevational view, a top plan view, and a bottom plan view. Similarly, FIG. 5D depicts multiple views of the second acoustic package 108b, including a front elevational view, a rear elevational view, a left-side elevational view, a right-side elevational view, a top plan view, and a bottom plan view.

Example dimensions of the first acoustic package 108a are as follows. In front elevational view, the housing 530 may have a length from an extremity of the first housing portion 508 to an extremity of the second housing portion 506 of about approximately 16 mm to about approximately 18 mm, such as approximately 16.4 mm, the first housing portion 508 may have a width of about approximately 12 mm to about approximately 14 mm, such as approximately 13.1 mm, and the second housing portion 506 may have a width of about approximately 6 mm to about approximately 8 mm, such as approximately 7.3 mm. In side view, the housing 530 may have a height of about approximately 8 mm to about approximately 10 mm, such as approximately 8.8 mm. The third housing portion 578 may have an outside diameter of about approximately 4 mm to about approximately 6 mm, such as approximately 5.0 mm. The second acoustic package 108b may have similar example dimensions.

Other embodiments of the acoustic package may have a different shape. For example, in one embodiment, an acoustic package may have a housing that has an asymmetric teardrop shape in front elevational view. The housing of the acoustic package for the left ear may be larger towards the left of the housing and smaller towards the right of the housing in front elevational view. Similarly, the housing of the acoustic package for the right ear may be larger towards the right of the housing and smaller towards the left of the housing in front elevational view. Other shapes for the acoustic package that fit the anatomy of an ear are possible. Accordingly, the first acoustic package 108a may have any suitable configuration and corresponding dimensions that fits a left ear and the second acoustic package 108b may have any suitable configuration and corresponding dimensions that fits a right ear.

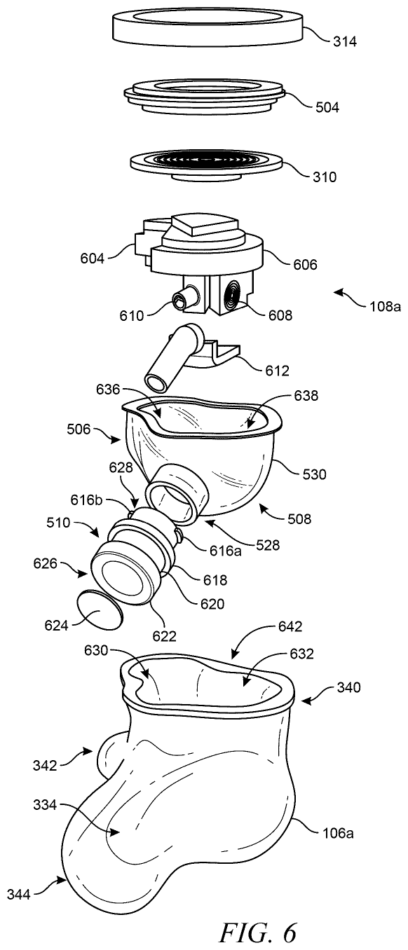

FIG. 6 is an exploded view of the first acoustic package 108a and the first ear interface 106a. The first acoustic package 108a includes the magnet 314, the cap 504, and the connector 310. The first acoustic package 108a also includes a flexible printed circuit board 604, a driver 606, a balanced armature 610, and an in-ear canal microphone 608. The first acoustic package 108a also includes a balanced armature port 612 into which a portion of the balanced armature 610 is positioned.

The in-ear canal microphone 608 may be utilized as an error reference microphone for feedback active noise cancellation. The driver 606 may serve as a woofer and may provide a suitable low-frequency response. The balanced armature 610 may serve as a tweeter and may provide a suitable high-frequency response. In some embodiments the first acoustic package 108a includes only analog components, which may allow for long usage of the first acoustic package 108a.

The first housing portion 508 and the second housing portion 506 of the housing 530 define a first housing cavity 638 and a second housing cavity 636. The flexible printed circuit board 604, the driver 606, the balanced armature 610, the in-ear canal microphone 608, and the balanced armature port 612 may be positioned at least partially in the first housing cavity 638 and the second housing cavity 636. The snout 510 is generally cylindrically shaped and includes a snout proximal portion 628 positioned at least partially within the third housing portion 528 and a snout distal portion 626. A first wing 616a and a second wing 616b positioned at the snout proximal portion 628 may function to secure the snout proximal portion 628 to the third housing portion 528.

The snout 510 further includes a first flange 618, an intermediate snout portion 620, and a second flange 622. The first flange 618 is positioned flush against the third housing portion 528. The snout 510 has a first opening at the snout proximal portion 628, a second opening at the snout distal portion 626, and a snout passage therebetween such that the sound emitted by driver 606 and the balanced armature 610 may pass through the first opening, the snout passage, and the second opening.

The snout 510 further includes one or more acoustic mesh layers 624, which may be made of any suitable material, such as stainless steel, and have oleophobic and hydrophobic properties. The one or more acoustic mesh layers 624 may provide suitable acoustic resistance so that the effect of external acoustics on the components of the first acoustic package 108a is reduced or eliminated. The one or more acoustic mesh layer 624 may also not interfere with sound generated by the first acoustic package 108a and allow air to pass through.

The first ear interface 106a includes the proximal portion 340, the upper portion 342, and the distal portion 344. The first ear interface 106a further includes a first opening 642 at the proximal portion 340 and a first cavity 632 and a second cavity 630 extending away, or inwardly, from the first opening 642. The first cavity 632 has a partial generally capsule shape generally matching the partial generally capsule shape of the first housing portion 508. The second cavity 630 has a partial generally capsule shape generally matching the second partial generally capsule shape of the second housing portion 556. The matching shapes of the first cavity 632 and the second cavity 630 allow the first acoustic package 108a to be positioned within the first ear interface 106a.

The first ear interface 106a further includes a second opening (not illustrated in FIG. 6) at the distal portion 344. Sound emitted by the driver 606 and the balanced armature 610 may pass through the passage 334 and the second opening.

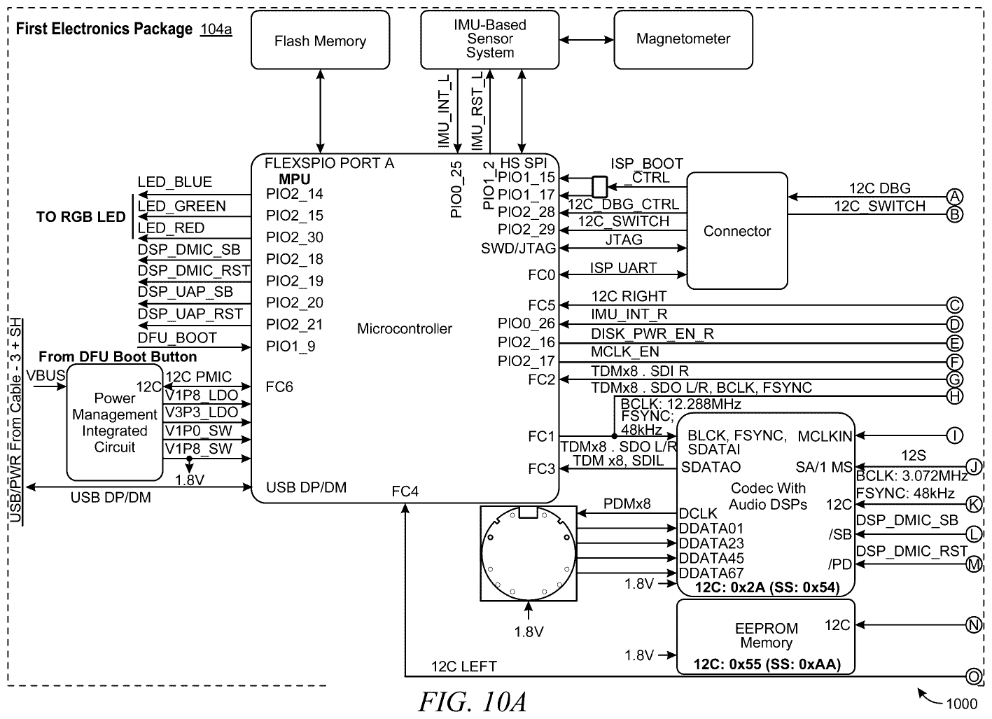

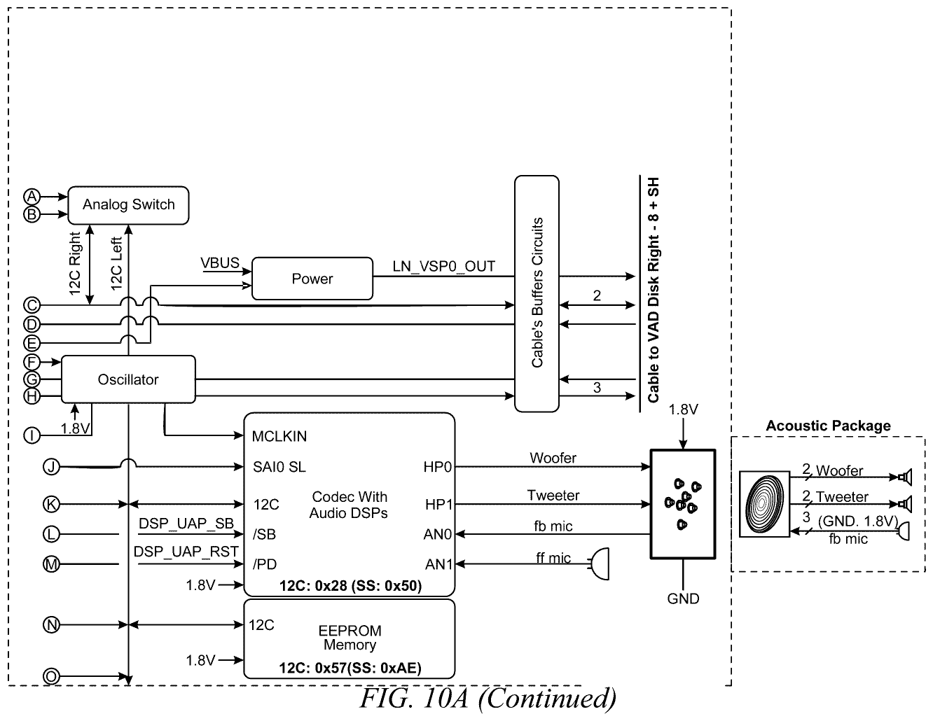

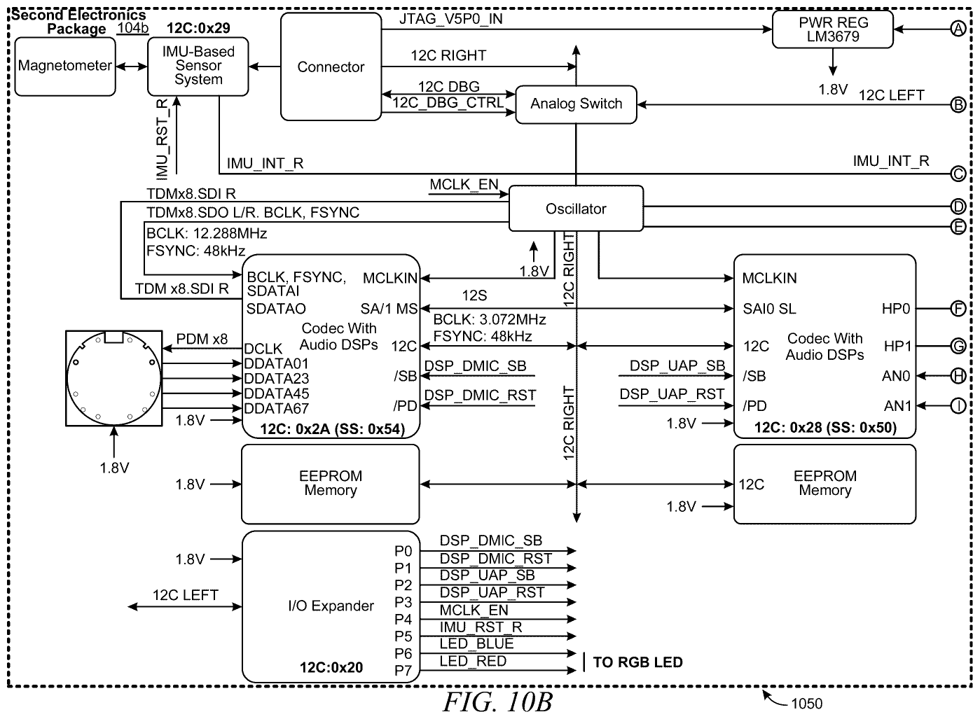

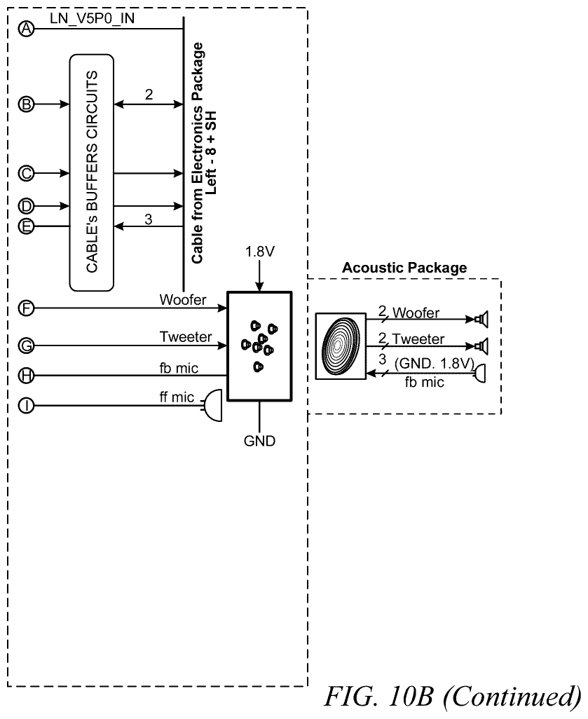

FIG. 10A is a logic block diagram 1000 of the first electronics package 104a. The logic block diagram 1000 depicts the first electronics package 104a as including multiple electronic components that perform various functions. The multiple electronic components include memory, both flash and EEPROM, an IMU-based sensor system, a magnetometer, a microcontroller which may include one or more processors, a power management integrated circuit, codecs with audio digital signal processors (DSPs), an oscillator, microphones, and switches. The various functions that the multiple electronic components may perform include receiving a digital audio signal, processing the audio signal by applying digital filters to the audio signal, generating an analog signal based on the processed digital signal, and providing the analog signal to first acoustic package 108a. The electronic components may perform functions other than those described herein.

FIG. 10B is another logic block diagram 1050 of the second electronics package 104b. The logic block diagram 1050 depicts the second electronics package 104b as including multiple electronic components that perform various functions. The multiple electronic components include EEPROM memory, an IMU-based sensor system, a magnetometer, codecs with audio DSPs, an oscillator, microphones, and a switch. The various functions that the multiple electronic components may perform include receiving a digital audio signal, processing the audio signal by applying digital filters to the audio signal, generating an analog signal based on the processed digital signal, and providing the analog signal to the second acoustic package 108b.

The memories of the first electronics package 104a and/or the second electronics package 104b may store instructions that may be executed by the microcontroller and/or the DSPs. In some embodiments, the memory may store virtual auditory display filters that the microcontroller processor and/or the DSPs may apply to audio signals that the first electronics package 104a and the second electronics package 104b receive.

One or more components of the first electronics package 104a and/or the second electronics package 104b (for example, the IMU-based sensor system, the magnetometer, an accelerometer, a gyroscope, or other suitable components) may be configured to capture head orientation data for a head orientation of a wearer of the first ear-worn device and the second ear-worn device. The memories of the first electronics package 104a and/or the second electronics package 104b may store instructions that when executed by the microcontroller and/or the DSPs may cause the microcontroller and/or the DSPs to determine the head orientation of the wearer based on the head orientation data captured by the one or more components.

The memories of the first electronics package 104a and/or the second electronics package 104b may store instructions that when executed by the microcontroller and/or the DSPs may also cause the microcontroller and/or the DSPs to perform active noise cancellation of the sounds of the wearer captured by the in-canal microphone in the first acoustic package 108a and/or the second acoustic package 108b and/or active noise cancellation of external sounds captured by the high signal-to-noise ratio analog microphone in the first electronics package 104a and/or the second electronics package 104b.

Electronic components of the first electronics package 104a, such as the microcontroller, may control electronic components of the second electronics package 104b. Accordingly, the first electronics package 104a may be considered as a primary electronics package and the second electronics package 104b may be considered as a secondary electronics package.

The virtual auditory display device 100 may interface with a virtual auditory display system as described herein to render virtual auditory display sound for a wearer. Virtual auditory display sound may be considered as immersive, panoramic sound that is capable of being perceived as emanating from any point in space surrounding the wearer. The virtual auditory display system may apply digital filters to a multi-channel audio signal to generate audio signals that are sent to the virtual auditory display device 100. The virtual auditory display device 100 generates, based on the audio signals, the virtual auditory display sound.

Virtual auditory display sound may be especially desirable for a music creator, who may create music with multiple channels (for example, 9.1.6). The music creator may use a digital audio workstation to create music. The music creator may then use the virtual auditory display system to apply digital filters to the music so that the music may be rendered as virtual auditory display sound by the virtual auditory display device 100. The virtual auditory display system may allow the music creator to apply different acoustic environment filters so that the virtual auditory display sound may be heard in different simulated acoustic environments (for example, in a car, in a night club).

The music creator may then remix or modify the music based on their hearing the music rendered as virtual auditory display sound. For example, the music creator may move the location of certain sounds, emphasize certain sounds, de-emphasize certain sounds, and the like. In this fashion, the music creator may utilize the virtual auditory display device 100 as part of an iterative process of creating music until the music creator achieves the desired effect for the music.

The virtual auditory display device 100 may switch between a transparency mode and an immersion mode by detecting interactions of the wearer with the virtual auditory display device 100. For example, the wearer may tap once on either the first electronics package 104a or the second electronics package 104b to cause the virtual auditory display device 100 to enter a transparency mode. In the transparency mode one or more microphones of the first electronics package 104a and the second electronics package 104b may capture external sounds, signals based on the captured external sounds may be generated, and the one or more speakers of the first acoustic package 108a and the second acoustic package 108b may output sound based on the generated signals.

As another example, the wearer may also tap twice on either the first electronics package 104a or the second electronics package 104b to cause the virtual auditory display device 100 to enter the immersion mode. In the immersion mode the first electronics package 104a and the second electronics package 104b may perform active noise cancellation on signals corresponding to sound captured by one or more microphones of the first electronics package 104a and the second electronics package 104b.

The virtual auditory display device 100 may provide other functionality enabled by components of the virtual auditory display device 100. For example, the arrays of microphones may enable the virtual auditory display device 100 to selectively amplify certain sounds and selectively cancel certain sounds. The DSPs may enable sound detection and the arrays of microphones may enable the virtual auditory display device 100 to locate detected sounds. The virtual auditory display device 100 may then amplify the detected sounds. As another example, the microphones of the virtual auditory display device 100 may enable active noise cancellation of sounds generated by the wearer, such as the wearer's voice. The virtual auditory display device 100 may also provide functionality other than what is described herein.

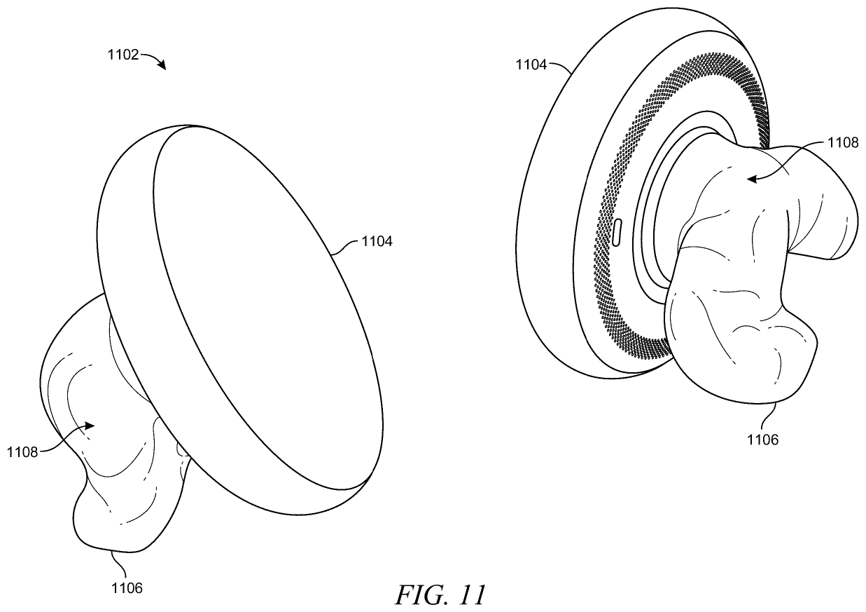

FIG. 11 depicts a front perspective view and a rear perspective view of an ear-worn device 1102 of another virtual auditory display device according to another embodiment. The ear-worn device 1102 is for a left ear of a wearer. The ear-worn device 1102 includes an electronics package 1104, an ear interface 1106, and an acoustic package 1108 (not illustrated in FIG. 11) positioned within the ear interface 1106. The virtual auditory display system may include the ear-worn device 1102 and another ear-worn device (not illustrated in FIG. 11) for the right ear of the wearer.

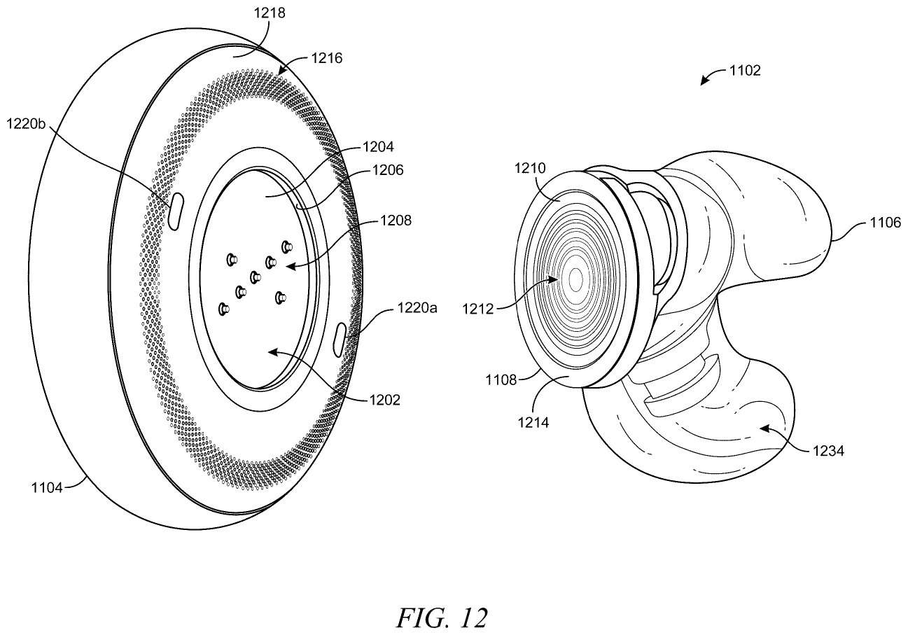

FIG. 12 is an exploded view of the ear-worn device 1102 showing the ear interface 1106, the acoustic package 1108, and the electronics package 1104. The acoustic package 1108 includes a connector 1210 having a generally planar surface. The connector 1210 includes a set of annular electrical contacts 1212 on the generally planar surface. In some embodiments, the set of annular electrical contacts 1212 includes seven annular electrical contacts. The acoustic package 1108 also includes a magnet 1214 having a generally hollow cylindrical shape. The ear interface 1106 and the acoustic package 1108 may be generally similar to the first ear interface 106a and the first acoustic package 108a, respectively, of the virtual auditory display device 100. Also depicted is a passage 1234 between a cavity of the ear interface 1106 and an opening at a distal portion of the ear interface 1106.

The electronics package 1104 includes a microphone cover 1218 including multiple perforations 1216, a first proximity sensor window 1220a and a second proximity sensor window 1220b. The electronics package 1104 also includes a magnet 1206 positioned inward relative to the microphone cover 1218. The microphone cover 1218 and the magnet 1206 form a generally cylindrical recess 1202 having a generally planar surface 1204. A set of electrical connectors 1208 extend outwards from the generally planar surface 1204. Each electrical connector is configured to connect with an electrical contact of the set of annular electrical contacts 1212. In some embodiments, the set of electrical connectors 1208 includes seven electrical connectors. In some embodiments, the set of electrical connectors 1208 includes a set of seven pogo pins.

The generally cylindrical recess 1202 has the same general shape as the magnet 1214 and the connector 1210. The electronics package 1104 may thus removably couple to the acoustic package 1108. The electronics package 1104 is removably magnetically coupleable to the acoustic package 1108 due to attractive magnetic forces between the magnet 1214 and the magnet 1206.

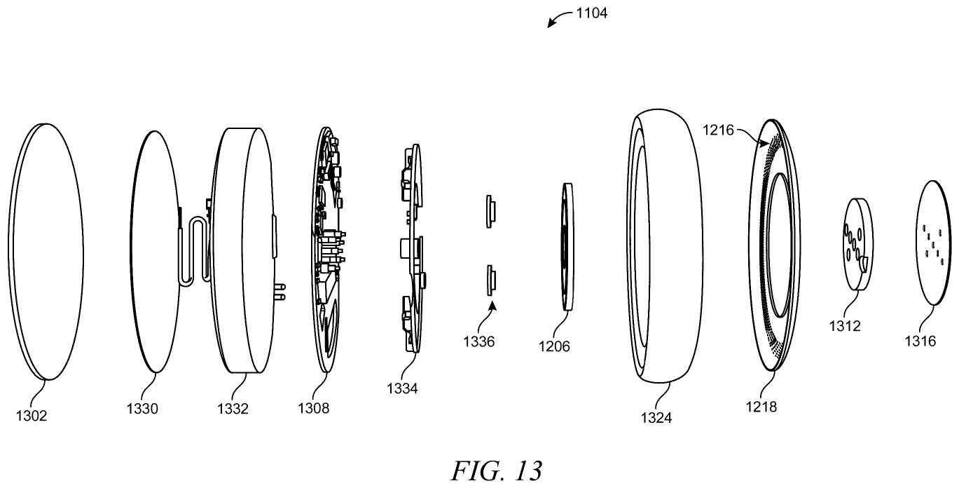

FIG. 13 is an exploded view of the electronics package 1104. From left to right, the electronics package 1104 includes a cap 1302. The cap 1302 may be made from glass or other suitable material that allows wireless signals to pass through the cap 1302. The cap 1302 may have a generally convex surface. In some embodiments, the cap 1302 may have a generally planar surface.

The electronics package 1104 also includes an antenna component 1330 and a battery 1332. The antenna component 1330 may include one or more antennas configured to receive and transmit wireless signals (for example, Wi-Fi, Bluetooth, cellular signals). The battery 1332 may be a pouch or coin cell battery and provide power to multiple electronics components of the electronics package 1104. The battery 1332 may be or include a rechargeable battery. In some embodiments, the electronics package 1104 may be removed from the ear-worn device and placed in a charging case having electrical contacts that connect with the set of electrical connectors 1208, so that the charging case may charge the electronics package 1104.

The electronics package 1104 also includes a printed circuit board 1308 which may include multiple electronics components such as a microcontroller, memory, codecs with audio digital signal processors (DSPs), multiple microphones, and the set of electrical connectors 1208. In some embodiments, the printed circuit board 1308 includes nine microphones. The electronics package 1104 further includes a circuit board 1334, which may include multiple electronics components such as an inertial measurement unit (IMU)-based sensor system (which may be referred to as an IMU), a magnetometer, and/or other sensors, such as accelerometers and/or gyroscopes to aid head orientations detections, and proximity sensors to detect proximity to a wearer. The electronics package 1104 further includes one or more sensor lenses 1336.

The electronics package 1104 also includes the magnet 1206 and a housing 1324 including a microphone manifold. The microphone manifold may have a continuously increasing radius like the microphone manifold 418 so as to reduce or eliminate a Helmholtz resonance. The electronics package 1104 further includes the microphone cover 1218, which includes the multiple perforations 1216. The multiple perforations 1216 allow sounds to pass through and be captured by the multiple microphones on the printed circuit board 1308. The microphone cover 1218 may be made of any suitable material, such as stainless steel, and the multiple perforations 1216 may be created by chemical etching. In some embodiments a perforation has a diameter of approximately 150 microns.

The electronics package 1104 further includes an electrical connector spacer 1312, which functions to space apart the electrical connectors of the set of electrical connectors 1208, and a glide film layer 1316, which functions to reduce a friction of the generally planar surface 1204.

Although not depicted in FIG. 13, the other electronics package of the other ear-worn device of the other virtual auditory display device may include generally similar components as the electronics package 1104.

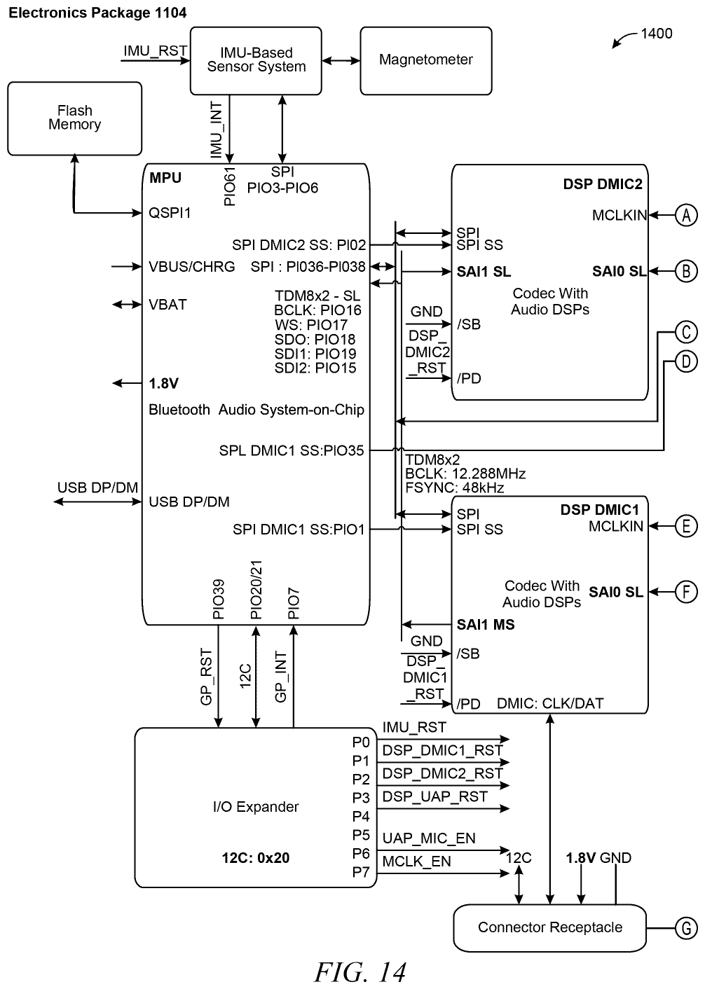

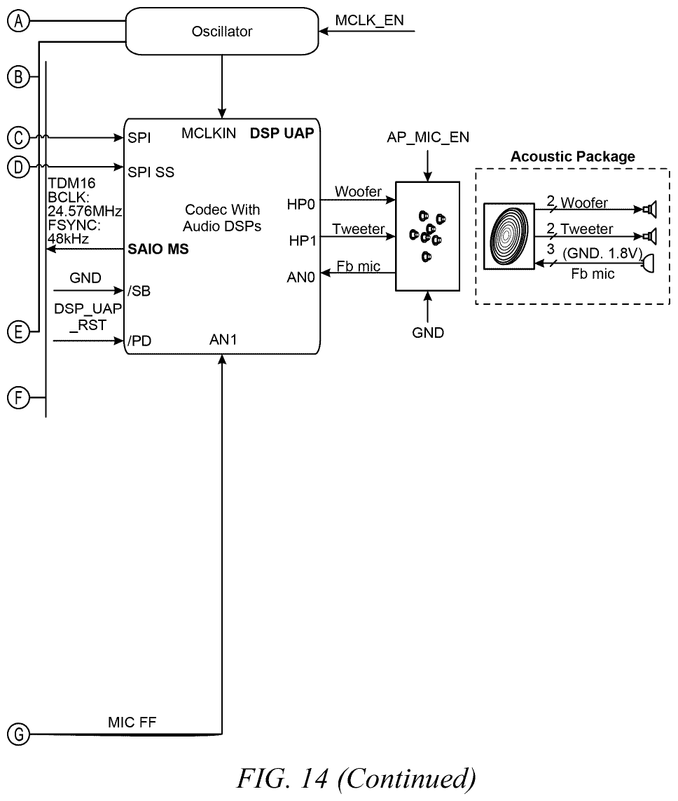

FIG. 14 is a logic block diagram 1400 of components of the electronics package 1104. The logic block diagram 1400 depicts the electronics package 1104 including multiple electronic components that perform various functions. The multiple electronic components include flash memory, an IMU-based sensor system, a magnetometer, a system-on-chip (SOC), codecs with audio digital signal processors (DSPs), an oscillator, and a switch. The various functions that the multiple electronic components may perform include receiving a digital audio signal, processing the audio signal by applying digital filters to the audio signal, generating an analog signal based on the processed digital signal, and providing the analog signal to the second acoustic package 108b. The electronic components may perform functions other than those described herein.

The other virtual auditory display device that comprises the ear-worn device 1102 and a corresponding ear-worn device for the right ear may provide the same functionality as the virtual auditory display device 100. In addition, the other virtual auditory display device may provide acoustic zoom functionality that may be static, adaptive, or directional. For example, the other virtual auditory display device may enhance sounds based on a head orientation of the wearer. As another example of additional functionality, the other virtual auditory display device may provide gradual noise cancellation when starting or playing sound received from another device. Other functionality will be apparent.

In addition, the electronics package 1104 of the ear-worn device 1102 may be rotatable relative to the acoustic package 1108. The ear-worn device 1102 may thus provide a rotatable user interface for the wearer. The wearer may thus rotate the electronics package 1104 to cause the ear-worn device to perform certain functions, such as to adjust a sound volume. Other functionality will be apparent.

As described herein, an acoustic package (for example, the first acoustic package 108a) may be removed from the ear interface (for example, the first ear interface 106a). The ear interface may be made of a material (for example, silicone) that may be subject to degradation from use. On some occasions, the acoustic package may not be positioned within the ear interface as securely as desired. Accordingly, a mechanism for further securing the acoustic package within the ear interface may be desirable.

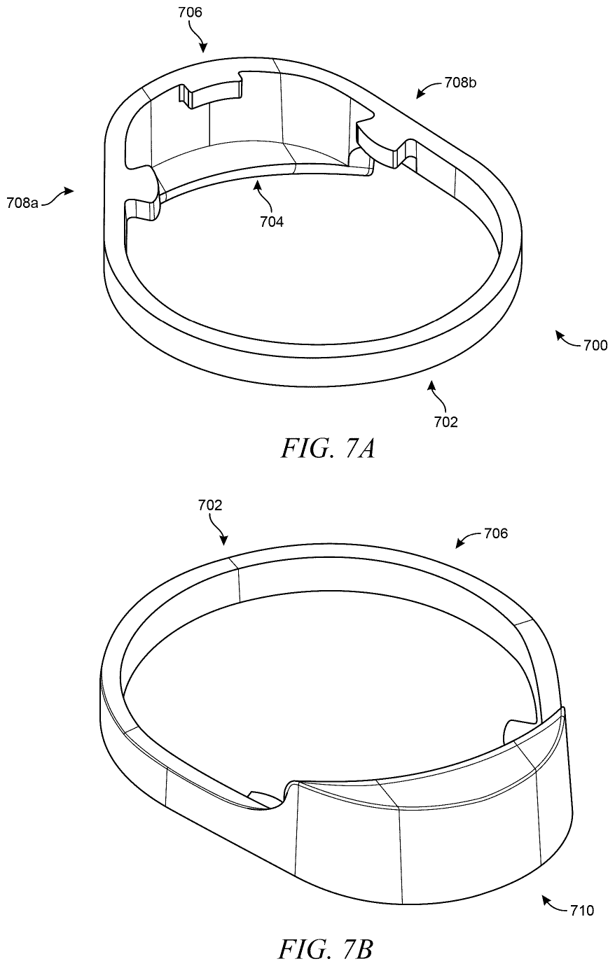

FIG. 7A is a rear bottom perspective view and FIG. 7B is a front top perspective view of a collar 700 for an ear-worn device in some embodiments. The collar 700 includes a strap portion 702 having a generally annular shape. A lifter portion 710 and a shelf portion 704 is opposite the apex of the strap portion 702. Protruding from the lifter portion 710 is a first wing portion 706. Protruding from the strap portion 702 is a second wing portion 708a and a third wing portion 708b.

The collar 700 is removably coupleable to the first ear interface 106a. When coupled to the first ear interface 106a, the collar 700 extends generally circumferentially around the proximal portion 340 proximate to the first opening 642. The shelf portion 704 abuts the cap 554 and the lifter portion 710 abuts a portion of the first ear interface 106a. The inner perimeter of the collar 700 may be generally the same or slightly smaller than the outer perimeter of the proximal portion 340 proximate to the first opening 642, so as to result in the collar 700 exerting pressure upon the proximal portion 340.

A function of the collar 700 is to further secure the first acoustic package 108a in the first ear interface 106a. The first wing portion 706, the second wing portion 708a, and the third wing portion 708b may mate with corresponding notches or grooves in the proximal portion 340 and assist with the securing function. Accordingly, the collar 700 may further secure the first acoustic package 108a within the first ear interface 106a. The collar 700 may also be used with the second ear interface 106b and the other ear interfaces described herein.

The ear interfaces described herein may provide a generally sealed acoustic fit between the ear interface and the ear in which the ear interface is positioned. The generally sealed acoustic fit may prevent exterior noises from reaching the ear canal, thus preventing exterior noises from interfering with the sound produced by the acoustic package.

However, changes in air pressure, such as when the wearer of a virtual auditory display device is changing elevation (for example, when the wearer is traveling in an airplane) may affect the sound produced by the acoustic package. For example, the dynamic driver may become pinned and unable to move, thus affecting the low frequency response of the acoustic package.

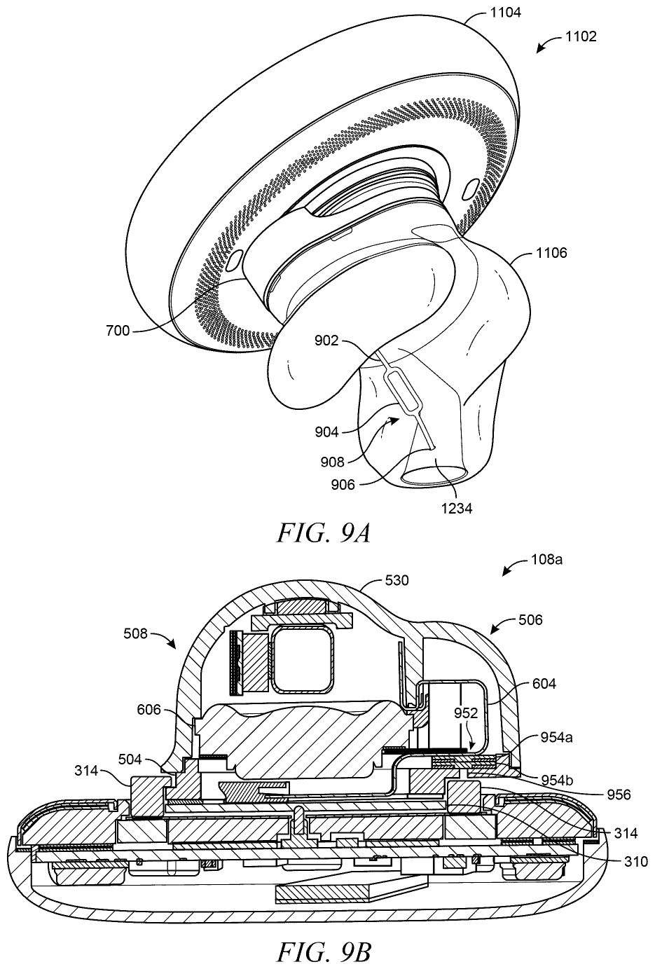

FIG. 9A is a rear perspective view of the ear-worn device 1102 including the collar 700, the electronics package 1104, the ear interface 1106, and a pressure-equalization vent 908 in the ear interface 1106 in some embodiments. The pressure-equalization vent 908 includes a first opening (not depicted in FIG. 9A) at an exterior of the ear interface 1106. For example, the first opening may be at a middle portion of the ear interface 1106 between the proximal portion and the distal portion.

The pressure-equalization vent 908 also includes a second opening 906 at the passage 1234 and a passage 902 between the first opening and the second opening 906. The diameter of the first opening or the second opening 906 may be approximately 0.1 mm. The diameter of the first opening or the second opening 906 may be approximately 0.1 mm, although the diameter of the first opening or the second opening may have other suitable sizes to allow for air passage. The passage 902 may have a diameter of approximately 0.1 mm at certain portions of the passage 902. A hollow plug 904 is positioned in the passage 902. The hollow plug 904 may function to ensure that air may travel through the passage 902. Air may pass through the first opening, the passage 902, and the second opening 906 to allow for static air pressure equalization between an air pressure in an ear canal of the wearer and an exterior air pressure without affecting the sound produced by the acoustic package. Furthermore, the pressure-equalization vent 908 may be sized to prevent undue ingress of particulate matter.

Although FIG. 9A depicts the pressure-equalization vent 908 having the second opening 906 in the passage 1234, the second opening 906 may be in the first cavity 632, in the second cavity 630, or in another suitable cavity in the ear interface 1106. The first opening may be at any suitable position in the ear interface 1106. Accordingly, the pressure-equalization vent 908 may be in any suitable position in the ear interface 1106 that allows for static air pressure equalization and provides acoustic resistance.

The pressure-equalization vent 908 may have any passage size or combination of passage sizes that allows for air flow between the exterior and the cavities of the ear interface 1106 while maintaining the desired acoustic resistance properties. Furthermore, in some embodiments, the pressure-equalization vent 908 may include one or more layers of acoustic mesh. For example, the pressure-equalization vent 908 may have a passage size larger than 0.1 mm and include one or more layers of acoustic mesh. It will be appreciated that the pressure-equalization vent 908 may have varying passage sizes and/or configurations to allow for the passage of air while achieving desired acoustic resistance properties.

FIG. 9B is a cross-sectional view of the first acoustic package 108a having another pressure-equalization vent 952 in the cap 504 in some embodiments. The pressure-equalization vent 952 is positioned in the cap 504 of the first acoustic package 108a. The pressure-equalization vent 952 includes a passage 956 in the cap 504 in a portion of the cap 504 that is proximate to the magnet 552. The passage 956 may have a diameter of about 0.4 mm to about 0.5 mm, such as approximately 0.44 mm. The pressure-equalization vent 952 also includes a first opening proximate to the flexible printed circuit board 604 and a second opening proximate to the magnet 314.

The pressure-equalization vent 952 may also include a first layer of acoustic mesh 954a and a second layer of acoustic mesh 954b. The acoustic mesh 954a and the acoustic mesh 954b are positioned between the cap 504 and the flexible printed circuit board 604. Each layer of acoustic mesh may be generally circular and have a rayl value of 900. The two layers of acoustic mesh may function as acoustic resistors that prevent interference from external noises while still allowing air to pass through the passage 956. The layers of acoustic mesh act as acoustic resistors in parallel, so that their values are additive. Acoustic meshes that have other rayl values may be utilized in some embodiments to provide the desired acoustic resistance. The pressure-equalization vent 952 may allow for static air pressure equalization between an air pressure in the second housing portion 506 of the housing 530 and an exterior air pressure without unduly affecting the acoustic performance of the first acoustic package 108a or allowing undue transmission of unwanted acoustic energy. Furthermore, the pressure-equalization vent 952 may be sized to prevent undue ingress of particulate matter.

The configuration of the pressure-equalization vent 952 may be varied to achieve static pressure equalization across a range of operational environments for the first acoustic package 108a, while providing sufficient resistance to acoustic energy. For example, the diameter of the passage 956 may be reduced and total resistive value of the one or more layers of acoustic mesh may be reduced in order to achieve these objectives. As another example, the diameter of the passage 956 may be increased and the number of layers of acoustic mesh may be increased in order to achieve these objectives. It will be appreciated that the pressure-equalization vent 952 may have varying passage sizes and/or configurations to allow for the passage of air while achieving desired acoustic resistance properties.

Although FIG. 9B depicts the pressure-equalization vent 952 as in the cap 504, the pressure-equalization vent 952 may be in any suitable position in the first acoustic package 108a that allows for static air pressure equalization and provides acoustic resistance.

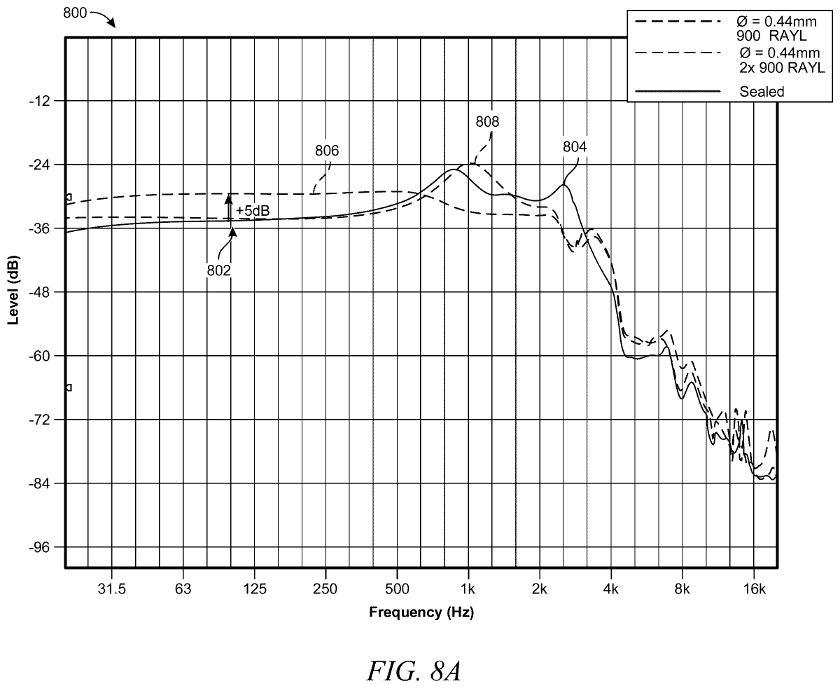

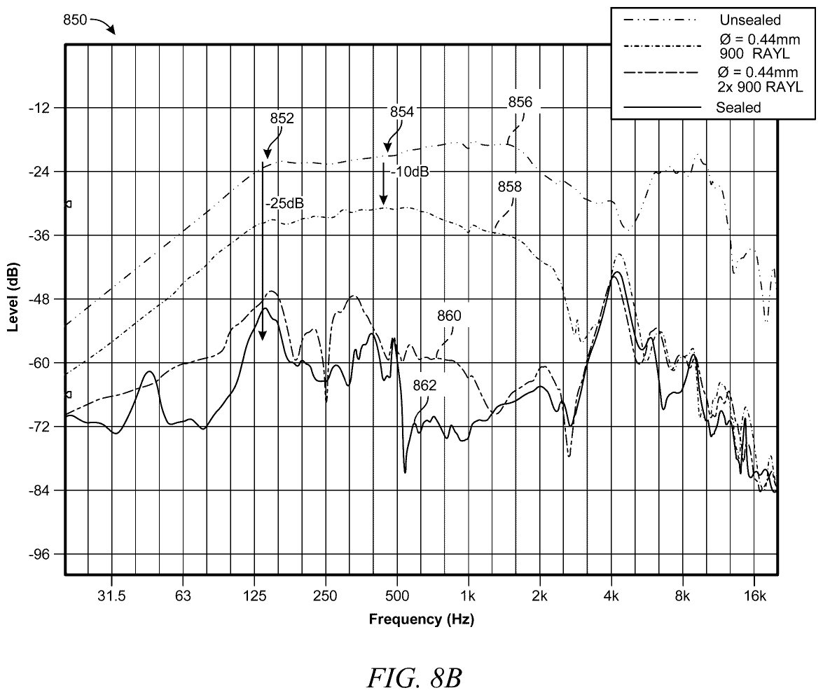

FIG. 8A is a graph 800 depicting frequency responses of multiple audio signals for acoustic packages according to various embodiments. A first audio signal 804 is for a first acoustic package without the pressure-equalization vent 952. A second audio signal 806 is for a second acoustic package with the pressure-equalization vent 952, having a single layer of acoustic mesh having a rayl value of 900. A third audio signal 808 is for a third acoustic package with the pressure-equalization vent 952 having two layers of acoustic mesh, each layer having a rayl value of 900.

The graph 800 indicates a difference in level between the second audio signal 806 and the third audio signal 808 of approximately five (5) decibels (dB) at a frequency region 802 between 63 hertz (Hz) and 125 Hz. Accordingly, the third acoustic package has an improved frequency response relative to that of the second acoustic package. However, the graph 800 indicates that that each of the frequency response of the second audio signal 806 and the frequency response of the third audio signal 808 generally corresponds to the frequency response of the first audio signal 804 throughout wide ranges of frequencies.

FIG. 8B is a graph 850 depicting frequency responses of multiple audio signals for acoustic packages according to various embodiments. A first audio signal 862 is for a first acoustic package without the pressure-equalization vent 952. A second audio signal 856 is for a second acoustic package with the pressure-equalization vent 952 but without any layers of acoustic mesh. A third audio signal 858 is for a third acoustic package with the pressure-equalization vent 952 having a single layer of acoustic mesh having a rayl value of 900. A fourth audio signal 860 is for a fourth acoustic package with the pressure-equalization vent 952 having two layers of acoustic mesh, each layer having a rayl value of 900.

The graph 850 indicates a difference in level between the second audio signal 856 and the first audio signal 862 of approximately 25 dB at a frequency region 852 between approximately 125 Hz and approximately 250 Hz. Accordingly, the frequency response of the second acoustic package does not track the frequency response of the first acoustic package well in the frequency region 852.

The graph 850 further indicates a difference in level between the second audio signal 856 and third audio signal 858 of approximately 10 dB at a frequency region 854 between approximately 250 Hz and approximately 500 Hz. Accordingly, the third acoustic package, with the pressure-equalization vent 952 having a single layer of acoustic mesh, has an improved frequency response relative to that of the second acoustic package with the pressure-equalization vent 952 but without any layers of acoustic mesh.

The graph 850 further indicates the frequency response of the fourth audio signal 860 generally corresponds to the frequency response of the first audio signal 862. Accordingly, the fourth acoustic package, with the pressure-equalization vent 952 having a double layer of acoustic mesh, has an improved frequency response relative to that of the second acoustic package and the third acoustic package.

Therefore, an ear-worn device having one or more pressure-equalization vents such as the pressure-equalization vent 908 and the pressure-equalization vent 952 may have desirable acoustic properties. Such an ear-worn device may be able to maintain a quality of the audio produced by the ear-worn device while blocking external sounds from being heard by a wearer and interfering with the audio.

Furthermore, an ear-worn device with one or more pressure-equalization vents such as the pressure-equalization vent 908 and the pressure-equalization vent 952 may allow for air pressure differentials between an air pressure in the cavities of the ear-worn device and an external air pressure to be reduced or eliminated. Such an ear-worn device may thus be more comfortable to wear during times when a wearer may experience changes in air pressure, such as when traveling in an airplane.

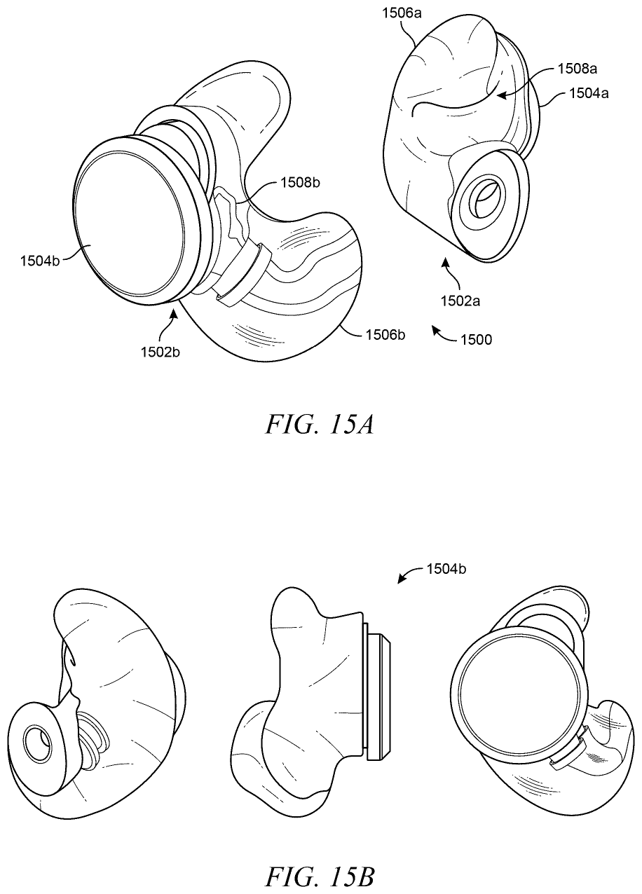

FIGS. 15A and 15B depict a virtual auditory display device 1500 according to another embodiment. The virtual auditory display device 1500 includes a first ear-worn device 1502a and a second ear-worn device 1502b. The first ear-worn device 1502a is for a left ear of a wearer and the second ear-worn device 1502b is for a right ear of the wearer.

Each of the first ear-worn device 1502a and the second ear-worn device 1502b includes an electronics package (shown as a first electronics package 1504a and a second electronics package 1504b), an ear interface (shown as a first ear interface 1506a and a second ear interface 1506b), and an acoustic package (shown individually as a first acoustic package 1508a and a second acoustic package 1508b). Certain components of each of the first ear-worn device 1502a and the second ear-worn device 1502b may be generally similar to certain components of the ear-worn device 1102 of FIG. 11.

The virtual auditory display device 1500 may be utilized for various purposes, such as providing passive noise protection for military personnel and first responders, as well as active noise enhancement. The virtual auditory display device 1500 may provide additional functionality.

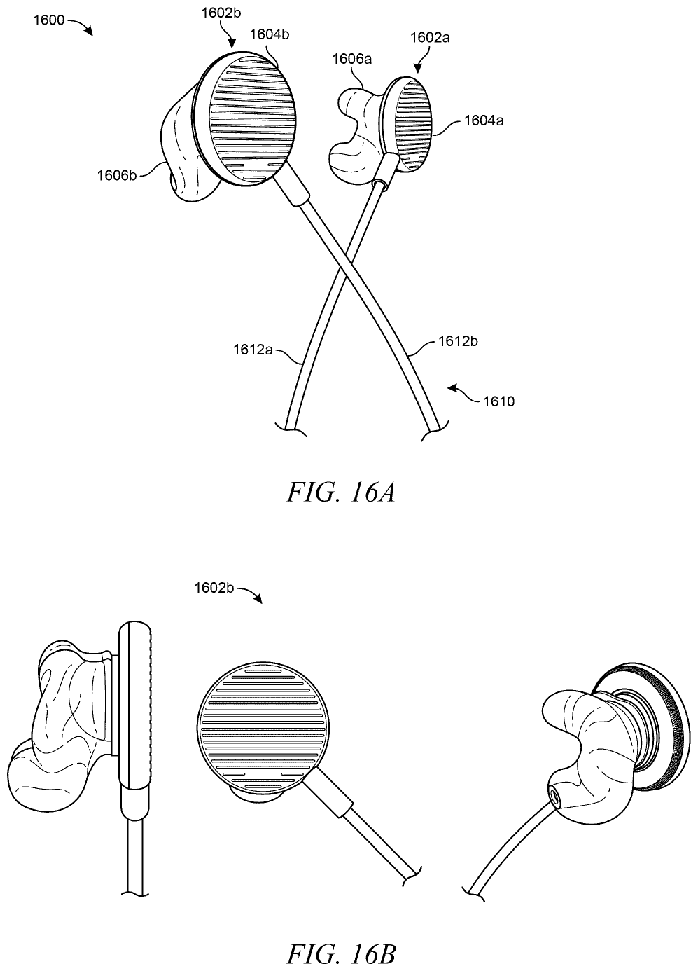

FIGS. 16A and 16B depict multiple views of a virtual auditory display device 1600 according to another embodiment. The virtual auditory display device 1600 includes a first ear-worn device 1602a, a second ear-worn device 1602b, and a cable 1610 that includes a first cable portion 1612a and a second cable portion 1612b. The first ear-worn device 1602a includes a first electronics package 1604a to which the first cable portion 1612a is connected, a first ear interface 1606a, and a first acoustic package (not illustrated in FIGS. 16A and 16B) positioned within the first ear interface 1606a that is removably magnetically coupleable to the first electronics package 1604a. The second ear-worn device 1602b also includes a second electronics package 1604b to which the second cable portion 1612b is connected, a second ear interface 1606b, and a second acoustic package (not illustrated in FIGS. 16A and 16B) positioned within the second ear interface 1606b that is removably magnetically coupleable to the second electronics package 1604b.

Certain components of each of the first ear-worn device 1602a and the second ear-worn device 1602b may be generally similar to certain components of the first ear-worn device 102a and of the second ear-worn device 102b of FIG. 1A.

The virtual auditory display device 1600 may be utilized for various purposes, such as for providing hyper-realistic training of military personnel and facilitating multi-threaded communications amongst military personnel.

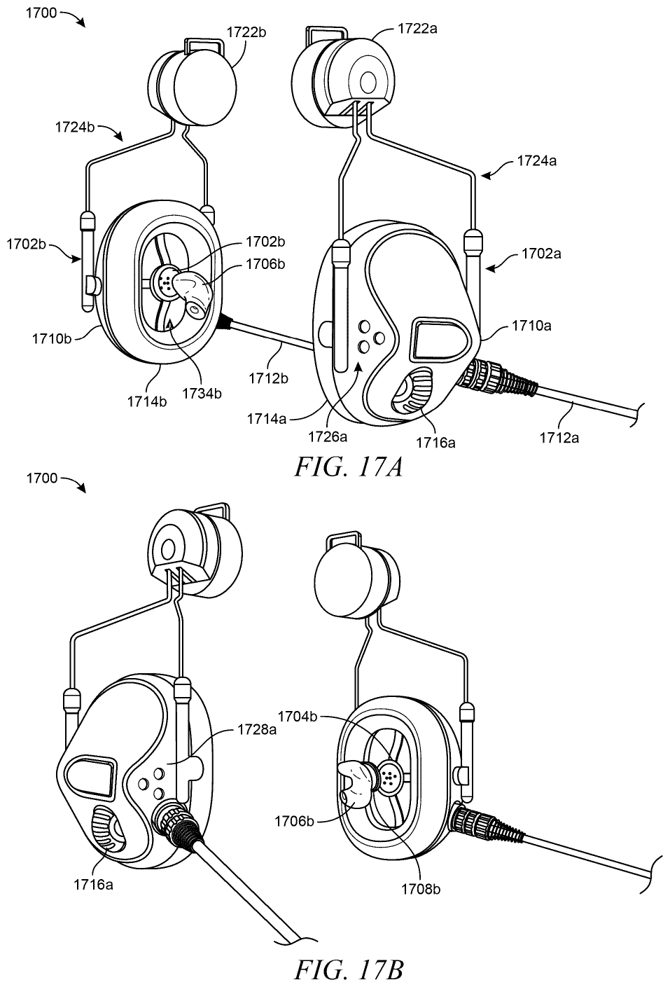

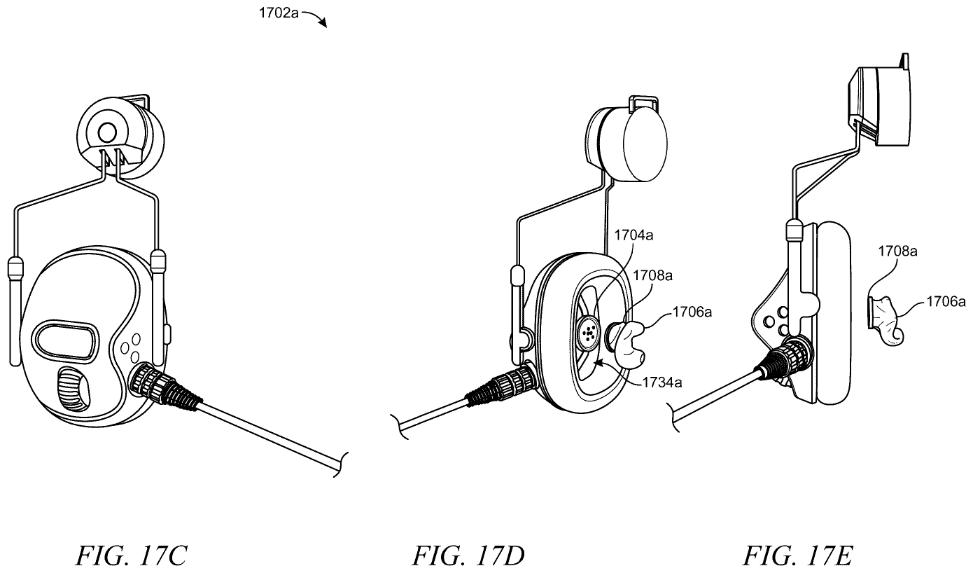

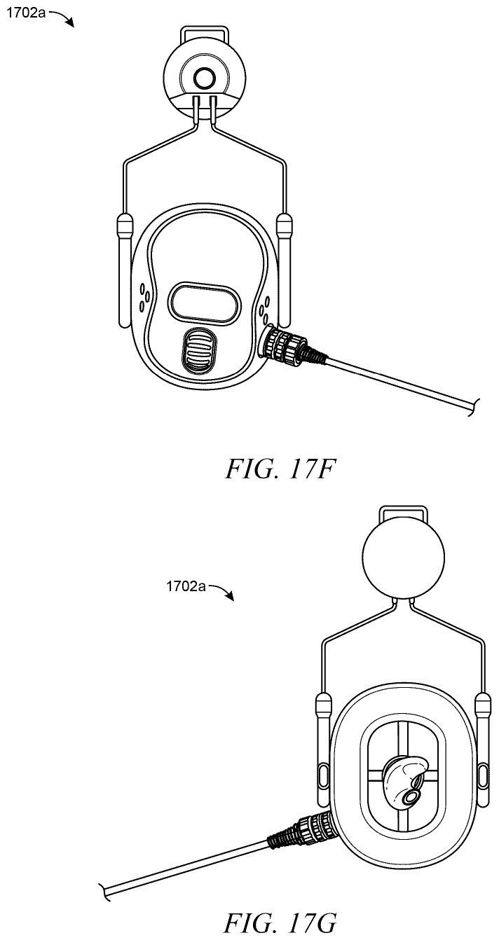

FIGS. 17A and 17B depict a front perspective view and a rear perspective view, respectively, of a virtual auditory display device 1700 including a first ear-worn device 1702a and a second ear-worn device 1702b according to an embodiment. FIGS. 17C through 17G depict views of the first ear-worn device 1702a. The first ear-worn device 1702a includes a main housing 1710a that includes a first set of microphones 1726a, a second set of microphones 1728a, and a volume control knob 1716a. The first ear-worn device 1702a also includes a compute housing 1722a connected to the main housing 1710a by multiple rigid connectors 1724a. The first ear-worn device 1702a also includes a first cable 1712a.

The first ear-worn device 1702a also includes an ear cup 1714a coupled to the main housing 1710a. A first electronics package 1704a is positioned in a center of the ear cup 1714a and is coupled to the ear cup 1714a by multiple bands 1734a. The first ear-worn device 1702a also includes a first ear interface 1706a that includes a first acoustic package 1708a.

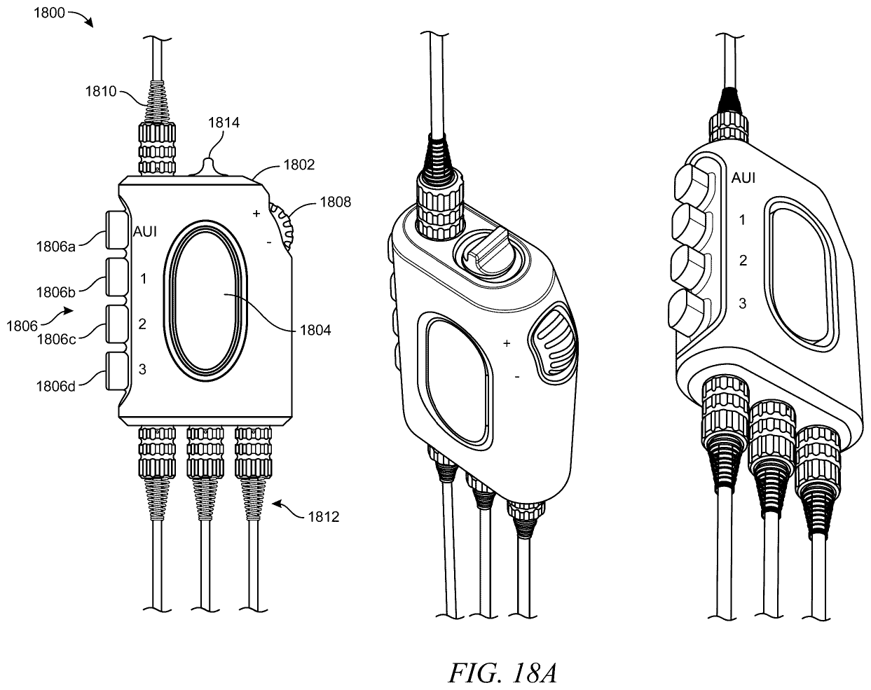

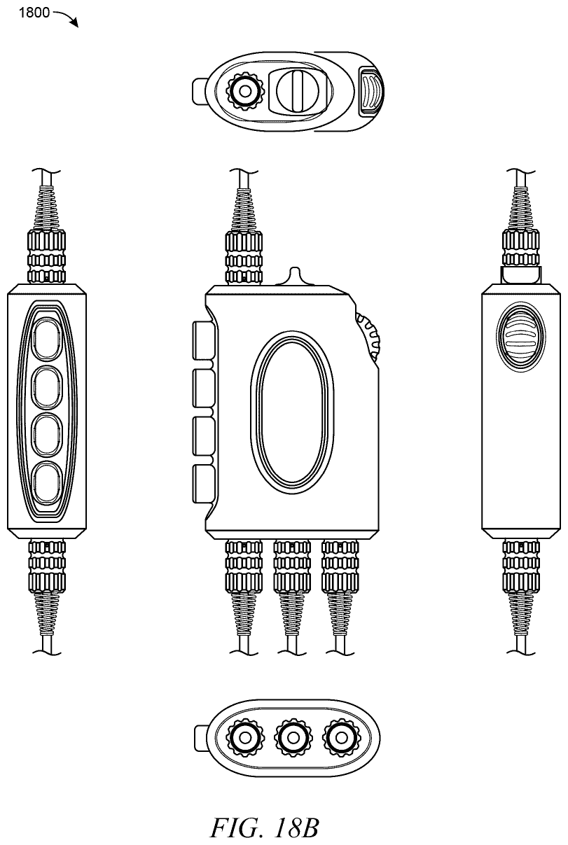

The second ear-worn device 1702b includes a main housing 1710b, an ear cup 1714b coupled to the main housing 1710b, and a compute housing 1722b connected to the main housing 1710b by multiple rigid connectors 1724b. The second ear-worn device 1702b also includes two sets of microphones and a volume control knob (not illustrated in FIGS. 17C through 17G) on the main housing 1710b. The second ear-worn device 1702b also includes a second electronics package 1704b, multiple bands 1734b, and a second ear interface 1706b containing a second acoustic package 1708b. The second ear-worn device 1702b also includes a second cable 1712b. The first cable 1712a and the second cable 1712b may join at a junction and the joined cable may connect to another device, such as a controller described with reference to, for example, FIGS. 18A and 18B.

The first electronics package 1704a and the second electronics package 1704b may be generally similar to the electronics package 1104 of the ear-worn device 1102 of FIG. 11. Similarly, the first acoustic package 1708a and the second acoustic package 1708b may be generally similar to the acoustic packages of the other virtual auditory display devices described herein.

Each of the compute housing 1722a and the compute housing 1722b may include multiple electronics components (for example, one or more processors, memory). The electronics package of the first ear-worn device 1702a may be electrically connected to the multiple electronics components of the compute housing 1722a. The second electronics package 1704b may be electrically connected to the multiple electronics components of the compute housing 1722b. Compute functionality may be shared between the electronics package and the multiple electronics components in the compute housing.

A wearer may insert the first ear interface 1706a into a left ear and the second ear interface 1706b into a right ear. The wearer may then place the first ear-worn device 1702a over the wearer's left ear and the second ear-worn device 1702b over the wearer's right ear, and the attractive magnetic forces between the first acoustic package 1708a and the first electronics package 1704a and between the second acoustic package 1708b and the second electronics package 1704b will cause the first acoustic package 1708a and the first electronics package 1704a to couple together and the second acoustic package 1708b and the second electronics package 1704b to couple together.

The generally sealed acoustic fit of the first ear interface 1706a and of the second ear interface 1706b, in combination with the ear cup 1714a and the ear cup 1714b, may provide passive ear protection for a wearer of the first ear-worn device 1702a and the second ear-worn device 1702b. The microphones on the main housing 1710a and the main housing 1710b may capture external sounds and use active noise cancellation technology to provide active ear protection for the wearer.

Additionally or alternatively, the first ear-worn device 1702a and/or the second ear-worn device 1702b may amplify external sounds captured by the microphones. The virtual auditory display device 1700 may thus enhance the hearing of the wearer of the first ear-worn device 1702a and the second ear-worn device 1702b, allowing the wearer to hear sounds that the wearer may not otherwise hear.

FIGS. 18A and 18B depict multiple views of a controller 1800 for the virtual auditory display device 1700 of FIGS. 17A through 17G. The controller 1800 includes a housing 1802 which includes a switch 1814, a volume control knob 1808, a push-to-talk button 1804, and multiple control buttons 1806. A first cable 1810 may be coupled to the controller 1800 and extend to the junction of the first cable 1712a and the second cable 1712b of the virtual auditory display device 1700. A set 1812 of multiple cables may also be coupled to the controller 1800 and to other devices (not illustrated in FIGS. 18A and 18B) that provide audio to the controller 1800, such as communications devices.

A wearer of the virtual auditory display device 1700 may turn the controller 1800 on and off using the switch 1814 and adjust an audio volume using the volume control knob 1808. When on, the controller 1800 may control audio interactions that a wearer of the virtual auditory display device 1700 may have. For example, the virtual auditory display device 1700 may have a transparency mode and an active noise cancellation mode. The wearer may select the transparency mode by selecting a button 1806a labeled “AUI” (auditory user interface). In this mode the virtual auditory display device 1700 may enhance the sounds captured by the first set of microphones on the virtual auditory display device 1700, thereby allowing the wearer to hear sounds that the wearer may not otherwise hear.

The wearer may also select either a button 1806b labeled “1”, a button 1806c labeled “2”, or a button 1806d labeled “3”. Selecting one of these three buttons may switch the virtual auditory display device 1700 into the active noise cancellation mode and cause the virtual auditory display device 1700 to emit audio received from an external device corresponding to the selected button. The wearer may push the push-to-talk button 1804 to transmit communications to the external device.

The form factor, ergonomics, and ability to switch between an enhanced hearing mode and multiple communications channels may make the virtual auditory display device 1700 and the controller 1800 suitable for challenging use cases, such as military use cases.

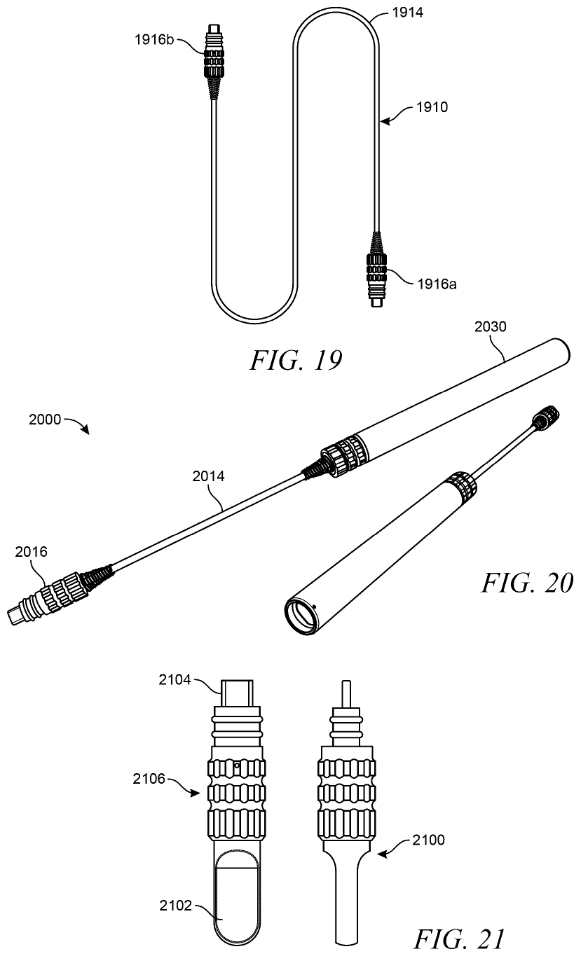

FIG. 19 depicts a cable 1910 that may be utilized with the virtual auditory display device 1700 and the controller 1800. The cable 1910 includes a first connector 1916a, a second connector 1916b, and a cable portion 1914. In some embodiments, the first connector 1916a and the second connector 1916b include USB-C connectors. The cable 1910 may provide power, data and communications interconnectivity for the virtual auditory display device 1700 and/or the controller 1800. For example, the first connector 1916a may be plugged into the controller 1800 and the second connector 1916b may be plugged into an external device, such as a communications device (for example, a military radio).

FIG. 20 depicts a battery assembly 2000 that may be utilized with the controller 1800 and the virtual auditory display device 1700. The battery assembly 2000 includes a battery housing 2030, a cable portion 2014, and a connector 2016. In some embodiments, the battery housing 2030 is sized to include AAA batteries. Additionally or alternatively, the battery housing 2030 may include lithium chemistry batteries. The connector 2016 may be plugged into the virtual auditory display device 1700 and/or the controller 1800 to provide an external power source in addition to the internal power sources of these devices.

FIG. 21 depicts a wireless communications device 2100 in some embodiments. The wireless communications device 2100 includes a connector 2104, a body portion 2106, and an end portion 2102. The wireless communications device 2100 may include wireless communications components such as Wi-Fi, Bluetooth, and/or cellular communications components. The wireless communications device 2100 may be connected to the virtual auditory display device 1700 and/or the controller 1800 and facilitate wireless communications between the device the wireless communications device 2100 is plugged into and any other device capable of wireless communications, such as another device into which another wireless communications device 2100 is plugged.

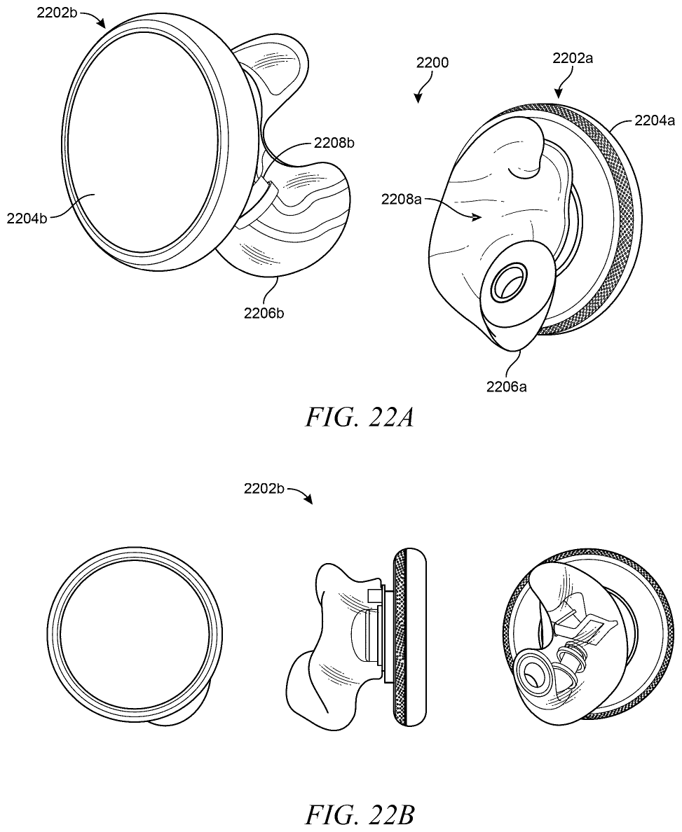

FIGS. 22A and 22B depict a virtual auditory display device 2200 according to another embodiment. The virtual auditory display device 2200 includes a first ear-worn device 2202a and a second ear-worn device 2202b. The first ear-worn device 2202a is for a left ear of a wearer and the second ear-worn device 2202b is for a right ear of the wearer.

Each of the first ear-worn device 2202a and the second ear-worn device 2202b includes an electronics package (shown as a first electronics package 2204a and a second electronics package 2204b), an ear interface (shown as a first ear interface 2206a and a second ear interface 2206b), and an acoustic package (shown individually as a first acoustic package 2208a and a second acoustic package 2208b). Certain components of each of the first ear-worn device 2202a and the second ear-worn device 2202b may be generally similar to certain components of the ear-worn device 1102 of FIG. 11.

The virtual auditory display device 2200 may provide the auditory user interface controls of the controller 1800. For example, a wearer of the virtual auditory display device 2200 may tap on the first electronics package 2204a and/or the second electronics package 2204b to switch between a first, transparency, mode and a second, active noise cancellation, mode. The first electronics package 2204a and/or the second electronics package 2204b may be touch-sensitive. Accordingly, the wearer may be able to move between different communications channels using touch gestures.

The first ear interface and the second ear interface of the virtual auditory display device 1500, the virtual auditory display device 1600, the virtual auditory display device 1700, and the virtual auditory display device 2200 may be custom made for the wearer's ears so as to provide a generally acoustically sealed fit for the wearer's ears. Accordingly, the virtual auditory display device 1500, the virtual auditory display device 1600, the virtual auditory display device 1700, and the virtual auditory display device 2200 may thus provide passive protection for wearer's ears.

Each of the virtual auditory display device 1500, the virtual auditory display device 1600, the virtual auditory display device 1700, and the virtual auditory display device 2200 may include components that allow for wireless transmission and reception of signals over IP-based networks and/or radio communication networks, such as those used by military personnel and public safety officers.

One advantage of the virtual auditory display devices described herein is that the virtual auditory display devices may enable wearers to hear sounds that are beyond the visible spectrum, hear sounds that may be too high or too low for human ears, and feel vibrations that may be too subtle to notice. For example, military personnel, such as military personnel on a battlefield, in a rescue mission, or performing normal duties, may utilize the virtual auditory display devices to detect threats before they become visible, hear enemy movements before they are audible, and feel changes in the environment before they're noticeable. Such virtual auditory display devices may provide military personnel with a competitive advantage and allow them to complete their missions with greater efficiency and safety.

As an example, military personnel could use the sensory augmentation features of the devices to identify the location of an enemy target. One possible scenario is that an enemy has made a brief sound that can be identified by digital signal processing. Examples of these sounds could be a gunshot, a footstep or other noise. The devices may identify the location of the sound and inform the military personnel the location of the target. Guidance to the military personnel could include a notification or continuous sound beacon placed in virtual auditory space or a spoken notification from a conversational user interface.

Another advantage of the virtual auditory display devices described herein is that such virtual auditory display devices may allow wearers to communicate with others in even loud environments and reduce interference. The virtual auditory display devices may filter out background noise and amplify the wearer's voice, thereby allowing the wearer to easily communicate with others and reducing distractions. The virtual auditory display devices may allow wearers to communicate with others clearly and effectively even if the wearers are in loud environments such as concerts and construction sites.

An HRTF may be for one person. Generating an individual HRTF typically requires a highly specialized environment and acoustic testing equipment. A person must remain still for approximately 30 minutes in an anechoic chamber while audio signals are emitted from different known locations. A microphone is placed in each ear of the person to capture the audio signals. However, this method presents challenges as there may be spurious responses due to factors such as the chamber, the audio signal source(s) and the microphone, that need to be eliminated in order to obtain an accurate Head Related Impulse Response (HRIR) which can then be converted to an HRTF. Furthermore, any movement by the person may affect the measurements, which may result in an inaccurate HRTF for the person. Another practical limitation of measuring an HRIR is that the time to collect directly scales with the number of discrete coordinates and practically limits the resolution of the resulting HRTF.

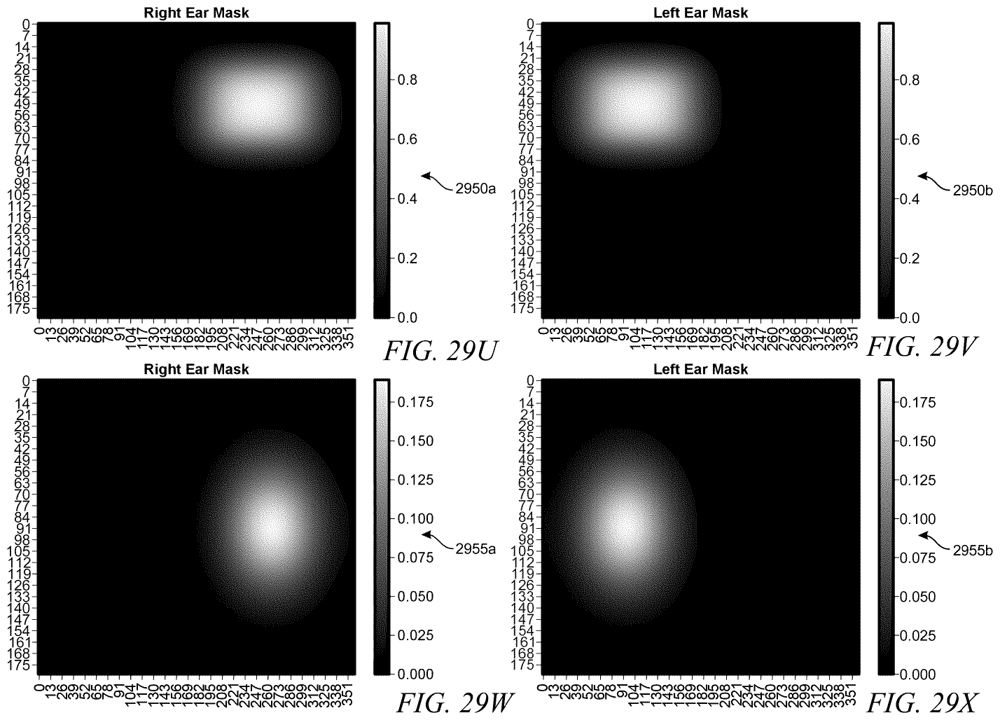

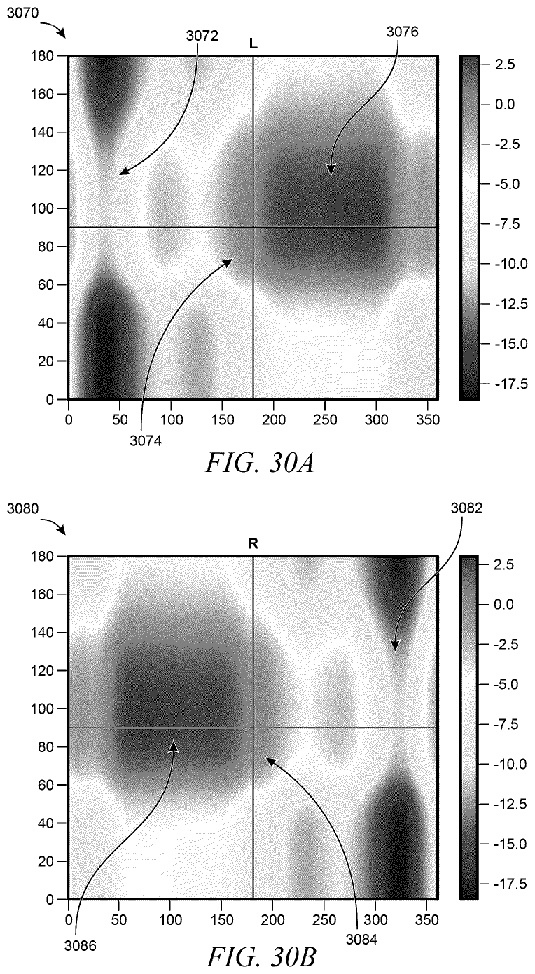

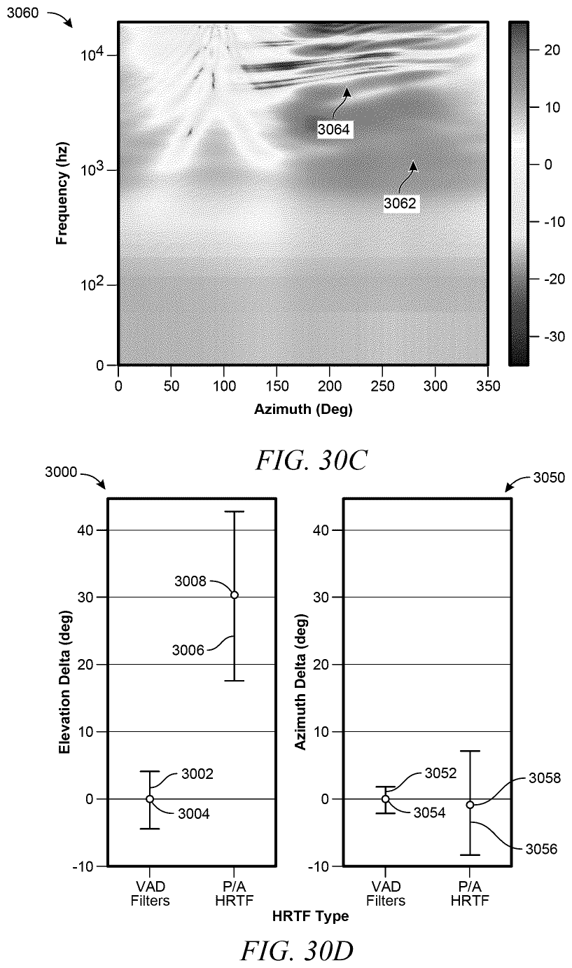

So-called universal HRTFs have been utilized to overcome disadvantages of individual HRTFs. Such universal HRTFs may be produced by averaging or otherwise combining measurements from multiple persons. However, such combining typically results in losing the individual characteristics of each person that are necessary to produce accurate virtual 3D sound for the person. As a result, such universal HRTFs may not accurately locate sound in virtual 3D space for all users, especially sound that is located directly in front of a user at approximately zero degrees azimuth and zero degrees elevation. FIG. 30E depicts an example HRTF 3010.

Another prior approach has attempted to simulate a personalized HRTF using photogrammetry of the head, torso, and pinna, or using other methods with highly precise head, torso, and pinna scanning via time of flight or structured light. A physical acoustics model is then generated based on the resulting scanned form. However, this approach may not yield convincing rendering of virtual 3D space, because after the physical scan is measured, the physics-based simulation of sound interacting with the modeled surface may introduce complexity and inaccuracy in the resulting psychoacoustic cues.

The technology described herein provides technical solutions to the technical problems of the prior approaches described above. The technology may utilize virtual auditory display filters that may result in accurately rendered sounds in their locations in virtual auditory space. The virtual auditory display filters may utilize spectral shaping techniques, using equalizers, filters, and/or dynamic range compression, to manipulate the frequency spectrum of audio signals. Virtual auditory display filters may be generated without resort to direct physical measurements (for example, measurements in an anechoic chamber, photogrammetry, etc.).

Virtual auditory display filters may be or include functions that manipulate a frequency spectrum of an audio signal. Virtual auditory display filters may be or include digital filters, such as parametric equalization (EQ) filters that allow for adjustment of parameters such as the center frequency, gain, quality (Q or q), cutoff frequency, slope, bandwidth and/or filter type. The parameters may be set as a function of a location of a sound in virtual auditory space. The functions or the digital filters may affect the frequency spectrum of an audio signal by creating notches and peaks in the audio signal. The notches, peaks, and other spectral shaping of the audio signal accurately places the resulting sound in virtual auditory space. Furthermore, the notches, peaks, and other spectral shaping of the audio signal produces a processed audio signal that may be used to output high-quality clear sound that, in the example of music recordings, may accurately represent the original recorded performance and allow listeners to hear subtleties and nuances of the original recorded performance. As described herein, a digital filter may refer to a digital filter, a function, and/or some combination of one or more functions or one or more digital filters.

Virtual auditory space may be described as a virtual 3D sound environment of a person in which the person may perceive a sound as emanating from any location in the virtual 3D sound environment. In the described technology, each location in virtual auditory space may have an associated function or digital filter that is applied to audio signals that have that location. The application of the function or digital filter to an audio signal with a location results in sound, which may be referred to as virtual auditory display sound, that is perceived by the person as coming from that location. Accordingly, the person, who may be wearing headphones, earbuds, or other ear-worn devices, may experience virtual auditory display sound. Other advantages of the described technology will be apparent.

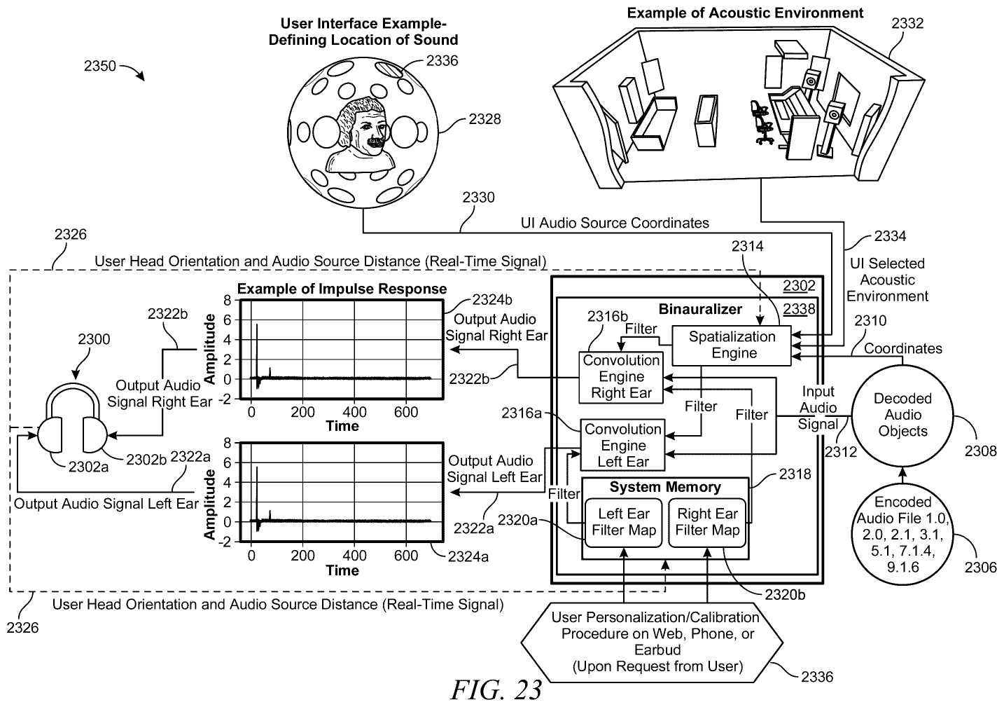

FIG. 23 is a diagram of an environment 2350 in which a virtual auditory display system and virtual auditory display devices that interface with the virtual auditory display system may operate in some embodiments. As depicted, the environment 2350 includes a virtual auditory display system 2302 and a virtual auditory display device 2300. The virtual auditory display system 2302 and the virtual auditory display device 2300 may together comprise a system. The virtual auditory display system 2302 and the virtual auditory display device 2300 may together render sounds in virtual auditory space for a wearer of the virtual auditory display device 2300.

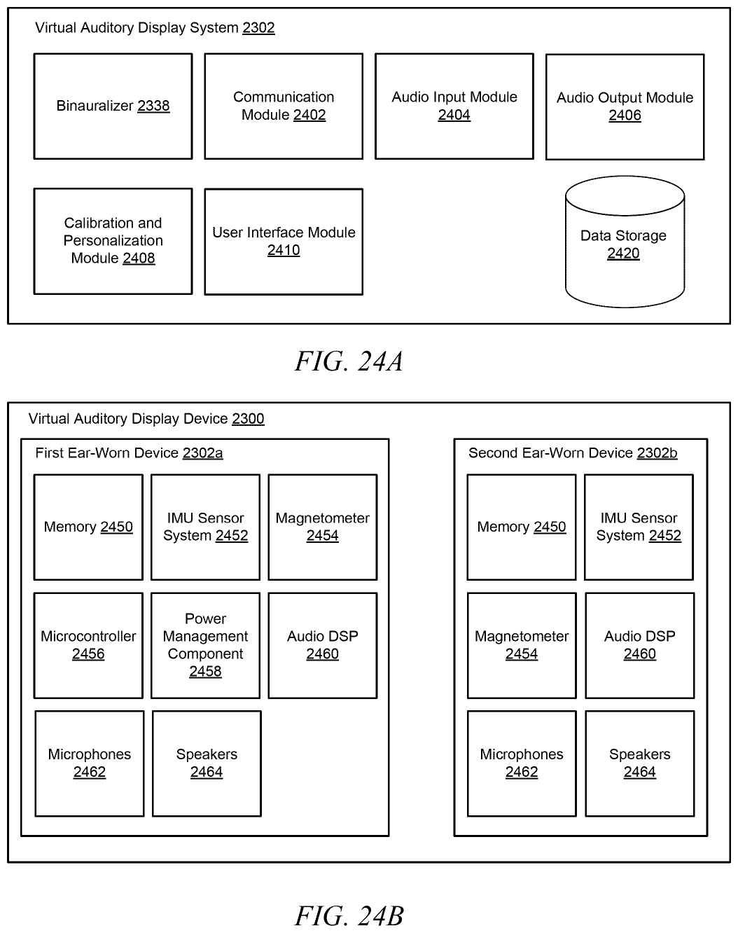

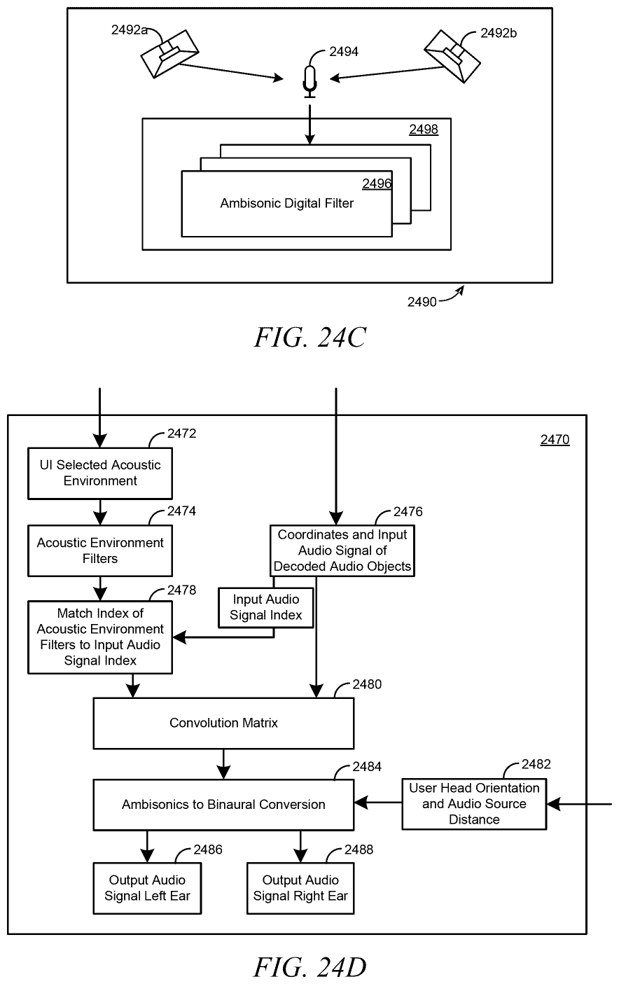

The virtual auditory display system 2302 may include a binauralizer 2338. The binauralizer may include a system memory 2318, which may include a left ear digital filter map 2320a and a right ear digital filter map 2320b. The binauralizer 2338 may also include a left ear convolution engine 2316a, a right ear convolution engine 2316b, and a spatialization engine 2314. The virtual auditory display system 2302 may also include other components, modules and/or engines, such as those described with reference to, for example, FIG. 24A.

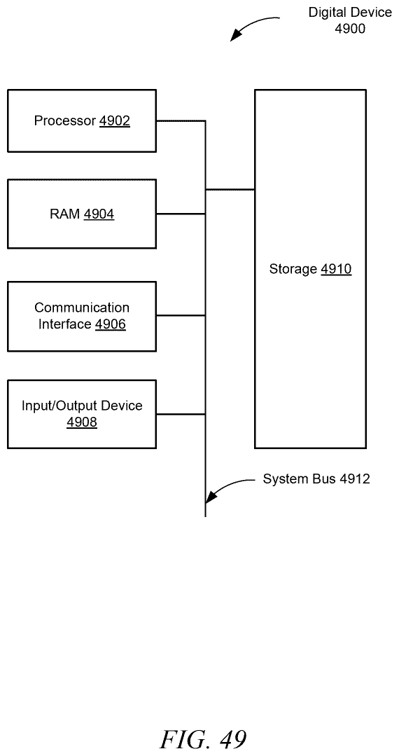

In some embodiments, the virtual auditory display system 2302 may be or include a software application that may execute on a digital device. A digital device is any device with at least one processor and memory. Digital devices are discussed further herein, for example, with reference to FIG. 49. For example, the virtual auditory display system 2302 may be a software application that executes on a general-purpose computing device, such as a laptop or desktop computer. As another example, the virtual auditory display system 2302 may be a software application that executes on a mobile device such as a phone or a tablet. In other embodiments, the virtual auditory display system 2302 be or include a software application or a firmware application that executes on a special-purpose computing device, such as on the virtual auditory display device 2300.

The virtual auditory display device 2300 may include a first ear-worn device 2302a and a second ear-worn device 2302b. The first ear-worn device 2302a and the second ear-worn device 2302b may each be any ear-worn, ear-mounted or ear-proximate device such as an earphone of a pair of earphones, an earbud of a pair of earbuds, a headphone of a headset, a speaker of a virtual reality headset, and the like. In some embodiments, the virtual auditory display device 2300 may be an embodiment of the virtual auditory display devices described herein. The first ear-worn device 2302a and/or the second ear-worn device 2302b may include components, such as an inertial measurement unit (IMU), an accelerometer, a gyroscope, and/or a magnetometer, that detect a head orientation of a wearer wearing the first ear-worn device 2302a and the second ear-worn device 2302b.

In some embodiments, a digital device (for example, a laptop or desktop computer) may receive an encoded audio file 2306 that has one or more channels of audio. Examples of an encoded audio file 2306 include 2.0 (two channels of audio), 2.1 (three channels of audio), 5.1 (six channels of audio), 7.1.4 (12 channels of audio), and 9.1.6 (16 channels of audio). The digital device may decode the encoded audio file 2306 to obtain decoded audio objects 2308 and an input audio signal 2312 that includes one or more audio sub-signals (alternately, audio channels). Each of the decoded audio objects 2308 and/or the audio sub-signals may have associated coordinates which identify the location of the audio object in virtual auditory space. The coordinates may be cartesian coordinates, spherical coordinates, and/or polar coordinates. Although specific examples of encoded audio files are described herein, the technology is not limited to such examples, and may be used with audio files that have any number of channels.

The digital device may send the coordinates 2310 to the spatialization engine 2314 and the input audio signal 2312 to the left ear convolution engine 2316a and the right ear convolution engine 2316b. In some embodiments, the virtual auditory display system 2302 receives the encoded audio file 2306 and decodes the encoded audio file 2306 to obtain the decoded audio objects 2308 and the input audio signal 2312.

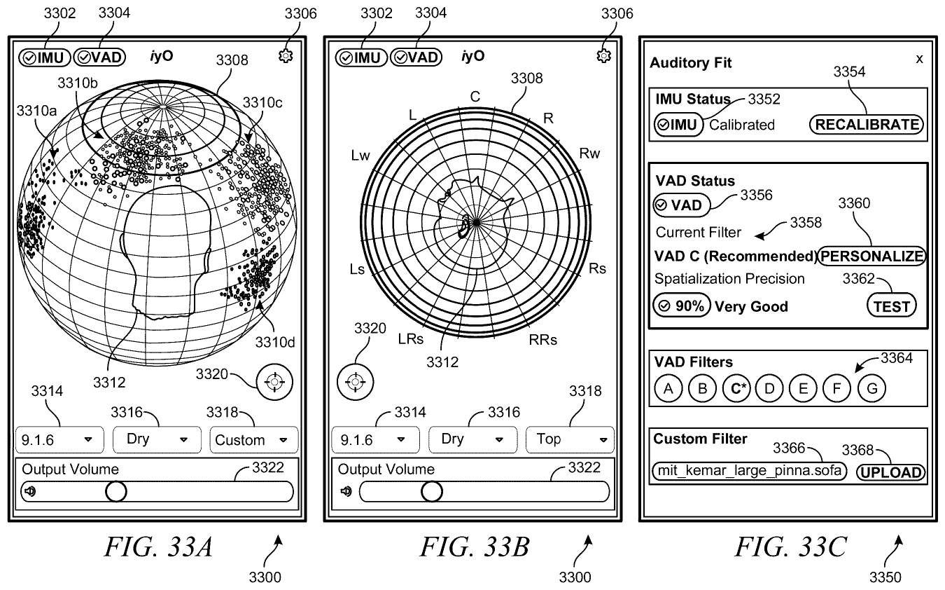

As described with reference to, for example, FIGS. 33A and 33B, a user interface component of the virtual auditory display system 2302 may provide a user interface that allows the user to select an acoustic environment. The spatialization engine 2314 may receive a selection 2334 of the acoustic environment 2332 via the user interface component from the wearer and utilize the selection 2334 to process audio signals that are sent to the first ear-worn device 2302a and the second ear-worn device 2302b of the virtual auditory display device 2300.

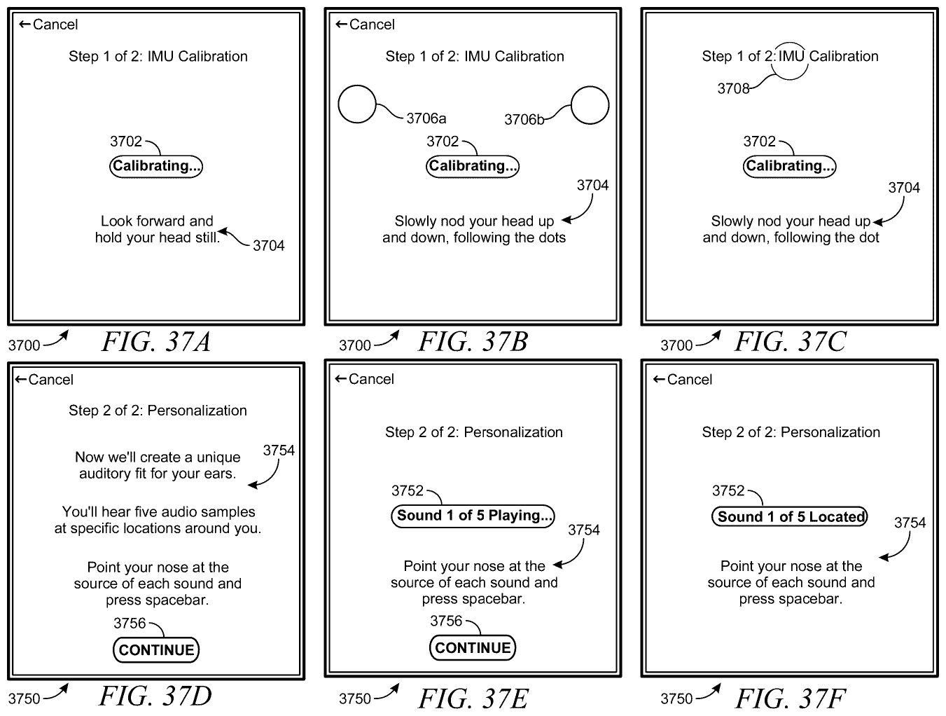

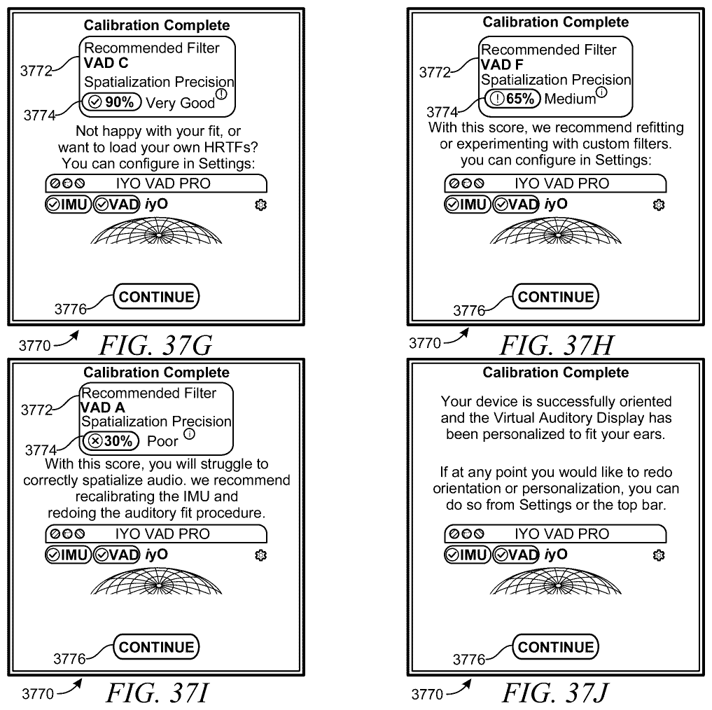

As described with reference to, for example, FIGS. 37A through 37J, the user interface component of the virtual auditory display system 2302 may provide a user interface 2328 that allows the user to perform a calibration and/or personalization procedure 2336 to calibrate and/or personalize the virtual auditory display system 2302. The wearer may use the user interface 2328 to personalize the virtual auditory display system 2302 so that the user's perception of the location of a sound matches the location of the sound in virtual auditory space. The user-perceived location of the sound may be sent in a signal 2330 to the spatialization engine 2314.

The spatialization engine 2314 may determine, based on the acoustic environment 2332, a first acoustic environment digital filter and a second acoustic environment digital filter. An acoustic environment digital filter may be or include a digital filter that is applied to an audio signal to manipulate the audio signal so as to produce the effect of the audio being played, generated or produced in a particular acoustic environment. The spatialization engine 2314 may provide the first acoustic environment digital filter to the left ear convolution engine 2316a and the second acoustic environment digital filter to the right ear convolution engine 2316b.

While the virtual auditory display system 2302 is receiving the input audio signal 2312, one or both of the first ear-worn device 2302a and the second ear-worn device 2302b may detect a head orientation of a wearer of the virtual auditory display device 2300 and provide the head orientation and an audio source distance 2326 (which may be specified by the wearer) to the virtual auditory display system 2302.

The binauralizer 2338 may, for each audio sub-signal of the one or more audio sub-signals, obtain multiple first processed audio sub-signals and multiple second processed audio sub-signals. The binauralizer 2338 may do so by determining, based on the virtual auditory space location associated with the audio sub-signal and the head orientation, a particular first location in the virtual auditory space for the audio sub-signal. The left ear digital filter map 2320a maps locations in virtual auditory space to digital filters and/or functions for the first ear-worn device 2302a and the right ear digital filter map 2320b maps locations in virtual auditory space to digital filters and/or functions for the second ear-worn device 2302b.

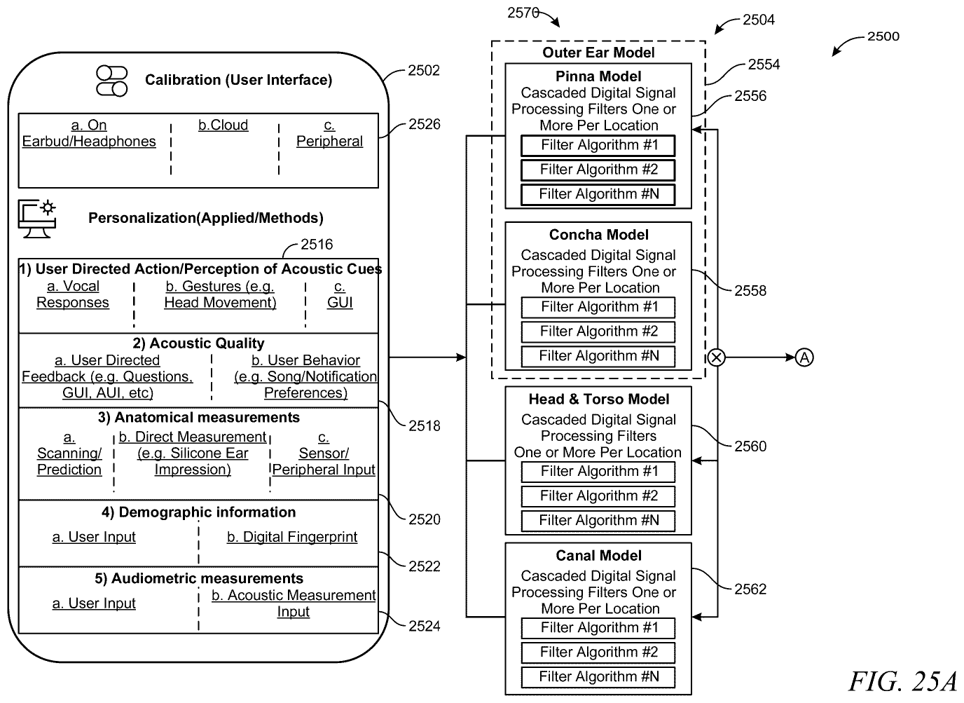

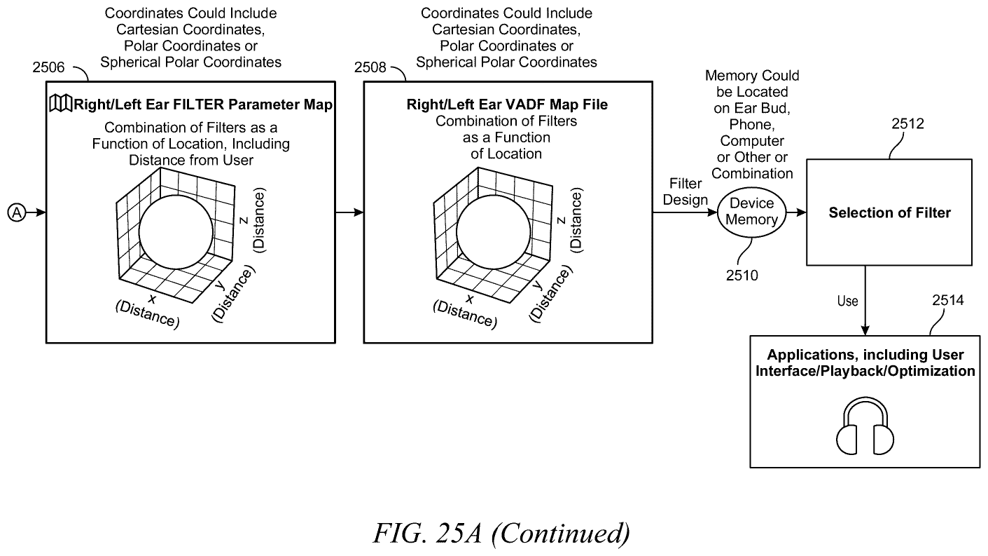

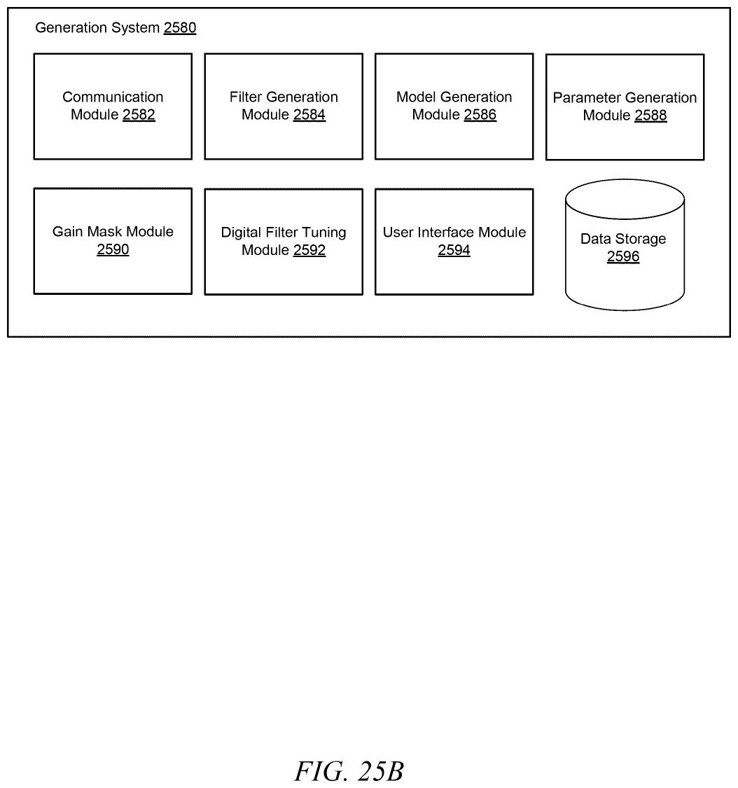

Virtual auditory display filters may be or include functions and/or digital filters that the virtual auditory display system 2302 applies to audio signals to create virtual auditory display sound. A generation system, discussed in more detail with reference to, for example, FIGS. 25A and 25B, may generate the virtual auditory display filters that the virtual auditory display system 2302 applies to audio signals.

The binauralizer 2338 may select a particular first digital filter and/or function from the left ear digital filter map 2320a and a particular second digital filter and/or function from the right ear digital filter map 2320b in the system memory 2318. The binauralizer 2338 may provide the particular first digital filter and/or function to the left ear convolution engine 2316a and the particular second digital filter and/or function to the right ear convolution engine 2316b.

The left ear convolution engine 2316a may apply the particular first digital filter and/or function and the first acoustic environment digital filter to the audio sub-signal to obtain a first processed audio sub-signal. The left ear convolution engine 2316a may then generate, based on the multiple first processed audio sub-signals, an output audio signal 2322a for the first ear-worn device 2302a. The right ear convolution engine 2316b may apply the particular second digital filter and/or function and the second acoustic environment digital filter to the audio sub-signal to obtain a second processed audio sub-signal. The right ear convolution engine 2316b may then generate, based on the multiple second processed audio sub-signals, an output audio signal 2322b for the second ear-worn device 2302b. The graph 2324a depicts an example impulse response for the output audio signal 2322a and the graph 2324b depicts an example impulse response for the output audio signal 2322b.

FIG. 24A is a block diagram depicting components of the virtual auditory display system 2302 in some embodiments. The virtual auditory display system 2302 may include the binauralizer 2338, a communication module 2402, an audio input module 2404, an audio output module 2406, a calibration and personalization module 2408, a user interface module 2410, and a data storage 2420.

The communication module 2402 may send requests and/or data between components of the virtual auditory display system 2302 and any other components or devices, such as the virtual auditory display device 2300 and a generation system 2580 (described with reference to, for example, FIGS. 25A and 25B). The communication module 2402 may also receive requests and/or data between components of the virtual auditory display system 2302 and any other components or devices.

The audio input module 2404 may receive the input audio signal 2312 from, for example, the general purpose computing device on which the virtual auditory display system 2302 executes. The audio output module 2406 may provide the output audio signal 2322a to the first ear-worn device 2302a and the output audio signal 2322b to the second ear-worn device 2302b.

The calibration and personalization module 2408 may calibrate IMUs and/or other sensors of the first ear-worn device 2302a and the second ear-worn device 2302b. The calibration and personalization module 2408 may also generate personalization audio signals and receive personalization information for personalizing filters. The user interface module 2410 may provide user interfaces that allow users to, among other things, select an acoustic environment, select an audio visualization, control audio volume, and request calibration and/or personalization procedures be performed by the virtual auditory display system 2302.

The data storage 2420 may include data stored, accessed, and/or modified by any of the engines, components, modules or the like of the virtual auditory display system 2302. The data storage 2420 may include any number of data storage structures such as tables, databases, lists, and/or the like. The data storage 2420 may include data that is stored in memory (for example, random access memory (RAM)), on disk, or some combination of in-memory and on-disk.

FIG. 24B is a block diagram depicting components of the first ear-worn device 2302a and the second ear-worn device 2302b in some embodiments. The first ear-worn device 2302a may include a memory 2450, an IMU sensor system 2452 (inertial measurement unit sensor system), a magnetometer 2454, a microcontroller 2456, a power management component 2458, an audio DSP 2460 (audio digital signal processor), microphones 2462, and speakers 2464. The second ear-worn device 2302b may include a memory 2450, an IMU sensor system 2452 (inertial measurement unit sensor system), a magnetometer 2454, an audio DSP 2460, microphones 2462, and speakers 2464.

The memory 2450 may store software and/or firmware. The IMU sensor system 2452 and/or the magnetometer 2454 may detect a head orientation of a wearer of the virtual auditory display device 2300 and/or user interactions with the virtual auditory display device 2300. The microcontroller 2456 may execute software and/or firmware stored in the memory 2450 or in the storage of the microcontroller 2456.

The power management component 2458 may provide power management. The audio DSP 2460 may process audio signals to perform functions such as noise cancellation. The microphones 2462 may capture audio, such as environmental audio and/or audio from a wearer of the first ear-worn device 2302a. The speakers 2464 may output sound based on the output audio signal 2322a and the output audio signal 2322b.

The first ear-worn device 2302a and/or the second ear-worn device 2302b may include components other than those depicted in FIG. 24B, such as switches, interconnects, and oscillators. The first ear-worn device 2302a may be the primary device and the second ear-worn device 2302b may be the secondary device. As such, the second ear-worn device 2302b may not include a microcontroller 2456. In some embodiments, the second ear-worn device 2302b includes a microcontroller 2456.

An engine, component, module, or the like of the virtual auditory display system 2302, the first ear-worn device 2302a, the second ear-worn device 2302b, or a generation system 2580 (described with reference to, for example FIG. 25B) may be hardware, software, firmware, or any combination. For example, each engine, component, module or the like may include functions performed by dedicated hardware (for example, an Application-Specific Integrated Circuit (ASIC), a Field Programmable Gate Array (FPGA), or the like), software, instructions maintained in memory, and/or any combination. Software and/or firmware may be executed by one or more processors.

Although a limited number of engines, components, and modules are depicted in FIGS. 24A and 24B and FIG. 25B, there may be any number of engines, components, and modules or the like. Further, individual engines, components, and modules may perform any number of functions, including functions of multiple modules as described herein. Moreover, although the virtual auditory display system 2302, the first ear-worn device 2302a, the second ear-worn device 2302b, and the generation system 2580 may be depicted as having a single one of several engines, components, or modules, the virtual auditory display system 2302, the first ear-worn device 2302a, the second ear-worn device 2302b, and the generation system 2580 may have multiple engines, components, modules, or the like that perform a particular function. For example, the first ear-worn device 2302a is depicted as having a single one of the audio DSP 2460, but the first ear-worn device 2302a may include multiple of the audio DSP 2460.

FIG. 25A is a block diagram of a method 2500 of personalizing, generating and applying digital filters in some embodiments. A generation system 2580 (see FIG. 25B) may perform the generation of digital filters (step 2504 through step 2510), and the virtual auditory display system 2302 may perform the personalization of digital filters (step 2502) and the application of digital filters (step 2512 through step 2514).

A digital filter may be or include one or more parametric equalization (EQ) filters that allow for adjustment of parameters such as the center frequency, gain, quality (Q or q), cutoff frequency, slope, bandwidth and/or filter type. The parametric EQ filters may be or include biquad filters. The biquad filters may be or include peaking, low shelf, and high shelf filters. In some embodiments, the digital filters may be or include one or more finite impulse response (FIR) filters. The FIR filters may be generated from or based on one or more infinite impulse response (IIR) filters. In some embodiments, the digital filters may be or include one or more IIR filters, or any other suitable type of digital filter.

The digital filters that the generation system 2580 generates may be organized into multiple groups. The groups of digital filters may include a group of notch filters, a group of head shadow filters, a group of shelf filters, a group of peak filters, a group of beam filters, a group of stereo filters, a group of rear filters, a group of top filters, a group of top transition filters, a group of bottom filters, a group of bottom transition filters, and a group of broadside filters. Other groups are possible. Certain digital filters or groups of digital filters may be utilized for purposes of setting the locations of sounds in virtual auditory space (for example groups of notch filters). Certain digital filters or groups of digital filters may be utilized for purposes of ensuring that sounds meet required thresholds of tonal quality, clarity, brightness, and the like.

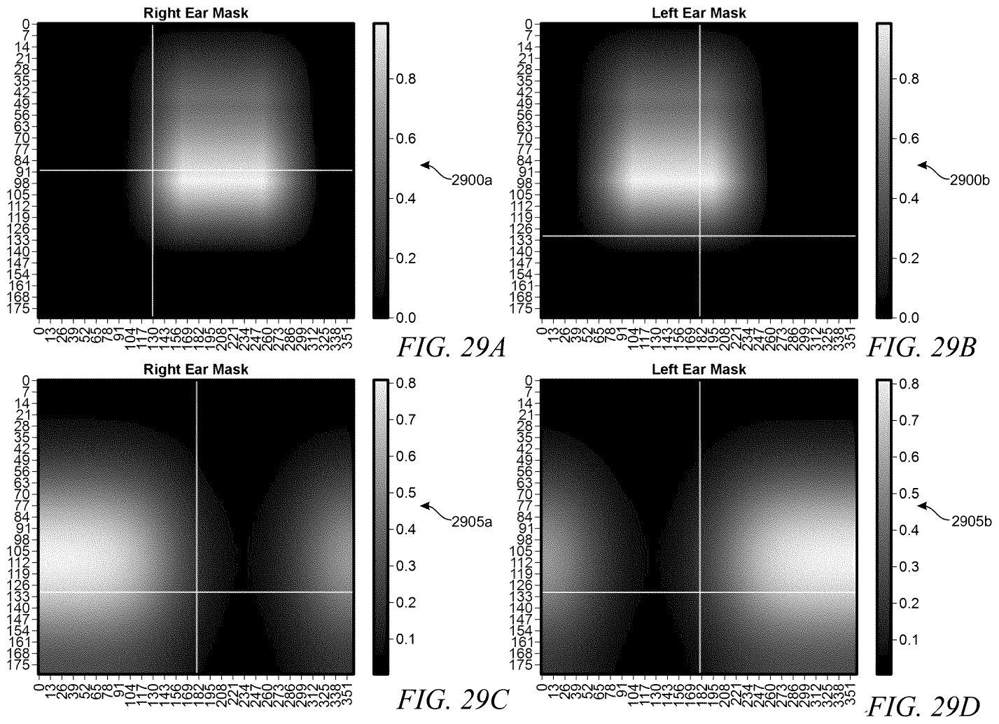

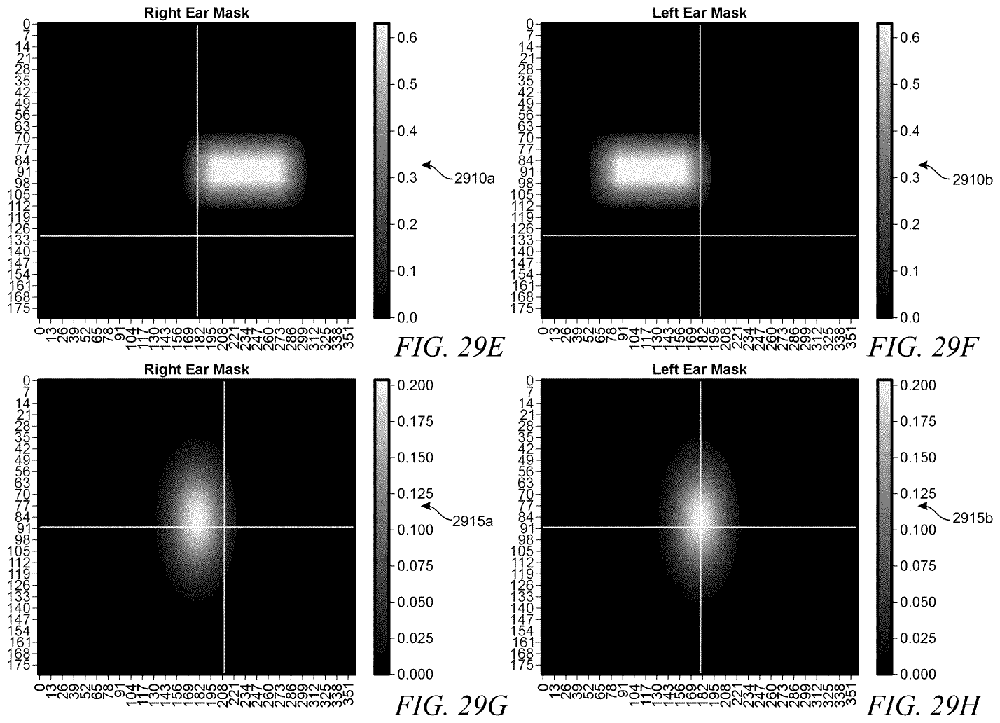

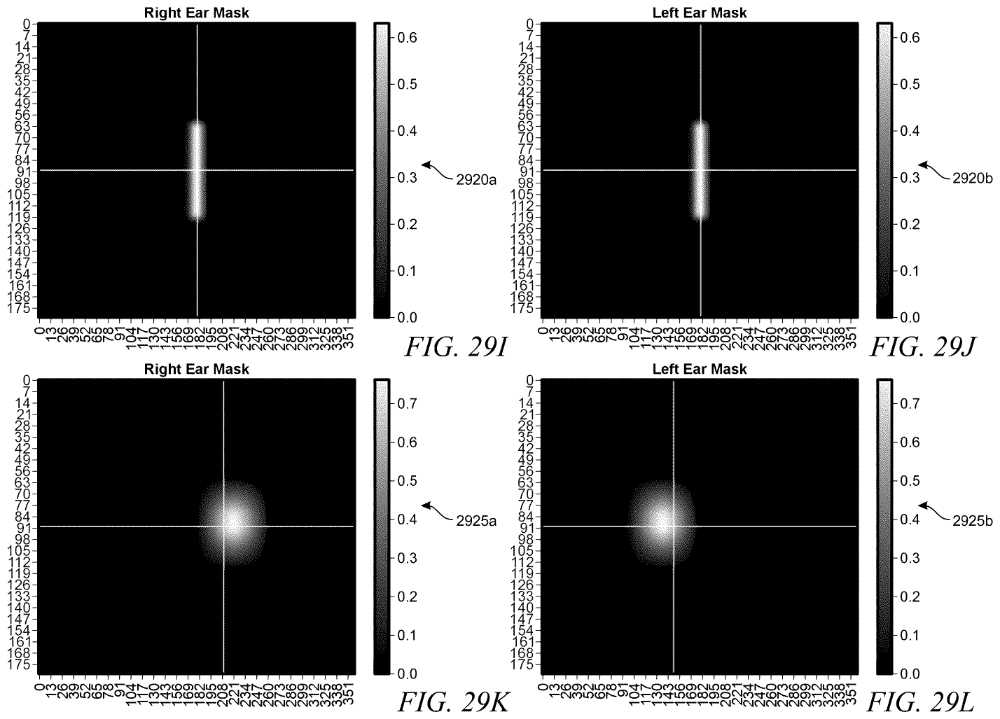

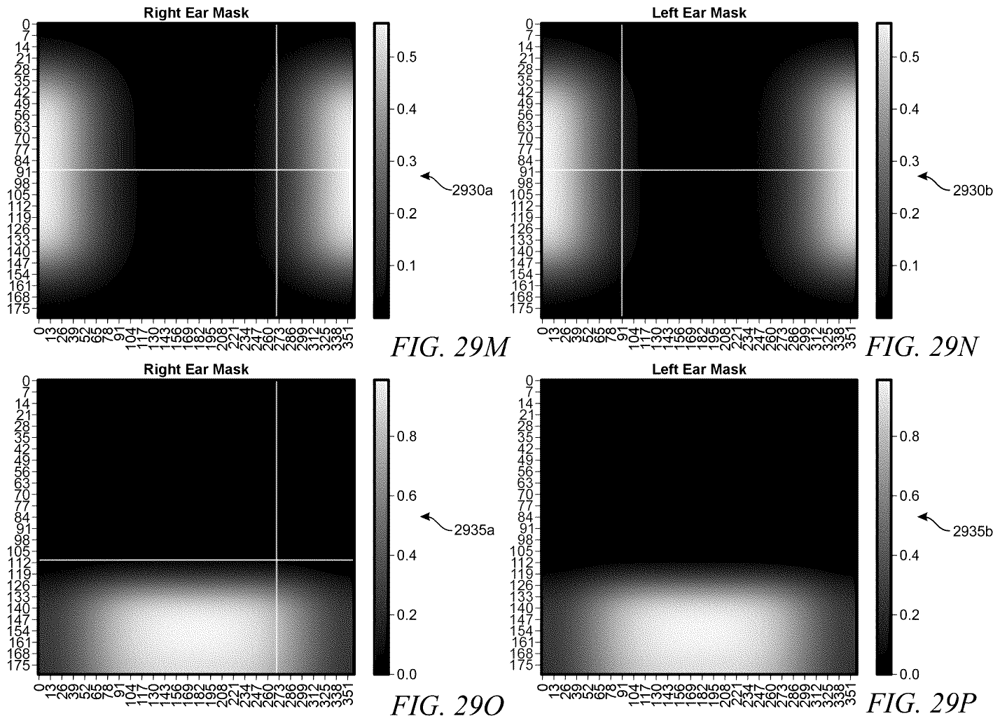

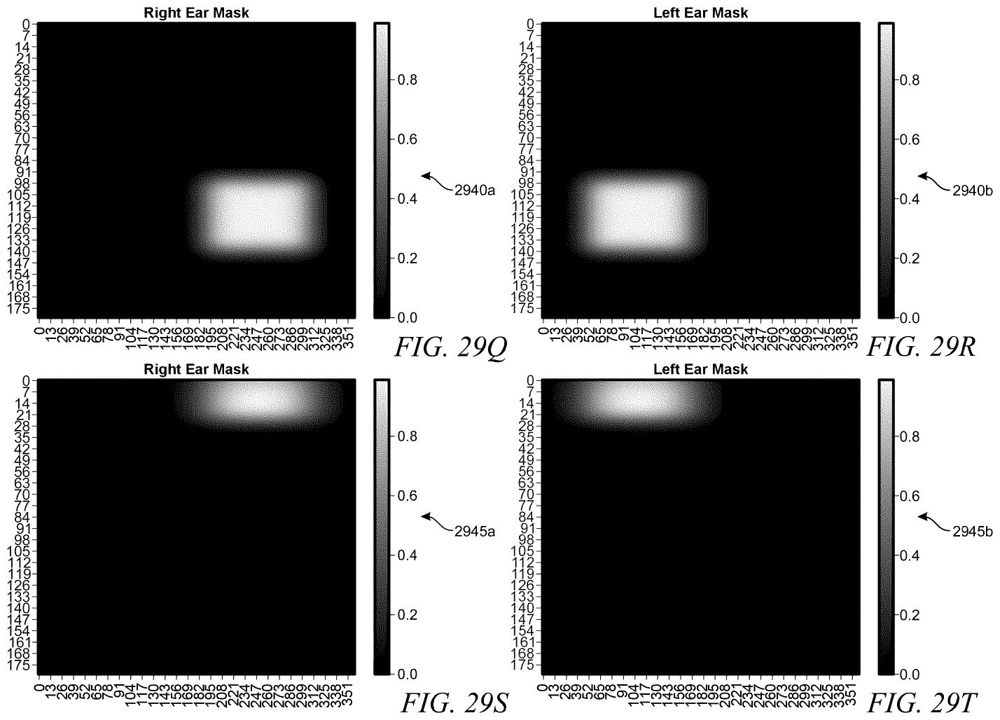

A digital filter may be or include an algorithm and one or more parameters for the algorithm. For example, the algorithm may be or include a high shelf, a low shelf, and a peaking algorithm. The one or more parameters may be or include a center frequency, a quality (Q or q), a gain, and a sampling frequency. For example, a notch digital filter may specify a peaking algorithm, an initial center frequency of 6600 Hz, a Q of 15, and an initial gain of −85 decibels (dB). The one or more parameters may be modified. For example, an initial center frequency may be shifted to obtain a shifted center frequency and an initial gain may be modified by a parameter modifier (see, for example, the discussion with reference to FIGS. 29A through 29X) and a factor that has any value, such as a value between 0 and 1, inclusive. The digital filter may be or include the one or more parameters as modified.

Digital filters may be generated and utilized based on how the digital filters represent individuals' geometries interact with sound waves. For example, a digital filter having a high shelf algorithm may produce a high shelf that may be a virtual representation of how the geometry of individual's concha bowl interacts with sound waves.

The method 2500 may include a step 2502 of calibration and/or personalization. The virtual auditory display system 2302 (for example, the calibration and personalization module 2408) may perform calibration of the IMUs and/or other sensors of the virtual auditory display device 2300 using various devices and/or services 2526, such as one or both of the first ear-worn device 2302a and the second ear-worn device 2302b, a cloud-based computing service, and/or a peripheral to a computing device, such as a camera.

The virtual auditory display system 2302 (for example, the calibration and personalization module 2408) may perform personalization of the virtual auditory display system using various methodologies and/or techniques, such as: 1) a user-directed action and/or perception of acoustic cues 2516; 2) acoustic quality user feedback 2518; 3) anatomical measurements 2520; 4) demographic information 2522; and 5) audiometric measurements 2524.

User-directed action and/or perception of acoustic cues 2516 may include capturing responses of a user to locations of acoustic cues. Responses may be vocal responses of a user captured using a microphone of a computing device, gestures (for example, head and/or arm movements) of a user captured using a camera of a computing device and/or one or both of the first ear-worn device 2302a and the second ear-worn device 2302b, and user input captured via a graphical user interface (GUI) of a computing device.

Acoustic quality user feedback 2518 may include user-directed feedback on acoustic quality (for example, responses to questions on quality metrics such as brightness, warmth, clarity, etc., responses to questions provided by a GUI or an Audio User Interface (AUI)), and observations of user behavior such as user song and/or notification preferences via, for example, a GUI or AUI.

Anatomical measurements 2520 may include measurements of user anatomical features, such as the head, the pinna, and/or the concha, via scanning or prediction. Anatomical measurements 2520 of one or more users may also include direct measurements (for example, via silicone ear impressions) and indirect measurements obtained via sensors and/or computer peripherals.

Demographic information 2522 may include information provided by users such as user age or other demographics and a digital fingerprint of a user generated from one or more user features such as age, gender, and/or other user characteristics.

Audiometric measurements 2524 may include those provided by user input and or obtained via acoustic measurements, such as in an anechoic chamber while audio signals are emitted from different known locations.

The method 2500 may include a step 2504 of the generation system 2580 (for example, a model generation module 2586 of the generation system 2580, see FIG. 25B) generating, modifying, and/or receiving multiple models 2570. The multiple models 2570 may include one or more outer ear models 2554, which may include one or more pinna models 2556 and one or more concha models 2558. The multiple models 2570 may also include one or more head and torso models 2560 and one or more canal models 2562. The generation system 2580 may generate the multiple models 2570 based on the calibration and/or personalization information obtained in step 2502.

For each model of the multiple models 2570, for each location in virtual auditory space, the generation system 2580 may generate one or more first digital filters (for the left ear) and one or more second digital filters (for the right ear) based on the model. Accordingly, for the multiple models 2570, for each location in virtual auditory space, the generation system 2580 may generate multiple first digital filters and multiple second digital filters.

For example, for the one or more head and torso models 2560, the generation system 2580 may generate one or more first digital filters and one or more second digital filters that take into account shoulder width and/or breadth, head diameter, neck height, and other factors. For the one or more concha models 2558 the generation system 2580 may generate one or more first digital filters and one or more second digital filters that represent the acoustic effects of the physical features of the concha. These features include (but are not limited to), concha depth, width, and angle.

As another example, for the one or more pinna models 2556, the generation system 2580 may generate one or more first digital filters and one or more second digital filters that represent the acoustic effects of the physical features of the pinna. These features include (but are not limited to), pinna height, width, depth, location on the head, and flare angle relative to head. For the one or more canal models 2562, the generation system 2580 may generate one or more first digital filters and one or more second digital filters that take into account the physical proportions of the pinna, concha, and other ear components.

Also at the step 2504, for each location in virtual auditory space, the generation system 2580 may sum, aggregate, or otherwise combine the multiple first digital filters into combined first digital filters, and may sum, aggregate, or otherwise combine the multiple second digital filters into combined second digital filters. The combined first digital filters may be or include one or more finite impulse response (FIR) filters. The combined second digital filters may also be or include one or more FIR filters. Accordingly, at the conclusion of the step 2504, for all the locations in virtual auditory space, there may be a set of combined first digital filters and a set of combined second digital filters.

At a step 2506, the generation system 2580 may generate a mapping or association of the combined first digital filters to their corresponding locations in virtual auditory space for the left ear. The generation system 2580 may also generate a mapping or association of the combined second digital filters to their corresponding locations in virtual auditory space for the right ear. The generation system 2580 may utilize cartesian, polar, and/or spherical polar coordinates for the mapping or association.

At a step 2508, the generation system 2580 may generate a file, a database, or other data structure that includes the mapping or association of the combined first digital filters to their corresponding locations in virtual auditory space and the mapping or association of the combined second digital filters to their corresponding locations in virtual auditory space.

At a step 2510, the generation system 2580 may provide or store the file, the database, or other data structure on one or more non-transitory computer-readable media of a device. The device may be the first ear-worn device 2302a and/or the second ear-worn device 2302b, a mobile device such as a phone or a tablet, a laptop or desktop computer, another device, or any combination of the foregoing.

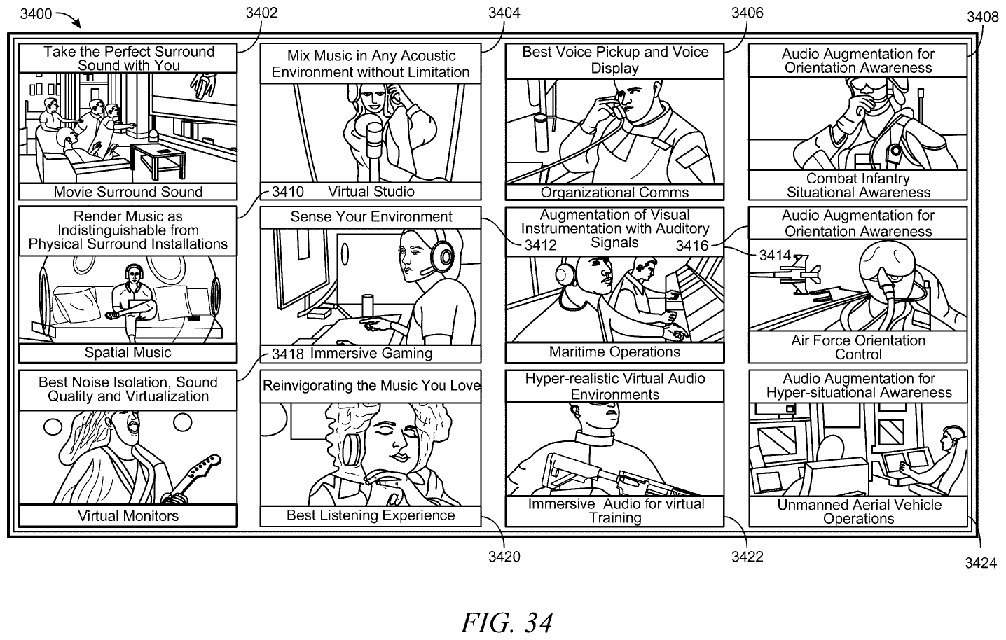

At a step 2512, the virtual auditory display system 2302 may select the combined first digital filters and the combined second digital filters for use. After selection, at a step 2514, the virtual auditory display system 2302 may utilize the combined first digital filters and the combined second digital filters in various applications, such as to render music. Various applications of the disclosed technology are discussed with reference to, for example, FIG. 34.

In some embodiments, at step 2504, for each model of the multiple models 2570, the generation system 2580 may generate one or more first digital filters and one or more second digital filters for each azimuth and elevation combination at locations in virtual auditory space of one degree increments of azimuth and elevation at a distance of one meter (1 m) from a center point representing a virtual listener in virtual auditory space. The one degree increments of azimuth are from approximately negative 180 degrees, inclusive, to approximately positive 180 degrees, inclusive. The one degree increments of elevation are from approximately negative 90 degrees, inclusive, to approximately 90 degrees, inclusive. Accordingly, there are 65, 160 combinations of azimuth and elevation, and therefore 65, 160 locations in virtual auditory space, each location being at a distance of 1 m from the center point. Therefore, the generation system 2580 may generate 65, 160 sets of one or more first digital filters and 65,160 sets of one or more second digital filters.

In some embodiments, the method 2500 may include a step of the generation system 2580 reducing the number of locations in virtual auditory space for which digital filters are generated or stored. For example, after step 2504, the generation system 2580 may a select a proper subset from the set of combined first digital filters and a proper subset from the set of combined second digital filters.

In embodiments where there are 65,160 locations in virtual auditory space, the generation system 2580 may select a proper subset from the set of combined first digital filters that includes approximately 7,000, such as 7,220, combined first digital filters. Similarly, the generation system 2580 may select a proper subset from the set of combined second digital filters that includes approximately 7,000, such as 7,220, combined second digital filters.

The generation system 2580 may select a proper subset that adequately represent locations in virtual auditory space, while reducing the amount of storage required for the sets of digital filters and reducing the amount of time to select and process digital filters. The generation system 2580 may achieve these objectives in other ways, such as by generating mapping or associations for a reduced number of locations in virtual auditory space or storing the mapping or associations for a reduced number of locations in virtual auditory space.

In some embodiments, at step 2504 the generation system 2580 does not sum, aggregate, or otherwise combine the multiple first digital filters into combined first digital filters and the multiple second digital filters into combined second digital filters. Accordingly, at the conclusion of the step 2504, for all the locations in virtual auditory space, there may be a set of multiple first digital filters and a set of multiple second digital filters. A proper subset of the set of multiple first digital filters and a proper subset of the set of multiple second digital filters may be utilized as described herein.

In such embodiments, at step 2506 the generation system 2580 may instead generate a mapping or association of the multiple first digital filters to their corresponding locations in virtual auditory space for the left ear and generate a mapping or association of the multiple second digital filters to their corresponding locations in virtual auditory space for the right ear.

Further in such embodiments, at step 2508 the generation system 2580 may instead generate a file, a database, or other data structure that includes the mapping or association of the multiple first digital filters to their corresponding locations in virtual auditory space and the mapping or association of the multiple combined second digital filters to their corresponding locations in virtual auditory space.

In some embodiments, the generation system 2580 generates multiple sets of digital filters for the locations in virtual auditory space. The generation system 2580 may generate a first set of digital filters for the left ear and a first set of digital filters for the right ear as described herein. The generation system 2580 may then generate one or more second sets of digital filters for the left ear and one or more second sets of digital filters for the right ear based on the first set of digital filters for the left ear and the first set of digital filters for the right ear. Each pair of sets may be for a different archetype representing a different user population or grouping of users.

The generation system 2580 may generate the one or more second sets of digital filters for the left ear and the one or more second sets of digital filters for the right ear by modifying one or more parameters of the digital filters for the left ear and the digital filters for the right ear. For example, the generation system 2580 may modify the center frequency of notch filters that are included in the first set of digital filters for the left ear and the first set of digital filters for the right ear. The generation system 2580 may modify the center frequency of notch filters to personalize digital filters to a user, as described with reference to, for example, FIGS. 37A through 37F. The generation system 2580 may do so to adjust for a delta between an actual location of a sound in virtual auditory space and the location of the sound the wearer perceives.

In some embodiments, the generation system 2580 may generate a first set of digital filters for the left ear and a first set of digital filters for the right ear for a distance of 1 m from a center point representing a virtual listener in virtual auditory space, as described herein. The generation system 2580 may generate one or more second sets of digital filters for the left ear and the one or more second sets of digital filters for the right ear for other distances from the center point. The generation system 2580 may generate one or more second sets of digital filters for the left ear based on the first set of digital filters for the left ear and one or more second sets of digital filters for the right ear based on the first set of digital filters for the right ear. For example, the generation system 2580 may increase the gain of digital filters for distances closer than 1 m from the center point and may decrease the gain of digital filters for distances further than 1 m from the center point. Other methods will be apparent.

FIG. 25B is a block depicting components of the generation system 2580 in some embodiments. The generation system 2580 may include a communication module 2582, a filter generation module 2584, a model generation module 2586, a parameter generation module 2588, a parameter mask module 2590, a digital filter tuning module 2592, a user interface module 2594, and a data storage 2596.

The communication module 2582 may send requests and/or data between components of the generation system 2580 and any other systems, components or devices, such as the virtual auditory display system 2302. The communication module 2582 may also receive requests and/or data between components of the generation system 2580 and any other systems, components or devices.

The filter generation module 2584 may generate digital filters and the acoustic environment digital filters. A filter may be or include one or more algorithms and, optionally, one or more parameters for the one or more algorithms.

The model generation module 2586 may generate, modify, or access multiple models. The parameter generation module 2588 may generate parameters for digital filters.

The parameter mask module 2590 may generate parameter modifier masks. The parameter mask module 2590 may use image processing techniques to generate parameter modifier masks. The parameter mask module 2590 may determine one or more parameter modifiers to one or more parameter of filters using the parameter modifier masks. The parameter mask module 2590 may modify the one or more parameter using the one or more parameter modifiers.

The digital filter tuning module 2592 may receive parameters for digital filters from users and modify digital filters based on the received parameters. The user interface module 2594 may provide user interfaces that allow users to, among other things, listen to sound output from audio signals generated by application of digital filters and modify parameters of digital filters.

The data storage 2596 may include data stored, accessed, and/or modified by any of the engines, components, modules or the like of the generation system 2580. The data storage 2596 may include any number of data storage structures such as tables, databases, lists, and/or the like. The data storage 2596 may include data that is stored in memory (for example, random access memory (RAM)), on disk, or some combination of in-memory and on-disk.

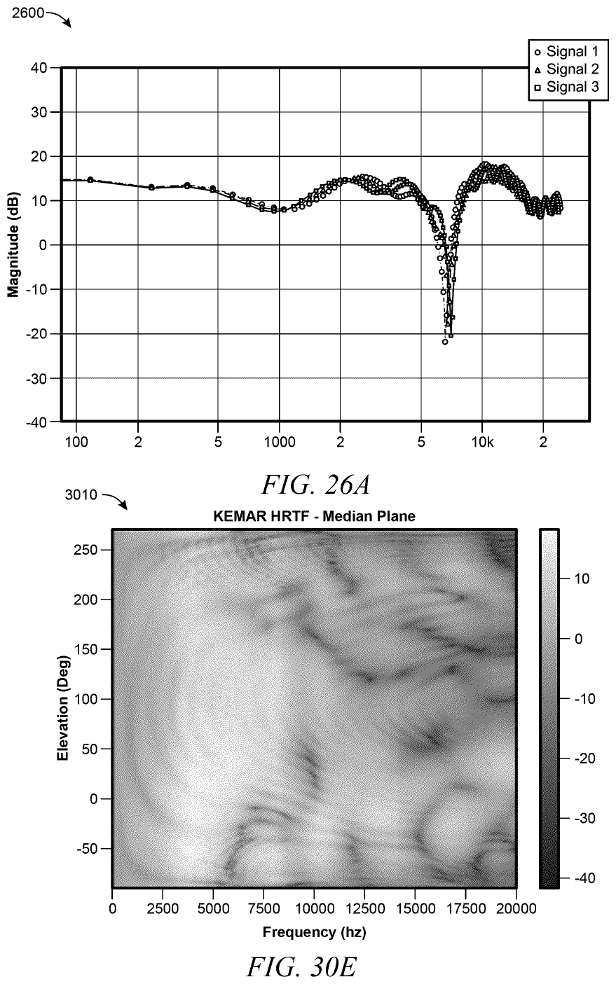

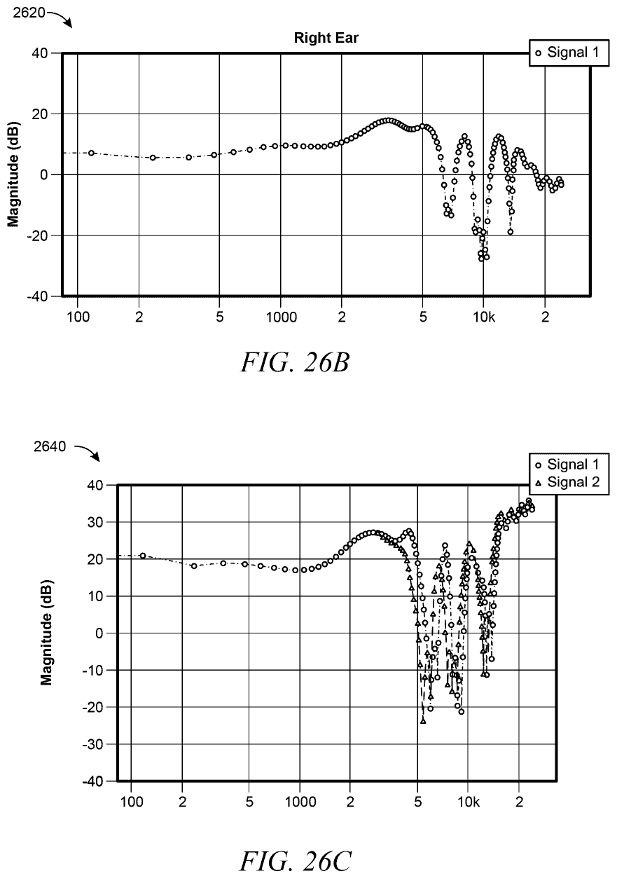

FIGS. 26A-26C are graphs of frequency responses of digital audio signals in some embodiments. FIG. 26A is a graph 2600 the frequency response for three audio signals. Each audio signal has a notch at a different center frequency. The center frequency of the notch is a factor in specifying the location in virtual auditory space of the sound corresponding to the audio signal, meaning where a user (for example, a wearer of the first ear-worn device 2302a and the second ear-worn device 2302b) perceives the location of the sound to be.

The first audio signal is for a first sound that has a first location in virtual auditory space at a distance of one (1) meter (m), zero degrees (0°) azimuth and zero degrees (0°) elevation. The second audio signal is for a second sound that has a second location in virtual auditory space at a distance of one (1) m, five degrees (5°) azimuth and zero degrees (0°) elevation The third audio signal is for a third sound that has a third location in virtual auditory space at a distance of one (1) m, ten degrees (10°) azimuth and zero degrees (0°) elevation. FIG. 26A shows the variation of the center frequency notch in the three signals due to the differences in locations in virtual auditory space. The virtual auditory display system 2302 has applied a notch filter to the three audio signals produce each notch in each of the three frequency responses in order to produce the three sounds at the specified locations in virtual auditory space. The notch filter may be or include parametric EQ filters with the parameters being the center frequency, the gain, and the bandwidth.

FIG. 26B is a graph 2620 of a frequency response of an audio signal to which digital filters have been applied according to some embodiments. The frequency response has three notches at three different center frequencies. The audio signal is for a sound that has a location in virtual auditory space at a distance of one (1) meter (m), zero degrees (0°) azimuth and zero degrees (0°) elevation. The virtual auditory display system 2302 has applied three notch filters to produce the three notches in the frequency response of the audio signal. The notch filters may be or include parametric EQ filters with the parameters being the center frequency, the gain, and the bandwidth.

FIG. 26C is a graph 2640 of frequency responses of two audio signals to which digital filters have been applied according to some embodiments. Each frequency response has a notch at a different center frequency. The virtual auditory display system 2302 has applied three notch filters to produce the three notches in each frequency response. The notch filters may be or include parametric EQ filters with the parameters being the center frequency, the gain, and the bandwidth.

In the examples depicted in FIGS. 26A-26C, the peak-to-trough decibel values of notches of the azimuthal values between negative ten degrees (−10°) to ninety-five degrees (95°) and the elevation values of between negative thirty degrees (−30°) to forty-five degrees (45°) reach<negative thirty (−30) decibels (dB). When a virtual sound-source exists within the proposed azimuth-elevation bounds, the peak-to-trough decibel value of −30 dB or more may be beneficial for producing accurate sound-source localization for the hearer.

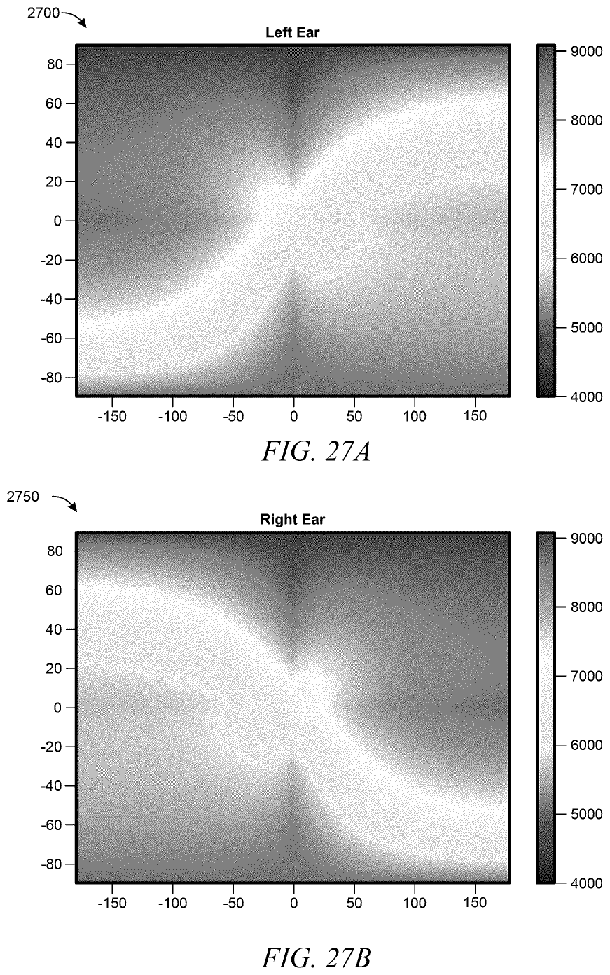

FIG. 27A depicts a distribution 2700 of center frequencies as a function of azimuth (x-axis) and elevation (y-axis) for the left ear. FIG. 27B depicts a distribution 2750 of center frequencies as a function of azimuth (x-axis) and elevation (y-axis) for the right ear. The distribution 2700 and the distribution 2750 indicate that, for any particular azimuth, the center frequencies follow a generally sigmoidal curve or have a generally sigmoidal shape or distribution. Similarly, for any particular elevation, the center frequencies follow a generally sigmoidal curve or have a generally sigmoidal shape or distribution.

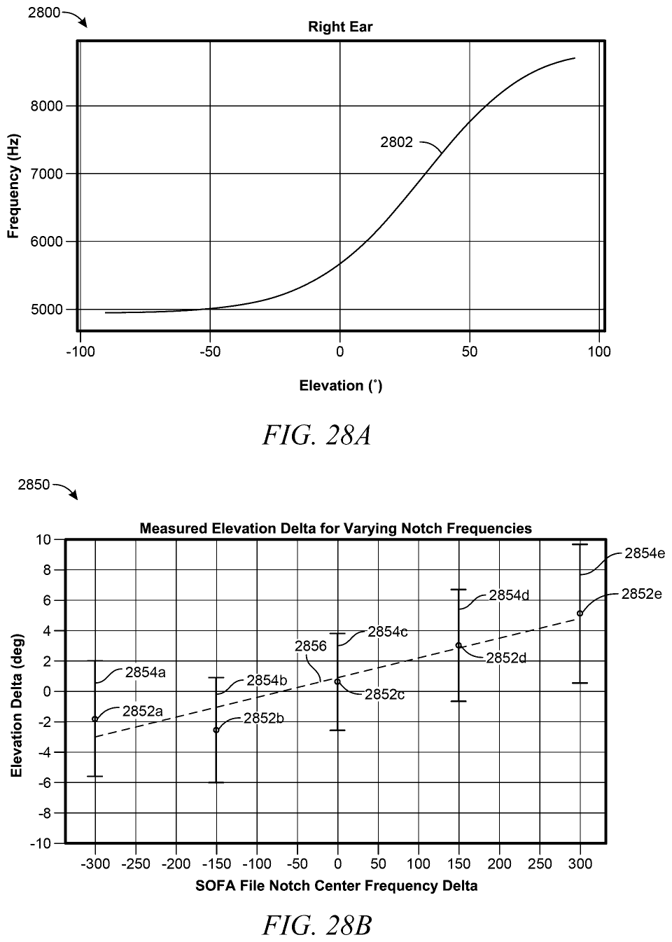

For example, FIG. 28A is a graph 2800 of a center frequency curve 2802 as a function of elevation (x-axis) for the right ear where the azimuth is zero degrees (0°). The center frequency values range from about approximately 4900 Hz to about approximately 8700 Hz from negative 90 degrees elevation to 90 degrees elevation. The center frequency curve 2802 has a generally sigmoidal shape or distribution.

Returning to FIGS. 27A and 27B, the virtual auditory display system 2302 may utilize the distribution 2700 and/or the distribution 2750 to determine the center frequencies for one or more notches in the frequency spectrums of audio signals. The virtual auditory display system 2302 may determine the center frequencies for the one or more notches based on the location of the sounds in virtual auditory space that the audio signal will cause the first ear-worn device 2302a and the second ear-worn device 2302b to produce.

That is, based on the location (as specified by, for example, azimuth and elevation) of the sounds in virtual auditory space, the virtual auditory display system 2302 may determine the center frequencies for one or more notches in a frequency spectrum of the audio signals that cause the first ear-worn device 2302a and the second ear-worn device 2302b to produce the sounds. The virtual auditory display system 2302 may determine the center frequencies of the first notches in the frequency spectrums of the audio signals by accessing the distribution 2700 and the distribution 2750. The virtual auditory display system 2302 may determine the center frequencies of the second notches and subsequent notches in the frequency spectrums of the audio signals based on the distribution 2700 and the distribution 2750 and on one or more shifts from the center frequencies obtained from the distribution 2700 and the distribution 2750.

In some embodiments, in addition to or as an alternative to utilizing the distribution 2700 and/or the distribution 2750, the virtual auditory display system 2302 may utilize one or more center frequency curves, each of which may be for a different azimuth value, like the center frequency curve 2802 of FIG. 28A, or a different elevation value. The virtual auditory display system 2302 determines the center frequencies for one or more notches in a frequency spectrum of an audio signal, based on the location of the resulting sounds in virtual auditory space.

FIG. 28B is a graph 2850 of user experience data of multiple trials with five different digital filters, which vary as a function of notch center frequency, in some embodiments. Each of the point 2852a, the point 2852b, the point 2852c, the point 2852d, and the point 2852e is the mean of 15 user trials that collected real-time user feedback on perceived sound location in virtual auditory space, for a total of 75 user trials. The bar 2854a, the bar 2854b, the bar 2854c, the bar 2854d, and the bar 2854e each represent plus or minus one (1) standard deviation. The point 2852b, the point 2852c, the point 2852d and the point 2852e demonstrate that there is an observed delta of approximately 2.5° for each 150 Hz added to the notch center frequencies. The line 2856 can be fit to the points 2852. The virtual auditory display system 2302 may utilize the linear function that produced the line 2856 to determine the center frequency to use for one or more notches based on the elevation of the sound to be produced. For example, for certain ranges of elevations (for example, between approximately zero degrees and approximately 50 degrees, or between approximately 10 degrees and approximately 40 degrees), the virtual auditory display system 2302 may utilize the linear that produced the line 2856 to determine one or more shifts from a center frequency in the ranges. The virtual auditory display system 2302 may do so in addition to or as an alternative to utilizing the distribution 2700 and/or the distribution 2750 depicted in FIGS. 27A and 27B.

FIGS. 29A through 29X depict parameter modifier masks that may be applied to modify parameters used in generating digital filters in some embodiments. FIG. 29A depicts a right ear parameter modifier mask 2900a and FIG. 29B depicts a left ear parameter modifier mask 2900b for notch filters. FIG. 29C depicts a right ear parameter modifier mask 2905a and FIG. 29D depicts a left ear parameter modifier mask 2905b for head shadow filters. FIG. 29E depicts a right ear parameter modifier mask 2910a and FIG. 29F depicts a left ear parameter modifier mask 2910b for shelf filters. FIG. 29G depicts a right ear parameter modifier mask 2915a and FIG. 29H depicts a left ear parameter modifier mask 2915b for peak filters. FIG. 29I depicts a right ear parameter modifier mask 2920a and FIG. 29J depicts a left ear parameter modifier mask 2920b for beam filters. FIG. 29K depicts a right ear parameter modifier mask 2925a and FIG. 29L depicts a left ear parameter modifier mask 2925b for stereo filters.

FIG. 29M depicts a right ear parameter modifier mask 2930a and FIG. 29N depicts a left ear parameter modifier mask 2930b for rear filters. FIG. 29O depicts a right ear parameter modifier mask 2935a and FIG. 29P depicts a left ear parameter modifier mask 2935b for top filters. FIG. 29Q depicts a right ear parameter modifier mask 2940a and FIG. 29R depicts a left ear parameter modifier mask 2940b for top transition filters. FIG. 29S depicts a right ear parameter modifier mask 2945a and FIG. 29T depicts a left ear parameter modifier mask 2945b for bottom filters. FIG. 29U depicts a right ear parameter modifier mask 2950a and FIG. 29V depicts a left ear parameter modifier mask 2950b for bottom transition filters. FIG. 29W depicts a right ear parameter modifier mask 2955a and FIG. 29X depicts a left ear parameter modifier mask 2955b for broadside filters.

The parameter modifier masks depicted in FIGS. 29A-29X specify parameter modifier values as a function of a location in virtual auditory space as specified by, for example, azimuth and elevation. The parameter modifier values may range from between any two values. In some embodiments, the parameter modifier values range between zero (0), inclusive, and another value, such as one (1), 0.2, 0.4, 0.8, inclusive. The parameter mask module 2590 may generate the parameter modifier masks by specifying a particular region in virtual auditory space in which the values are to be one (1), and by specifying that regions other than the particular region have values of zero (0). For example, for the right ear parameter modifier mask 2900a of FIG. 29A, the particular region in virtual auditory space may be from approximately negative 50 (−50) degrees azimuth to approximately 110 degrees azimuth and from approximately negative 290 (−290) degrees elevation to approximately 30 degrees elevation. The parameter mask module 2590 may use other particular regions for the parameter modifier mask 2900a and the other parameter modifier masks in FIGS. 29A-29X.

The parameter mask module 2590 may use image processing algorithms to create continuous transitions of values between the particular region and the other regions to generate the parameter modifier masks with the parameter modifier values. For example, the parameter mask module 2590 may use image processing algorithms such as a gaussian function, a sharpening function, a contrast adjustment function, a color correction function, a thresholding function, an edge detection function, and/or a segmentation function. In some embodiments, the parameter mask module 2590 uses a gaussian blur mask to generate the parameter modifier values. The parameter mask module 2590 may generate the parameter modifier mask for a right ear and then reflect the parameter modifier mask for the right ear about a vertical axis at an azimuth value of zero (0) to obtain the parameter modifier mask for the right ear.

The filter generation module 2584 may utilize the parameter modifier masks depicted in FIGS. 29A-29X to select, based on a location for a sound in virtual auditory space, one or more parameter modifiers that the filter generation module 2584 may use to modify one or more parameters to obtain one or more modified parameters. For example, the filter generation module 2584 may utilize one or more parameter modifiers to modify the gain of digital filters. In some embodiments, the filter generation module 2584 multiplies the one or more parameters by the one or more parameter modifiers to obtain the one or more modified parameters. Other uses of parameter modifiers will be apparent.

FIG. 30A depicts a gain distribution 3070 for a head shadow for a left ear and FIG. 30B depicts a gain distribution 3080 for a head shadow for a right ear according to some embodiments. The gain distribution 3070 depicts how a gain changes as a sound source transitions from a location 3072 generally by the right ear to a location 3074 generally in front of the wearer to a location 3076 generally by the left ear. The gain distribution 3080 depicts how a gain changes as a sound source transitions from a location 3082 generally by the left ear to a location 3084 generally in front of the wearer to a location 3086 generally by the left ear.

FIG. 30C depicts a gain distribution 3060 of the application of digital filters to an audio signal according to some embodiments. The gain distribution 3060 shows several notches 3064 across a head shadow 3062. The several notches 3064 are at center frequencies between 10\hat{ }3 Hz and 10\hat{ }4 Hz.

FIG. 30D depicts user experience data for digital filters according to some embodiments and user experience data for a prior art head-related transfer function (HRTF). The prior art HRTF is used as a standard model for many past and present HRTF applications. Panel 3000 of FIG. 30D reports the difference between the user-perceived elevation of a virtual sound object and the actual elevation of the sound object for both the digital filters for 150 trials and the prior art HRTF for 150 trials. For the digital filters trials, point 3004 is the mean user-perceived elevation and band 3002 is the standard deviation of the user-perceived elevation. For the HRTF trials, point 3008 is the mean user-perceived elevation and band 3006 is the standard deviation of the user-perceived elevation.

Panel 3050 of FIG. 30D reports the difference between the user-perceived azimuth of a virtual sound object and the actual azimuth of the sound object for both the digital filters for 150 trials and the prior art HRTF for 150 trials. For the digital filters trials, point 3052 is the mean user-perceived azimuth and band 3054 is the standard deviation of the user-perceived azimuth. For the HRTF trials, point 3058 is the mean user-perceived azimuth and band 3056 is the standard deviation of the user-perceived azimuth.

For the elevation trials, the closer the elevation delta is to 0°, the more accurate the representation of the virtual sound object. Similarly, for the azimuth trials, the closer the elevation delta is to 0°, the more accurate the representation of the virtual sound object. The user experience data shows that the digital filters improve the elevation delta from a mean of approximately 30.19° with a standard deviation of approximately 12.54° to a mean of approximately −0.03° with a standard deviation of approximately 4.12°. The user experience data also shows the digital filters improves the azimuth delta from a mean of approximately −0.64° with a standard deviation of approximately 7.76° to a mean of approximately −0.02° with a standard deviation of approximately 2.04°. The data shows that the digital filters according to some embodiments improve the accuracy and precision of virtual sound objects.

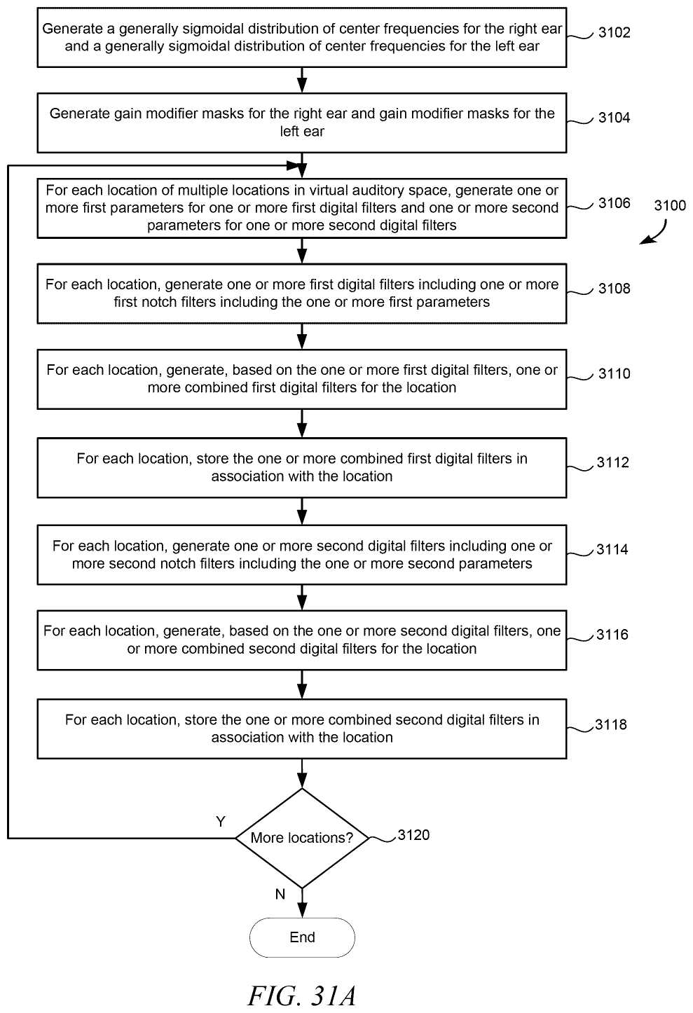

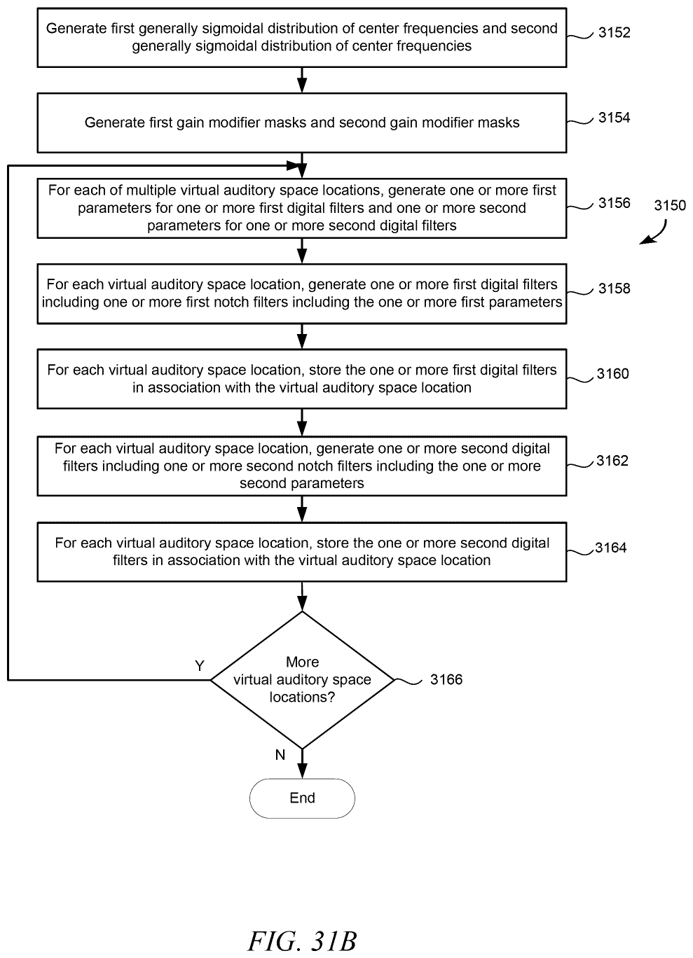

FIG. 31A depicts a method 3100 of generating digital filters according to some embodiments. The generation system 2580 may perform the method 3100. The generation system 2580 may perform the method 3100 to generate a set of combined first digital filters and a set of combined second digital filters. The method 3100 begins at a step 3102, where the generation system 2580 (for example, the filter generation module 2584) may generate a generally sigmoidal distribution of center frequencies for the right ear (see, for example, FIG. 27A) and a generally sigmoidal distribution of center frequencies for the left ear (see, for example, FIG. 27B).

At a step 3104 the generation system 2580 (for example, the parameter mask module 2590) generates parameter modifier masks for the right ear and parameter modifier masks for the left ear (see, for example, FIGS. 29A through 29X). The generation system 2580 may generate the parameter modifier masks using one or more image processing algorithms. The one or more image processing algorithms may include one or more of a gaussian function, a sharpening function, a contrast adjustment function, a color correction function, a thresholding function, an edge detection function, and a segmentation function.

At a step 3106, for each location of multiple locations in virtual auditory space, the generation system 2580 (for example, the parameter generation module 2588) may generate one or more first parameters for one or more first digital filters and one or more second parameters for one or more second digital filters. The one or more first parameters may include one or more first q's, one or more first gains, and one or more first center frequencies. The one or more second parameters may include one or more second q's, one or more second gains, and one or more second center frequencies.

The generation system 2580 may utilize the parameter modifier masks for the right ear and the parameter modifier masks for the left ear to select, based on the location in virtual auditory space, one or more parameter modifiers that the generation system 2580 may use to modify one or more parameter to obtain one or more modified parameter. In some embodiments, the generation system 2580 multiplies the one or more parameter by the one or more parameter modifiers to obtain the one or more modified parameter.

The generation system 2580 may utilize the generally sigmoidal distribution of center frequencies for the right ear and/or the generally sigmoidal distribution of center frequencies for the left ear to determine one or more center frequencies for one or more notches in the frequency spectrums of the audio signal for the right ear and the audio signal for the left ear. The generation system 2580 may determine the center frequencies for the one or more notches based on the location in virtual auditory space.

At a step 3108, for each location, the generation system 2580 (for example, the filter generation module 2584) may generate one or more first digital filters including one or more first notch filters including the one or more first parameters. The generation system 2580 may utilize the one or more first q's, the one or more first gains, and the one or more first center frequencies to generate the one or more first notch filters. The one or more first notch filters are configured to produce one or more first notches in a first frequency spectrum of a first audio signal according to the one or more first q's, the one or more first gains, and the one or more first center frequencies when the generation system 2580 applies the one or more notch filters to an audio signal for the right ear.

At a step 3110, for each location, the generation system 2580 (for example, the filter generation module 2584) may generate, based on the one or more first digital filters, one or more combined first digital filters for the location. In some embodiments, the one or more first digital filters are IIR filters, and the one or more combined first digital filters are FIR filters.

At a step 3112, for each location, the generation system 2580 may store the one or more combined first digital filters in association with the location (in, for example, the data storage 2420).

At a step 3114, for each location, the generation system 2580 (for example, the filter generation module 2584) may generate one or more second digital filters including one or more second notch filters including the one or more second parameters. The generation system 2580 may utilize the one or more second q's, the one or more second gains, and the one or more second center frequencies to generate the one or more second notch filters. The one or more second notch filters are configured to produce one or more second notches in a second frequency spectrum of a second audio signal according to the one or more second q's, the one or more second gains, and the one or more second center frequencies when the generation system 2580 applies the one or more notch filters to an audio signal for the left ear.

At a step 3116, for each location, the generation system 2580 (for example, the filter generation module 2584) may generate, based on the one or more second digital filters, one or more combined second digital filters for the location. In some embodiments, the one or more second digital filters are IIR filters, and the one or more combined second digital filters are FIR filters.

At a step 3118, for each location, the generation system 2580 may store the one or more combined second digital filters in association with the location (in, for example, the data storage 2420).

At a step 3120 the generation system 2580 tests to see if there are more locations for which the generation system 2580 is to generate digital filters. If so, the method 3100 returns to step 3106. The generation system 2580 may perform the method 3100 multiple times to generate multiple sets of combined first digital filters and multiple sets of combined second digital filters. Each pair of sets of digital filters may be for a different archetype

In some embodiments, the generation system 2580 may perform the method 3100 several times to generate multiple sets of combined first digital filters and combined second digital filters. Each pair of sets may be for a different archetype representing a different user population or grouping of users.

FIG. 31B depicts a method 3150 of generating digital filters in some embodiments. The generation system 2580 may perform the method 3100. The method 3150 includes certain steps that may be generally similar to certain steps of the method 3100. The generation system 2580 (for example, various components of the generation system 2580) may perform the method 3150. The generation system 2580 may perform the method 3150 to generate a set of first digital filters and a set of second digital filters.

The method 3150 begins at a step 3152, where the generation system 2580 (for example, the parameter generation module 2588) may generate a first generally sigmoidal distribution of center frequencies and a second generally sigmoidal distribution of center frequencies. At a step 3154 the generation system 2580 (for example, the parameter mask module 2590) may generate first parameter modifier masks and second parameter modifier masks.

At a step 3156, for each of multiple virtual auditory space locations, the generation system 2580 (for example, the parameter generation module 2588) may generate one or more first parameters for one or more first digital filters and one or more second parameters for one or more second digital filters. The one or more first parameters may include one or more first q's, one or more first gains, and one or more first center frequencies. The one or more second parameters may include one or more second q's, one or more second gains, and one or more second center frequencies.

At a step 3158, for each virtual auditory space location, the generation system 2580 may generate one or more first digital filters including one or more first notch filters including the one or more first parameters. Step 3158 is generally similar to step 3108 of the method 3100.

At a step 3160, for each virtual auditory space location, the generation system 2580 may store the one or more first digital filters in association with the virtual auditory space location. Step 3160 is generally similar to step 3112 of the method 3100.

At a step 3162, for each virtual auditory space location, the generation system 2580 may generate one or more second digital filters including one or more second notch filters including the one or more second parameters. Step 3162 is generally similar to step 3114 of the method 3100.

At a step 3164, for each virtual auditory space location, the generation system 2580 may store the one or more second digital filters in association with the virtual auditory space location. Step 3164 is generally similar to step 3118 of the method 3100.

At a step 3166 the generation system 2580 tests to see if there are more virtual auditory space locations for which the generation system 2580 is to generate digital filters. If so, the method 3100 returns to step 3156. The generation system 2580 may perform the method 3150 multiple times to generate multiple sets of one or more first digital filters and multiple sets of one or more second digital filters.

The method 3100 and the method 3150 may include additional steps. For example, the generation system 2580 may provide for testing digital filters. The generation system 2580 (for example, the user interface module 2594) may provide a user interface that allows for sound generated by audio signals to which digital filters have been applied to be played. A user may listen to the sounds and determine that one or more parameters of the digital filters should be modified. For example, the user may modify parameters of digital filters to ensure that sounds meet required thresholds of tonal quality, clarity, brightness, and the like. The generation system 2580 may provide another user interface that allows the user to modify the one or more parameters of the digital filters. The generation system 2580 (for example, the digital filter tuning module 2592) may receive the one or more parameters of the digital filters from users and modify digital filters based on the received one or more parameters.

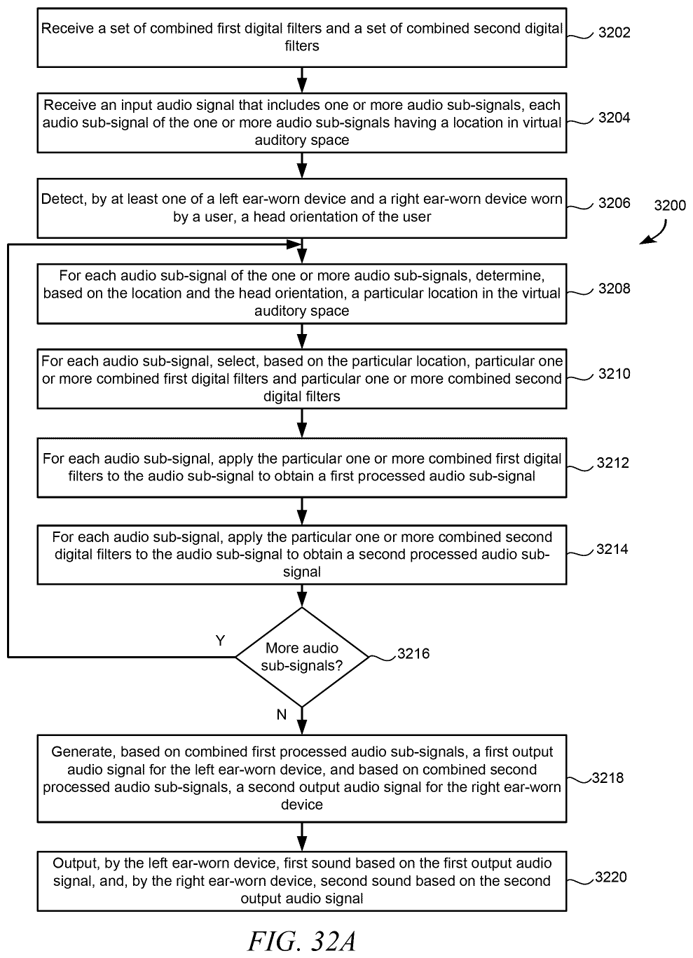

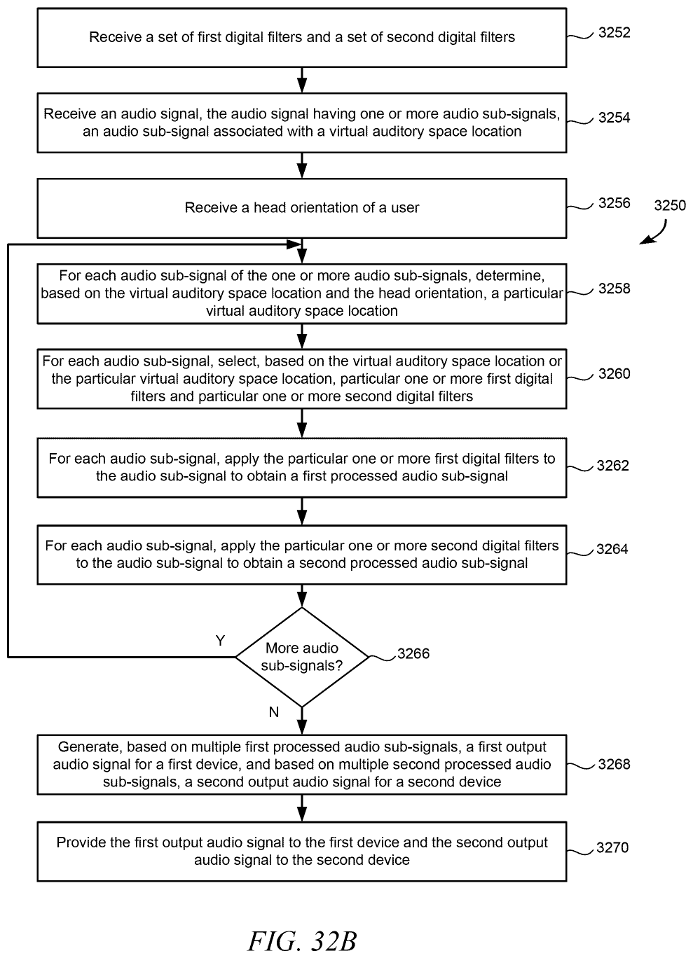

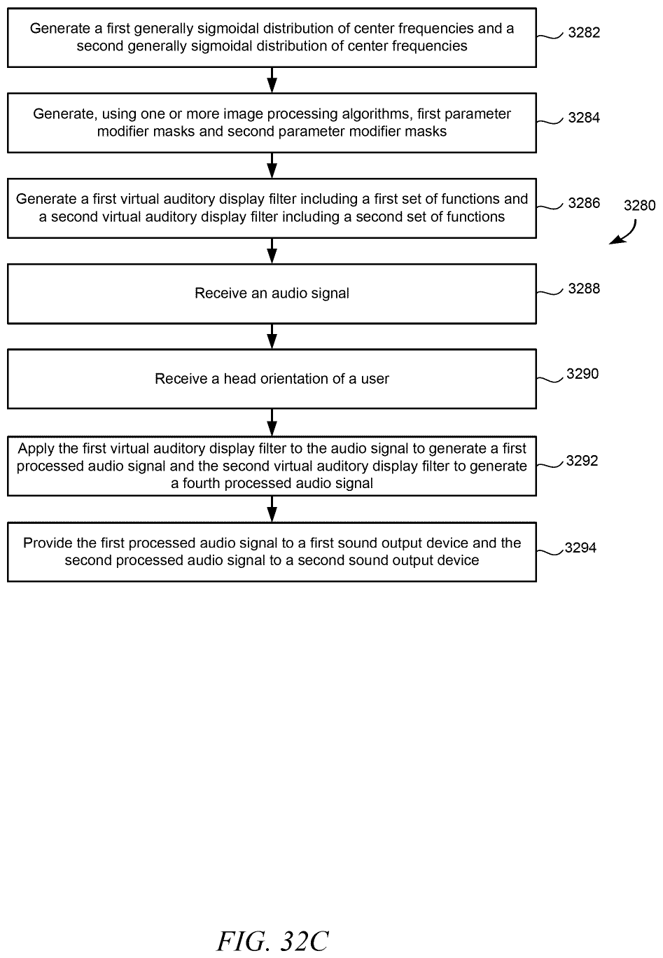

FIG. 32A depicts a method 3200 of applying digital filters according to some embodiments. The virtual auditory display system 2302 and the virtual auditory display device 2300 may perform the method 3200. The method 3200 begins at a step 3202, where the virtual auditory display system 2302 (for example, the binauralizer 2338) receives a set of combined first digital filters and a set of combined second digital filters. At a step 3204 the virtual auditory display system 2302 (for example, the binauralizer 2338) receives an input audio signal that includes one or more audio sub-signals. Each audio sub-signal of the one or more audio sub-signals has a location in virtual auditory space.

While receiving the input audio signal, the virtual auditory display system 2302 performs step 3206 through step 3220 of the method 3200. At step 3206 one or both of the first ear-worn device 2302a and the second ear-worn device 2302b detects a head orientation of the user wearing the first ear-worn device 2302a and the second ear-worn device 2302b. The first ear-worn device 2302a and/or the second ear-worn device 2302b provide the head orientation to the virtual auditory display system 2302.

At a step 3208, for each audio sub-signal of the one or more audio sub-signals, the virtual auditory display system 2302 determines, based on the location of the audio sub-signal and the head orientation, a particular location in the virtual auditory space. At a step 3210, for each audio sub-signal, the virtual auditory display system 2302 selects, based on the particular location, particular one or more combined first digital filters and particular one or more combined second digital filters.

At a step 3212, for each audio sub-signal, the virtual auditory display system 2302 applies the particular one or more combined first digital filters to the audio sub-signal to obtain a first processed audio sub-signal. At a step 3214, for each audio sub-signal, the virtual auditory display system 2302 applies the particular one or more combined second digital filters to the audio sub-signal to obtain a second processed audio sub-signal.

At a step 3216 the virtual auditory display system 2302 tests to see if there are more audio sub-signals to process. If so, the method 3200 returns to step 3208. If not the method 3200 continues to step 3218. After processing all the audio sub-signals the virtual auditory display system 2302 obtains multiple first processed audio sub-signals and multiple second processed audio sub-signals.

At a step 3218 the virtual auditory display system 2302 generates, based on the multiple first processed audio sub-signals, a first output audio signal for the left ear-worn device, and based on the multiple second processed audio sub-signals, a second output audio signal for the right ear-worn device. The virtual auditory display system 2302 provides the first output audio signal to the first ear-worn device 2302a and the second output audio signal to the second ear-worn device 2302b.

At a step 3220 the first ear-worn device 2302a outputs first sound based on the first output audio signal and the second ear-worn device 2302b outputs second sound based on the second output audio signal. The virtual auditory display system 2302 may thus utilize the method 3200 to provide virtual auditory display sound based on an audio signal that may have multiple audio sub-signals (or channels) that would typically require multiple speakers to produce a surround sound effect. The virtual auditory display system 2302 may provide the virtual auditory display sound to the user using only the first ear-worn device 2302a and the second ear-worn device 2302b.

FIG. 32B depicts a method 3250 of applying digital filters according to some embodiments. The method 3250 includes certain steps that may be generally similar to certain steps of the method 3200. The virtual auditory display system 2302 may perform the method 3250.

The method 3250 begins at a step 3252, where the virtual auditory display system 2302 (for example, the binauralizer 2338) receives a set of one or more first digital filters and a set of one or more second digital filters. At a step 3254 the virtual auditory display system 2302 (for example, the binauralizer 2338) receives an audio signal that has one or more audio sub-signals. Each audio sub-signal of the one or more audio sub-signals is associated with a virtual auditory space location.

At a step 3256 the virtual auditory display system 2302 receives a head orientation of a user. At a step 3258, for each audio sub-signal of the one or more audio sub-signals, the virtual auditory display system 2302 determines, based on the virtual auditory space location and the head orientation, a particular virtual auditory space location. At a step 3260, for each audio sub-signal, the virtual auditory display system 2302 selects, based on the virtual auditory space location or the particular virtual auditory space location, particular one or more first digital filters and particular one or more second digital filters.

At a step 3262, for each audio sub-signal, the virtual auditory display system 2302 applies the particular one or more first digital filters to the audio sub-signal to obtain a first processed audio sub-signal. At a step 3264, for each audio sub-signal, the virtual auditory display system 2302 applies the particular one or more second digital filters to the audio sub-signal to obtain a second processed audio sub-signal.

At a step 3266 the virtual auditory display system 2302 tests to see if there are more audio sub-signals to process. If so, the method 3250 returns to step 3258. If not the method 3200 continues to step 3268. After processing all the audio sub-signals the virtual auditory display system 2302 obtains multiple first processed audio sub-signals and multiple second processed audio sub-signals.

At a step 3268 the virtual auditory display system 2302 generates, based on multiple first processed audio sub-signals, a first output audio signal for a first device, and based on multiple second processed audio sub-signals, a second output audio signal for a second device. The first device may be or include, for example, the first ear-worn device 2302a, and the second device may be or include, for example, the second ear-worn device 2302b. At a step 3270 the virtual auditory display system 2302 provides the first output audio signal to the first device and the second output audio signal to the second device.

FIG. 32C depicts a method 3280 of generating and applying virtual auditory display filters in some embodiments. The generation system 2580 and the virtual auditory display system 2302 may perform the method 3200. The method 3280 begins at a step 3282 where the generation system 2580 (for example, the parameter generation module 2588) may generate a first generally sigmoidal distribution of center frequencies and a second generally sigmoidal distribution of center frequencies. At a step 3284 the generation system 2580 (for example, the parameter mask module 2590) may generate first parameter modifier masks and second parameter modifier masks, including a first notch parameter modifier mask and a second notch parameter modifier mask.

At a step 3286 the generation system 2580 (for example, the filter generation module 2584) may generate a first virtual auditory display filter and a second virtual auditory display filter. The first virtual auditory display filter may include a first set of first functions. One or more first functions, when applied to a first audio signal having a first location in virtual auditory space, may generate a first processed audio signal having a first frequency response with one or more first notches at one or more first center frequencies that are based on the first location. The one or more first notches may have one or more first peak-to-trough depths of at most −10 dB (for example, approximately-30 dB).

The second virtual auditory display filter may include a second set of second functions. One or more second functions, when applied to the first audio signal, may generate a second processed audio signal having a second frequency response with one or more second notches at one or more second center frequencies that are based on the second location. The one or more second notches may have one or more second peak-to-trough depths of at most −10 dB (for example, approximately −30 dB).

At a step 3288 the virtual auditory display system 2302 may receive an audio signal having a second location in the virtual auditory space. For example, the virtual auditory display system 2302 may receive the audio signal from a digital device on which the virtual auditory display system 2302 is executing. At a step 3290 the virtual auditory display system 2302 may receive a head orientation of a user, for example, from the virtual auditory display device 2300 that the user is utilizing.

At a step 3292 the virtual auditory display system 2302 may apply the first virtual auditory display filter, including a first subset of first functions selected based on the second location, to the second audio signal to generate a third processed audio signal having a third frequency response. At a step 3294 the virtual auditory display system 2302 may apply the second virtual auditory display filter, including a second subset of second functions selected based on the second location, to the second audio signal to generate a fourth processed audio signal having a fourth frequency response. At a step 3294 the virtual auditory display system 2302 may provide the first processed audio signal to a first sound output device (for example, the first ear-worn device 2302a) and the second processed audio signal to a second sound output device (for example, the second ear-worn device 2302b).

The virtual auditory display system 2302 may perform step 3288 through step 3294 of the method 3280 while the virtual auditory display system 2302 is receiving an input audio signal that may correspond to, for example, a song file, an audio stream, a podcast, or any other audio.

The method 3200, the method 3250, and the method 3280 may include additional steps not illustrated in FIGS. 32A through 32C. For example, these methods may include a step of the virtual auditory display system 2302 receiving a selection of an acoustic environment and a step of the virtual auditory display system 2302 determining, based on the acoustic environment, a first acoustic environment digital filter and a second acoustic environment digital filter. The acoustic environment may be represented by one or more ambisonic arrays. The virtual auditory display system 2302 may determine the acoustic environment digital filters based on the one or more ambisonics arrays. The virtual auditory display system 2302 may apply the digital filters and the acoustic environment digital filters to obtain the processed audio sub-signals. Other modifications to these methods will be apparent.

FIG. 24C is a block diagram depicting a process 2490 for generating acoustic environment digital filters in some embodiments. A first speaker 2492a and a second speaker 2492b may be in a particular acoustic environment, such as a concert hall, a vehicle, a night club, or the like. Sound output by the first speaker 2492a and the second speaker 2492b are captured by a microphone 2494 and converted into signals. The virtual auditory display system 2302 (for example, the filter generation module 2584) generates one or more ambisonics digital filters 2496 based on the signals. The one or more ambisonics digital filters 2496 are a set of one or more acoustic environment digital filters 2498.

FIG. 24D is a block diagram depicting operations of a spatialization engine 2470 of the virtual auditory display system 2302 in some embodiments. The spatialization engine 2470 may be part of the binauralizer 2338 or a separate component. The spatialization engine 2470 receives a user interface (UI) selected acoustic environment at a block 2472 and determines acoustic environment digital filters based on the selected acoustic environment at a block 2474. The spatialization engine 2470 receives coordinates and the input audio signal of decoded audio objects at a block 2476. At a block 2478 the spatialization engine 2470 matches an index of the acoustic environment digital filters to an input audio signal index. At a block 2480 the spatialization engine 2470 applies a convolution matrix to the output of the block 2478 and the coordinates and the input audio signal.

At a block 2482 the spatialization engine 2470 receives the user head orientation and audio source distance signal. At a block 2484 the spatialization engine performs an ambisonics to binaural conversion based on the output of the block 2480 and the user head orientation and audio source distance signal, by applying digital filters to the audio signals received at a block 2476 based on the locations of the audio signals in virtual auditory space. At a block 2486 the spatialization engine 2470 outputs the audio signal for the left ear and at a block 2488 the spatialization engine 2470 outputs the audio signal for the right ear.

FIGS. 33A and 33B depict an example user interface 3300 for displaying a representation of a virtual audio display in some embodiments. The virtual auditory display system 2302 (for example, the user interface module 2410) may provide the user interface 3300. FIGS. 33A and 33B are described with reference to the virtual auditory display device 2300, but the virtual auditory display system 2302 may provide the user interface 3300 for other devices.

The user interface 3300 includes an icon 3304 labeled “VAD” indicating that the virtual auditory display device 2300 is connected to the virtual auditory display system 2302 and an icon 3302 labeled “IMU” indicating that the IMU-based sensor systems of the virtual auditory display device 2300 are calibrated. The user interface 3300 also includes an encoding representation dropdown 3314 that allows the wearer to select how the virtual auditory display system 2302 should represent audio received by the virtual auditory display system 2302. Example encoding representations are mono (a single audio channel), stereo (two channels of audio), 5.1 5.1 (six channels of audio), 7.1 (eight channels of audio), 7.1.4 (12 channels of audio), and 9.1.6 (16 channels of audio).

The user interface 3300 also includes an acoustic environment dropdown 3316 that allows the wearer to select an acoustic environment in which the virtual auditory display system 2302 should render the virtual auditory display. Example acoustic environments include a dry acoustic environment, a studio acoustic environment, a car acoustic environment, a phone acoustic environment, a club acoustic environment, and a headphone acoustic environment. The virtual auditory display system 2302 may select an acoustic environment digital filter based on the selected acoustic environment and apply the acoustic environment digital filter along with the virtual auditory display filters. The virtual auditory display sounds will sound different for the wearer based on the selected acoustic environment. The user interface 3300 also includes an output volume slider 3322 allowing the wearer to adjust the volume of the sound output by the virtual auditory display device 2300.

The user interface 3300 also includes a representation 3308 of a virtual audio display. In FIG. 33A, the virtual auditory display system 2302 depicts the representation 3308 as a virtual sphere surrounding a head 3312 representing the head of the wearer from a top rear perspective. The user interface 3300 also displays sounds at their locations in virtual auditory space relative to the head of the wearer at corresponding locations relative to the head 3312 on the representation 3308. For example, sounds 3310a are depicted as to the left of, below, and to the rear of the head 3312. This is because the actual sounds corresponding to the sounds 3310a have those locations in virtual auditory space. Sounds 3310b are depicted as above, behind, and slightly to the left of the head 3312. Sounds 3310c are depicted as in front of and to the right of the head 3312. Sounds 3310d are depicted as to the right of, below, and to the rear of the head 3312.

While outputting sounds, the virtual auditory display device 2300 detects head orientations of the wearer and sends the head orientation to the virtual auditory display system 2302. The virtual auditory display system 2302 updates the representation 3308 based on the detected head orientations. The virtual auditory display system 2302 may move the head 3312 and the sounds 3310 based on the detected head orientations.

The user interface 3300 also includes a virtual auditory display representation dropdown 3318 that allows the wearer to select how the virtual auditory display system 2302 provides the virtual auditory display representation. Example virtual auditory display representations include a custom representation (depicted in FIG. 33A), which provides the wearer a top right rear perspective of the representation 3308, a top representation (depicted in FIG. 33B), which provides the wearer a top perspective of the representation 3308 (from the top of the sphere in FIG. 33A), and a back representation, which provides the wearer a rear perspective of the representation 3308 (from the rear of the sphere in FIG. 33A).

The user interface 3300 also includes a location button 3320 which, if selected by the wearer, may cause the virtual auditory display system 2302 to change the representation 3308 such that the location specified by a certain coordinate (for example, zero degrees azimuth, zero degrees elevation) may be directly in front of the head 3312. The user interface 3300 also includes a settings icon 3306 which, if selected by the wearer, may cause the virtual auditory display system 2302 to provide an example user interface for adjusting settings for a virtual audio display.

FIG. 33C depicts an example user interface 3350 for adjusting settings for a virtual audio display in some embodiments. The virtual auditory display system 2302 (for example, the user interface module 2410) may provide the user interface 3350. The user interface 3350 includes an icon 3352 labeled “IMU” indicating that the IMU-based sensor systems of the virtual auditory display device 2300 are calibrated. The user interface 3350 also includes a button 3354 labeled “Recalibrate” that the wearer may select to have the virtual auditory display system 2302 perform the calibration part of the calibration and/or personalization process.

The user interface 3350 also includes an icon 3356 labeled “VAD” indicating that the virtual auditory display device 2300 is connected to the virtual auditory display system 2302, a recommendation 3358 of a virtual auditory display filter, and a button 3360 labeled “Personalize” that the wearer may select to have the virtual auditory display system 2302 perform the personalization part of the calibration and/or personalization process. The user interface 3350 also indicates the spatialization precision estimate of the virtual auditory display of the wearer and a button 3362 labeled “Test” that the wearer may select to have the virtual auditory display system 2302 provide a test procedure for the wearer to allow the wearer to test to see if the wearer can accurately locate virtual auditory display sounds.

The user interface 3350 also includes a group 3364 of icons (labeled “A” through “G”) that indicates the set of virtual auditory display filters that create the virtual auditory display for the wearer. As depicted, the current set of virtual auditory display filters is “VAD C.” The wearer may select a different set of virtual auditory display filters by selecting a different icon in the group 3364. The wearer may then perform the calibration part of the calibration and/or personalization process by selecting the button 3354 and/or perform the personalization part of the calibration and/or personalization process by selecting the button 3360.

The user interface 3350 also allows the wearer to select a custom set of digital filters for the virtual auditory display system 2302 to use to generate the virtual auditory display. The wearer may do so by selecting a button 3368 labeled “Upload,” which allows the wearer to upload a file containing a custom set of digital filters to the virtual auditory display system 2302. The user interface element 3366 may then display the name of the file. This functionality may be desirable for wearers who already have a custom HRTF and want the virtual auditory display system 2302 to utilize the custom HRTF.

FIG. 34 is multiple images 3400 depicting example use cases of virtual auditory display filter technology described in this application in some embodiments. One example use case is for improved virtual surround sound for television or movies using only a pair of speakers, as depicted in image 3402. A group of example use cases relates to producing or listening to music. Image 3410 depicts an example use case of listening to music on headphones. The virtual auditory display filter technology may render music played on headphones as indistinguishable from music played using physical surround sound installations.

Image 3418 depicts the use of virtual auditory display filter technology in virtual monitors to provide noise isolation, sound quality, and virtualization to musicians. Image 3404 depicts the use of the virtual auditory display filter technology to mix music in any acoustic environment. Image 3420 depicts how the virtual auditory display filter technology may provide a listening experience that reinvigorates the music that listeners love for them. Image 3412 depicts using virtual auditory display filter technology in games to provide an immersive gaming experience. virtual auditory display filter technology may allow users to hear sounds emanating from locations that are not shown on users' displays and thus improve users' awareness.

Another group of example use cases relate to military, non-military (for example, first responders such as police and firefighters) and/or other organizational applications. For example, military personnel may use military radio systems to communicate with fellow soldiers, commanders, and other military personnel. The present technology may be utilized in scenarios including military operations, emergency services, aviation, marine and others.

Image 3406 depicts virtual auditory display filter technology providing improved voice pickup and voice display for organizational communications. Image 3414 depicts virtual auditory display filter technology providing augmentation of visual instrumentation with auditory signals in maritime operations. Image 3422 depicts virtual auditory display filter technology providing hyper-realistic virtual audio environments which facilitates virtual training for military and/or non-military personnel.

Image 3408 depicts virtual auditory display filter technology providing audio augmentation for orientation awareness for combat infantry situational awareness. Image 3416 depicts virtual auditory display filter technology providing audio augmentation for orientation awareness for air force orientation control. For example, pilots may use the localization of virtual beacons to assist in situational awareness. Image 3424 depicts virtual auditory display filter technology providing audio augmentation for hyper-situational awareness for unmanned aerial vehicle operations.

Another example use case of virtual auditory display filter technology involves phone calls or video conferences. For example, multiple people may talk at the same time in a phone call or video conference, making it difficult for listeners to focus on the speaker they want to hear, which may lead to confusion and misunderstandings. The present technology allows users to virtually select which talker they want to listen to through the simple movement of a head or other gesture. This attention selection mechanism may help avoid confusion and make meetings more productive.

As another example, air traffic controllers use radio messages to communicate with pilots. The air traffic controllers monitor the position, speed and altitude of aircraft in their assigned airspace visually and by radar and give directions to the pilots by radio. Often, air traffic controllers will need to communicate with multiple pilots simultaneously. Today, these situations requiring multiple pilot communications are addressed by physical switch boards that do not allow for user directed attention selection. The present technology may allow an air traffic controller to use gestures (for example, movement of a head or a hand) or other actions to localize radio communications so that there is seamless attention selection. In a simple example, multiple radio communication signals are statically arranged in unique virtual locations. The air traffic controller then looks at these predefined locations to hear the radio signal. In other examples, the radio communication signals are dynamically updated with the position, speed and altitude of the aircraft.

Other example use cases include virtual auditory display notifications to localize notifications such as voice, text-to-speech messages, email alerts, phone messages or other audio notifications, spatial navigation to use virtual auditory display cues to communicate direction and distance of virtual or real objects, which may also be used for wayfinding or orientation awareness, and spatial ambience to give a user a virtual sound environment that can be mixed with local or virtual sounds (for example, to experience music as if in a concert hall). Other example use cases of virtual auditory display filter technology are possible.

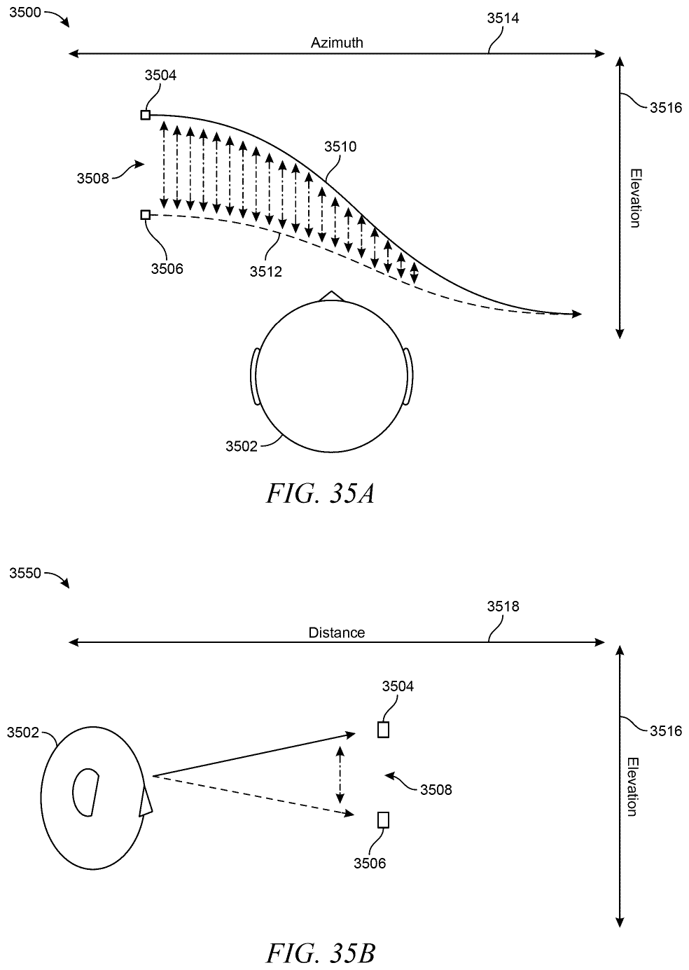

FIGS. 35A and 35B are diagrams of a method of personalizing digital filters in some embodiments that involves providing an action (for example, playing a sound) and detecting a user perception of the action. As described herein, the user may indicate perception of the action in various ways, such as by pointing his or her head, making one or more gestures, indicating where the sound is on a graphical user interface, and the like.

FIG. 35A depicts a view 3500 indicating how the location of a sound in virtual auditory space as indicated by azimuth 3514 and elevation 3516 may be perceived by a user. FIG. 35B depicts a view 3550 indicating how the location of a sound in virtual auditory space as indicated by distance 3518 and elevation 3516 may be perceived by a user. In both the view 3500 and the view 3550, the user 3502 is wearing the first ear-worn device 2302a and the second ear-worn device 2302b (not illustrated in FIGS. 35A and 35B). The virtual auditory display system 2302 may provide instructions to the user 3502 to follow a sound in virtual auditory space with the user's head as the user hears the sound. The virtual auditory display system 2302 may then generate audio signals that cause the first ear-worn device 2302a and the second ear-worn device 2302b to output one or more sounds that have a location 3504 in virtual auditory space. As the user 3502 hears the one or more sounds, the user 3502 may point his or her head towards a perceived location 3506 the user perceives the sound to be coming from, which may be different from the location 3504. In pointing his or her head towards the perceived location 3506, it may appear as if the user 3502 is looking in the direction of where the user 3502 perceives the sound to be. Other gestures the user may make with his or her head include nodding, shaking, tilting, and turning. Other head gestures will be apparent.

As the user 3502 moves his or her head to point towards the perceived location 3506 of the one or more sounds, one or both of the first ear-worn device 2302a and the second ear-worn device 2302b (for example, using the IMU sensor system 2452 and/or the magnetometer 2454) may detect a head orientation of the user 3502. The virtual auditory display system 2302 may utilize the detected head orientation to determine the perceived location 3506. The virtual auditory display system 2302 may then determine a delta 3508 between the location 3504 and the perceived location 3506. The virtual auditory display system 2302 may calculate the delta 3508 based on differences between the azimuth 3514 and/or elevation 3516 of the location 3504 and the azimuth 3514 and/or elevation 3516 of the perceived location 3506.

The user 3502 may user other gestures to indicate distance, such as extending an arm a specified amount, and the virtual auditory display system 2302 may use such gestures to determine the delta 3508 based on differences between the distance 3518 of the location 3504 and the distance 3518 of the perceived location 3506.

The virtual auditory display system 2302 may generate audio signals that cause the first ear-worn device 2302a and the second ear-worn device 2302b to output one or more subsequent sounds whose locations in virtual auditory space change, as indicated by solid line 3510. The user 3502 may move his or her head to follow the movement of the one or more subsequent sounds, and the perceived locations of the one or more sounds may change, as indicated by dashed line 3512.

One or both of the first ear-worn device 2302a and the second ear-worn device 2302b may detect subsequent head orientations of the user 3502 as he or she moves his or her head. The virtual auditory display system 2302 may utilize the detected subsequent head orientations to determine perceived locations of the one or more subsequent sounds. The virtual auditory display system 2302 may then determine one or more subsequent deltas between the location of the one or more subsequent sounds and the perceived locations of the one or more subsequent sounds.

The virtual auditory display system 2302 may store the deltas that the virtual auditory display system 2302 determines and utilize the deltas to modify the digital filters so as to cause the user 3502 to perceive the location of sounds in virtual auditory space to be closer to the actual locations in virtual auditory space. In some embodiments, the virtual auditory display system 2302 modifies the digital filters by selecting a different set of digital filters that the virtual auditory display system 2302 determines will reduce or minimize the deltas for the user 3502. The virtual auditory display system 2302 may then use the different set of digital filters for the user 3502.

In some embodiments, the virtual auditory display system 2302 modifies the parameters of the digital filters. For example, the virtual auditory display system 2302 may modify parameters such as center frequencies, gains, and/or q's. For example, the user 3502 may have an elevation delta of several degrees. The virtual auditory display system 2302 may modify the center frequency of a notch, a pair of notches, or a group of notches (see, for example, FIG. 28B) to modify the elevation of a virtual sound object and thereby reduce the elevation delta. The virtual auditory display system 2302 may then utilize the modified digital filters during real-time audio playback.

The virtual auditory display system 2302 may repeat the personalization procedure one or more times until the virtual auditory display system 2302 determines that the deltas are within certain ranges or thresholds.

In some embodiments, the virtual auditory display system 2302 and/or other devices may capture other actions that the user may make in response to the user hearing a sound in virtual auditory space to indicate where the user perceives the location of the sound to be. Example actions may include vocal responses by the user, gestures by the user using parts of the user's body other than the user's head (for example, pointing with a finger or an arm of the user, waving, clapping, tapping and hand signals). Such actions may be captured by a device connected to the virtual auditory display system 2302, such as a microphone, camera or a motion sensing device.

Other example actions include the user indicating the perceived location of the sound using a graphical user interface and/or user input devices of a digital device such as a phone, tablet or laptop or desktop computer. For example, the virtual auditory display system 2302 may provide a graphical user interface that graphically represents virtual auditory space for the user, and the user may utilize an input device (mouse, keyboard, touchscreen, and/or voice command) to indicate the perceived location of the sound on the graphical representation of the virtual auditory space. It will be appreciated that there are various methods to capture user actions in response to the user perception of the location of the sound, and that the virtual auditory display system 2302, optionally in cooperation with other devices, may utilize the various methods.

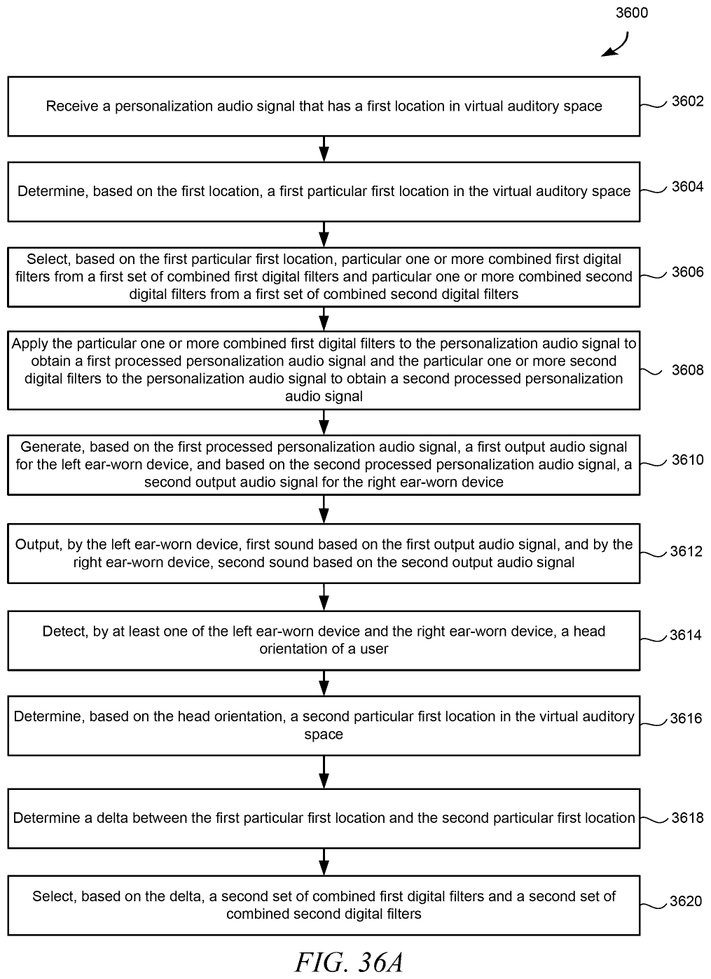

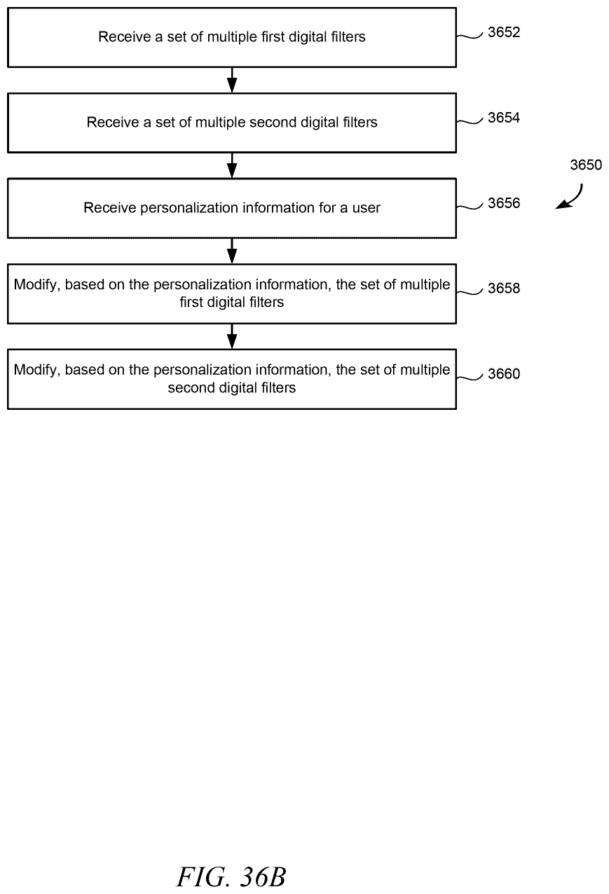

FIG. 36A depicts a method 3600 of personalizing digital filters in some embodiments. The virtual auditory display system 2302 may perform the method 3600. The method 3600 begins at a step 3602 where the virtual auditory display system 2302 (for example, the binauralizer 2338) receives a personalization audio signal that has a first location in virtual auditory space. At a step 3604 the virtual auditory display system 2302 (for example, the binauralizer 2338) determines, based on the first location, a first particular first location in the virtual auditory space.

At a step 3606 the virtual auditory display system 2302 selects, based on the first particular first location, particular one or more combined first digital filters from a first set of combined first digital filters and particular one or more combined second digital filters from a first set of combined second digital filters.

At a step 3608 the virtual auditory display system 2302 applies the particular one or more combined first digital filters to the personalization audio signal to obtain a first processed personalization audio signal and the particular one or more combined second digital filters to the personalization audio signal to obtain a second processed personalization audio signal.

At a step 3610 the virtual auditory display system 2302 generates, based on the first processed personalization audio signal, a first output audio signal for a left ear-worn device, and based on the second processed personalization audio signal, a second output audio signal for a right ear-worn device. At a step 3612 the left ear-worn device outputs first sound based on the first output audio signal and the right ear-worn device outputs second sound based on the second output audio signal.

At a step 3614 one or both of the left ear-worn device and the right ear-worn device detects a head orientation of a user wearing the left ear-worn device and the right ear-worn device. At a step 3616 the virtual auditory display system 2302 determines, based on the head orientation, a second particular first location in the virtual auditory space.

At a step 3618 the virtual auditory display system 2302 determines a delta between the first particular first location and the second particular first location. At a step 3620 the virtual auditory display system 2302 selects, based on the delta, a second set of combined first digital filters and a second set of combined second digital filters. The virtual auditory display system 2302 may use the second set of combined first digital filters and the second set of combined second digital filters while receiving a subsequent input audio signal.

FIG. 36B depicts a method 3650 of personalizing digital filters in some embodiments. The method 3650 includes certain steps that may be generally similar to certain steps of the method 3600. The virtual auditory display system 2302 (for example, various components of the virtual auditory display system 2302) may perform the method 3650.

At a step 3652 the virtual auditory display system 2302 receives a set of multiple first digital filters. At a step 3654 the virtual auditory display system 2302 receives a set of multiple second digital filters. There are one or more first digital filters and one or more second digital filters generated for each of multiple virtual auditory space locations.

At a step 3656 the virtual auditory display system 2302 receives personalization information for a user. Personalization information may include user-directed action or perception of acoustic cues, acoustic quality information, user anatomical measurements, user demographic information, and/or user audiometric measurements.

At a step 3658 the virtual auditory display system 2302 modifies, based on the personalization information for the user, the set of multiple first digital filters. At a step 3660 the virtual auditory display system 2302 modifies, based on the personalization information for the user, the set of multiple second digital filters.

In some embodiments, modifying, based on the personalization information, the set of multiple first digital filters includes modifying one or more first center frequencies of the multiple first digital filters. Moreover, modifying, based on the personalization information, the set of multiple second digital filters includes modifying one or more second center frequencies of the multiple second digital filters.

In some embodiments, modifying, based on the personalization information, the set of multiple first digital filters includes selecting a different set of multiple first digital filters. Further, modifying, based on the personalization information, the set of multiple second digital filters includes selecting a different set of multiple second digital filters.

The virtual auditory display system 2302 may provide a calibration and/or personalization process that allows a wearer of a virtual auditory display device to calibrate the virtual auditory display device and/or to personalize a virtual auditory display provided by the virtual auditory display device.

The calibration and/or personalization process may include a calibration part and a personalization part. The virtual auditory display device may include an inertial measurement unit (IMU). Calibrating the virtual auditory display device may refer to calibrating the IMU. Personalizing the virtual auditory display may refer to selecting a set of virtual auditory display filters for the wearer and/or modifying an existing set of virtual auditory display filters so that the virtual auditory display provided by the virtual auditory display device is customized to the wearer. The virtual auditory display system 2302 may allow the wearer to perform both the calibration part and the personalization part of the calibration and/or personalization process, just the calibration part, or just the personalization part.

FIGS. 37A through 37C depict an example user interface 3700 for calibrating a virtual auditory display device in some embodiments. The virtual auditory display device may be the virtual auditory display device 2300 which includes the first ear-worn device 2302a and the second ear-worn device 2302b. FIGS. 37A through 37F are described with reference to the virtual auditory display device 2300, but other virtual auditory display devices may be calibrated and/or personalized.

The virtual auditory display system 2302 (for example, the user interface module 2410) may provide the user interface 3700. The wearer may start a calibration and/or personalization process by selecting a button labeled “Start” (not shown in FIGS. 37A through 37C) displayed by the virtual auditory display system 2302. FIG. 37A depicts the user interface 3700 providing a user interface element 3702 indicating the point in the calibration part of the calibration and/or personalization process at which the wearer is, and instructions 3704 for the wearer.

FIG. 37B depicts the user interface 3700 providing a first circle 3706a and a second circle 3706b. The virtual auditory display system 2302 may cause the first circle 3706a and/or the second circle 3706b to move up and down on the user interface 3700 and instruct the wearer to nod their head up and down to follow the first circle 3706a and the second circle 3706b.

FIG. 37C depicts the user interface 3700 providing a circle 3708. The virtual auditory display system 2302 may cause the circle 3708 to move up and down on the user interface 3700 and instruct the wearer to nod their head up and down to follow the circle 3708. Additionally or alternatively, the virtual auditory display system 2302 may cause the circle 3708 to move from side to side on the user interface 3700 and instruct the wearer to move their head from side to side to follow the circle 3708.

While the virtual auditory display system 2302 performs the calibration part of the calibration and/or personalization process, the virtual auditory display system 2302 may receive detections of head orientations of the head of the wearer from the virtual auditory display device 2300 based on data obtained from the IMU-based sensor system and/or other sensors of the first ear-worn device 2302a and/or the second ear-worn device 2302b. The virtual auditory display system 2302 may use the detections of head orientations and other factors, such as a known or estimated distance from a display providing the user interface 3700, a width and height of the display, positions of the first circle 3706a, the second circle 3706b, and/or the circle 3708, and/or other data from the IMU-based sensor system to calibrate the IMU-based sensor system.

FIGS. 37D through 37F depict an example user interface 3750 for personalizing a virtual auditory display provided by a virtual auditory display device in some embodiments. The virtual auditory display system 2302 (for example, the user interface module 2410) may provide the user interface 3750.

The wearer of the virtual auditory display device 2300 may start the personalization part of the calibration and/or personalization process after completing the calibration part. The virtual auditory display system 2302 may cause the virtual auditory display device 2300 to play sounds at several locations (for example, five locations). The sounds may include, for example, sounds produced by objects that appear to the wearer as moving around his or her head, such as airplanes, helicopters, birds, and other flying creatures. FIG. 37D depicts the user interface 3750 providing instructions 3754 instructing the wearer to point their nose at the source of each sound as the virtual auditory display device 2300 plays the sound. The wearer may begin the personalization part of the calibration and/or personalization process by selecting the button 3756 labeled “Continue.”

FIG. 37E depicts the user interface 3750 providing a user interface element 3752 indicating the point in the personalization part of the calibration and/or personalization process at which the wearer is, and the instructions 3754. FIG. 37F depicts the user interface 3750 with the user interface element 3752 indicating that the wearer has located a sound that the virtual auditory display device 2300 played at a first location. The virtual auditory display system 2302 may cause the virtual auditory display device 2300 to play sounds at subsequent locations and update the user interface 3750 accordingly.

While the virtual auditory display system 2302 performs the personalization part of the calibration and/or personalization process, the virtual auditory display system 2302 may receive detections of head orientations of the head of the wearer from the virtual auditory display device 2300 based on data obtained from the IMU-based sensor system and/or other sensors of the first ear-worn device 2302a and/or the second ear-worn device 2302b. The virtual auditory display system 2302 may use the detections of head orientations and the locations of the sounds generated by the virtual auditory display system 2302 to calculate one or more deltas, as described with reference to, for example, FIGS. 35A and 35B. The virtual auditory display system 2302 may use the calculated one or more deltas to select a set of virtual auditory display filters and estimate a spatialization precision of the virtual auditory display for the wearer.

FIGS. 37G through 37J depict an example user interface 3770 for providing information on calibration of a virtual auditory display device and personalization of a virtual auditory display of the virtual auditory display device in some embodiments. The user interface 3770 includes a recommendation 3772 of a set of virtual auditory display filters. In some embodiments, as described herein with reference to, for example, FIGS. 35A and 35B, the virtual auditory display system 2302 may select a set of virtual auditory display filters from among multiple sets of virtual auditory display filters based on the results of the calibration and/or personalization process. The user interface 3770 also includes an estimate 3774 of a spatialization precision of the virtual auditory display for the wearer.

The virtual auditory display system 2302 may categorize the spatialization precision of the virtual auditory display for the wearer based on the estimate 3774, such as “Very Good” (FIG. 37G), “Medium” (FIG. 37H), and “Poor” (FIG. 37I). The virtual auditory display system 2302 may provide recommendations to redo the calibration part and/or the personalization part of the calibration and/or personalization process and/or to use custom filters. The user interface 3770 also includes a button 3776 labeled “Continue” that the wearer may select to return to the user interface 3300 depicted in FIGS. 33A and 33B.

Although the virtual auditory display system 2302 is described as using circles, the virtual auditory display system 2302 may utilize other visual user interface elements in the calibration and/or personalization process. Furthermore, although the virtual auditory display system 2302 is described as receiving detections of head orientations from the virtual auditory display device 2300 in the calibration and/or personalization process, the virtual auditory display system 2302 may receive detections of head orientations from other devices connected to the virtual auditory display system 2302, such as cameras, motion sensing devices, virtual reality headsets, and the like.

One advantage of the calibration and/or personalization process is that the virtual auditory display system 2302 may personalize a set of virtual auditory display filters for a wide range of individuals. The virtual auditory display system 2302 may personalize the set of virtual auditory display filters by modifying the set of virtual auditory display filters. The virtual auditory display system 2302 may have pre-configured multiple sets of virtual auditory display filters and may modify the set of virtual auditory display filters by selecting a different set of virtual auditory display filters based on the results of the calibration and/or personalization process for a user.

Additionally or alternatively, the virtual auditory display system 2302 may modify the set of virtual auditory display filters by modifying the digital filters or functions included in the set of virtual auditory display filters. For example, where the set of virtual auditory display filters includes digital filters, the virtual auditory display system 2302 may modify parameters of the digital filters, such as the center frequencies, gains, q's, algorithm type, or other parameters based on the results of the calibration and/or personalization process for a user.

Personalization of virtual auditory display filters allows a wide range of individuals to experience immersive, accurately rendered sound in a virtual auditory space. Moreover, such individuals would not have to have HRTFs generated for them using potentially difficult and/or unreliable physical measurement procedures. Such individuals could obtain a personalized set of virtual auditory display filters simply by having the virtual auditory display system 2302 perform the calibration and/or personalization process for them. The modification of virtual auditory display filters may be performed at an initial setup procedure for the person and at any subsequent point during the person's use of the virtual auditory display system 2302 and/or virtual auditory display device 2300.

One advantage of virtual auditory display filters is that sounds in far more locations in virtual auditory space may be rendered in comparison to existing technologies. For example, a 9.1.6 configuration has 16 virtual speakers and thus may be limited to accurately rendering sounds for only those 16 virtual speaker locations. Such configurations may render sounds from other locations by smearing sounds from virtual speaker locations to represent the other locations, but such artifacts may be noticeable to listeners.

In contrast, virtual auditory display filters may be able to render sound at far more locations. For example, using locations at one degree increments of azimuth and elevation results in 65,160 locations. However, the described technology may generate virtual auditory display filters at smaller increments, resulting in even more locations at which the virtual auditory display filters may render sound. Moreover, typical approaches render sound at a modeled distance of 1 m from a center point representing the listener. The described technology may generate virtual auditory display filters for any number of distances from the center point. Accordingly, the described technology may accurately render sounds at varying distances.

One advantage of the described technology is that the described technology accurately renders virtual auditory display sound in virtual auditory space, meaning that sound is perceived by a listener as coming from the location that the creator of the sound intended for the sound. Another advantage of the described technology is that the described technology may be utilized with any ear-worn device, such as headphones, headset, and earbuds. Another advantage is that the virtual auditory display sound is high-quality and clear. Another advantage is the described technology may emphasize or de-emphasize sounds in certain regions or locations of virtual auditory space so as to focus a listener's attention on those certain regions or locations. Such an approach may increase the listener's hearing abilities and allow the listener to hear sounds that the listener would not otherwise hear.

Another advantage of the described technology is that any digital device with suitable storage and processing power may store and apply the virtual auditory display filters. As described herein, a general purpose computing device such as a laptop or desktop computer may store and apply the virtual auditory display filters to audio signals to generate processed audio signals. The laptop or desktop computer may then send the processed audio signals to ear-worn devices to generate sound based on the processed audio signals. Similarly, a digital device such as a phone, tablet, or a virtual reality headset may store and apply the virtual auditory display filters to audio signals to generate processed audio signals and send the processed audio signals to ear-worn devices.

Additionally or alternatively, ear-worn devices, such as the virtual auditory display device 2300 described herein, may store and apply the virtual auditory display filters. The ear-worn devices may receive an input audio signal from, for example, a digital device with which the ear-worn devices are paired such as a phone or tablet, or from a cloud-based service. The ear-worn devices may apply the stored virtual auditory display filters to the input audio signal to generate processed audio signals and output virtual auditory display sound based on the processed audio signals. Another example is that a cloud-based service may store and apply the virtual auditory display filters to generate processed audio signals and send the processed audio signals to ear-worn devices. Other advantages will be apparent.

### In-Canal Microphones

Described herein is technology for utilizing in-canal microphones and other microphones in wearable devices for various purposes, such as interacting with artificial intelligence agents. Aspects of the technology may be embodied in wearable devices, such as ear-worn devices, and in other computing systems and devices. One embodiment of an aspect of the technology is an ear-worn device that includes an in-canal microphone configured to capture sounds or vibrations in an ear canal and an array of microphones configured to capture sounds external to the wearer of the ear-worn device.

The ear-worn device may utilize the in-canal microphone for various purposes. One purpose is to determine if the user is actively speaking. When the in-canal microphone indicates that the user is actively speaking, the ear-worn device may turn on the array of microphones to capture the user's voice and perform beamforming to focus the array of microphones on the user's mouth. The array of microphones may capture higher-fidelity speech than the in-canal microphone. Such speech can then be processed and provided to one or more artificial intelligence agents. The ear-worn device may switch between using the in-canal microphone and the array of microphones to capture the user's voice depending on various factors, such as environmental noise, the context of the user, and the content of what the user is saying. The ear-worn device may also blend or mix captures from the in-canal microphone and the array of microphones to ensure the quality of the voice capture.

Another purpose is to detect sub-vocalized or whispered speech. The ear-worn device may use customized speech to text recognition models to enable accurate low-volume speech capture. Additionally or alternatively, the ear-worn device may utilize signal processing techniques to modify the signal resulting from sub-vocalized or whispered speech so that the modified speech may be recognized by general speech to text recognition models.

Another purpose the ear-worn device may utilize the in-canal microphone for is to compensate for internal body noises that may result from speaking, chewing, or movement of the user that may resonate within the sealed ear canal. The ear-worn device may utilize noise cancellation and adaptive equalization techniques to remove or reduce unwanted internal sounds as well as to mitigate the sensation of the user's voice being muffled or overly loud.

Aspects of the described technology provide numerous improvements over existing systems. One improvement relates to improved voice activity detection and improved quality of voice captures. Another improvement relates to better recognition of whispered or sub-vocalized speech due to signal processing techniques or customized speech recognition models. Another improvement relates to mitigating or reducing occlusion effects and body-conducted sounds. Other improvements will be apparent. Accordingly, the described technology offers significant advantages over existing systems.

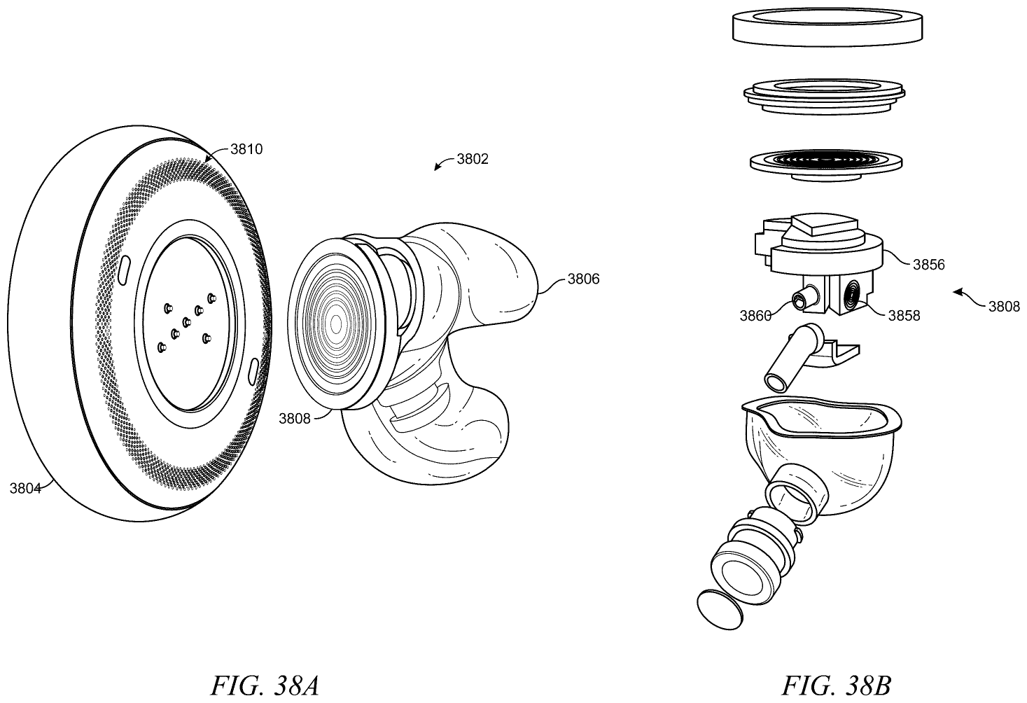

Aspects of the described technology may be embodied in wearable devices, such as ear-worn devices. FIG. 38A is an exploded view of an example ear-worn device 3802 that may embody aspects of the described technology. The ear-worn device 3802 includes an ear interface 3806, an electronics package 3804, and an acoustic package 3808. The ear interface 3806, which may be referred to as a soft ear interface, is made of a suitable material such as silicone. The ear interface 3806 may be custom-made for a wearer of the ear-worn device 3802 and provide an acoustically sealed fit when inserted into or positioned in an ear canal of the wearer. Removably positioned in the ear interface 3806 is an acoustic package 3808. The acoustic package 3808 may include one or more analog components, such as one or more sound output devices, that are configured to output sound based on the audio signals received from the electronics package 3804. The acoustic package 3808 may also include one or more in-canal microphones configured to capture sounds or vibrations in the ear canal of the wearer.

The electronics package 3804 removably couples to the acoustic package 3808 via magnets in the electronics package 3804 and the acoustic package 3808. The electronics package 3804 includes electronics components, including multiple microphones positioned proximate to a microphone cover. The microphone cover includes multiple perforations 3810 through which air-conducted sound may travel to be captured by one or more of the multiple microphones. In some embodiments of the ear-worn device 3802, there are nine microphones, eight of which are digital and one of which is analog. The eight digital microphones may be arranged in a generally circular array and be configured to capture diverse acoustic signals from various directions. The one analog microphone may be a high signal-to-noise ratio analog microphone that may be utilized for feedforward active noise cancellation. The multiple microphones may capture sounds external to the wearer of the ear-worn device 3802, such as the voice of the wearer, voices of other persons, and other environmental noise. The multiple microphones may perform beamforming to capture sounds, such as the voice of the wearer.

The ear-worn device 3802 may be for a left ear for a wearer, and there may be a similar ear-worn device for the right ear of the wearer. The wearer may wear both the ear-worn device 3802 and the similar ear-worn device simultaneously or one of the ear-worn devices individually. U.S. Patent Application Publication No. 2024/0334112, titled “VIRTUAL AUDITORY DISPLAY DEVICES AND ASSOCIATED SYSTEMS, METHODS, AND DEVICES” and filed Mar. 29, 2024, describes the ear-worn device 3802 and the similar ear-worn device in more detail, and is incorporated in its entirety herein by reference.

In some embodiments, when the ear interface 3806 is positioned in an ear canal of a wearer, the ear interface 3806 forms at least partial seal that reduces or minimizes sounds from leaving or entering the ear canal. However, pressure changes, which may be caused by user movement, jaw shifts, or slight device repositioning, can degrade microphone performance and user comfort. The ear interface 3806 may have one or more pressure-equalization vents to allow for static air pressure equalization between an air pressure in an ear canal of the wearer and an exterior air pressure, while still providing acoustic resistance. The one or more pressure-equalization vents may thus facilitate a stable environment for audio capture by one or more in-canal microphones.

FIG. 38B is an exploded view of the acoustic package 3808. The acoustic package 3808 includes multiple sound output devices, including a driver 3856 and a balanced armature 3860. The driver 3856 may serve as a woofer and may provide a suitable low-frequency response. The balanced armature 3860 may serve as a tweeter and may provide a suitable high-frequency response. The acoustic package 3808 also includes an in-canal microphone 3858, which may also be referred to as an in-ear canal microphone. The in-canal microphone 3858 may be configured to capture the voice of the wearer in the ear canal or other sounds or vibrations. As the ear canal may be acoustically sealed due to the custom fit of the ear-worn device 3802, the in-canal microphone 3858 may thus provide a voice signal with minimal or reduced background noise interference.

As described in more detail herein, the ear-worn device 3802 may utilize the multiple microphones in the electronics package 3804 or the in-canal microphone 3858 to capture sounds or vibrations, process the sounds or vibrations, and take certain actions. For example, the ear-worn device 3802 may utilize the multiple microphones or the in-canal microphone 3858 to capture speech of the user requesting that one or more artificial intelligence agents respond to a request. The ear-worn device 3802 may receive one or more responses provided by the one or more artificial intelligence agents and generate an audio signal based on the one or more responses to be output by the driver 3856 or the balanced armature 3860.

As another example, the ear-worn device 3802 may utilize the multiple microphones to capture external environmental noise and the multiple sound output devices to output sound corresponding to the external environmental noise to provide a transparency mode for the wearer of the ear-worn device 3802. As yet another example, the ear-worn device 3802 may utilize the in-canal microphone 3858 to capture near-silent sounds or vibrations, such as whispered or sub-audible speech of the wearer, and process the near-silent sounds or vibrations.

Although aspects of the technology may be described as embodied in the ear-worn device 3802 or in a device comprising the ear-worn device 3802 and the ear-worn device for the other ear, it is to be understood that aspects of the technology may also be embodied in other ear-worn devices, such as headphones, headsets, or earbuds, as well as other wearable devices, such as augmented reality or virtual reality headsets or augmented or mixed reality glasses. Moreover, certain aspects of the technology may be embodied in or provided by non-wearable devices, such as mobile devices (for example, mobile phones, tablets, or laptops) and non-mobile devices, such as household appliances, vehicles, or desktop computer systems. Accordingly, the technology is not necessarily limited to being embodied in the ear-worn device 3802 or in a device comprising the ear-worn device 3802 and the ear-worn device for the other ear.

The ear-worn device 3802 may utilize the in-canal microphone 3858 to capture speech of the wearer in the ear canal. The ear interface 3806 is configured to be at least partially positioned in an ear canal of a wearer of the ear-worn device 3802 and form at least a partial seal with an ear of the wearer, which may be referred to as an acoustic seal. One effect of the least partial seal is that speech of the wearer in the ear canal may be passively amplified for a first range of frequencies. In some embodiments, the first range of frequencies is about 250 Hz to about 500 Hz. In some embodiments, the speech of the wearer is passively amplified by at least approximately 10 dB, such as at least approximately 20 dB. The amount of passive amplification may depend upon a presence of a pressure-equalization vent or a diameter of the pressure-equalization vent in the ear interface 3806. Table 1 depicts passive amplification values in dB for several frequencies for an ear interface 3806 without a pressure-equalization vent, for an ear interface 3806 with a pressure-equalization vent having a diameter of approximately 0.06 mm, and for an ear interface 3806 with a pressure-equalization vent having a diameter of approximately 2.0 mm.

TABLE 1
Amplification at Frequencies of Speech
in Ear Canal for Various Ear Interfaces

| Frequency | Sealed | 0.06 mm | 2.0 mm |
|---|---|---|---|
| (Hz) | (dB) | (dB) | (dB) |
| 250 | 22 | 20 | 14 |
| 500 | 23 | 23 | 20 |
| 1000 | 0 | 0 | 0 |
| 2000 | 0 | 0 | 0 |
| 4000 | 0 | 0 | 0 |
| 8000 | 0 | 0 | 0 |

Although Table 1 includes values for only certain frequencies, it is to be understood that speech may be amplified for ranges of frequencies. For example, speech in the ear canal may be passively amplified by at least approximately 10 dB for a range of frequencies including about 250 Hz to about 500 Hz for certain ear interfaces. In some embodiments, speech in the ear canal may be passively amplified by at least approximately 20 dB for a range of frequencies including about 250 Hz to about 500 Hz for certain ear interfaces.

In various embodiments, the ear interface 3806 may include a dynamic pressure-equalization vent that is or includes a dynamic micro-electromechanical system (MEMS) vent. The dynamic pressure-equalization vent may be coupled to the electronics package or the acoustic package of the ear-worn device 3802 so that the dynamic pressure-equalization vent may be controlled. In various embodiments, the dynamic pressure-equalization vent has an adjustable diameter that may be adjusted to be between approximately 0.01 mm and approximately 4.0 mm.

In some embodiments, the pressure-equalization vent or the dynamic pressure-equalization vent may have an opening that is other than circular (for example, rectangular or square). Accordingly, such non-circular openings may have other dimensions instead of diameters.

Another effect of the least partial seal is that external noises in the ear canal (that is, environmental noises from outside the ear canal that enter into the ear canal) may be passively attenuated for a second range of frequencies. In some embodiments, the first range of frequencies is about 125 Hz to about 8000 Hz. In some embodiments, external noises are passively attenuated by at least approximately 10 dB, such as at least approximately 20 dB. The amount of passive attenuation may depend upon a presence of a pressure-equalization vent or a diameter of the pressure-equalization vent in the ear interface 3806. Table 2 depicts passive attenuation values in dB for several frequencies for an ear interface 3806 with a pressure-equalization vent having a diameter of approximately 0.10 mm diameter.

TABLE 2
Attenuation at Frequencies of
External Noises in Ear Canal

| Frequency | Mean | Standard |
|---|---|---|
| (Hz) | Attenuation (dB) | Deviation (dB) |
| 125 | 20.00 | 4.10 |
| 250 | 21.74 | 5.81 |
| 500 | 24.50 | 5.46 |
| 1000 | 22.06 | 4.01 |
| 2000 | 27.64 | 3.08 |
| 4000 | 30.36 | 2.41 |
| 8000 | 37.24 | 6.04 |

Although Table 2 includes values for only certain frequencies, it is to be understood that external noises may be attenuated for ranges of frequencies. For example, external noises in the ear canal may be passively attenuated by at least approximately 10 dB for a range of frequencies including about 125 Hz to about 8000 Hz for certain ear interfaces. In some embodiments, external noises in the ear canal may be passively attenuated by at least approximately 20 dB for a range of frequencies including about 125 Hz to about 8000 Hz for certain ear interfaces.

Accordingly, effects of the at least partial seal include amplifying the speech of the wearer and attenuating external noises within the ear canal within predetermined frequency ranges that are relevant to speech intelligibility and noise reduction. In some embodiments, a signal to noise ratio (SNR) of the signal generated from the passively amplified speech of the wearer to a signal generated from passively attenuated external noises in the ear canal is at least approximately 6 to 12 dB for a third range of frequencies, such as at least approximately 10 dB. In some embodiments, a signal to noise ratio (SNR) of the signal generated from the passively amplified speech of the wearer to a signal generated from passively attenuated external noises in the ear canal is at least approximately 2 to 5 dB for a third range of frequencies, such as at least approximately 3 dB.

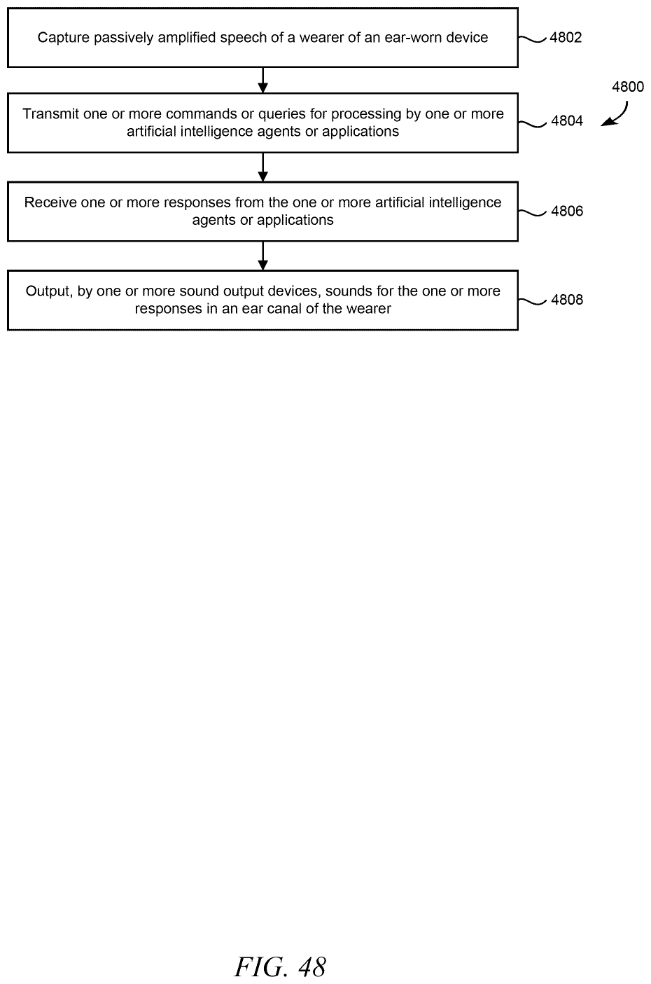

FIG. 48 is a flow diagram illustrating an example method 4800 that the ear-worn device 3802 may perform according to some embodiments. The method 4800 may begin at step 4802, where the ear-worn device 3802 captures, using the in-canal microphone 3858, passively amplified speech of a wearer of the ear-worn device 3802. When the wearer wears the ear-worn device 3802, the ear interface 3806 is positioned at least partially in the ear canal and forms at least a partial seal with the ear of the wearer. Accordingly, the in-canal microphone 3858 is positioned in the ear canal. One effect of the at least partial seal may be that the speech of the wearer is passively amplified for a first range of frequencies (for example, from about 250 Hz to about 500 Hz). In some embodiments, the passive amplification is at least approximately 10 dB across the first range of frequencies. Another effect of the at least partial seal may be that external noises in the ear canal are passively attenuated for a second range of frequencies different from the first range of frequencies (for example, from about 125 Hz to about 8000 Hz). In some embodiments, the passive attenuation is at least approximately 10 dB across the second range of frequencies. The passively amplified speech may include one or more commands or queries for one or more artificial intelligence agents or applications.

At step 4804, the ear-worn device 3802 transmits the one or more commands or queries for processing by the one or more artificial intelligence agents or applications. At step 4806, the ear-worn device 3802 receives one or more responses from the one or more artificial intelligence agents or applications. At step 4808, the ear-worn device 3802 outputs, by one or more sound output devices (for example, by the driver 3856 or the balanced armature 3860), sounds for the one or more responses in the ear canal of the wearer.

Additional or alternative steps or variations of steps in the method 4800 are possible. For example, the ear-worn device 3802 may capture passively amplified whispered or sub-vocal speech of the wearer. As another example, the ear-worn device 3802 may capture bone-conducted speech or noises, apply, based on the bone-conducted speech or noises, one or more noise suppression or equalization algorithms to generate a signal, and output, by the one or more sound output devices, sounds for the signal in the ear canal so as to cancel or reduce the bone-conducted speech or noises. As another example, the ear interface 3806 may include a dynamic pressure-equalization vent having an adjustable opening that may be adjusted to be between approximately 0.01 millimeters (mm) and approximately 4.0 mm, and the ear-worn device 3802 may adjust the adjustable opening of the dynamic pressure-equalization vent. The ear-worn device 3802 may do so to maintain passive amplification of the speech of the wearer in the ear canal by at least approximately 10 dB at certain frequencies (for example, from about 250 Hz to about 500 Hz) and passive attenuation of external noises in the ear canal by at least approximately 10 dB at other frequencies (for example, from about 125 Hz to about 8000 Hz). Sounds within some or all of these certain frequency ranges may be especially suitable for recognizing speech of the wearer and reducing noises, such as external noises.

In some aspects, the techniques described herein relate to an ear-worn device including: an ear interface configured to be at least partially positioned in an ear canal of a wearer of the ear-worn device and form at least a partial seal with an ear of the wearer, wherein effects of the at least partial seal include speech of the wearer in the ear canal to be passively amplified for a first range of frequencies and external noises in the ear canal to be passively attenuated for a second range of frequencies; one or more in-canal microphones configured to be positioned at least partially in the ear canal and to capture passively amplified speech of the wearer in the ear canal; one or more sound output devices configured to be positioned at least partially in the ear canal and to output sounds in the ear canal; one or more communication components configured to transmit and receive communication signals; one or more processors; and one or more memories storing instructions that, when executed by the one or more processors, cause the ear-worn device to perform a method, the method including: receiving a signal generated from the passively amplified speech of the wearer captured by the one or more in-canal microphones, the passively amplified speech including one or more commands or queries for one or more artificial intelligence agents; transmitting, by the one or more communication components, a first communication signal including the one or more commands or queries for processing by the one or more artificial intelligence agents; receiving, by the one or more communication components, a second communication signal including one or more responses from the one or more artificial intelligence agents; and outputting, by the one or more sound output devices, sounds for the one or more responses in the ear canal.

In some aspects, the techniques described herein relate to an ear-worn device wherein a signal to noise ratio (SNR) of the signal generated from the passively amplified speech of the wearer to a signal generated from passively attenuated external noises in the ear canal is at least approximately 10 dB for a third range of frequencies.

In some aspects, the techniques described herein relate to an ear-worn device wherein the speech of the wearer in the ear canal is passively amplified by at least approximately 10 dB for the first range of frequencies, the first range of frequencies including about 250 Hz to about 500 Hz, and the external noises in the ear canal are passively attenuated by at least approximately 10 dB for the second range of frequencies, the second range of frequencies including about 125 Hz to about 8000 Hz.

In some aspects, the techniques described herein relate to an ear-worn device wherein the effects of the at least partial seal further include speech of the wearer emanating from the ear canal to be passively attenuated by at least approximately 10 dB for a third range of frequencies, the third range of frequencies including about 125 Hz to about 8000 Hz.

In some aspects, the techniques described herein relate to an ear-worn device wherein the speech of the wearer captured by the one or more in-canal microphones includes passively amplified whispered or sub-vocal speech.

In some aspects, the techniques described herein relate to an ear-worn device wherein the signal is a first signal, the sounds are first sounds, and the method further includes: receiving a second signal generated from bone-conducted speech or noises captured by the one or more in-canal microphones; applying, based on the second signal, one or more noise suppression or equalization algorithms to generate a third signal; and outputting, by the one or more sound output devices, second sounds for the third signal in the ear canal.

In some aspects, the techniques described herein relate to an ear-worn device wherein the signal is a first signal, the sounds are first sounds, further including one or more external microphones configured to capture external noises, and the method further includes: receiving a second signal generated from passively amplified external noises captured by the one or more in-canal microphones or external noises captured by the one or more external microphones; applying, based on the second signal, one or more noise suppression or equalization algorithms to generate a third signal; and outputting, by the one or more sound output devices, second sounds for the third signal in the ear canal.

In some aspects, the techniques described herein relate to an ear-worn device wherein the ear interface includes a dynamic pressure-equalization vent having an adjustable opening that may be adjusted to be between approximately 0.01 mm and approximately 4.0 mm.

In some aspects, the techniques described herein relate to an ear-worn device wherein the method further includes adjusting the adjustable opening of the dynamic pressure-equalization vent to maintain passive amplification of the speech of the wearer in the ear canal by at least approximately 10 dB for the first range of frequencies and passive attenuation of external noises in the ear canal by at least approximately 10 dB for the second range of frequencies.

In some aspects, the techniques described herein relate to a method including: capturing passively amplified speech of a wearer of an ear-worn device, the passively amplified speech captured by one or more in-canal microphones included in the ear-worn device, the one or more in-canal microphones positioned at least partially in an ear canal of the wearer, the passively amplified speech including one or more commands or queries for one or more artificial intelligence agents or applications, the ear-worn device further including: an ear interface positioned at least partially in the ear canal, the ear interface forming at least a partial seal with an ear of the wearer, wherein effects of the at least partial seal include: speech of the wearer in the ear canal to be passively amplified for a first range of frequencies; and external noises in the ear canal to be passively attenuated for a second range of frequencies different from the first range of frequencies; and one or more sound output devices positioned at least partially in the ear canal, the one or more sound output devices configured to output sounds in the ear canal; transmitting the one or more commands or queries for processing by the one or more artificial intelligence agents or applications; receiving one or more responses from the one or more artificial intelligence agents or applications; and outputting, by the one or more sound output devices, sounds for the one or more responses in the ear canal.

In some aspects, the techniques described herein relate to a method wherein a signal to noise ratio (SNR) of a first signal generated from the passively amplified speech of the wearer to a second signal generated from passively attenuated external noises in the ear canal is at least approximately 10 dB for a third range of frequencies.

In some aspects, the techniques described herein relate to a method wherein the first range of frequencies for which the speech of the wearer in the ear canal is passively amplified includes about 250 Hz to about 500 Hz, and the second range of frequencies for which the external noises in the ear canal are passively attenuated includes about 125 Hz to about 8000 Hz.

In some aspects, the techniques described herein relate to a method wherein the effects of the at least partial seal further include speech of the wearer emanating from the ear canal to be passively attenuated across the second range of frequencies.

In some aspects, the techniques described herein relate to a method wherein capturing passively amplified speech of the wearer includes capturing passively amplified whispered or sub-vocal speech of the wearer.

In some aspects, the techniques described herein relate to a method wherein the sounds are first sounds, and further including: capturing, by the one or more in-canal microphones, bone-conducted speech or noises; applying, based on the bone-conducted speech or noises, one or more noise suppression or equalization algorithms to generate a signal; and outputting, by the one or more sound output devices, second sounds for the signal in the ear canal.

In some aspects, the techniques described herein relate to a method wherein the sounds are first sounds, the ear-worn device further includes one or more external microphones configured to capture external noises, and further including: receiving a signal generated from passively amplified external noises captured by the one or more in-canal microphones or external noises captured by the one or more external microphones; applying, based on the signal, one or more noise suppression or equalization algorithms to generate a second signal; and outputting, by the one or more sound output devices, second sounds for the second signal in the ear canal.

In some aspects, the techniques described herein relate to a method wherein the ear interface includes a dynamic pressure-equalization vent having an adjustable opening that may be adjusted to be between approximately 0.01 millimeters (mm) and approximately 4.0 mm.

In some aspects, the techniques described herein relate to a method, further including adjusting the adjustable opening of the dynamic pressure-equalization vent to maintain passive amplification of the speech of the wearer in the ear canal by at least approximately 10 dB at frequencies from about 250 Hz to about 500 Hz and passive attenuation of external noises in the ear canal by at least approximately 10 dB at frequencies from about 125 Hz to about 8000 Hz.

In some aspects, the techniques described herein relate to one or more non-transitory computer-readable media including executable instructions that when executed by one or more processors of an ear-worn device cause the ear-worn device to perform a method including: capturing passively amplified speech of a wearer of an ear-worn device, the passively amplified speech captured by one or more in-canal microphones included in the ear-worn device, the one or more in-canal microphones positioned at least partially in an ear canal of the wearer, the passively amplified speech including one or more commands or queries for one or more artificial intelligence agents or applications, the ear-worn device further including: an ear interface positioned at least partially in the ear canal, the ear interface forming at least a partial seal with an ear of the wearer, wherein effects of the at least partial seal include: speech of the wearer in the ear canal to be passively amplified for a first range of frequencies; and external noises in the ear canal to be passively attenuated for a second range of frequencies different from the first range of frequencies; and one or more sound output devices positioned at least partially in the ear canal, the one or more sound output devices configured to output sounds in the ear canal; transmitting the one or more commands or queries for processing by the one or more artificial intelligence agents or applications; receiving one or more responses from the one or more artificial intelligence agents or applications; and outputting, by the one or more sound output devices, sounds for the one or more responses in the ear canal.

In some aspects, the techniques described herein relate to one or more non-transitory computer-readable media wherein a signal to noise ratio (SNR) of a first signal generated from the passively amplified speech of the wearer to a second signal generated from passively attenuated external noises in the ear canal is at least approximately 10 dB for a third range of frequencies.

In some aspects, the techniques described herein relate to one or more non-transitory computer-readable media wherein the first range of frequencies for which the speech of the wearer in the ear canal is passively amplified includes about 250 Hz to about 500 Hz, and the second range of frequencies for which the external noises in the ear canal are passively attenuated includes about 125 Hz to about 8000 Hz.

In some aspects, the techniques described herein relate to one or more non-transitory computer-readable media wherein the effects of the at least partial seal further include speech of the wearer emanating from the ear canal to be passively attenuated across the second range of frequencies.

In some aspects, the techniques described herein relate to one or more non-transitory computer-readable media wherein capturing speech of the wearer includes capturing passively amplified whispered or sub-vocal speech of the wearer.

In some aspects, the techniques described herein relate to one or more non-transitory computer-readable media wherein the sounds are first sounds, and the method further includes: capturing, by the one or more in-canal microphones, bone-conducted speech or noises; applying, based on the bone-conducted speech or noises, one or more noise suppression or equalization algorithms to generate a signal; and outputting, by the one or more sound output devices, second sounds for the signal in the ear canal.

In some aspects, the techniques described herein relate to one or more non-transitory computer-readable media wherein the sounds are first sounds, the ear-worn device further includes one or more external microphones configured to capture external noises, and the method further includes: receiving a signal generated from passively amplified external noises captured by the one or more in-canal microphones or external noises captured by the one or more external microphones; applying, based on the signal, one or more noise suppression or equalization algorithms to generate a second signal; and outputting, by the one or more sound output devices, second sounds for the second signal in the ear canal.

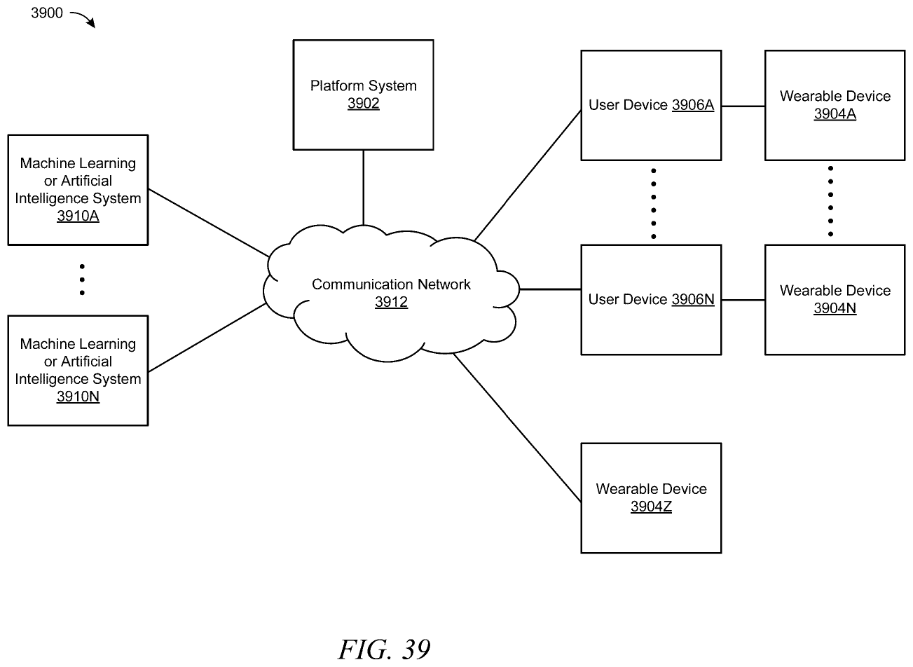

FIG. 39 depicts an example environment 3900 in which aspects of the described technology may operate in some embodiments. The environment 3900 includes multiple wearable devices 3904, such as a wearable device 204A, a wearable device 204N, and a wearable device 204Z. The environment 3900 also includes multiple user devices, such as a user device 206A and a user device 206N, a platform system 3902, and multiple machine learning or artificial intelligence system 3910, such as a machine learning or artificial intelligence system 210A and a machine learning or artificial intelligence system 210N. A machine learning or artificial intelligence system 3910 may be or include one or more machine learning or artificial intelligence models, such as speech-to-text models such as acoustic models or language models, large language models, or other models that receive an input and provide an output based on the input or that are applied to data to process the data and provide a result. A machine learning or artificial intelligence system 3910 may also be or include one or more artificial intelligence agents that utilize machine learning or artificial intelligence models or reasoning techniques to provide output, such as output in response to an input or a prompt. An artificial intelligence agent may be referred to herein as a digital assistant, a voice assistant, as an artificial agent, or as an agent or an assistant.

A wearable device 3904 may need to be coupled to a user device 3906 to connect to the communication network 3912. For example, the wearable device 204A is illustrated as coupled to the user device 206A and the wearable device 204N to the user device 206N (for example, via a wireless connection such as Bluetooth Low Energy (BLE)). In other cases, a wearable device 3904, such as the wearable device 204Z, may connect to the communication network 3912 using a wireless internet connection or a wireless cellular network connection.

The wearable device 3904, which may include one or more in-canal microphones configured to capture sounds or vibrations in an ear-canal of a wearer of the wearable device 3904 and one or more other microphones configured to capture sounds or vibrations that are external to the wearer. The one or more other microphones may be referred to as external microphones or air-conducting microphones. The wearable device 3904 may also include one or more sound output devices configured to output sounds or vibrations. The wearable device 3904 may capture sounds or vibrations, process the sounds or vibrations, and take certain actions based on the sounds or vibrations. For example, the wearable device 3904 may capture speech of the wearer. The wearable device 3904 may digitize the speech if necessary or desired and provide the digitized (and optionally, compressed and encrypted) speech to the platform system 3902 to be recognized. The platform system 3902 may recognize the speech using Natural Language Processing (NLP) techniques and convert the speech to text. The platform system 3902 may then determine the intent or context of the text, and identify one or more of machine learning or artificial intelligence systems 3910 to provide the text or the speech to for processing and for providing a response.

The platform system 3902 may receive one or more responses from one or more of the multiple machine learning or artificial intelligence systems 3910 and provide the one or more responses for the wearable device 3904. In some embodiments, one or more of the machine learning or artificial intelligence systems 3910 may provide one or more responses for the wearable device 3904 without the one or more responses passing through the platform system 3902. After receiving the one or more responses from the platform system 3902 or the one or more of the machine learning or artificial intelligence systems 3910, the wearable device 3904 may generate an audio signal based on the one or more responses to be output by the one or more sound output devices and cause the one or more sound output devices to output sound based on the audio signal.

The communication network 3912 may represent one or more computer networks (for example, local area networks (LANs), wide area networks (WANs), or the like). The communication network 3912 may provide or facilitate communication between any of the systems or devices illustrated in FIG. 39. In some implementations, the communication network 3912 comprises computer devices, routers, cables, or other network components. In some embodiments, the communication network 3912 may be wired or wireless. In various embodiments, the communication network 3912 may comprise the Internet, one or more networks that may be public, private, IP-based, non-IP based, and so forth.

The wearable devices 3904, the user devices 3906, the platform system 3902, and the machine learning or artificial intelligence systems 3910 may be or include any number of digital devices. A digital device is any device with at least one processor and memory. Digital devices are discussed further herein, for example, with reference to FIG. 49.

It is to be understood that the environment 3900 is exemplary and that aspects of the described technology may operate in other environments. Such environments may include fewer or more systems or devices than the environment 3900, or such environments may be configured differently than the environment 3900. For example, there may be multiple platform systems 3902. Furthermore, functionality may be distributed across or provided by multiple systems or devices of the environment 3900 or by other systems or devices not illustrated in FIG. 39.

### Hybrid Microphone Utilization for Speech Capture

One technical problem existing ear-worn devices have is that a microphone may capture speech from the user's mouth, but may also pick up ambient sound from other speakers or unwanted acoustic interference. Existing ear-worn devices also do not provide for confidential voice input. If a user speaks at normal volume, there is a risk that bystanders can overhear, and the microphone may also pick up extraneous chatter such as the vocalizations of the bystanders as voice input. An in-ear canal microphone may suffer from limited fidelity or have difficulty capturing a robust full-spectrum speech signal for advanced processing, such as voice recognition.

Embodiments of the described technology provide technical solutions to these technical problems. An example embodiment is the ear-worn device 3802 of FIG. 38A. The ear-worn device 3802 may utilize the in-canal microphone 3858 to capture the wearer's speech. The ear-worn device 3802 may utilize the multiple microphones in the electronics package 3804 to capture external sounds. For example, in embodiments where there are nine microphones, the ear-worn device 3802 may utilize the array of eight microphones to capture diverse acoustic signals from various directions, which enhances the ability of the ear-worn device 3802 to isolate the primary voice signal amidst background noise. The ear-worn device 3802 may utilize the single analog microphone in the electronics package 3804 to gather real-time audio feeds from external sources, which aids in environmental sound analysis. The ear-worn device 3802 may utilize the inputs from the multiple microphones in the electronics package 3804 to dynamically cancel noise, which may ensure clear voice capture even in noisy environmental conditions.

The ear-worn device 3802 may also apply echo reduction techniques by processing variances in sound captured by the in-canal microphone 3858 and the multiple microphones in the electronics package 3804. Machine learning techniques may be utilized to suppress non-speech elements in the voice signal by analyzing patterns from both the in-canal microphone 3858 and the multiple microphones in the electronics package 3804. The ear-worn device 3802 may thus continuously adapt to the user's voice and typical noise environments. Contextual sound patterns (for example, the recognition of train noises) may be used to adjust the sensitivity of voice recognition.

The system of the ear-worn device 3802 may have numerous potential applications, including in smartphones and wearables, where enabling reliable hands-free operation may be an important feature, and in smart home systems, where the system may facilitate robust voice control capabilities in diverse environments. Other potential applications include in automotive systems, where the system may ensure precise detection of driver commands amidst road and vehicle noise, and in conference systems, where the system may facilitate capturing distinct voices in settings with multiple speakers.

There are numerous advantages provided by the system. One advantage is that the system, by virtue of the array of multiple microphones, may provide for excellent raw data capture, which is important for high-quality speech detection. Another advantage is that the noise cancellation and echo reduction may provide improved clarity and accuracy in voice recognition, which may reduce errors. The use of machine learning may allow for adaptive learning, which may enhance system performance over time by customizing the system to user-specific voice patterns and environments. Moreover, the use of both air-conducted and in-canal microphones may ensure robustness in voice detection across a variety of acoustic settings, which may enhance user satisfaction and system reliability.

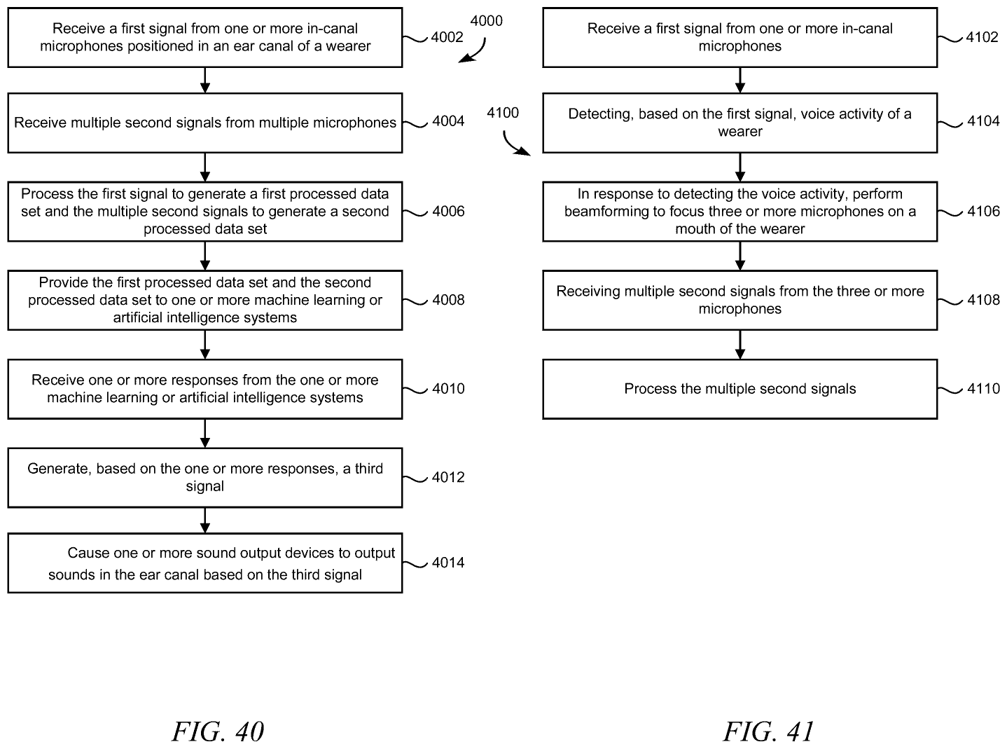

FIG. 40 is a flow diagram illustrating an example method 4000 that some embodiments of aspects of the described technology may perform. The method 4000 and the other methods herein are described as being at least partially performed by the ear-worn device 3802, but it is to be understood that other systems or devices may perform some or all of the steps of the method 4000 and the other methods herein. Furthermore, other devices, such as the wearable device 3904, may perform some or all of the steps of the method 4000 and the other methods herein, and other systems in the environment 3900 may perform some of the steps.

The method may begin at step 4002, where a first signal from one or more in-canal microphones positioned in an ear canal of a wearer is received. The first signal is generated from speech of the wearer (for example, a request by the wearer) captured by the one or more in-canal microphones (for example, the in-canal microphone 3858). The one or more in-canal microphones are included in a first portion (for example, the acoustic package 3808) of a device worn by the wearer (for example, the ear-worn device 3802). The first portion is positioned at least partially in the ear canal and also includes one or more sound output devices configured to output sounds in the ear canal (for example, the driver 3856 or the balanced armature 3860).

At step 4004, multiple second signals from the multiple microphones are received. The multiple microphones are included in a second portion (for example, the electronics package 3804) of the device. The multiple second signals are generated from the speech of the wearer, such as the same speech captured by the one or more in-canal microphones. At step 4006, the first signal is processed to generate a first processed data set and the multiple second signals are processed to generate a second processed data set. For example, the signals may be digitized, and features may be extracted from the digitized signals.

At step 4008, the first processed data set and the second processed data set are provided to one or more machine learning or artificial intelligence systems. The first processed data set and the second processed data set may be compressed and encrypted prior to being provided to the one or more machine learning or artificial intelligence systems. In some embodiments, a compression algorithm that is tailored for sub-1 kHz speech is utilized to compress the first processed data set. At step 4010 one or more responses (for example, responses to the wearer's request) are received from the one or more machine learning or artificial intelligence systems. At step 4012, based on the one or more responses, a third signal (for example, an audio signal) is generated. At step 4014, the one or more sound output devices (for example, the driver 3856 or the balanced armature 3860) are caused to output sounds in the ear canal based on the third signal.

Additional steps may be performed, such as receiving signals generated from external sounds captured by the multiple microphones, generating noise cancellation signals based on the external sound signals, and causing the one or more sound output devices to output sound based on the noise cancellation signals.

In some aspects, the techniques described herein relate to a method including: receiving a first signal from one or more in-canal microphones positioned in an ear canal of a wearer, the first signal generated from speech of the wearer captured by the one or more in-canal microphones, the one or more in-canal microphones included in a first portion of a device worn by the wearer, the first portion positioned at least partially in the ear canal, the first portion further including one or more sound output devices configured to output sounds in the ear canal; receiving multiple second signals from multiple microphones included in a second portion of the device, the multiple second signals generated from the speech of the wearer; processing the first signal to generate a first processed data set and the multiple second signals to generate a second processed data set; providing the first processed data set and the second processed data set to one or more machine learning or artificial intelligence systems; receiving one or more responses from the one or more machine learning or artificial intelligence systems; generating, based on the one or more responses, a third signal; and causing the one or more sound output devices to output sounds in the ear canal based on the third signal.

In some aspects, the techniques described herein relate to a method wherein the sounds are first sounds, and further including: receiving multiple fourth signals from the multiple microphones, the multiple fourth signals generated from external sounds; generating, based on the multiple fourth signals, multiple noise cancellation signals; and causing the one or more sound output devices to output second sounds based on the multiple noise cancellation signals.

In some aspects, the techniques described herein relate to a method wherein the sounds are first sounds, and further including: detecting second sounds output by the one or more sound output devices emanating from the ear canal; generating, based on the second sounds, a noise cancellation signal; and causing at least one sound output device to output third sounds based on the noise cancellation signal.

In some aspects, the techniques described herein relate to a method wherein providing the first processed data set to the one or more machine learning or artificial intelligence systems includes providing the first processed data set to at least one speech to text model configured for in-canal speech.

In some aspects, the techniques described herein relate to a method, further including modifying at least one foundation model using in-canal speech data to generate the at least one speech to text model configured for in-canal speech.

In some aspects, the techniques described herein relate to a method wherein providing the first processed data set and the second processed data set to the one or more machine learning or artificial intelligence systems includes: providing the first processed data set to multiple speech to text models configured for in-canal speech; and receiving multiple responses and multiple confidence scores from the multiple speech to text models, wherein generating, based on the one or more responses, the third signal includes generating, based on the multiple responses and the multiple confidence scores, the third signal.

In some aspects, the techniques described herein relate to a method wherein the device is a first device, the first device further includes one or more processors and wireless communication circuitry, the one or more machine learning or artificial intelligence systems include a first artificial intelligence agent, the one or more processors execute instructions for the first artificial intelligence agent, the one or more responses are one or more first responses, the sounds are first sounds, and further including: detecting that the first device is not coupled to a second device via the wireless communication circuitry; receiving a fourth signal from the one or more in-canal microphones; processing the fourth signal to generate third data; providing the third data to the first artificial intelligence agent; receiving one or more second responses from the first artificial intelligence agent; generating, based on the one or more second responses, a fifth signal; and causing the one or more sound output devices to output second sounds based on the fifth signal.

In some aspects, the techniques described herein relate to one or more non-transitory computer-readable media including executable instructions that when executed by one or more processors of a system cause the system to perform a method including: receiving a first signal from one or more in-canal microphones positioned in an ear canal of a wearer, the first signal generated from speech of the wearer captured by the one or more in-canal microphones, the one or more in-canal microphones included in a first portion of a device worn by the wearer, the first portion positioned at least partially in the ear canal, the first portion further including one or more sound output devices configured to output sounds in the ear canal; receiving multiple second signals from multiple microphones included in a second portion of the device, the multiple second signals generated from the speech of the wearer; processing the first signal to generate a first processed data set and the multiple second signals to generate a second processed data set; providing the first processed data set and the second processed data set to one or more machine learning or artificial intelligence systems; receiving one or more responses from the one or more machine learning or artificial intelligence systems; generating, based on the one or more responses, a third signal; and causing the one or more sound output devices to output sounds in the ear canal based on the third signal.

In some aspects, the techniques described herein relate to one or more non-transitory computer-readable media wherein the sounds are first sounds, and the method further includes: receiving multiple fourth signals from the multiple microphones, the multiple fourth signals generated from external sounds; generating, based on the multiple fourth signals, multiple noise cancellation signals; and causing the one or more sound output devices to output second sounds based on the multiple noise cancellation signals.

In some aspects, the techniques described herein relate to one or more non-transitory computer-readable media, and the method further includes: detecting second sounds output by the one or more sound output devices emanating from the ear canal; generating, based on the second sounds, a noise cancellation signal; and causing at least one sound output device to output third sounds based on the noise cancellation signal.

In some aspects, the techniques described herein relate to one or more non-transitory computer-readable media wherein providing the first processed data set to the one or more machine learning or artificial intelligence systems includes providing the first processed data set to at least one speech to text model configured for in-canal speech.

In some aspects, the techniques described herein relate to one or more non-transitory computer-readable media, the method further including modifying at least one foundation model using in-canal speech data to generate the at least one speech to text model configured for in-canal speech.

In some aspects, the techniques described herein relate to one or more non-transitory computer-readable media wherein providing the first processed data set and the second processed data set to the one or more machine learning or artificial intelligence systems includes: providing the first processed data set to multiple speech to text models configured for in-canal speech; and receiving multiple responses and multiple confidence scores from the multiple speech to text models, wherein generating, based on the one or more responses, the third signal includes generating, based on the multiple responses and the multiple confidence scores, the third signal.

In some aspects, the techniques described herein relate to one or more non-transitory computer-readable media wherein the device is a first device, the first device further includes one or more processors and wireless communication circuitry, the one or more machine learning or artificial intelligence systems include a first artificial intelligence agent, the one or more processors execute instructions for the first artificial intelligence agent, the one or more responses are one or more first responses, the sounds are first sounds, and further including: detecting that the first device is not coupled to a second device via the wireless communication circuitry; receiving a fourth signal from the one or more in-canal microphones; processing the fourth signal to generate third data; providing the third data to the first artificial intelligence agent; receiving one or more second responses from the first artificial intelligence agent; generating, based on the one or more second responses, a fifth signal; and causing the one or more sound output devices to output second sounds based on the fifth signal.

In some aspects, the techniques described herein relate to a device including: a first portion configured to be positioned at least partially in an ear canal of a wearer, the first portion including: one or more in-canal microphones configured to capture sounds or vibrations in the ear canal; and one or more sound output devices configured to output sounds in the ear canal; a second portion including multiple microphones configured to capture external sounds; one or more processors; and one or more memories storing instructions that upon execution by the one or more processors cause the device to perform a method, the method including: receiving a first signal from the one or more in-canal microphones, the first signal generated from speech of the wearer captured by the one or more in-canal microphones, receiving multiple second signals from the multiple microphones, the multiple second signals generated from the speech of the wearer; processing the first signal to generate a first processed data set and the multiple second signals to generate a second processed data set; providing the first processed data set and the second processed data set to one or more machine learning or artificial intelligence systems; receiving one or more responses from the one or more machine learning or artificial intelligence systems; generating, based on the one or more responses, a third signal; and causing the one or more sound output devices to output sounds in the ear canal based on the third signal.

Noise Cancellation or Mitigation for in-Ear Canal Sound

Conventional in-ear designs, such as generic earbuds or noise-canceling headphones, help reduce external noise, but generally do not comprehensively contain sound output in an ear canal. As a result, sound can still leak out to the surrounding environment, which may risk the privacy of the wearer. Additionally, one-size-fits-all earbud designs often result in imperfect sealing, leading to suboptimal noise isolation and potential discomfort. Active noise cancellation (ANC) in standard earbuds focuses on blocking incoming noise. Users often require confidentiality when interacting with voice assistants in public spaces, at work, or during travel. In conventional in-ear designs, sound may inadvertently emanate from the ear canal, thus impairing confidentiality.

Embodiments of the described technology provide technical solutions to these technical problems. An example embodiment is the ear-worn device 3802 of FIG. 38A. In some embodiments, the ear-worn device 3802 may utilize active noise cancellation directed outward to reduce or minimize such sound, thereby ensuring that the in-canal sound is audible only to the wearer. The ear-worn device 3802 may use sensors, such as the multiple microphones or other sensors, to detect sounds output by the one or more sound output devices that are emanating from the ear canal. The ear-worn device 3802 may generate, based on the sounds, a noise cancellation signal and cause at least one sound output device to output sounds based on the noise cancellation signal. The ear-worn device 3802 may also continuously measure ambient sound levels and automatically raise or lower the volume to maintain clarity for the user while reducing or minimizing external audibility. The ear-worn device 3802 may also provide passive noise mitigation through the acoustically sealed fit provided by the ear interface 3806.

An example scenario where the ear-worn device 3802 may be utilized involves a user in a shared office who needs to discreetly listen to voice assistant notifications or dictate messages. The outward-directed ANC suppresses any unintended leaks, preserving privacy for the user and a quiet environment for coworkers.

Potential applications where the ear-worn device 3802 may be utilized include workplace settings, such as in an open-plan office, where it may be beneficial to discreetly access sensitive voice assistant data, and healthcare or defense settings where high levels of acoustic security may be required. Other potential use cases for the ear-worn device 3802 include in commuting and public spaces, as the ear-worn device 3802 may allow users to engage with artificial intelligence agents without disturbing others or revealing personal information, and in military and government settings, where confidentiality is a necessity, and where the ear-worn device 3802 may facilitate confidential personal audio feeds.

Advantages of the ear-worn device 3802 include that the ear-worn device 3802 may provide for enhanced privacy and confidentiality, as the outward-directed ANC may reduce or prevent unwanted sound leakage. The ear-worn device 3802 may allow for adaptive noise control by measuring environmental noise in real time, thereby ensuring clarity for the user while remaining unobtrusive to others. Another advantage is that the technology may be integrated into earbud form factors, making it compact, portable, and user-friendly for daily use. By reducing external noise leakage, the technology fosters a quiet environment, benefiting both the user and nearby individuals.

### Natural Language Processing Model Adaptation for In-Canal Voice Capture

Conventional natural language process (NLP) systems are typically trained on broad-range, open-air recordings, such as datasets from smartphone microphones, conference recordings, or headset audio. These models do not fully capture the muffled or bone-conducted speech characteristics common in sound captured by in-canal microphones. As a result, the word error rate (WER) rises, and natural language understanding (NLU) performance diminishes when in-canal recordings deviate significantly from standard training data. Some voice assistant platforms may adjust for environmental or dialect nuances, but they do not incorporate specialized frequency corrections or confidence scoring relevant to in-canal acoustic profiles. Occluded ear captures highlight low-to-mid frequency ranges and often distort higher-frequency speech components, impairing model accuracy.

Embodiments of the described technology provide technical solutions to these technical problems. A system according to the described technology leverages transfer learning approaches to fine-tune existing speech and NLP models with in-canal-specific data. By employing data augmentation techniques, such as synthetically simulating resonances and muffled acoustic patterns, the system learns to account for shifts caused by ear occlusion. A frequency-specific confidence scoring mechanism further refines output based on real-time acoustic reliability (for example, if certain consonants are consistently misheard). Moreover, specialized data collection from actual in-canal devices captures realistic samples, ensuring a robust adaptation pipeline

The system may utilize speech to text models configured for in-canal speech in various embodiments. Such a speech to text model may be configured by fine-tuning or modifying a foundation model by modifying parameters to account for occluded ear acoustics. Moreover, in-canal data may be incorporated in an acoustic model, a language model, or both. Other techniques that may be used include augmenting existing data to simulate in-canal microphone characteristics by applying filters and convolutions that replicate resonance and muffling or by merging realistic background noise or bone-conducted input patterns into existing data. Both approaches may expand the diversity of training data. Other techniques may include modifying phoneme recognition probabilities by assigning higher or lower confidence to recognized phonemes based on known in-canal misrecognition tendencies and utilizing real-time feedback from the user, which would allow for re-checks or re-queries when certain frequency bands are consistently unreliable. Specialized datasets covering a representative range of occluded voices, speaking styles, and ambient conditions may be used, as well as datasets in different languages to ensure wide linguistic variety.

An example use of the technology involves a user wearing in-canal earbuds that connect to a voice assistant for dictating emails. Traditional NLP models might struggle to parse fast spoken or mid-syllable consonants muffled by occlusion. With this system, the user seamlessly dictates text, and the model-augmented assistant accurately understands context and meaning, even in noisy locations or while the user speaks at a low volume.

A potential application of the system is in earbuds and hearables to enhance everyday command-and-control for artificial intelligence assistants in occluded ear designs. Another potential application is in the enterprise and industrial context, where the system may improve voice-based instruction systems in environments where workers use sealed hearing protection. The system may also be utilized in medical and healthcare settings to aid medical staff wearing noise-isolating earpieces for privacy and safety, and in military and security settings to facilitate accurate speech recognition under helmet or ear-sealed conditions.

Advantages of the technology include improved recognition accuracy: by adapting proven NLP solutions to occluded environments, word error rates can be reduced. The system also allows for more efficient development, by leveraging existing models (transfer learning) instead of building from scratch. Other advantages include context-aware processing: frequency-specific confidence scoring allows dynamic error correction; a flexible implementation that may be integrated into various ear-worn devices or hearing aids; and a scalable methodology, as augmentation and data collection can be expanded to new languages, user populations, or device types.

### Utilizing Multiple Speech to Text Models in Parallel

Voice recognition systems typically use a single speech to text engine or occasionally switch among multiple speech to text engines manually or via hard-coded domain triggers. Variance in model performance is common: some speech to text engines excel with non-native accents, others handle domain-specific vocabulary or noisy surroundings better. Moreover, a single speech to text engine may degrade in performance if it is not well-adapted to the in-canal microphone environment, which can produce distinctive audio profiles due to occlusion effects and body-conducted sounds.

The described technology provides technical solutions to these technical problems. A system according to the technology implements an architecture in which multiple specialized speech to text models run simultaneously, each receiving the same audio stream (either in-canal speech, external microphone speech, or a combination of the two) but optimized for different user speech traits, domain context, or environment conditions. The system may transmit real-time audio input to multiple speech to text models (for example, a model specialized in noisy environments, another in medical vocabulary, yet another in standard conversation). Depending on device constraints, the system may run these models locally or offload some parallel processing to one or more artificial intelligence agents.

Each speech to text engine returns a confidence measure for its transcription (for example, a per-word or per-phrase probability). The system may reweigh confidences if it knows, for instance, that the user is discussing a certain domain or if the user's accent aligns with a particular model. The system may choose the transcription path with the highest overall confidence or optionally merge segments if the confidence distribution indicates certain engines did better on specific parts (a “composite” approach). Once the best transcription is selected, it can be provided to a language model or for intent parsing. If partial transcripts are streaming in, the system can perform ongoing confidence checks, improving partial transcripts on the fly to minimize user wait times.

Over time, the system learns which speech to text engines excel for a given user's accent or usage scenario and may adjust priority or weighting accordingly. If the user starts discussing domain-specific topics (for example, medical, automotive, music playlists), the system selectively favors the model known to handle that lexicon more accurately.

The system may account for an in-canal microphone's unique acoustic profile, ensuring each speech to text path is trained or pre-processed to handle muffled or body-transmitted vibrations. Each model may receive audio processed by different noise-cancellation approaches, with the system selecting the pipeline output that yields the clearest speech recognition.

The following scenario illustrates a use of the system: A user wearing custom in-canal earbuds in a crowded, noisy coffee shop tries to place a voice-enabled coffee order and discuss meeting details using specialized terms. The system runs three speech to text models: Model A tuned for noisy environments, Model B for standard everyday conversation, and Model C specialized in calendar/schedule domain speech.

The user says, “Hey, book a staff meeting for next Tuesday at 2 PM, then order me a latte.” Each model produces a real-time transcript with confidence scores. The system identifies Model C's transcript for the meeting portion as highest confidence, but Model A outperforms for the ordering portion with coffee shop noise. The system merges or chooses whichever approach yields the best final output for each segment. The system routes the “staff meeting” request to a calendar agent and “order me a latte” to a coffee agent. As a result, the user's commands are accurately recognized and executed, despite noise and domain-specific language.

Potential applications include recognizing mixed-domain or mixed-language speech. Advantages of the technology include improved recognition accuracy by utilizing results and confidence scores from multiple models without undue latency.

### Agent Conversation Continuity During Connectivity Interruptions

Cloud-based artificial intelligence agents often rely on constant internet access to interpret commands and deliver responses. If connectivity drops, conventional assistants frequently fail, losing any ongoing conversation context. Existing fallback mechanisms typically rely on a complete offline model or degrade to rudimentary local mode that cannot store or process queued commands properly. Users in remote, mobile, or otherwise connectivity-limited scenarios cannot afford conversation breakdowns with their artificial intelligence assistant. Moreover, in-canal microphones present additional challenges due to the unique frequency profile (enhanced bone conduction in sub-1 kHz ranges) that may differ from typical microphone design assumptions.

The described technology provides technical solutions to these technical problems. A system according to the technology may utilize local processing tuned for in-canal audio input, with command queuing and seamless handoff to maintain continuity. The system may optimize for the sub-1 kHz frequency that is typical of bone-conducted or occluded speech. The system may utilize an artificial intelligence agent that can be run locally.

In the event of a network interruption, the system may hold parsed commands until network availability is detected, and may notify the user once queued instructions are successfully processed. The system may dynamically route commands to the local engine or the cloud back-end without interrupting the conversation flow and ensure both local and remote systems synchronize conversation state when connectivity returns.

In some embodiments, the system may offer subtle audio or haptic cues when switching between offline (local) and online (cloud) modes. This allows the user to keep engaging naturally with the artificial intelligence agent while staying informed about system status.

The system may be utilized in outdoors and adventure settings, for example, to ensure hikers, campers, or travelers maintain artificial intelligence support in limited-signal zones. The system may also be utilized in rural and developing areas to offer robust agent functionality where broadband connections are sporadic. The system may also be used in industrial and enterprise settings to help workers in large facilities with intermittent wireless connections remain productive, and in emergency and military environments, where the system may maintain critical voice-based systems when communications are compromised.

Advantages of the system include that the system provides for resilient communication by persisting the conversation flow with the artificial intelligence assistant despite poor or lost connectivity. The system also provides efficient local processing that is tailored for in-canal microphones, which may improve recognition accuracy without heavy dependency on remote systems. The system is also user-friendly in that command queueing and transparent handoffs minimize frustration, letting the user focus on tasks rather than network status. The system may also have limited hardware impact, as local artificial intelligence models and efficient voice capture are tailored to the power constraints of typical earbuds/hearables. The system may also be adapted for commercial wearables or specialized devices across multiple industries.

Dual-Channel In-Canal and Multiple Microphone Array for Privacy-Protected Voice Activity Detection

Traditional voice interfaces rely on either a single external microphone (or two microphones) to capture speech or an in-canal microphone for noise insulation and privacy. External microphones do not guarantee privacy, because external microphones can still pick up ambient sound from other speakers or unwanted acoustic interference. On the other hand, an in-canal microphone is naturally more private, as it may be acoustically sealed in the ear canal, but it may suffer from limited fidelity or have difficulty capturing a robust full-spectrum speech signal for advanced processing. Existing solutions do not adequately combine these two approaches to exploit the strengths of both: increased performance on the exterior and robust voice activity detection from an in-canal microphone.

The described technology combines in-canal privacy with beamforming by an array of microphones. The in-canal microphone may be included inside a custom in-ear monitor (IEM) or other device that isolates the ear canal with sound-absorbing materials, yielding a highly private reference signal containing the user's speech. There may be three or more microphones around the ear's exterior (for example, integrated into an earbud housing) that perform beamforming to focus on the user's mouth. This produces a high-fidelity speech capture but may still pick up loud external noises.

The in-canal microphone, being mostly or entirely isolated from external noise, provides reliable voice activity cues even in loud environments. Its signal is used as a gate to determine if the user is actively speaking. When the in-canal microphone does not detect user voice, the external array's captured data is either not used, or remains idle, preventing unintentional listening or triggers from other sound sources.

During speaking episodes (as gated by the in-canal microphone), the system activates or unmutes the beamformed signal from the exterior array. This yields a full-spectrum user voice input that may be utilized for speech recognition or telephony. Beamforming algorithms help ignore off-axis signals, reducing background chatter or random shouts, although some external sound may still be recognized if loud enough or from a near field.

If the in-canal microphone does not detect user speech, the external array remains in a low-power or non-recording state (or heavily attenuated). Only upon confident voice activity detection does the system process and transmit the user's external microphone signal. The system allows for optional listen-through or transparency modes where the exterior array can intentionally capture external sound with user consent, but only after explicit enabling. By pairing an isolated in-canal microphone for voice gating with a directional exterior array for high-quality speech capture, the system delivers privacy safeguards (no open listening unless the user is speaking) and noise-robust beamformed audio.

An example use case is the following: a user is working in a bustling coffee shop. When the user speaks, the in-canal microphone reliably detects voice activity, activating the external beamforming array. The array hones in on the user's mouth, capturing crisp speech for a voice call or artificial intelligence assistant, despite surrounding chatter. If someone shouts in the distance, the in-canal microphone does not detect user speech, so the system remains effectively off for external capture. This ensures no accidental triggers from external noises and protects the user's privacy, as well as the privacy of other individuals who may be near the user, by not listening when the user is silent.

FIG. 41 is a flow diagram illustrating an example method 4100 that some embodiments of aspects of the described technology may perform. The method may begin at step 4102, where a first signal from one or more in-canal microphones is received. The one or more in-canal microphones are included in a first portion of a device that is positioned at least partially in an ear canal of a wearer. The one or more in-canal microphones are configured to capture sounds or vibrations in the ear canal.

At step 4104, based on the first signal, voice activity of the wearer is detected. At step 4106, in response to detecting the voice activity, beamforming is performed to focus three or more microphones on a mouth of the wearer. The three or more microphones are included in a second portion of the device and are configured to capture external sounds. At step 4108, multiple second signals from the three or more microphones are received, and at step 4110, the multiple second signals are processed.

Additional steps may include providing the multiple second signals to an artificial intelligence agent, receiving a response from the artificial intelligence agent, generating, based on the response, a third signal, and outputting, by one or more sound output devices included in the first portion of the device, the third signal.

In some aspects, the techniques described herein relate to a device including: a first portion configured to be positioned at least partially in an ear canal of a wearer, the first portion including one or more in-canal microphones configured to capture sounds or vibrations in the ear canal; a second portion including three or more microphones configured to capture external sounds; and one or more memories storing instructions that upon execution cause the device to perform a method, the method including: receiving a first signal from the one or more in-canal microphones; detecting, based on the first signal, voice activity of the wearer; in response to detecting the voice activity, performing beamforming to focus the three or more microphones on a mouth of the wearer; receiving multiple second signals from the three or more microphones; and processing the multiple second signals.

In some aspects, the techniques described herein relate to a device wherein the three or more microphones are configured to be in an active capture mode in response to detecting the voice activity and the three or more microphones are configured to be in a low-power mode or an idle capture mode prior to detecting the voice activity.

In some aspects, the techniques described herein relate to a device wherein receiving the multiple second signals is in response to detecting the voice activity and the method further includes providing the multiple second signals to a computing device.

In some aspects, the techniques described herein relate to a device wherein receiving the multiple second signals occurs prior to detecting the voice activity and the method further includes discarding at least some of the multiple second signals.

In some aspects, the techniques described herein relate to a device wherein the first portion further includes one or more sound output devices configured to output sounds in the ear canal, and the method further includes: providing the multiple second signals to an artificial intelligence agent; receiving a response from the artificial intelligence agent; generating, based on the response, a third signal; and outputting, by the one or more sound output devices, the third signal.

In some aspects, the techniques described herein relate to a device, wherein the method further includes: receiving a fourth signal from the one or more in-canal microphones; identifying portions of the fourth signal attributable to bone-conducted speech of the wearer; generating, based on the identified portions of the fourth signal, a fifth signal to reduce or attenuate the bone-conducted speech of the wearer; and outputting, by the one or more sound output devices, the fifth signal, thereby reducing or attenuating the bone-conducted speech of the wearer in the ear canal of the wearer.

In some aspects, the techniques described herein relate to a method including: receiving a first signal from one or more in-canal microphones included in a first portion of a device, the first portion positioned at least partially in an ear canal of a wearer, the one or more in-canal microphones configured to capture sounds or vibrations in the ear canal; detecting, based on the first signal, voice activity of the wearer; in response to detecting the voice activity, performing beamforming to focus three or more microphones on a mouth of the wearer, the three or more microphones included in a second portion of the device, the three or more microphones configured to capture external sounds; receiving multiple second signals from the three or more microphones; and processing the multiple second signals.

In some aspects, the techniques described herein relate to a method, further including: maintaining the three or more microphones in a low-power mode or an idle capture mode prior to detecting the voice activity; and in response to detecting the voice activity, transitioning the three or more microphones to an active capture mode.

In some aspects, the techniques described herein relate to a method wherein receiving the multiple second signals is in response to detecting the voice activity, and further including providing the multiple second signals to a computing device.

In some aspects, the techniques described herein relate to a method wherein receiving the multiple second signals occurs prior to detecting the voice activity and the method further includes discarding at least some of the multiple second signals.

In some aspects, the techniques described herein relate to a method wherein the first portion further includes one or more sound output devices, and further including: providing the multiple second signals to an artificial intelligence agent; receiving a response from the artificial intelligence agent; generating, based on the response, a third signal; and outputting, by the one or more sound output devices, the third signal.

In some aspects, the techniques described herein relate to a method, further including: receiving a fourth signal from the one or more in-canal microphones; identifying portions of the fourth signal attributable to bone-conducted speech of the wearer; generating, based on the identified portions of the fourth signal, a fifth signal to reduce or attenuate the bone-conducted speech of the wearer; and outputting, by the one or more sound output devices, the fifth signal, thereby reducing or attenuating the bone-conducted speech of the wearer in the ear canal of the wearer.

In some aspects, the techniques described herein relate to one or more non-transitory computer-readable media including executable instructions that when executed by one or more processors of a system cause the system to perform a method including: receiving a first signal from one or more in-canal microphones included in a first portion of a device, the first portion positioned at least partially in an ear canal of a wearer, the one or more in-canal microphones configured to capture sounds or vibrations in the ear canal; detecting, based on the first signal, voice activity of the wearer; in response to detecting the voice activity, performing beamforming to focus three or more microphones on a mouth of the wearer, the three or more microphones included in a second portion of the device, the three or more microphones configured to capture external sounds; receiving multiple second signals from the three or more microphones; and processing the multiple second signals.

In some aspects, the techniques described herein relate to one or more non-transitory computer-readable media, the method further including: maintaining the three or more microphones in a low-power mode or an idle capture mode prior to detecting the voice activity; and in response to detecting the voice activity, transitioning the three or more microphones to an active capture mode.

In some aspects, the techniques described herein relate to one or more non-transitory computer-readable media wherein receiving the multiple second signals is in response to detecting the voice activity, and further including providing the multiple second signals to a computing device.

In some aspects, the techniques described herein relate to one or more non-transitory computer-readable media wherein receiving the multiple second signals occurs prior to detecting the voice activity and the method further includes discarding at least some of the multiple second signals.

In some aspects, the techniques described herein relate to one or more non-transitory computer-readable media wherein the first portion further includes one or more sound output devices, and the method further includes: providing the multiple second signals to an artificial intelligence agent; receiving a response from the artificial intelligence agent; generating, based on the response, a third signal; and outputting, by the one or more sound output devices, the third signal.

In some aspects, the techniques described herein relate to one or more non-transitory computer-readable media wherein the method further includes: receiving a fourth signal from the one or more in-canal microphones; identifying portions of the fourth signal attributable to bone-conducted speech of the wearer; generating, based on the identified portions of the fourth signal, a fifth signal to reduce or attenuate the bone-conducted speech of the wearer; and outputting, by the one or more sound output devices, the fifth signal, thereby reducing or attenuating the bone-conducted speech of the wearer in the ear canal of the wearer.

### Self-Voice Cancellation or Attenuation

In-canal earbuds and other ear-worn devices often occlude the ear canal, causing the user's own voice (transmitted via bone conduction) to mask or overpower external sounds. Traditional transparency or ambient modes typically only capture external audio through microphones and feed it back into the user's ears. While this improves awareness of surroundings, it does not adequately handle the occlusion effect of the user's self-voice, which can still dominate. Moreover, many voice-enabled devices prioritize capturing speech for artificial intelligence agents without optimizing the user's experience of environmental sounds. Consequently, critical external cues, such as oncoming vehicles or important announcements, can be missed when the user is speaking.

For example, to ensure safety and situational awareness, it may be important that users can hear their surroundings while speaking, such as to an artificial intelligence agent. The described technology provides technical solutions to these technical problems. In some embodiments, the technology may apply a real-time separation filter that identifies and subtracts bone-conducted self-voice from the overall sound mix. A predictive model of the user's speech may help the filter anticipate and cancel or reduce the user's own voice frequencies. The device may operate in a transparent mode that maintains a clear channel for the artificial intelligence agent while simultaneously enhancing external audio cues. Context-aware balancing may adjust how aggressively self-voice is canceled, which may ensure that the user maintains some sense of his or her own speech (to avoid disorienting experiences) but not to the extent that it drowns out important ambient sounds.

In the system, in-canal microphones capture the overall audio signal, while additional sensors measure bone conduction. The system applies subtraction algorithms to isolate self-voice frequencies. The system continuously adjusts parameters to handle variations in user voice volume or pitch.

The system may use predictive modeling of a user's speech by learning unique features of the user's vocal signature and articulation habits. The system may create a short predictive window, letting the system begin self-voice attenuation as soon as speech is detected. The system may enhance external sounds by simultaneously monitoring ambient sounds and injecting them into the user's ear at a comfortable level for the user. The system may not remove user speech entirely but instead scale it down to prevent disorientation, maintaining a natural sense of vocal feedback. The system may also balance self-voice and environmental sounds based on the context. For example, the system may increase external sound gain when in busy or hazardous environments (for example, crossing a street). The system may also temporarily lower the attenuation of self-voice if the user needs clear feedback on their speaking volume in quiet areas (for example, a library).

An example use case is as follows: a user is jogging on a city street wearing in-canal earbuds. The user engages with a voice assistant, asking for directions or controlling music. Normally, the user's own speaking voice would be amplified inside their head, making it difficult to hear approaching bicycles or traffic signals. With self-voice cancellation, the device filters out the user's own voice while maintaining a safe level of surrounding sound. The user benefits from unobstructed awareness and can continue talking to the assistant without losing track of the urban environment.

Potential applications of the system include for urban commuters and joggers who need to hear traffic, alerts, and general surroundings while engaging in conversation with an artificial intelligence agent and in workplace scenarios for employees operating machinery or collaborating in open spaces. The system can allow such employees to hear coworkers while using voice commands for devices. Other potential applications include military and public safety uses, in which the system may enable personnel to maintain high situational awareness while issuing voice-based directives, and in conference and lecture environments, in which the system may allow users to discreetly communicate with artificial intelligence agents without fully isolating themselves from a presenter or group discussion.

Advantages of the technology include enhanced safety and awareness, as the user perceives crucial environmental audio cues even while speaking to the assistant. Another advantage is that the subtle attenuation of the system allows for enough self-voice feedback to be retained to prevent speech disorientation. Another advantage is reduced occlusion fatigue, as the booming or muffled quality of one's own voice in in-canal devices is reduced or minimized. The system is adaptive, in that the use of predictive modeling and context awareness allows the system to adapt to changes in the user's environment and speaking style. The system also allows for an improved user experience, as the system may provide a seamless interaction with artificial intelligence agents without sacrificing ambient perception.

Dual-Mode Agent Interaction System with Seamless Microphone Switching or Blending

Most earbuds, headsets, or smart devices rely on a single primary microphone, either a standard external microphone to capture ambient speech or an in-canal microphone designed to reduce noise through occlusion and bone conduction. However, no single solution may be optimal for all conditions. In quiet environments, an external microphone may capture nuanced speech more naturally, while high-noise settings usually benefit from an in-canal microphone's inherent noise isolation. Existing products seldom incorporate a real-time switching mechanism that intelligently selects (or blends) audio streams from both sources.

The described technology provides technical solutions to these technical problems. Users often move through environments with rapidly changing noise levels: a quiet office hallway one moment, a bustling street the next. A system according to the described technology may continuously analyze external noise via external microphones and monitor speech clarity from the in-canal microphone. When the system detects that background noise exceeds a threshold (or that the user's speech is overshadowed by ambient sounds), the system may switch to the in-canal microphone. Conversely, if the environment is quieter, the system may revert to using the external microphone alone or in combination with the in-canal microphone for a more natural-sounding conversation. A blended processing pipeline further refines voice quality by dynamically weighting the two audio inputs. Over time, user preference learning adjusts these thresholds or weighting factors based on individual speaking habits and feedback, minimizing manual intervention.

The system may continuously monitor ambient noise and automatically switch or blend input from external and in-canal microphones, thereby facilitating voice capture quality. The system may measure ambient sounds in real time, identifying threshold crossings for noise intensity. When ambient decibels (dB) surpasses a preset threshold, the system may seamlessly transition to the in-canal microphone to leverage noise isolation. The smooth handoff avoids abrupt audio loss or latency, ensuring continuous conversation with the artificial intelligence agent. In some embodiments, the system incorporates location and time-based clues to anticipate changes in noise levels (for example, rush-hour traffic).

The system may combine signals from external and in-canal mics, selecting the most intelligible phonemes from each source. The system may adjust weighting in real time (for example, 30% external, 70% in-canal) depending on detected speech clarity. The system may learn user preferences over time by remembering a user's acceptance or rejection of certain switching decisions, thereby allowing the system to refine crossing thresholds automatically. The system may also learn the user's typical environments (home, office, gym) and preemptively configure the microphone priority, meaning that the system may prioritize the in-canal microphone over the external microphones, or vice-versa.

An example use of the system involves a user strolling through a city, occasionally passing construction zones. While walking in moderate noise, the device defaults to external microphone mode for a more natural vocal capture. Approaching the loud construction site, the system detects elevated noise levels and instantly switches to the in-canal microphone to maintain clear speech pickup. Once the user moves away from the noise, the system may seamlessly shift back or blend the inputs. The user experiences no disruption, enjoying continuous, high-quality artificial intelligence assistant interaction regardless of location.

Potential applications of the system include consumer earbuds and headsets to enhance everyday voice assistant usage in various environments, from quiet offices to busy city streets and in enterprise and industrial headsets to protect worker productivity in factories or construction sites where noise levels fluctuate. Another potential application is in military and security contexts, as the system may be utilized to support mission-critical communication where external or in-canal modes can be toggled rapidly, and in healthcare environments, such as to allow medical staff to swiftly adapt between silent wards and more bustling areas with minimal user action.

Advantages of the technology include adaptive audio quality, as the system may maintain clear speech recognition in both low-noise and high-noise conditions, and hands-free operation, as the automatic switching may free users from manual microphone mode adjustments. Another advantage involves user-centric learning: the system may continuously improve by incorporating personal usage patterns and feedback. Yet another advantage involves seamless transition between microphones: no conversation dropouts or reconfigurations may be necessary to switch microphones when ambient noise changes suddenly.

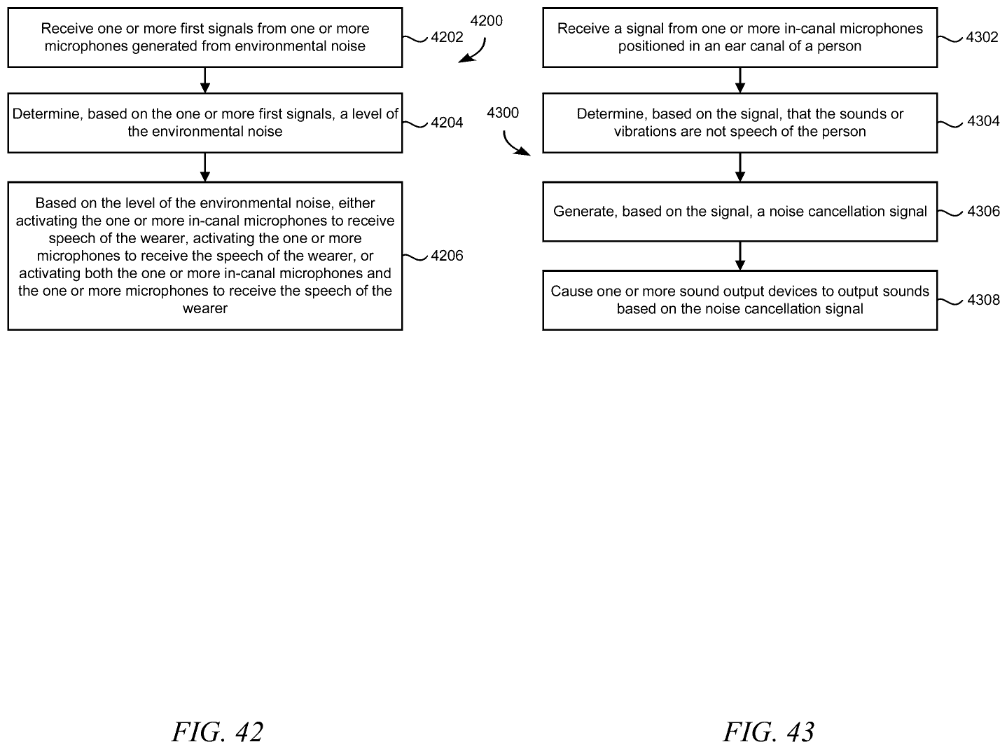

FIG. 42 is a flow diagram illustrating an example method 4200 that some embodiments of aspects of the described technology may perform. The method 4200 may begin at step 4202 where one or more first signals that are generated from environmental noise captured by one or more microphones are received. The one or more microphones are included in a second portion of a device and are configured to capture external sounds. The device also includes a first portion configured to be at least partially inserted into an ear canal of a wearer. The first portion includes one or more in-canal microphones configured to capture sounds or vibrations in the ear canal.

At step 4204, based on the one or more first signals, a level of the environmental noise is determined. At step 4206, based on the level of the environmental noise, either the one or more in-canal microphones are activated to receive speech of the wearer, the one or more microphones are activated to receive the speech of the wearer, or both the one or more in-canal microphones and the one or more microphones are activated to receive the speech of the wearer.

Additional steps may include determining a first clarity of the speech received from the one or more in-canal microphones, determining a second clarity of the speech received from the one or more microphones, and adjusting, based on the first clarity and the second clarity, a first weighting of the speech received from the one or more in-canal microphones and a second weighting of the speech received from the one or more microphones.

In some aspects, the techniques described herein relate to a device including: a first portion configured to be positioned at least partially in an ear canal of a wearer, the first portion including one or more in-canal microphones configured to capture sounds or vibrations in the ear canal; a second portion including one or more microphones configured to capture external sounds; one or more processors; and one or more memories storing instructions that upon execution by the one or more processors cause the device to perform a method, the method including: receiving one or more first signals from the one or more microphones, the one or more first signals generated from environmental noise; determining, based on the one or more first signals, a level of the environmental noise; and based on the level of the environmental noise, either: activating the one or more in-canal microphones to receive speech of the wearer; activating the one or more microphones to receive the speech of the wearer; or activating both the one or more in-canal microphones and the one or more microphones to receive the speech of the wearer.

In some aspects, the techniques described herein relate to a device wherein the method further includes if both the one or more in-canal microphones and the one or more microphones are activated to receive the speech of the wearer: determining a first clarity of the speech received from the one or more in-canal microphones; determining a second clarity of the speech received from the one or more microphones; and adjusting, based on the first clarity and the second clarity, a first weighting of the speech received from the one or more in-canal microphones and a second weighting of the speech received from the one or more microphones.

In some aspects, the techniques described herein relate to a device wherein the method further includes: receiving one or more of a location of the device, a time, or a schedule of the wearer of the device; and prioritizing, based on one or more of the location, the time, or the schedule, either the one or more in-canal microphones or the one or more microphones to receive the speech of the wearer.

In some aspects, the techniques described herein relate to a device wherein the method further includes if the one or more in-canal microphones is activated to receive the speech of the wearer: receiving a second signal from the one or more in-canal microphones, the second signal generated from the speech of the wearer; determining, based on the second signal, an intensity of the speech; and based on the intensity of the speech, either: alerting the wearer to reduce the intensity of the speech; or alerting the wearer to increase the intensity of the speech.

In some aspects, the techniques described herein relate to a device wherein the device further includes a haptic feedback device and one or more sound output devices and alerting the wearer includes either providing a haptic alert using the haptic feedback device or a sound alert using the one or more sound output devices.

In some aspects, the techniques described herein relate to a device wherein the device further includes wireless communication circuitry that enables a wireless connection with a second device, and alerting the wearer includes instructing the second device using the wireless connection to provide an alert via the second device.

In some aspects, the techniques described herein relate to a device wherein the first portion further includes one or more sound output devices that is physically segregated from the one or more in-canal microphones and one or more dampening materials positioned between the one or more sound output devices and the one or more in-canal microphones.

In some aspects, the techniques described herein relate to a device wherein the second portion further includes a feedforward microphone, and the method further includes if the one or more microphones are activated to receive the speech of the wearer: performing beamforming to focus the one or more microphones on a mouth of the wearer; receiving a second signal from the one or more microphones, the second signal generated from the speech of the wearer; receiving a third signal from the feedforward microphone, the third signal generated from the environmental noise; generating, based on the third signal, a noise cancellation signal; and causing the one or more sound output devices to output sound based on the noise cancellation signal.

In some aspects, the techniques described herein relate to a method including: receiving one or more first signals from one or more microphones generated from environmental noise, the one or more microphones included in a second portion included in a device and configured to capture external sounds, the device further including a first portion configured to be at least partially inserted into an ear canal of a wearer, the first portion including one or more in-canal microphones configured to capture sounds or vibrations in the ear canal; determining, based on the one or more first signals, a level of the environmental noise; and based on the level of the environmental noise, either: activating the one or more in-canal microphones to receive speech of the wearer; activating the one or more microphones to receive the speech of the wearer; or activating both the one or more in-canal microphones and the one or more microphones to receive the speech of the wearer.

In some aspects, the techniques described herein relate to a method, further including if both the one or more in-canal microphones and the one or more microphones are activated to receive the speech of the wearer: determining a first clarity of the speech received from the one or more in-canal microphones; determining a second clarity of the speech received from the one or more microphones; and adjusting, based on the first clarity and the second clarity, a first weighting of the speech received from the one or more in-canal microphones and a second weighting of the speech received from the one or more microphones.

In some aspects, the techniques described herein relate to a method, further including: receiving one or more of a location of the device, a time, or a schedule of the wearer of the device; and prioritizing, based on one or more of the location, the time, or the schedule, either the one or more in-canal microphones or the one or more microphones to receive the speech of the wearer.

In some aspects, the techniques described herein relate to a method, further including if the one or more in-canal microphones is activated to receive the speech of the wearer: receiving a second signal from the one or more in-canal microphones, the second signal generated from the speech of the wearer; determining, based on the second signal, an intensity of the speech; and based on the intensity of the speech, either: alerting the wearer to reduce the intensity of the speech; or alerting the wearer to increase the intensity of the speech.

In some aspects, the techniques described herein relate to a method wherein the device further includes a haptic feedback device and one or more sound output devices and alerting the wearer includes either providing a haptic alert using the haptic feedback device or a sound alert using the one or more sound output devices.

In some aspects, the techniques described herein relate to a method wherein the device further includes a communication component enabling a wireless connection with a second device, and alerting the wearer includes instructing the second device using the wireless connection to provide an alert via the second device.

In some aspects, the techniques described herein relate to a method wherein the first portion further includes one or more sound output devices that is physically segregated from the one or more in-canal microphones and one or more dampening materials positioned between the one or more sound output devices and the one or more in-canal microphones.

In some aspects, the techniques described herein relate to a method wherein the second portion further includes a feedforward microphone, and the method further includes if the one or more microphones are activated to receive the speech of the wearer: performing beamforming to focus the one or more microphones on a mouth of the wearer; receiving a second signal from the one or more microphones, the second signal generated from the speech of the wearer; receiving a third signal from the feedforward microphone, the third signal generated from the environmental noise; generating, based on the third signal, a noise cancellation signal; and causing the one or more sound output devices to output sound based on the noise cancellation signal.

In some aspects, the techniques described herein relate to one or more non-transitory computer-readable media including executable instructions that when executed by one or more processors of a system cause the system to perform a method including: receiving one or more first signals from one or more microphones generated from environmental noise, the one or more microphones included in a second portion included in a device and configured to capture external sounds, the device further including a first portion configured to be at least partially inserted into an ear canal of a wearer, the first portion including one or more in-canal microphones configured to capture sounds or vibrations in the ear canal; determining, based on the one or more first signals, a level of the environmental noise; and based on the level of the environmental noise, either: activating the one or more in-canal microphones to receive speech of the wearer; activating the one or more microphones to receive the speech of the wearer; or activating both the one or more in-canal microphones and the one or more microphones to receive the speech of the wearer.

In some aspects, the techniques described herein relate to one or more non-transitory computer-readable media, the method further including if both the one or more in-canal microphones and the one or more microphones are activated to receive the speech of the wearer: determining a first clarity of the speech received from the one or more in-canal microphones; determining a second clarity of the speech received from the one or more microphones; and adjusting, based on the first clarity and the second clarity, a first weighting of the speech received from the one or more in-canal microphones and a second weighting of the speech received from the one or more microphones.

In some aspects, the techniques described herein relate to one or more non-transitory computer-readable media, the method further including: receiving one or more of a location of the device, a time, or a schedule of the wearer of the device; and prioritizing, based on one or more of the location, the time, or the schedule, either the one or more in-canal microphones or the one or more microphones to receive the speech of the wearer.

In some aspects, the techniques described herein relate to one or more non-transitory computer-readable media, the method further including if the one or more in-canal microphones is activated to receive the speech of the wearer: receiving a second signal from the one or more in-canal microphones, the second signal generated from the speech of the wearer; determining, based on the second signal, an intensity of the speech; and based on the intensity of the speech, either: alerting the wearer to reduce the intensity of the speech; or alerting the wearer to increase the intensity of the speech.

In some aspects, the techniques described herein relate to one or more non-transitory computer-readable media wherein the device further includes a haptic feedback device and one or more sound output devices and alerting the wearer includes either providing a haptic alert using the haptic feedback device or a sound alert using the one or more sound output devices.

In some aspects, the techniques described herein relate to one or more non-transitory computer-readable media wherein the device further includes a communication component enabling a wireless connection with a second device, and alerting the wearer includes instructing the second device using the wireless connection to provide an alert via the second device.

In some aspects, the techniques described herein relate to one or more non-transitory computer-readable media wherein the first portion further includes one or more sound output devices that is physically segregated from the one or more in-canal microphones and one or more dampening materials positioned between the one or more sound output devices and the one or more in-canal microphones.

In some aspects, the techniques described herein relate to one or more non-transitory computer-readable media wherein the second portion further includes a feedforward microphone, and the method further includes if the one or more microphones are activated to receive the speech of the wearer: performing beamforming to focus the one or more microphones on a mouth of the wearer; receiving a second signal from the one or more microphones, the second signal generated from the speech of the wearer; receiving a third signal from the feedforward microphone, the third signal generated from the environmental noise; generating, based on the third signal, a noise cancellation signal; and causing the one or more sound output devices to output sound based on the noise cancellation signal.

### Voice Effort Reduction for Occluded Ear Agent Interaction

In-canal earbuds and hearing aids commonly occlude the ear canal, making ambient sounds and one's own voice seem muffled. This partial loss of natural auditory feedback can cause users to speak louder than necessary, which is sometimes known as the occlusion effect, which may lead to discomfort and disruption in shared or quiet environments. Certain solutions such as vented ear tips or active noise cancellation for external sounds may improve user comfort, but they do not address real-time monitoring and adjustment of the user's vocal intensity, especially when speaking to an artificial intelligence agent.

The described technology provides technical solutions to these technical problems. Users speaking with occluded ears unwittingly raise their voice because they have an inaccurate perception of loudness. A system according to the described technology may leverage an in-canal microphone to analyze the user's speech intensity in real time. Subtle feedback mechanisms (haptic vibrations, tonal cues, or visual indicators) prompt the user to lower or adjust their speaking volume when levels exceed optimal thresholds. The system also adapts to ambient noise conditions, allowing for comfortable voice effort whether the user is in a quiet library or a bustling train station. Over time, a user training module records personal voice patterns and guides the user toward more consistent, comfortable speaking levels-particularly crucial for lengthy conversations with an artificial intelligence agent.

The system continuously measures vocal amplitude, factoring in the natural occlusion effect, and gently prompts the user with alerts (for example, haptic or tonal alerts) when speech volume exceeds or falls below desired thresholds. In some embodiments, the system adjusts acceptable volume ranges based on user profile and environmental noise. Users can select the type of feedback they find most comfortable (vibration, audio tone, LED flash on paired device, etc.).

The system may identify background noise level and adjust thresholds accordingly. The system may automatically refine feedback parameters as the user moves between quiet and noisy surroundings. The system may also create a personal voice profile by storing average speaking amplitude and patterns for a user over time. The system may also provide progress tracking and coaching by providing insights or notifications that help users learn to maintain consistent, comfortable voice levels with occluded ears.

An example use case involves a user wearing in-canal earbuds on a crowded commuter train. As the user asks the artificial intelligence agent for travel updates, the in-canal microphone detects that the user is speaking at a higher volume than needed. The system gently provides haptic feedback, nudging the user to reduce vocal effort. The user's speech then hits the acceptable intensity range, preserving battery life for noise-canceling features and preventing unwanted disruption to fellow passengers.

A potential application of the technology includes consumer earbuds and hearing aids, as the system may alleviate excessive vocal loudness in daily communication with artificial intelligence agents. Another potential application is for workplace communication: the system may help employees in open-plan offices maintain quieter speech, thereby promoting a more pleasant environment. Another potential application is in healthcare and clinical settings, where the system may encourage softer, confidential speech in sensitive environments where privacy is important, and in military and security settings, where the system may aid personnel needing discreet interactions with artificial intelligence agents, ensuring they do not inadvertently raise their voices.

One advantage of the technology is improved comfort and social discretion, as users may learn to speak more softly in enclosed public settings or quiet workplaces. Another advantage is more efficient voice artificial intelligence agent interaction: the system may preserve accurate speech recognition by regulating volume spikes. Another advantage relates to context-aware operation: the system may automatically shift speaking thresholds in response to changing ambient noise conditions. The system may also provide for personalized training: over time, the user may refine his or her vocal habits, even transitioning seamlessly between occluded and non-occluded environments. The system may also integrate into existing earbud, hearing aid, or wearable designs with minimal or reduced hardware adjustments.

### Dual-Channel Audio Isolation Architecture

Current earbuds and headsets typically share compact enclosures for both microphone input and speaker output. Because of this, crosstalk or acoustic interference can arise, causing diminished audio quality or unintended feedback loops. While noise-canceling techniques reduce external sounds, they do not always isolate the microphone channel from the speaker output completely, particularly in more advanced setups where voice assistants are used frequently. Moreover, conventional materials and designs often fail to prevent audio leakage into the environment, compromising the user's privacy.

The described technology provides technical solutions to these technical problems. The proliferation of voice assistants integrated into personal headsets has heightened the need for robust privacy and clearer audio signals. Users frequently give voice commands or engage in private communications that should not be overheard. Simultaneously, users wish to hear responses from the agent without losing clarity or leaking sound externally. By establishing two physically and acoustically distinct channels in one ear-worn device-one for capturing in-canal speech input and the other for sound output-a system according to the technology ensures there is minimal risk of feedback, interference, or sound leakage. Carefully placed resonance-dampening materials and isolation barriers further guarantee a clean and discrete audio environment, both inside and outside the ear.

The system utilizes two distinct audio pathways, one exclusively for user input and one for sound output, that are both fully isolated from each other and from external environmental sounds. The microphone and speaker components reside in separate compartments within the earbud, reducing direct acoustic coupling. In some embodiments, the system utilizes layered materials (for example, silicone, foam composites) to trap and absorb sound within the earbud enclosure. In addition, the system utilizes ventilation and targeted cable routing to prevent unwanted audio paths while maintaining airflow and user comfort.

The system directs audio into the ear canal, minimizing spillover into the surrounding area. Resonance-dampening materials may be positioned between the microphone and speaker assemblies to absorb vibrations. The system may also utilize frequency-specific damping that is tuned to target the most common ranges for speech and artificial intelligence agent output, thereby mitigating internal crosstalk.

The system may utilize sensors and software algorithms to detect unintended sound escaping from either channel and may make automated adjustments (for example, phase inversion) to reduce or eliminate detected leakage in real time.

An example use case of the technology is a user working in an open-plan office environment, making sensitive requests to an artificial intelligence agent. The isolated in-canal microphone picks up the user's voice with minimal background noise, while the sealed output driver delivers artificial intelligence responses to only the user's ear. Coworkers remain undisturbed, and there is no or minimal risk of acoustic feedback or inadvertent sound leakage revealing private information

A potential application of the technology is for private corporate communications, where highly confidential voice commands and agent responses in open-office setups may be important. Another potential application is in consumer devices such as earbuds or headsets to allow users to make and receive discreet phone calls and artificial intelligence agent interactions without disturbing others. Other potential applications are in government and military settings, where operations may require minimal or reduced sound leakage and reliable voice capture, and in healthcare environments, where medical professionals can discreetly interact with artificial intelligence agents while ensuring patient privacy.

Advantages of the technology include providing improved privacy, as the system may prevent both external audibility and crosstalk between user and agent audio channels and provide enhanced clarity, as the system reduces or eliminates feedback loops, thereby ensuring high-quality sound capture and playback. Other advantages relate to real-time monitoring, as the automated leakage detection may allow for the system to continuously correct acoustic anomalies, and user comfort and practicality, as physical isolation barriers and tuned damping help maintain a compact form factor. The technology also has broad utility, as the system may be utilized in a variety of consumer, professional, and specialized ear-worn devices.

### Directional Voice Focusing

Existing consumer microphones, such as those in conventional earbuds or headsets, are typically omnidirectional or only mildly directional, leading to potential issues with background noise, lack of privacy, and reduced clarity. Conventional beamforming techniques often enhance the user's voice relative to ambient noise but can still capture undesired sounds, especially in public or noisy environments. Additionally, many solutions do not address confidentiality; if a user speaks at normal volume, there may still be a risk that bystanders can overhear, and the microphone may also pick up extraneous chatter.

The described technology provides technical solutions to these technical problems. Voice assistants and artificial intelligence systems rely on clear, accurate voice input for best performance. However, modern workspaces and public areas can be extremely noisy, and users desire private interactions. A system according to the described technology employs a directional microphone assembly and destructive interference tactics to capture the user's speech with precision while suppressing or eliminating background noise. The adaptive focusing feature accommodates user-specific mouth and face geometry, further refining capture precision and preventing leakage of speech to the surroundings.

The system may utilize an array of phase-manipulated microphones configured to pick up sound primarily from the user's mouth, rejecting signals outside the narrow capture zone. The system may apply adaptive gain control in real time by amplifying the user's voice while minimizing ambient noise. The system may utilize other sensors to detect ambient noise sources, generating out-of-phase signals to partially negate background interference. The system may adjust interference patterns to account for shifting environmental noise profiles. The system may also adapt based on characteristics of the user. The system may calibrate to the user's mouth position, facial structure, or jawline for optimal pickup angles and can account for small movements of the user's head or mouth in real time to maintain acceptable voice capture.

An example use case of the technology is a user on a commuter train who wants to give private commands to their smartphone's artificial intelligence agent. A typical microphone might pick up train noises and other passengers' conversations, diminishing accuracy. With this system, the user can speak at a normal volume, confident that the microphone array captures only their voice while blocking external sounds.

One potential application of the technology is in consumer headsets and earbuds, as the system provides enhanced voice command accuracy and privacy in varied settings, such as busy coffee shops, public transport, or offices. Another setting in which the technology may be used is in office environments, as the system provides secure dictation tools for confidential corporate or legal settings where privacy is important. Other potential applications of the technology are in medical and assistive devices to allow for clear speech capture for patients or users with voice impairments, reducing ambient noise impact, and in military and security devices, where discreet, reliable communication in noisy or sensitive contexts is important.

Advantages of the technology include improved speech accuracy, as the directional array reduces interference from external sources and enhanced privacy, as the system limits how much a user must raise their voice, thereby minimizing or reducing speech leakage to the surrounding area. Another advantage relates to adaptive noise control, as the system may make real-time adjustments to handle changes in the environment, thereby delivering consistent performance in dynamic or unpredictable settings. The system may also be used in various devices, from personal consumer wearables to specialized, high-security applications. The system allows for a user-centric design, as the system's ability to recalibrate ensures comfort and reliability even as the user moves or changes posture.

### Adaptive Occlusion Effect Compensation for In-Canal Ear Devices

In closed-back or fully occluded in-canal devices, users benefit from superior noise isolation and the ability to capture voice with minimal external interference. However, these advantages come at the cost of internal body noise amplification. Vibrations from speaking, chewing, or movement can resonate within the sealed ear canal, causing discomfort, distorted self-perception of voice volume (leading users to speak louder), and distracting drumming or pulsating sounds (for example, footsteps, heartbeat). Current attempts at tackling occlusion rely on partial venting or rudimentary equalization, which can degrade noise cancellation quality or fail to address dynamic scenarios (for example, transitioning from stillness to activity).

The described technology provides technical solutions to these technical problems. A system according to the described technology may dynamically remove body-borne noises and maintain high-quality, closed-back audio performance. In some embodiments, the system may utilize the in-canal microphone to pick up vibrations and resonances traveling through the wearer's body (for example, chewing, heartbeat). The system may apply phase-inverted signals or specialized algorithms to subtract or attenuate these body noises, preserving clarity in the user's self-perception and conversation.

The system may adjust equalization in real time to reduce the “boomy” or muffled sensation of one's own voice, thereby enabling natural speech levels. The system also may provide dynamic transparency by augmenting certain external frequency bands or reintroducing external ambient noise to prevent an overly enclosed feel, with minimal or reduced impact on in-ear audio fidelity. The system may process the user's speech to reduce the harshness or overly amplified resonance caused by the in-canal seal. For example, the system may remove internal echoes or reflections within the sealed ear canal. Doing so may facilitate clear artificial intelligence agent communications and minimal or reduced interference for the user.

This system retains the strong benefits of a closed-back approach, such as deep bass and minimal external noise intrusion, while compensating for the drawbacks of occlusion. The result is an enhanced user experience, ideal for applications where high-fidelity audio, effective voice capture, and discreet conversation with an artificial intelligence agent are desired.

An example use case of the technology involves a user wearing custom in-canal earbuds with a personal artificial intelligence agent who is walking through a busy street. The user starts chewing gum and notices that the typical in-ear thumping or drumming is absent. The system's adaptive occlusion compensation filters out these body-borne sounds and maintains a comfortable self-voice perception. Simultaneously, the user can quietly converse with the device's artificial intelligence agent about directions or schedule updates, enjoying excellent voice capture (no or reduced external noise bleed) and a rich, immersive music background track.

FIG. 43 is a flow diagram illustrating an example method 4300 that some embodiments of aspects of the described technology may perform. The method 4300 may begin at step 4302, where a signal from one or more in-canal microphones positioned in an ear canal of a person is received. The signal is generated from sounds or vibrations in the ear canal captured by the one or more in-canal microphones. The one or more in-canal microphones are included in a portion of a device worn by the person. The portion is positioned at least partially in the ear canal. The portion also includes one or more sound output devices configured to output sounds in the ear canal.

At step 4304, based on the signal, it is determined that the sounds or vibrations are not speech of the person. At step 4306, based on the signal, a noise cancellation signal is generated. At step 4308, the one or more sound output devices are caused to output sounds based on the noise cancellation signal.

In some aspects, the techniques described herein relate to a device including: a portion configured to be positioned at least partially in an ear canal of a wearer, the portion including one or more in-canal microphones configured to capture sounds or vibrations in the ear canal and one or more sound output devices configured to output sounds in the ear canal; one or more processors; and one or more memories storing instructions that upon execution by the one or more processors cause the device to perform a method, the method including: receiving a signal from the one or more in-canal microphones, the signal generated from sounds or vibrations in the ear canal captured by the one or more in-canal microphones; determining, based on the signal, that the sounds or vibrations are not speech of the wearer; generating, based on the signal, a noise cancellation signal; and causing the one or more sound output devices to output sounds based on the noise cancellation signal.

In some aspects, the techniques described herein relate to a device wherein the sounds or vibrations are first sounds or vibrations, the signal is a first signal, the sounds are first sounds, and the method further includes: receiving a second signal from the one or more in-canal microphones, the second signal generated from second sounds or vibrations in the ear canal captured by the one or more in-canal microphones; determining, based on the second signal, that the second sounds or vibrations are speech of the wearer; adjusting an equalization of the second signal to obtain an equalized second signal; and causing the one or more sound output devices to output second sounds based on the equalized second signal.

In some aspects, the techniques described herein relate to a device wherein the portion is a first portion, the device further includes a second portion including multiple microphones configured to capture sounds external to the wearer, the signal is a first signal, the sounds are first sounds, and the method further includes: receiving multiple second signals from the multiple microphones, the multiple second signals generated from sounds external to the wearer captured by the multiple microphones; processing the multiple second signals to obtain multiple processed second signals; and causing the one or more sound output devices to output second sounds based on the multiple processed second signals.

In some aspects, the techniques described herein relate to a device wherein processing the multiple second signals to obtain the multiple processed second signals includes increasing one or more frequency bands of the multiple second signals.

In some aspects, the techniques described herein relate to a device wherein the sounds or vibrations are first sounds or vibrations, and the method further includes: receiving a third signal from the one or more in-canal microphones, the third signal generated from second sounds or vibrations in the ear canal captured by the one or more in-canal microphones; determining, based on the third signal, that the second sounds or vibrations are speech of the wearer; processing the third signal to reduce echo or resonance in the speech of the wearer; and causing the one or more sound output devices to output third sounds based on the processed third signal.

In some aspects, the techniques described herein relate to a method including: receiving a signal from one or more in-canal microphones positioned in an ear canal of a person, the signal generated from sounds or vibrations in the ear canal captured by the one or more in-canal microphones, the one or more in-canal microphones included in a portion of a device worn by the person, the portion positioned at least partially in the ear canal, the portion further including one or more sound output devices configured to output sounds in the ear canal; determining, based on the signal, that the sounds or vibrations are not speech of the person; generating, based on the signal, a noise cancellation signal; and causing the one or more sound output devices to output sounds based on the noise cancellation signal.

In some aspects, the techniques described herein relate to a method wherein the sounds or vibrations are first sounds or vibrations, the signal is a first signal, the sounds are first sounds, and further including: receiving a second signal from the one or more in-canal microphones, the second signal generated from second sounds or vibrations in the ear canal captured by the one or more in-canal microphones; determining, based on the second signal, that the second sounds or vibrations are speech of the person; adjusting an equalization of the second signal to obtain an equalized second signal; and causing the one or more sound output devices to output second sounds based on the equalized second signal.

In some aspects, the techniques described herein relate to a method wherein the portion is a first portion, the device further includes a second portion including multiple microphones configured to capture sounds external to the person, the signal is a first signal, the sounds are first sounds, and further including: receiving multiple second signals from the multiple microphones, the multiple second signals generated from sounds external to the person captured by the multiple microphones; processing the multiple second signals to obtain multiple processed second signals; and causing the one or more sound output devices to output second sounds based on the multiple processed second signals.

In some aspects, the techniques described herein relate to a method wherein processing the multiple second signals to obtain the multiple processed second signals includes increasing one or more frequency bands of the multiple second signals.

In some aspects, the techniques described herein relate to a method wherein the sounds or vibrations are first sounds or vibrations, and the method further includes: receiving a third signal from the one or more in-canal microphones, the third signal generated from second sounds or vibrations in the ear canal captured by the one or more in-canal microphones; determining, based on the third signal, that the second sounds or vibrations are speech of the person; processing the third signal to reduce echo or resonance in the speech of the wearer; and causing the one or more sound output devices to output third sounds based on the processed third signal.

In some aspects, the techniques described herein relate to one or more non-transitory computer-readable media including executable instructions that when executed by one or more processors of a system cause the system to perform a method including: receiving a signal from one or more in-canal microphones positioned in an ear canal of a person, the signal generated from sounds or vibrations in the ear canal captured by the one or more in-canal microphones, the one or more in-canal microphones included in a portion of a device worn by the person, the portion positioned at least partially in the ear canal, the portion further including one or more sound output devices configured to output sounds in the ear canal; determining, based on the signal, that the sounds or vibrations are not speech of the person; generating, based on the signal, a noise cancellation signal; and causing the one or more sound output devices to output sounds based on the noise cancellation signal.

In some aspects, the techniques described herein relate to one or more non-transitory computer-readable media wherein the sounds or vibrations are first sounds or vibrations, the signal is a first signal, the sounds are first sounds, and the method further includes: receiving a second signal from the one or more in-canal microphones, the second signal generated from second sounds or vibrations in the ear canal captured by the one or more in-canal microphones; determining, based on the second signal, that the second sounds or vibrations are speech of the person; adjusting an equalization of the second signal to obtain an equalized second signal; and causing the one or more sound output devices to output second sounds based on the equalized second signal.

In some aspects, the techniques described herein relate to one or more non-transitory computer-readable media wherein the portion is a first portion, the device further includes a second portion including multiple microphones configured to capture sounds external to the person, the signal is a first signal, the sounds are first sounds, and the method further includes: receiving multiple second signals from the multiple microphones, the multiple second signals generated from sounds external to the person captured by the multiple microphones; processing the multiple second signals to obtain multiple processed second signals; and causing the one or more sound output devices to output second sounds based on the multiple processed second signals.

In some aspects, the techniques described herein relate to one or more non-transitory computer-readable media wherein processing the multiple second signals to obtain the multiple processed second signals includes increasing one or more frequency bands of the multiple second signals.

In some aspects, the techniques described herein relate to one or more non-transitory computer-readable media wherein the sounds or vibrations are first sounds or vibrations, and the method further includes: receiving a third signal from the one or more in-canal microphones, the third signal generated from second sounds or vibrations in the ear canal captured by the one or more in-canal microphones; determining, based on the third signal, that the second sounds or vibrations are speech of the person; processing the third signal to reduce echo or resonance in the speech of the wearer; and causing the one or more sound output devices to output third sounds based on the processed third signal.

### Whispered Speech Recognition

Conventional voice recognition engines are primarily trained on normal-volume speech. When users whisper, significant high-frequency and amplitude content is lost, degrading recognition accuracy. Moreover, privacy-conscious individuals often avoid speaking aloud in shared or public spaces, but existing voice systems are not tuned to capture quiet, breathy vocalizations. Furthermore, conventional microphone arrays are not always optimized for bone-conducted whispers, making them prone to missing or misidentifying commands delivered at whisper-level amplitude.

The described technology provides technical solutions to these technical problems. A system according to the described technology may integrate whisper-specific acoustic models within the speech recognition pipeline. In-canal earbuds may leverage bone conduction to capture even the faintest vocalizations, while amplification and filtering techniques may allow for isolation of whispered frequencies. A privacy mode may allow users to communicate with an artificial intelligence agent silently in libraries, open-plan offices, or public transportation, ensuring minimal disruption to the surroundings. Through a user training module, individuals may learn to produce optimal whisper levels that balance clarity and stealth, further enhancing accuracy and user comfort.

In some embodiments, the system may utilize in-canal microphones combined with whisper-specific recognition models and amplification to achieve accurate, low-volume speech capture for silent, discreet user-agent conversations. The models may be trained on datasets of whispered vocal samples covering different accents and intensities. The system may utilize phoneme mapping that accounts for the breathy, low-amplitude characteristics unique to whispering.

The system may utilize amplification techniques for whispered voice patterns, such as adaptive gain control to dynamically boost near-silent signals while minimizing noise artifacts, and accentuating whispered consonant formation (for example, /s/ or /f/) often lost in quiet speech.

The privacy mode may ensure that minimal sound escapes the user's immediate vicinity. The system may use context-aware activation by automatically switching to whisper-detection mode in recognized quiet or sensitive environments. The system may provide guided exercises through on-device tutorials that teach acceptable whisper volumes and enunciations. The system may also provide real-time feedback through subtle auditory, haptic, or visual cues to notify users if their whisper is too faint or too strong for clear recognition.

In some embodiments, the system may utilize adaptive gain control and bone-conducted speech processing to recognize whispered speech. The system may utilize in-canal sensors that capture subtle vocal vibrations transmitted through the user's bones and soft tissues. The system may recognize that the user is whispering through models that are trained on whisper-level inputs, facilitating robust recognition even with minimal vocal output.

The system may use adaptive gain control for whispered input by automatically boosting only the relevant whisper-range frequencies while minimizing noise. The system may use filters to remove environmental noise without compromising the clarity of the whisper signal.

In some embodiments, the system may compress whispered speech data to reduce bandwidth usage and potential interception points and encrypt the compressed data prior to transmitting the data. The system may detect quiet surroundings or user-defined private zones to automatically activate whisper mode. The system may learn user behavior and typical usage patterns so as to transition seamlessly between normal and whisper-level interaction.

An example use of technology involves a professional in a quiet coworking space who needs to quickly retrieve sensitive information from a cloud assistant. Rather than speaking at a normal volume, the professional whispers commands into an in-canal device. The system's whisper-adapted recognition models and amplification filters capture and interpret these low-amplitude signals accurately. Meanwhile, coworkers remain undisturbed, and the professional maintains privacy.

Another example use case is a user in a quiet library who needs to query an artificial intelligence agent regarding research materials or scheduling. By switching to whisper mode, the user can speak softly into the in-canal microphone. The system amplifies and processes this near-silent input for the voice assistant without disturbing anyone nearby or risking personal privacy. Once the conversation is over or the user leaves the library, the system reverts to a normal listening state automatically.

A potential application of the technology relates to use in libraries, offices, and classrooms, where the system may offer silent command-and-control for personal assistants in noise-restricted areas. Another potential application may be in healthcare and clinical settings, as the system may enable confidential patient data queries without raising one's voice. Another potential application may be in security and military settings, as the system may allow for discreet communication with artificial intelligence agents when auditory discretion is critical. The technology may also be utilized in public spaces, as the system may empower users with private, whispered voice interaction in public transit or crowded events and preserves user privacy by preventing overheard conversations while minimizing ambient noise pickup.

Advantages of the technology include enhanced privacy, as users can access artificial intelligence agents without broadcasting requests audibly, and better recognition accuracy, as whisper-specific acoustic models may outperform generic speech to text solutions in low-volume conditions. Another advantage relates to robust recognition: whisper-optimized voice modeling and bone conduction detection may improve command accuracy. Another advantage is the system may allow for minimal disruption and therefore may be suitable for quiet, shared, or formal settings. The system also may provide for efficient user training by providing guided whisper practice, which may build confidence and proficiency in near-silent communication. The system may also be integrated into various in-canal wearable devices and earbud designs.

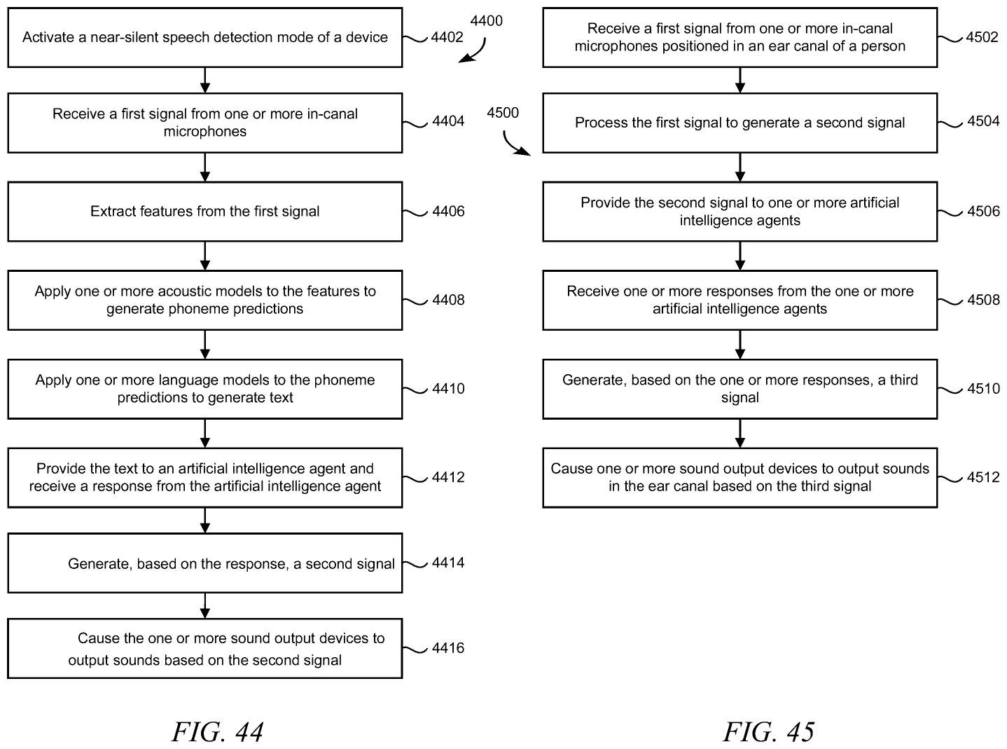

FIG. 44 is a flow diagram illustrating an example method 4400 that some embodiments of aspects of the described technology may perform. The method 4400 may begin at step 4402, where a near-silent speech detection mode of a device is activated. The device has the near-silent speech detection mode and a normal speech detection mode. The device includes a portion positioned at least partially in an ear canal of a wearer of the device. The portion includes one or more in-canal microphones configured to capture sounds or vibrations in the ear canal and one or more sound output devices configured to output sounds in the ear canal. At step 4404 a first signal from the one or more in-canal microphones is received. The first signal is generated from near-silent sounds or vibrations captured by the one or more in-canal microphones.

At step 4406, features are extracted from the first signal. At step 4408, one or more acoustic models are applied to the features to generate phoneme predictions. At step 4410 one or more language models are applied to the phoneme predictions to generate text. At step 4412, the text is provided to an artificial intelligence agent and a response from the artificial intelligence agent is received. At step 4414, based on the response, a second signal is generated. At step 4416 the one or more sound output devices are caused to output sounds based on the second signal.

Additional steps may be performed, such as amplifying the first signal prior to extracting features from the first signal.

In some aspects, the techniques described herein relate to a method including: activating a near-silent speech detection mode of a device, the device having the near-silent speech detection mode and a normal speech detection mode, the device including a portion positioned at least partially in an ear canal of a wearer of the device; the portion including one or more in-canal microphones configured to capture sounds or vibrations in the ear canal and one or more sound output devices configured to output sounds in the ear canal; receiving a first signal from the one or more in-canal microphones, the first signal generated from near-silent sounds or vibrations captured by the one or more in-canal microphones; extracting features from the first signal;
applying one or more acoustic models to the features to generate phoneme predictions;
applying one or more language models to the phoneme predictions to generate text;
providing the text to an artificial intelligence agent; receiving a response from the artificial intelligence agent; generating, based on the response, a second signal; and
causing the one or more sound output devices to output sounds based on the second signal.

In some aspects, the techniques described herein relate to a method, further including determining that the device is operating in a quiet environment, wherein the near-silent speech detection mode is activated in response to determining that the device is operating in the quiet environment.

In some aspects, the techniques described herein relate to a method wherein the portion is a first portion, the device further includes a second portion including multiple microphones configured to capture sounds external to the wearer, and further including receiving multiple second signals from the multiple microphones, the multiple second signals generated from sounds external to the wearer captured by the multiple microphones, wherein determining that the device is operating in the quiet environment is based on the multiple second signals.

In some aspects, the techniques described herein relate to a method, further including receiving a location of the device, wherein determining that the device is operating in the quiet environment is based on the location of the device.

In some aspects, the techniques described herein relate to a method, further including amplifying the first signal.

In some aspects, the techniques described herein relate to a method, wherein the one or more acoustic models are trained on near-silent speech.

In some aspects, the techniques described herein relate to a method, further including: determining, based on the first signal, an intensity of the near-silent sounds or vibrations; and alerting the wearer if the intensity is either below a first intensity threshold or above a second intensity threshold.

In some aspects, the techniques described herein relate to one or more non-transitory computer-readable media including executable instructions that when executed by one or more processors of a system cause the system to perform a method including: activating a near-silent speech detection mode of a device, the device having the near-silent speech detection mode and a normal speech detection mode, the device including a portion positioned at least partially in an ear canal of a wearer of the device; the portion including one or more in-canal microphones configured to capture sounds or vibrations in the ear canal and one or more sound output devices configured to output sounds in the ear canal; receiving a first signal from the one or more in-canal microphones, the first signal generated from near-silent sounds or vibrations captured by the one or more in-canal microphones; extracting features from the first signal; applying one or more acoustic models to the features to generate phoneme predictions; applying one or more language models to the phoneme predictions to generate text; providing the text to an artificial intelligence agent; receiving a response from the artificial intelligence agent; generating, based on the response, a second signal; and causing the one or more sound output devices to output sounds based on the second signal.

In some aspects, the techniques described herein relate to one or more non-transitory computer-readable media, the method further including determining that the device is operating in a quiet environment, wherein the near-silent speech detection mode is activated in response to determining that the device is operating in the quiet environment.

In some aspects, the techniques described herein relate to one or more non-transitory computer-readable media wherein the portion is a first portion, the device further includes a second portion including multiple microphones configured to capture sounds external to the wearer, and the method further includes receiving multiple second signals from the multiple microphones, the multiple second signals generated from sounds external to the wearer captured by the multiple microphones, wherein determining that the device is operating in the quiet environment is based on the multiple second signals.

In some aspects, the techniques described herein relate to one or more non-transitory computer-readable media, the method further including receiving a location of the device, wherein determining that the device is operating in the quiet environment is based on the location of the device.

In some aspects, the techniques described herein relate to one or more non-transitory computer-readable media, the method further including amplifying the first signal.

In some aspects, the techniques described herein relate to one or more non-transitory computer-readable media, wherein the one or more acoustic models are trained on near-silent speech.

In some aspects, the techniques described herein relate to one or more non-transitory computer-readable media, the method further including: determining, based on the first signal, an intensity of the near-silent sounds or vibrations; and alerting the wearer if the intensity is either below a first intensity threshold or above a second intensity threshold.

### Bone-Conducted Voice Quality Enhancement

Existing in-canal and bone-conduction systems typically pick up low-frequency-dominant speech signals, as bone conduction tends to attenuate higher frequencies crucial for clarity and natural timbre. While such methods may reduce ambient noise, they often yield a muffled or unnatural vocal quality. Conventional hearing aids, bone-conduction headsets, and some in-ear monitors attempt partial compensations via equalization, but they do not integrate advanced articulation enhancement or resonance modeling to fully restore a user's authentic sounding voice. Meanwhile, digital voice assistants rely heavily on speech clarity for accurate command interpretation and more natural conversational experiences.

The described technology provides technical solutions to these technical problems. A system according to the described technology may use a set of signal processing techniques—spectral balancing, articulation enhancement, resonance modeling—combined with A/B testing to refine and restore more natural voice characteristics. When users speak through bone conduction, critical higher-frequency components may be underrepresented, resulting in an atypically bass-heavy or dull sound signature that can degrade recognition accuracy for artificial intelligence agents and create an unnatural user experience. The system may apply spectral balancing to lift weaker high-frequency bands and articulation enhancement techniques targeting consonant formation to restore a more typical air-conducted vocal profile. Additionally, the system may utilize resonance modeling to simulate certain aspects of head and upper vocal tract resonance missing in purely bone-conducted signals. The system may provide an A/B testing framework to allow for the comparison of processed and unprocessed signals, which may allow for refining the algorithms for improved voice quality and agent interaction performance.

The system may utilize spectral balancing techniques to account for bone-conduction frequency limitations. For example, the system may utilize dynamic equalization that boosts or smooths specific frequency bands underrepresented in bone-conducted speech. The system may adjust equalization in real time based on measured speech intensity and user-specific bone conduction profiles.

The system may utilize articulation enhancement techniques to improve focus on consonant clarity, such as by selectively amplifying or sharpening high-frequency phonetic elements (for example, /s/, /t/, /ch/) that typically get lost in bone conduction. The system may also preserve rapid onset cues critical for differentiating similar sounds in whispered or lower-volume speech.

The system may utilize resonance modeling techniques to restore natural vocal qualities, such as by simulating the head and vocal tract to reintroduce frequency characteristics typically shaped by air conduction in the mouth and nasal cavity. The system may also adapt to the user's changing vocal dynamics, capturing variations in pitch, timbre, and inflection in real-time.

The system may utilize an A/B testing framework for quality comparison and optimization. The system may simultaneously process bone-conducted input and enhanced output, enabling quick toggling or side-by-side playback. The system may collect subjective quality ratings and objective speech recognition metrics from users to refine processing parameters.

An example use case of the technology involves a user talking to an artificial intelligence agent via in-canal earbuds while commuting in a noisy subway. Conventional bone-conduction pickups would create a muffled, low-frequency-biased signal that might lead to misinterpretations by the artificial intelligence agent or perceived awkwardness during voice calls. The system dynamically balances the high-frequency deficits and enhances articulation so consonants like “t,” “s,” and “f” remain crisp, allowing for more natural-sounding conversation with the artificial intelligence agent, even in challenging acoustic environments.

One potential application of the technology is for consumer earbuds and headsets: the system may improve clarity for voice assistant commands and phone calls in noisy or privacy-sensitive environments. Another potential application is in hearing aids and assistive devices: the system may provide more authentic voice output for individuals relying on bone conduction for speech capture. Other potential applications are in enterprise and call centers settings, as the system may help employees who use discreet in-canal devices maintain professional call quality, and in medical and military settings, as the system may ensure intelligible, stable voice performance in specialized settings where bone conduction is preferred.

One advantage of the technology relates to improved speech intelligibility, as the system may address the known deficiency of bone conduction in reproducing higher frequencies. Another advantage relates to natural sound quality, by resonance modeling, the system may allow voice warmth and expressiveness to be retained, which may enhance user confidence in agent interactions. The system also may provide improved recognition accuracy: artificial intelligence agents benefit from clearer voice input, thereby reducing misinterpretation and user frustration. The system may also adapt in real-time, as dynamic algorithms handle various speaking volumes or environmental contexts (for example, quiet offices vs. noisy outdoors). The system may also allow for refinement, as the A/B testing framework may drive iterative improvements, ensuring both objective and user-driven metrics guide enhancements.

FIG. 45 is a flow diagram illustrating an example method 4500 that some embodiments of aspects of the described technology may perform. The method 4500 may begin at step 4502 where a first signal from one or more in-canal microphones positioned in an ear canal of a person is received. The first signal is generated from bone-conducted speech captured by the one or more in-canal microphones. The one or more in-canal microphones are included in a portion of a device worn by the person that is positioned at least partially in the ear canal. The portion also includes one or more sound output devices configured to output sounds in the ear canal.

At step 4504, the first signal is processed to generate a second signal, by adjusting an equalization of the first signal, modifying one or more frequency bands of the first signal, and amplifying one or more portions of the first signal. At step 4506, the second signal is provided to one or more artificial intelligence agents. At step 4508, one or more responses from the one or more artificial intelligence agents are received. At step 4510 based on the one or more responses, a third signal is generated. At step 4512, the one or more sound output devices are caused to output sounds based on the third signal.

In some aspects, the techniques described herein relate to a method including: receiving a first signal from one or more in-canal microphones positioned in an ear canal of a person, the first signal generated from bone-conducted speech captured by the one or more in-canal microphones, the one or more in-canal microphones included in a portion of a device worn by the person, the portion positioned at least partially in the ear canal, the portion further including one or more sound output devices configured to output sounds in the ear canal; processing the first signal to generate a second signal, by: adjusting an equalization of the first signal; modifying one or more frequency bands of the first signal; and amplifying one or more portions of the first signal; providing the second signal to one or more artificial intelligence agents; receiving one or more responses from the one or more artificial intelligence agents; generating, based on the one or more responses, a third signal; and causing the one or more sound output devices to output sounds based on the third signal.

### Adaptive Speech-to-Text Processing for Sub-Vocalized Commands

Conventional speech-to-text (STT) algorithms assume audible vocal output at normal or slightly reduced volumes. Commercial solutions typically do not address the extreme low-volume range associated with sub-vocalization. In sub-vocalization, vocal cords vibrate minimally, and many speech formants lie below typical detection thresholds. Traditional voice activity detection (VAD) and standard machine learning-based STT models often fail to accurately identify phonemes when speech amplitude is so low. Additionally, in-canal microphones introduce unique acoustic profiles-particularly an emphasis on bone-conducted components in sub-1 kHz frequencies which standard STT pipelines do not fully accommodate.

The described technology provides technical solutions to these technical problems. For privacy or discreteness, users often want to issue near-silent commands to artificial intelligence agents—for example, in a library, during a meeting, or in other noise-sensitive environments. Standard STT systems struggle to detect or interpret sub-vocal signals, often discarding them as background noise. A system according to the described technology may utilize sensitive VAD, amplified detection hardware, and machine learning models specifically trained on progressively quieter speech samples. Transformer architectures optimized for in-canal, bone-conducted data may allow the system to accurately parse low-amplitude phonemes. A user training system may guide individuals to produce sub-vocal speech effectively, which may improve the system's recognition rate over time.

The system may provide sensitive VAD through monitoring tiny fluctuations in the user's vocal tract and activating STT processing only upon verifying authentic sub-vocal input. The system processes the signal for sub-vocal speech recognition through adaptive gain control—dynamically boosting low-amplitude signals typical of sub-vocalization—and noise suppression—filtering out peripheral sound while preserving faint vocal cues.

To recognize speech, the system may apply machine learning models trained on progressively quieter speech samples. The system may utilize an acoustic model that is trained on a wide range of sub-vocal intensities and bone-conducted examples. The system may adapt to various user accents and sub-vocalization styles, thereby improving accuracy over time. The system may also use transformer models for in-canal, bone-conducted speech. The models may focus on sub-1 kHz signals typically associated with bone conduction. The system may utilize self-attention mechanisms to decode subtle differences in low-volume phonemes.

The system may provide a training system to assist users in developing effective sub-vocalization techniques. For example, the system may provide guided exercises through on-device tutorials that help users master mouth and throat positions for reliable sub-vocal signals. The system may also provide feedback and metrics through real-time scoring to ensure users can track improvements in clarity and consistency.

An example use case of the technology is a user in a quiet library who needs to check messages or get information from an artificial intelligence agent without disturbing others. By sub-vocalizing commands, the user barely moves their lips or generates audible sound, yet the in-canal microphone detects faint vibrations. The adaptive STT system interprets these signals accurately, providing silent feedback on a smartwatch or earbud interface. Over time, the user learns an optimal sub-vocalization technique through guided practice, refining their silent communication with the AI assistant.

Potential applications of the technology relate to use in quiet environments such as libraries, offices, or conferences where discreet voice commands are important and in military and security settings, where certain scenarios may require near-silent speech. Another potential application is in accessibility solutions, as people with vocal strain or partial aphonia can still communicate commands sub-vocally. Yet another potential use of the technology is in consumer wearables such as earbuds and smart devices that support silent interactions in shared public spaces.

One advantage of the technology relates to the fact that near-silent operation preserves privacy and avoids social discomfort. Another advantage is that sub-vocal signals may be less prone to environmental noise, and thus there may be reduced ambient interference, which may result in improved STT accuracy. Another advantage relates to personalized learning: users may develop consistent sub-vocal techniques, which may improve system performance over time. Another advantage is that transformer-based models may be capable of handling complex linguistic contexts, thereby enabling advanced artificial intelligence agent interactions. Yet another advantage is that the technology may be applicable to a broad variety of settings, such as consumer settings, security/defense environments, and healthcare settings.

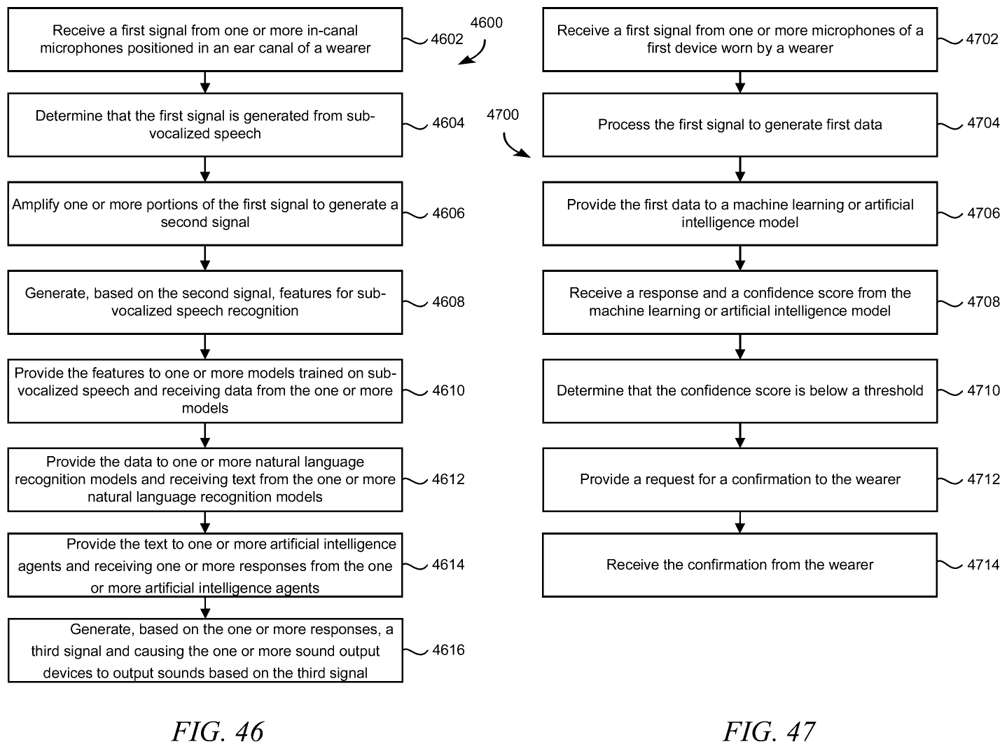

FIG. 46 is a flow diagram illustrating an example method 4600 that some embodiments of aspects of the described technology may perform. The method 4600 may begin at step 4602, where a first signal from one or more in-canal microphones positioned in an ear canal of a person is received. The first signal is generated from speech captured by the one or more in-canal microphones. The one or more in-canal microphones are included in a portion of a device worn by the person. The portion is positioned at least partially in the ear canal. The portion also includes one or more sound output devices configured to output sounds in the ear canal.

At step 4604, it is determined that the first signal is generated from sub-vocalized speech. At step 4606, one or more portions of the first signal are amplified to generate a second signal. At step 4608, based on the second signal, features for sub-vocalized speech recognition are generated. At step 4610, the features are provided to one or more models trained on sub-vocalized speech and data from the one or more models is received. At step 4612, the data is provided to one or more natural language recognition models and text from the one or more natural language recognition models is received. At step 4614 the text is provided to one or more artificial intelligence agents and one or more responses from the one or more artificial intelligence agents are received. At step 4616, based on the one or more responses, a third signal is generated, and the one or more sound output devices are caused to output sounds based on the third signal.

In some aspects, the techniques described herein relate to a method including: receiving a first signal from one or more in-canal microphones positioned in an ear canal of a person, the first signal generated from speech captured by the one or more in-canal microphones, the one or more in-canal microphones included in a portion of a device worn by the person, the portion positioned at least partially in the ear canal, the portion further including one or more sound output devices configured to output sounds in the ear canal; determining that the first signal is generated from sub-vocalized speech; amplifying one or more portions of the first signal to generate a second signal; generating, based on the second signal, features for sub-vocalized speech recognition; providing the features to one or more models trained on sub-vocalized speech; receiving data from the one or more models; providing the data to one or more natural language recognition models; receiving text from the one or more natural language recognition models; providing the text to one or more artificial intelligence agents; receiving one or more responses from the one or more artificial intelligence agents; generating, based on the one or more responses, a third signal; and causing the one or more sound output devices to output sounds based on the third signal.

### Multimodal Confirmation for Low-Confidence In-Canal Voice Commands

Voice assistants typically rely on confidence scores output by speech recognition engines to confirm command accuracy. If that score drops below a certain threshold, the system may misinterpret user intent. In in-canal devices, limited frequency range—especially for higher-frequency consonants—can further reduce recognition reliability. Conventional solutions often resort to repeating or re-prompting the user, which can feel intrusive or disruptive. Existing platforms do not employ a layered approach that dynamically switches across haptic, visual, and context-aware channels, all while considering user history, to minimize or reduce friction in the interactions.

The described technology provides technical solutions to these technical problems. When an in-canal voice command triggers a low recognition confidence score, a system according to the described technology may automatically request secondary confirmation. The user may receive a haptic prompt (for example, a subtle earbud vibration) indicating a need for validation. If the user has access to a connected device with a display-like a smartwatch or smartphone-a visual confirmation dialog may appear, offering quick approval or correction of the interpreted command. Furthermore, a prediction engine driven by user history and contextual cues may suggest the most likely commands (for example, frequent destinations, routine tasks), enabling a simpler yes/no confirmation if the recognized text is close to one of these predictable options. This multimodal approach may ensure minimal disruption and enhance accuracy while reducing repeated verbal queries.

The system may set a confidence threshold for ambiguous commands. If speech recognition confidence falls below a preset value, the system may mark the command as uncertain. In some embodiments, the system may adjust the threshold based on user speech patterns, noise levels, or real-time environmental inputs.

In some embodiments, the system may request secondary confirmation through haptic feedback requests. For example, the system may provide a short tap or buzz sequence to signal the user that confirmation is required. A single tap or a double tap by the user may accept or reject the command if that option is provided via earbud sensors.

In various embodiments, the system may provide visual confirmation options via connected devices, such as watches or mobile phones. The connected device may display the captured command text and request a quick tap or swipe for confirmation. In certain applications, such as augmented reality headsets or glasses, the user may see a low-confidence command text overlay.

The system may provide personalized shortcut suggestions: for example, the system may recommend probable commands (for example, frequently called contacts, commonly scheduled reminders). The system may also factor in location, time of day, or recurring user habits to refine likely command interpretations.

An example use case of the technology involves a user speaking a voice command in a noisy café. The in-canal microphone captures speech, but background chatter lowers the recognition confidence for “Remind me to call Sarah at 3 PM.” Automatically, the earbuds send a discreet haptic signal—two short taps—alerting the user that the system needs confirmation. Simultaneously, the user's smartwatch displays a prompt: “Did you say, ‘Call Sarah at 3 PM?’” With a single tap on the watch's display, the user confirms, avoiding the need for additional verbal repetition in a public space.

A potential application of the technology is in consumer earbuds and hearing aids, as the system may limit or reduce awkward re-queries in public, thereby improving user satisfaction with artificial intelligence agent. Another potential application is in workplace environments, as the system may allow employees to confirm voice commands in factories or offices without disrupting others. The system may also be utilized in healthcare and assistive devices to ensure patient or clinician commands are double-checked, thereby reducing the risk of critical errors. The system may also be utilized in military and security devices to minimize audible re-checks of voice commands in sensitive or high-noise settings.

One advantage of the technology is that the system may reduce repetition as users do not have to restate commands that fell below confidence thresholds, thereby saving time and avoiding frustration. Another advantage is that the system may provide enhanced privacy: in noisy or quiet public environments, discreet haptic and visual prompts replace extra voice prompts. Another advantage is that the system may provide improved accuracy: context-aware predictions and user history further minimize misinterpretation, leading to more precise outcomes. The system may also be implemented in existing wearable ecosystems, thereby supporting earbud and watch/phone synergy. The system may also be adaptive and scalable, as threshold tuning and multi-modal flexibility accommodate various usage styles and noise conditions.

FIG. 47 is a flow diagram illustrating an example method 4700 that aspects of the described technology may perform according to some embodiments. The method 4700 may begin at step 4702 where a first signal from one or more microphones of a first device worn by a wearer is received. The first device includes a haptic feedback component, a first user input component, and wireless communication circuitry. The first device is coupled to a second device via the wireless communication circuitry. The second device includes a display and a second user input component.

At step 4704, the first signal is processed to generate first data. At step 4706, the first data is provided to an artificial intelligence agent. At step 4708, a response and a confidence score is received from the artificial intelligence agent. At step 4710, it is determined that the confidence score is below a threshold. At step 4712, a request for a confirmation is provided to the wearer, by at least one of: providing a haptic alert via the haptic feedback component or providing a visual alert to the second device for display by the display. At step 4714, the confirmation is received from the wearer, by at least one of: receiving a first user input via the first user input component or receiving from the second device a second user input provided via the second user input component.

In some aspects, the techniques described herein relate to a method including: receiving a first signal from one or more microphones of a first device worn by a wearer, the first device including a haptic feedback component, a first user input component, and wireless communication circuitry, the first device coupled to a second device via the wireless communication circuitry, the second device including a display and a second user input component; processing the first signal to generate first data; providing the first data to an artificial intelligence agent; receiving a response and a confidence score from the artificial intelligence agent; determining that the confidence score is below a threshold; providing a request for a confirmation to the wearer, by at least one of: providing a haptic alert via the haptic feedback component; or providing a visual alert to the second device for display by the display; and receiving the confirmation from the wearer, by at least one of: receiving a first user input via the first user input component; or receiving from the second device a second user input provided via the second user input component.

### Multi-Modal Fallback System for Agent Communications

Traditional voice assistants rely predominantly on voice-based inputs and real-time network connectivity. When network conditions degrade or the user's environment becomes too noisy, these assistants often struggle to capture commands accurately or fail to respond at all. While some platforms offer text-based fallback, the transition between voice and text is usually not seamless, causing users to lose conversational context or repeat commands. Few solutions address the need for continuity across multiple modes, especially in the context of in-canal voice input, where ambient noise or occlusion effects can further degrade accuracy. As artificial intelligence agents become ubiquitous-used in cars, noisy workplaces, and areas with spotty connectivity-uninterrupted communication is essential. A user might start a conversation via in-canal microphone but run into poor network coverage or extreme background noise, rendering voice commands ineffective.

The described technology provides technical solutions to these technical problems. A system according to the described technology may monitor conversation quality and transition to another mode, such as a visual modality such as text or haptic feedback, without losing the user's place in the conversation. Additionally, predictive caching of likely responses (for example, local data for weather, directions, or personal notes) may allow the user to continue interacting with the agent even if connectivity is lost. Conversation state preservation may ensure that, upon returning to adequate network or quieter conditions, the dialogue may seamlessly continue where it left off.

The system may evaluate background interference and voice clarity in the user's ear canal as well as determine network strength, latency, and error rates to determine if voice-based communication remains feasible. The system may automatically switch between voice, visual modalities such as text, and haptic interaction. For example, the system may identify which mode best suits current conditions (for example, driving, high noise, no connectivity). The system may allow for preset user priorities in selecting a mode (for example, always switch to text if voice fails, or default to haptic in silent environments). The system may also learn common user queries, such as weather updates, directions, or daily schedules and predictively cache likely responses locally on the user device. If the network drops, the system can still provide pre-fetched responses or partial functionality.

The system may also maintain the thread of the conversation with the user so as to preserve conversation state across mode changes, thereby avoiding requiring the user to re-provide information. Furthermore, when switching back from offline or text modes, the system may synchronize agents with any new details.

An example use case involves a user wearing in-canal earbuds while traveling in a mountainous region with variable cellular coverage. At first, the user issues voice commands. Once the signal weakens, the system automatically switches to text-based interaction on a paired smartphone, preserving any partial conversation data. If the environment becomes too dangerous or inconvenient for texting (for example, driving or hiking), the system reverts to haptic prompts, prompting the user with simple touches to confirm or deny previously cached queries until connectivity or quieter conditions return.

Advantages of the technology include enhanced reliability, as the system may automatically adapt to fluctuating noise levels and network conditions, thereby reducing communication failures. The system may also facilitate a continuous user experience by retaining the conversation's context across voice, text, and haptic modes. Another advantage is that the predictive caching and context tracking may reduce redundant data transfers and user queries, thereby providing more efficient resource use. The system may offer multiple input/output methods which may meet various user abilities and situational requirements. The system may also be applicable to consumer, enterprise, and specialized devices that rely on artificial intelligence agent interactions.

### Conversation Security Classification and Response Methodology

Existing voice assistant and communication platforms generally use uniform response methods for all kinds of user queries. Regardless of whether a user is requesting a simple weather update or disclosing personal financial data, the output channel remains the same (for example, audible speaker output). This approach risks leaking confidential details in public or semi-public environments. While some systems incorporate user-defined privacy modes (for example, whisper mode, text-only), they often rely on manual toggling and fail to dynamically adapt as conversation topics evolve. Furthermore, these systems lack automated classification of conversation topics in real time, leading to potential oversights when users discuss multiple subjects of varying sensitivity.

A system according to the described technology provides technical solutions to these technical problems. The system may automatically classify conversation content in real time to adapt the response method (audio, haptic, bone conduction, etc.) in accordance with privacy sensitivity, ensuring secure and contextually appropriate communication. The system may enable context-aware privacy handling by scanning ongoing conversation content and applying predefined or user-set privacy thresholds. For example, if the user's conversation shifts from casual to sensitive banking questions, the system may upgrade to secure transmission, perhaps using bone conduction or haptic notifications. In case a user or system policy recognizes especially confidential content (for example, medical results), the system may adopt the most private channel available. Users can customize privacy tiers, so a high-sensitivity classification automatically suppresses audible responses while moderate-sensitivity classification could allow low-volume audio output. This adaptive mechanism may reduce the risk of inadvertently disclosing private information in public or shared spaces.

To analyze content in real-time, the system may use Natural Language Processing (NLP) algorithms to identify keywords and context to gauge the sensitivity of the communication. The system may compare detected content against user-defined or default classification rules (for example, personal data, financial info). The system may use one of multiple response modes based on the comparison: an audio output mode that may be used for low-sensitivity content or general inquiries, a haptic signals mode that may be used for moderate-sensitivity content, and a bone conduction mode for high-sensitivity content. Utilizing the bone conduction mode may minimize or reduce external audibility and ensure private playback for higher-security content.

The user may define privacy thresholds to tailor sensitivity levels (for example, low, medium, high) for various content categories. The user may also create custom profiles to allow for different contexts (work vs. personal) or environments (public vs. private). The system may allow the user to select a custom profile or may automatically select a custom profile based on context (for example, location). The system may dynamically switch modes during conversations. For example, once the system detects high-sensitivity content, the system may switch modes without interrupting the conversation. If the system detects low-sensitivity content, such as casual topics, the system may switch to a low-sensitivity mode.

An example use case involves a user wearing an in-ear device who initiates a conversation about general news. The system classifies this content as low-security and uses a conventional audio output. Partway through, the user pivots to credit card or health-related inquiries. As the classification engine flags the conversation as more sensitive, it transitions to bone conduction or haptic feedback to discreetly convey agent responses-protecting the user's privacy without requiring manual intervention.

Potential applications of the technology include corporate and enterprise settings. For example, the system may confidently handle confidential corporate strategies or sensitive human resources discussions through secure response methods. Another potential application includes healthcare environments, where the system may provide protected access to patient data or medical updates without risking audible disclosure in shared areas. Personal and financial services also may utilize the system: for example, the system may safeguard sensitive banking queries, investment details, or tax forms, thereby ensuring discretion in public spaces. Another potential application includes the military and the government, where the system may dynamically adapt to classified or high-security discussions in real time to prevent leaks.

Advantages of the technology include enhanced privacy: the system may minimize or reduce the risk of accidental exposure of sensitive data by switching to less audible or entirely silent feedback methods. Another advantage is given by the context-aware adaptation: NLP-driven classification logic may ensure that responses match the conversation's sensitivity, which may relieve users from manual mode toggling. Another advantage is provided by the customizable security levels: users or organizations can configure thresholds and response modes to align with privacy requirements or compliance regulations. The system may allow for continuous conversation flow: switching channels mid-conversation is seamless, preserving user engagement and minimizing disruption. The system may also be versatile in that the system may be deployed in consumer ear-worn devices, specialized security headsets, or integrated software solutions for broader communication systems.

FIG. 49 depicts a block diagram of an example digital device 4900 according to some embodiments. The digital device 4900 is shown in the form of a general-purpose computing device. The digital device 4900 includes at least one processor 4902, RAM 4904, communication interface 4906, input/output device 4908, storage 4910, and a system bus 4912 that couples various system components including storage 4910 to the at least one processor 4902. A system, such as a computing system, may be or include one or more of the digital devices 4900.

System bus 4912 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 4900 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 4902 is configured to execute executable instructions (for example, programs). In some embodiments, the at least one processor 4902 comprises circuitry or any processor capable of processing the executable instructions.

In some embodiments, RAM 4904 stores programs or data. In various embodiments, working data is stored within RAM 4904. The data within RAM 4904 may be cleared or ultimately transferred to storage 4910, such as prior to reset or powering down the digital device 4900.

In some embodiments, the digital device 4900 is coupled to a network, such as the communication network 3912, via communication interface 4906. The digital device 4900 can communicate with one or more networks such as a local area network (LAN), a general wide area network (WAN), or a public network (for example, the Internet).

In some embodiments, input/output device 4908 is any device that inputs data (for example, mouse, keyboard, stylus, sensors, etc.) or outputs data (for example, speaker, display, virtual reality headset).

In some embodiments, storage 4910 can include computer system readable media in the form of non-volatile memory, such as read only memory (ROM), programmable read only memory (PROM), solid-state drives (SSD), flash memory, or cache memory. Storage 4910 may further include other removable/non-removable, volatile/non-volatile computer system storage media. By way of example only, storage 4910 can be provided for reading from and writing to a non-removable, non-volatile magnetic media. The storage 4910 may include a non-transitory computer-readable medium, or multiple non-transitory computer-readable media, which stores programs or applications for performing functions. Although not shown, a magnetic disk drive for reading from and writing to a removable, non-volatile magnetic disk (for example, a floppy disk), and an optical disk drive for reading from or writing to a removable, non-volatile optical disk such as a CDROM, DVD-ROM or other optical media can be provided. In such instances, each can be connected to system bus 4912 by one or more data media interfaces. As will be further depicted and described below, storage 4910 may include at least one program product having a set (for example, at least one) of program modules that are configured to carry out the functions of embodiments of the technologies described herein. In some embodiments, RAM 4904 is found within storage 4910.

Programs/utilities, having a set (at least one) of program modules, such as the property layout system, may be stored in storage 4910 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions or methodologies of embodiments of the technologies described herein.

It should be understood that although not shown, other hardware or software components could be used in conjunction with the digital device 4900. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a circuit, module or system. Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present technologies may be written in any combination of one or more programming languages, including an object-oriented programming language such as Java, Smalltalk, C++, Python, or the like and conventional procedural programming languages, such as the C programming language or similar programming languages. The computer program code may execute entirely on any of the systems described herein or on any combination of the systems described herein.

Aspects of the present technologies may be described with reference to flowchart illustrations or block diagrams of methods, apparatus (systems) and computer program products according to embodiments of the technologies. It will be understood that each block of the flowchart illustrations or block diagrams, and combinations of blocks in the flowchart illustrations or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart or block diagram block or blocks.

While particular elements, embodiments and applications have been shown and described, it will be understood, of course, that the claims are not limited thereto since modifications may be made by those skilled in the art without departing from the spirit and scope of the present disclosure, particularly in light of the foregoing teachings. Such modifications are to be considered within the purview and scope of the claims appended hereto.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are examples only, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services,” and “providing products and services.”

Headings in this application may be provided for organization and may not necessarily be used to interpret or constrain the purview and scope of the claims appended hereto. Moreover, concepts or features of technologies described under a particular heading may be used in technologies described under other headings. Accordingly, technologies described under a particular heading are not limited to the concepts or features described under that particular heading.

It may be apparent that various modifications may be made, and other embodiments may be used without departing from the broader scope of the discussion herein. Therefore, these and other variations upon the example embodiments are intended to be covered by the disclosure herein.

1. An ear-worn device comprising:
an ear interface configured to be at least partially positioned in an ear canal of a wearer of the ear-worn device and form at least a partial seal with an ear of the wearer, wherein effects of the at least partial seal include speech of the wearer in the ear canal to be passively amplified for a first range of frequencies and external noises in the ear canal to be passively attenuated for a second range of frequencies;
one or more in-canal microphones configured to be positioned at least partially in the ear canal and to capture passively amplified speech of the wearer in the ear canal;
one or more sound output devices configured to be positioned at least partially in the ear canal and to output sounds in the ear canal;
one or more communication components configured to transmit and receive communication signals;
one or more processors; and
one or more memories storing instructions that, when executed by the one or more processors, cause the ear-worn device to perform a method, the method including:
receiving a signal generated from the passively amplified speech of the wearer captured by the one or more in-canal microphones, the passively amplified speech including one or more commands or queries for one or more artificial intelligence agents;
transmitting, by the one or more communication components, a first communication signal including the one or more commands or queries for processing by the one or more artificial intelligence agents;
receiving, by the one or more communication components, a second communication signal including one or more responses from the one or more artificial intelligence agents; and
outputting, by the one or more sound output devices, sounds for the one or more responses in the ear canal.

2. The ear-worn device of claim 1 wherein a signal to noise ratio (SNR) of the signal generated from the passively amplified speech of the wearer to a signal generated from passively attenuated external noises in the ear canal is at least approximately 10 dB for a third range of frequencies.

3. The ear-worn device of claim 2 wherein the speech of the wearer in the ear canal is passively amplified by at least approximately 10 dB for the first range of frequencies, the first range of frequencies including about 250 Hz to about 500 Hz, and the external noises in the ear canal are passively attenuated by at least approximately 10 dB for the second range of frequencies, the second range of frequencies including about 125 Hz to about 8000 Hz.

4. The ear-worn device of claim 1 wherein the effects of the at least partial seal further include speech of the wearer emanating from the ear canal to be passively attenuated by at least approximately 10 dB for a third range of frequencies, the third range of frequencies including about 125 Hz to about 8000 Hz.

5. The ear-worn device of claim 1 wherein the speech of the wearer captured by the one or more in-canal microphones includes passively amplified whispered or sub-vocal speech.

6. The ear-worn device of claim 1 wherein the signal is a first signal, the sounds are first sounds, and the method further includes:
receiving a second signal generated from bone-conducted speech or noises captured by the one or more in-canal microphones;
applying, based on the second signal, one or more noise suppression or equalization algorithms to generate a third signal; and
outputting, by the one or more sound output devices, second sounds for the third signal in the ear canal.

7. The ear-worn device of claim 1 wherein the signal is a first signal, the sounds are first sounds, further comprising one or more external microphones configured to capture external noises, and the method further includes:
receiving a second signal generated from passively amplified external noises captured by the one or more in-canal microphones or external noises captured by the one or more external microphones;
applying, based on the second signal, one or more noise suppression or equalization algorithms to generate a third signal; and
outputting, by the one or more sound output devices, second sounds for the third signal in the ear canal.

8. The ear-worn device of claim 1 wherein the ear interface includes a dynamic pressure-equalization vent having an adjustable opening that may be adjusted to be between approximately 0.01 mm and approximately 4.0 mm.

9. The ear-worn device of claim 8 wherein the method further includes adjusting the adjustable opening of the dynamic pressure-equalization vent to maintain passive amplification of the speech of the wearer in the ear canal by at least approximately 10 dB for the first range of frequencies and passive attenuation of external noises in the ear canal by at least approximately 10 dB for the second range of frequencies.

10. A method comprising:
capturing passively amplified speech of a wearer of an ear-worn device, the passively amplified speech captured by one or more in-canal microphones included in the ear-worn device, the one or more in-canal microphones positioned at least partially in an ear canal of the wearer, the passively amplified speech including one or more commands or queries for one or more artificial intelligence agents or applications, the ear-worn device further including:
an ear interface positioned at least partially in the ear canal, the ear interface forming at least a partial seal with an ear of the wearer, wherein effects of the at least partial seal include:
speech of the wearer in the ear canal to be passively amplified for a first range of frequencies; and
external noises in the ear canal to be passively attenuated for a second range of frequencies different from the first range of frequencies; and
one or more sound output devices positioned at least partially in the ear canal, the one or more sound output devices configured to output sounds in the ear canal;
transmitting the one or more commands or queries for processing by the one or more artificial intelligence agents or applications;
receiving one or more responses from the one or more artificial intelligence agents or applications; and
outputting, by the one or more sound output devices, sounds for the one or more responses in the ear canal.

11. The method of claim 10 wherein a signal to noise ratio (SNR) of a first signal generated from the passively amplified speech of the wearer to a second signal generated from passively attenuated external noises in the ear canal is at least approximately 10 dB for a third range of frequencies.

12. The method of claim 11 wherein the first range of frequencies for which the speech of the wearer in the ear canal is passively amplified includes about 250 Hz to about 500 Hz, and the second range of frequencies for which the external noises in the ear canal are passively attenuated includes about 125 Hz to about 8000 Hz.

13. The method of claim 10 wherein the effects of the at least partial seal further include speech of the wearer emanating from the ear canal to be passively attenuated across the second range of frequencies.

14. The method of claim 10 wherein capturing passively amplified speech of the wearer includes capturing passively amplified whispered or sub-vocal speech of the wearer.

15. The method of claim 10 wherein the sounds are first sounds, and further comprising:
capturing, by the one or more in-canal microphones, bone-conducted speech or noises;
applying, based on the bone-conducted speech or noises, one or more noise suppression or equalization algorithms to generate a signal; and
outputting, by the one or more sound output devices, second sounds for the signal in the ear canal.

16. The method of claim 10 wherein the sounds are first sounds, the ear-worn device further includes one or more external microphones configured to capture external noises, and further comprising:
receiving a signal generated from passively amplified external noises captured by the one or more in-canal microphones or external noises captured by the one or more external microphones;
applying, based on the signal, one or more noise suppression or equalization algorithms to generate a second signal; and
outputting, by the one or more sound output devices, second sounds for the second signal in the ear canal.

17. The method of claim 10 wherein the ear interface includes a dynamic pressure-equalization vent having an adjustable opening that may be adjusted to be between approximately 0.01 millimeters (mm) and approximately 4.0 mm.

18. The method of claim 17, further comprising adjusting the adjustable opening of the dynamic pressure-equalization vent to maintain passive amplification of the speech of the wearer in the ear canal by at least approximately 10 dB at frequencies from about 250 Hz to about 500 Hz and passive attenuation of external noises in the ear canal by at least approximately 10 dB at frequencies from about 125 Hz to about 8000 Hz.

19. One or more non-transitory computer-readable media comprising executable instructions that when executed by one or more processors of an ear-worn device cause the ear-worn device to perform a method comprising:
capturing passively amplified speech of a wearer of an ear-worn device, the passively amplified speech captured by one or more in-canal microphones included in the ear-worn device, the one or more in-canal microphones positioned at least partially in an ear canal of the wearer, the passively amplified speech including one or more commands or queries for one or more artificial intelligence agents or applications, the ear-worn device further including:
an ear interface positioned at least partially in the ear canal, the ear interface forming at least a partial seal with an ear of the wearer, wherein effects of the at least partial seal include:
speech of the wearer in the ear canal to be passively amplified for a first range of frequencies; and
external noises in the ear canal to be passively attenuated for a second range of frequencies different from the first range of frequencies; and
one or more sound output devices positioned at least partially in the ear canal, the one or more sound output devices configured to output sounds in the ear canal;
transmitting the one or more commands or queries for processing by the one or more artificial intelligence agents or applications;
receiving one or more responses from the one or more artificial intelligence agents or applications; and
outputting, by the one or more sound output devices, sounds for the one or more responses in the ear canal.

20. The one or more non-transitory computer-readable media of claim 19 wherein a signal to noise ratio (SNR) of a first signal generated from the passively amplified speech of the wearer to a second signal generated from passively attenuated external noises in the ear canal is at least approximately 10 dB for a third range of frequencies.

21. The one or more non-transitory computer-readable media of claim 19 wherein the first range of frequencies for which the speech of the wearer in the ear canal is passively amplified includes about 250 Hz to about 500 Hz, and the second range of frequencies for which the external noises in the ear canal are passively attenuated includes about 125 Hz to about 8000 Hz.

22. The one or more non-transitory computer-readable media of claim 19 wherein the effects of the at least partial seal further include speech of the wearer emanating from the ear canal to be passively attenuated across the second range of frequencies.

23. The one or more non-transitory computer-readable media of claim 19 wherein capturing speech of the wearer includes capturing passively amplified whispered or sub-vocal speech of the wearer.

24. The one or more non-transitory computer-readable media of claim 19 wherein the sounds are first sounds, and the method further comprises:
capturing, by the one or more in-canal microphones, bone-conducted speech or noises;
applying, based on the bone-conducted speech or noises, one or more noise suppression or equalization algorithms to generate a signal; and
outputting, by the one or more sound output devices, second sounds for the signal in the ear canal.

25. The one or more non-transitory computer-readable media of claim 19 wherein the sounds are first sounds, the ear-worn device further includes one or more external microphones configured to capture external noises, and the method further comprises:
receiving a signal generated from passively amplified external noises captured by the one or more in-canal microphones or external noises captured by the one or more external microphones;
applying, based on the signal, one or more noise suppression or equalization algorithms to generate a second signal; and
outputting, by the one or more sound output devices, second sounds for the second signal in the ear canal.

26-114. (canceled)
